(19) United States
(12) Patent Application Publication
(10) Pub. No.: US 2011/0060707 A1
(43) Pub. Date: Mar. 10, 2011

(54) INFORMATION PROCESSING DEVICE, INFORMATION PROCESSING METHOD, AND PROGRAM

(76) Inventor: Hirotaka SUZUKI, Kanagawa (JP)

(21) Appl. No.: 12/869,321

(22) Filed: Aug. 26, 2010

(30) Foreign Application Priority Data
Sep. 7, 2009 (JP) P2009-206435

(51) Int. Cl. G06F 15/18

(52) U.S. Cl. 706/12

(57) ABSTRACT

An information processing device includes: a hierarchy processing unit for generating a unit to connect the unit in a hierarchical structure, the unit including an input control unit for performing input control for storing an observed value, and outputting the time series of the observed value as input data to be given to a learning model having an HMM (Hidden Markov Model) as a minimum component module, a model processing unit for performing processing using the learning model, including a module learning unit for obtaining likelihood of the input data being observed with the module, to determine one module of the learning model, or new module to be an object module having HMM parameters to be updated, and to perform module learning processing for updating the HMM parameters, and a recognizing unit for recognizing the input data using the learning model, and an output control unit for performing output control.

### BACKGROUND OF THE INVENTION

1. Field of the Invention

The present invention relates to an information processing device, an information processing method, and a program, and more specifically, it relates to an information processing device, an information processing method, and a program, which enable a learning model having a suitable scale to be obtained as to a modeling object.

2. Description of the Related Art

Examples of a method for sensing a modeling object that is an object to be modeled by a sensor, and subjecting a sensor signal to be output by the sensor thereof to modeling (learning of a learning model) using an observed value, include the k-means clustering method for clustering a sensor signal (observed value), and SOM (Self-Organization Map).

For example, if we consider that a certain state (internal state) of a modeling object corresponds to a cluster, with the k-means clustering method and the SOM, a state is disposed within the signal space (observation space of an observed value) of a sensor signal as a representative vector.

That is to say, with the learning of the k-means clustering method, a representative vector serving as an initial value (centroid vector) is suitably disposed within signal space. Further, with a vector serving as a sensor signal at each point in time as input data, the input data (vector) is allocated to a representative vector having distance closest to the input data thereof. Subsequently, according to the mean vector of the input data allocated to each representative vector, updating of the representative vectors is repeated.

With the learning of the SOM, a representative vector serving as an initial value is suitably given to a node making up the SOM. Further, with a vector serving as a sensor signal as input data, a node having a representative vector having closest distance as to the input data is determined to be a winner node. Subsequently, competitive neighborhood learning is performed wherein the representative vectors of adjacent nodes including the winner node are updated so that the closer to the winner node the representative vector of a node is, the more the representative vector thereof is influenced by the input data (T. Kohonen, “Self-Organization Map” (Springer-Verlag Tokyo).

There are a great number of studies relating to SOM, and a learning method called Growing Grid for performing learning while successively increasing states (representative vectors), and so forth have been proposed (B. Fritzke, “Growing Grid—a self-organizing network with constant neighborhood range and adaptation strength”, Neural Processing Letters (1995), Vol. 2, No. 5, page 9-13).

With learning such as the above k-means clustering method, SOM method, a state (representative vector) is simply disposed within the signal space of a sensor signal, state transition information (information regarding how the state is changed) is not obtained.

Further, as no state transition information is obtained, and accordingly, a problem called perceptual aliasing, i.e., a problem is not readily handled wherein in the case that the sensor signals to be observed from a modeling object are the same even when the states of modeling objects differ, this is not readily distinguished.

Specifically, for example, in the event that a mobile robot including a camera observes a scenery image through the camera as a sensor signal, when there are multiple places where the same scenery image is observed within an environment, a problem occurs in that these places are not readily distinguished.

On the other hand, utilization of an HMM (Hidden Markov Model) has been proposed as a method wherein a sensor signal to be observed from a modeling object is handled as time series data, and the modeling object is learned as a probability model having both a state and a state transition using the time series data thereof.

The HMM is one of models widely used for audio recognition, and is a state transition model defined with a state transition probability representing a probability that a state may be changed, an output probability density function representing probability density serving as an observation probability that in each state, when the state is changed, a certain observed value may be observed, or the like (L. Rabiner, B. Juang, “An introduction to hidden Markov models”, ASSP Magazine, IEEE, January 1986, Volume: 3, Issue: 1, Part 1, pp. 4-16).

The parameters of the HMM, i.e., a state transition probability, an output density function, and so forth are estimated so as to maximize likelihood. As an estimation method for the HMM parameters (model parameters), the Baum-Welch reestimation method (Baum-Welch algorithm) has widely been employed.

The HMM is a state transition model capable of changing to another state from each state via a state transition probability, and according to the HMM, (a sensor signal observed from) a modeling object is subjected to modeling as process where a state is changed.

However, with the HMM, regarding which state a sensor signal to be observed corresponds to is determined a probability manner. Therefore, as a method for determining state transition process where the likelihood becomes the highest, i.e., a series of states that maximize the likelihood (maximum likelihood state series) (hereafter, also referred to as “maximum likelihood path”) based on a sensor signal to be observed, the Viterbi algorithm method has widely been employed.

According to the Viterbi algorithm method, a state corresponding to the sensor signal at each point in time may uniquely be determined along the maximum likelihood path.

According to the HMM, even when sensor signals to be observed from a modeling object become the same in a different situation (state), the same sensor signal may be handled as different state transition process according to difference of time change process of sensor signals before and after that point in time.

Note that, with the HMM, a perceptual aliasing problem is not completely solved, but a different state may be allocated to the same signal, and a modeling object may be modeled in more detail as compared to the SOM.

Incidentally, with the learning of the HMM, in the event that the number of states, and the number of state transitions increase, the parameters are not suitably (correctly) estimated.

In particular, the Baum-Welch reestimation method is not necessarily a method for ensuring determination of the optimal parameters, and accordingly, as the number of the parameters increase, it becomes extremely difficult to estimate the suitable parameters.

Also, in the case that a modeling object is an unknown object, it is difficult to suitably set the configuration of the HMM, the initial value of the parameters, and this also becomes a cause for preventing estimation of the suitable parameters.

With audio recognition, major factors whereby the HMM has been effectively used to obtain the great results of research over many years include sensor signals to be handled being restricted to audio signals, a great number of findings relating to audio being available, the configuration of a left-to-right type configuration being effective regarding the configuration of the HMM for suitably subjecting audio to modeling, and so forth.

Accordingly, in the event that a modeling object is an unknown object, and information for determining the configuration and initial values of the HMM is not given beforehand, it is a very difficult problem to cause a large-scale HMM to function as a practical model.

Note that a method for determining the configuration itself of the HMM instead of providing the configuration of the HMM beforehand has been proposed (Shiroh Ikeda, “Generation of Phonemic models by Structure Search of HMM”, the Institute of Electronics, Information and Communication Engineers paper magazine D-II, Vol. J78-D-II, No. 1, pp. 10-18, January 1995).

With the method described in Shiroh Ikeda, “Generation of Phonemic models by Structure Search of HMM”, the Institute of Electronics, Information and Communication Engineers paper magazine D-II, Vol. J78-D-II, No. 1, pp. 10-18, January 1995, the configuration of the HMM is determined while repeating processing wherein each time the number of HMM states, or the number of state transitions is incremented by one at a time, estimation of the parameters is performed, and the HMM is evaluated using an evaluation standard called Akaike's Information Criteria (referred to as AIC).

The method described in Shiroh Ikeda, “Generation of Phonemic models by Structure Search of HMM”, the Institute of Electronics, Information and Communication Engineers paper magazine D-II, Vol. J78-D-II, No. 1, pp. 10-18, January 1995 is applied to a small-scale HMM such as a phonemic model. However, the method described therein is not a method in which estimation of the parameters of a large-scale HMM is taken into consideration, and accordingly, it is difficult to suitably subject a complicated modeling object to modeling.

That is to say, in general, simply performing correction for adding a state and a state transition one at a time does not necessarily ensure improvement in the evaluation standard in a monotonous manner.

Accordingly, with regard to a complicated modeling object represented with a large-scale HMM, the suitable configuration of the HMM is not necessarily determined even when employing the method described in Shiroh Ikeda, “Generation of Phonemic models by Structure Search of HMM”, the Institute of Electronics, Information and Communication Engineers paper magazine D-II, Vol. J78-D-II, No. 1, pp. 10-18, January 1995.

With regard to a complicated modeling object, a learning method has been proposed wherein a small-scale HMM is taken as a module that is the minimum component, and the whole optimization learning of a group (module network) of modules is performed (Japanese Unexamined Patent Application Publication No. 2008-276290, Panu Somervuo, “Competing Hidden Markov Models on the Self-Organizing Map”, ijcnn, pp. 3169, IEEE-INNS-ENNS International Joint Conference on Neural Networks (IJCNN'00)-Volume 3, 2000, and R. B. Chinnam, P. Baruah, “Autonomous Diagnostics and Prognostics Through Competitive Learning Driven HMM-Based Clustering”, Proceedings of the International Joint Conference on Neural Networks, 20-24 Jul. 2003, On page(s): 2466-2471 vol. 4).

With the methods described in Japanese Unexamined Patent Application Publication No. 2008-276290, and Panu Somervuo, “Competing Hidden Markov Models on the Self-Organizing Map”, ijcnn, pp. 3169, IEEE-INNS-ENNS International Joint Conference on Neural Networks (IJCNN'00)-Volume 3, 2000, the SOM in which a small-scale HMM is allocated to each node is used as a learning model, and competitive neighborhood learning is performed.

The learning models described in Japanese Unexamined Patent Application Publication No. 2008-276290, and Panu Somervuo, “Competing Hidden Markov Models on the Self-Organizing Map”, ijcnn, pp. 3169, IEEE-INNS-ENNS International Joint Conference on Neural Networks (IJCNN'00)-Volume 3, 2000 are models having the SOM clustering capability, and the structuring features of the HMM time series data, but the number of nodes (modules) of the SOM has to be set beforehand, and in the case that the scale of a modeling object is not known beforehand, it is difficult to apply these to such a case.

Also, with the method described in R. B. Chinnam, P. Baruah, “Autonomous Diagnostics and Prognostics Through Competitive Learning Driven HMM-Based Clustering”, Proceedings of the International Joint Conference on Neural Networks, 20-24 Jul. 2003, On page(s): 2466-2471 vol. 4, the competitive learning of multiple modules is performed with the HMM as a module. That is to say, with the method described in R. B. Chinnam, P. Baruah, “Autonomous Diagnostics and Prognostics Through Competitive Learning Driven HMM-Based Clustering”, Proceedings of the International Joint Conference on Neural Networks, 20-24 Jul. 2003, On page(s): 2466-2471 vol. 4, a certain number of HMM modules are prepared, and the likelihood of each module is calculated as to input data. Subsequently, learning is performed by providing the input data to the HMM of a module (winner) that obtains the maximum likelihood.

With the method described in R. B. Chinnam, P. Baruah, “Autonomous Diagnostics and Prognostics Through Competitive Learning Driven HMM-Based Clustering”, Proceedings of the International Joint Conference on Neural Networks, 20-24 Jul. 2003, On page(s): 2466-2471 vol. 4 as well, in the same way as with the method described in Panu Somervuo, “Competing Hidden Markov Models on the Self-Organizing Map”, ijcnn, pp. 3169, IEEE-INNS-ENNS International Joint Conference on Neural Networks (IJCNN'00)-Volume 3, 2000, the number of modules has to be set beforehand, and in the case that the scale of a modeling object is not known beforehand, it is difficult to apply this to such a case.

### SUMMARY OF THE INVENTION

With a learning method according to the related art, in the case that the scale of a modeling object is not known beforehand, in particular, for example, it is difficult to obtain a suitable-scale learning model as to a large-scale modeling object.

Accordingly, it has been found to be desirable to enable a suitable-scale learning model to be obtained as to a modeling object even when the scale of a modeling object is not known beforehand.

An information processing device or program according to an embodiment of the present invention is an information processing device or program causing a computer to serve as an information processing device, including: a hierarchy processing unit configured to generate a unit to connect the unit in a hierarchical structure, the unit including an input control unit configured to perform input control for storing an observed value to be externally supplied, and outputting the time series of the observed value as input data to be given to a learning model having an HMM (Hidden Markov Model) as a module that is the minimum component, a model processing unit configured to perform processing using the learning model, which includes a module learning unit configured to obtain, regarding each module making up the learning model, likelihood of the input data being observed with the module, to determine one module of the learning model, or a new module to be an object module that is an object module having HMM parameters to be updated, based on the likelihood, and to perform module learning processing for updating the HMM parameters of the object module using the input data, and a recognizing unit configured to recognize the input data using the learning model to output recognition result information that represents the recognition result of the input data, and an output control unit configured to perform output control for storing the recognition result information to output the recognition result information as output data to be externally output; with the output control unit of a lower unit which is a lower layer unit outputting the output data to an upper unit which is an upper layer unit connected to the lower unit; and with the input control unit of the upper unit storing the output data from the lower unit, and outputting the time series of the output data as the input data.

An information processing method according to an embodiment of the present invention is an information processing method including a step of: generating a unit to connect the unit in a hierarchical structure, the unit including an input control unit configured to perform input control for storing an observed value to be externally supplied, and outputting the time series of the observed value as input data to be given to a learning model having an HMM (Hidden Markov Model) as a module that is the minimum component, a model processing unit configured to perform processing using the learning model, which includes a module learning unit configured to obtain, regarding each module making up the learning model, likelihood of the input data being observed with the module, to determine one module of the learning model, or a new module to be an object module that is an object module having HMM parameters to be updated, based on the likelihood, and to perform module learning processing for updating the HMM parameters of the object module using the input data, and a recognizing unit configured to recognize the input data using the learning model to output recognition result information that represents the recognition result of the input data, and an output control unit configured to perform output control for storing the recognition result information to output the recognition result information as output data to be externally output; with the output control unit of a lower unit which is a lower layer unit outputting the output data to an upper unit which is an upper layer unit connected to the lower unit; and with the input control unit of the upper unit storing the output data from the lower unit, and outputting the time series of the output data as the input data.

With the above configurations, there is generated a unit to connect the unit in a hierarchical structure, which includes an input control unit configured to perform input control for storing an observed value to be externally supplied, and outputting the time series of the observed value as input data to be given to a learning model having an HMM (Hidden Markov Model) as a module that is the minimum component, a model processing unit configured to perform processing using the learning model, and an output control unit configured to perform output control for storing the recognition result information to output the recognition result information as output data to be externally output. Subsequently, with the output control unit of a lower unit which is a lower layer unit, the output data is output to an upper unit which is an upper layer unit connected to the lower unit, and with the input control unit of the upper unit, the output data from the lower unit is stored, and the time series of the output data is output as the input data.

Note that the information processing device may be a stand-alone device, or may be an internal block making up a single device.

Also, the program may be provided by being transmitted via a transmission medium, or being recorded in a recording medium.

According to the above configurations, a suitable-scale learning model can be obtained as to a modeling object. In particular, for example, a suitable learning model can readily be obtained as to a large-scale modeling object.

### BRIEF DESCRIPTION OF THE DRAWINGS

FIG. 1 is a block diagram illustrating a configuration example of a first embodiment of a learning device to which an information processing device according to the present invention has been applied;

FIG. 2 is a diagram for describing the times series of an observed value to be supplied from an observation time series buffer to a module learning unit;

FIG. 3 is a diagram illustrating an example of an HMM (Hidden Markov Model).

FIG. 4 is a diagram illustrating an example of the HMM to be used for audio recognition;

FIG. 5 is a diagram illustrating an example of a small world network;

FIG. 6 is a diagram illustrating an example of an ACHMM (Additional Competitive Hidden Markov Model);

FIG. 7 is a diagram for describing the outline of ACHMM learning (module learning);

FIG. 8 is a block diagram illustrating a configuration example of a module learning unit;

FIG. 9 is a flowchart for describing module learning processing;

FIG. 10 is a flowchart for describing object module determining processing;

FIG. 11 is a flowchart for describing existing module learning processing;

FIG. 12 is a flowchart for describing new module learning processing;

FIG. 13 is a diagram illustrating an example of an observed value in accordance with each of Gauss distributions G1 through G3;

FIG. 14 is a diagram illustrating an example of timing for activating the Gauss distributions G1 through G3;

FIG. 15 is a diagram illustrating relationship of a coefficient, distance between mean vectors, and the number of modules making up the ACHMM after learning;

FIG. 16 is a diagram illustrating a coefficient and distance between means vectors in the case that the number of modules of the ACHMM after learning is 3 through 5;

FIG. 17 is a flowchart for describing module learning processing;

FIG. 18 is a flowchart for describing existing module learning processing;

FIG. 19 is a flowchart for describing new module learning processing;

FIG. 20 is a block diagram illustrating a configuration example of a recognizing unit;

FIG. 21 is a flowchart for describing recognition processing;

FIG. 22 is a block diagram illustrating a configuration example of a transition information management unit;

FIG. 23 is a diagram for describing transition information generating processing for the transition information management unit generating transition information;

FIG. 24 is a flowchart for describing transition information generating processing;

FIG. 25 is a block diagram illustrating a configuration example of an HMM configuration unit;

FIG. 26 is a diagram for describing a combined HMM configuration method by the HMM configuration unit;

FIG. 27 is a diagram for describing a specific example of a method for obtaining the HMM parameters of the combined HMM by the HMM configuration unit;

FIG. 28 is a block diagram illustrating a configuration example of the first embodiment of an agent to which the learning device has been applied;

FIG. 29 is a flowchart for describing learning processing for an action controller obtaining an action function;

FIG. 30 is a flowchart for describing action control processing;

FIG. 31 is a flowchart for describing planning processing;

FIG. 32 is a diagram for describing the outline of ACHMM learning by the agent;

FIG. 33 is a diagram for describing the outline of reconfiguration of the combined HMM by the agent;

FIG. 34 is a diagram for describing the outline of planning by the agent;

FIG. 35 is a diagram illustrating an example of ACHMM learning, and reconfiguration of the combined HMM by the agent which moves within a motion environment;

FIG. 36 is a diagram illustrating another example of ACHMM learning, and reconfiguration of the combined HMM by the agent which moves within a motion environment;

FIG. 37 is a diagram illustrating the time series of the index of a maximum likelihood module to be obtained by recognition using the ACHMM in the case that the agent moves within a motion environment;

FIG. 38 is a diagram for describing an ACHMM having a hierarchical structure of two hierarchies where a lower ACHMM and an upper ACHMM are connected in a hierarchical structure;

FIG. 39 is a diagram illustrating an example of a motion environment of the agent;

FIG. 40 is a block diagram illustrating a configuration example of a second embodiment of a learning device to which the information processing device according to the present invention has been applied;

FIG. 41 is a block diagram illustrating a configuration example of an ACHMM hierarchy processing unit;

FIG. 42 is a block diagram illustrating a configuration example of an ACHMM processing unit of an ACHMM unit;

FIG. 43 is a diagram for describing a first output control method of output control of output data by an output control unit;

FIG. 44 is a diagram for describing a second output control method of output control of output data by the output control unit;

FIG. 45 is a diagram for describing the granularity of the HMM state of an upper unit in the case that a lower unit outputs the recognition result information of each of types 1 and 2;

FIG. 46 is a diagram for describing a first input control method of input control of input data by an input control unit;

FIG. 47 is a diagram for describing a second input control method of input control of input data by the input control unit;

FIG. 48 is a diagram for describing expansion of the observation probability of an HMM serving as an ACHMM module;

FIG. 49 is a flowchart for describing unit generating processing;

FIG. 50 is a flowchart for describing unit learning processing;

FIG. 51 is a block diagram illustrating a configuration example of the second embodiment of the agent to which the learning device has been applied;

FIG. 52 is a block diagram illustrating a configuration example of an ACHMM unit of an h hierarchical level other than the lowermost level;

FIG. 53 is a block diagram illustrating a configuration example of an ACHMM unit of the lowermost level;

FIG. 54 is a flowchart for describing action control processing to be performed by a planning unit of a target state specifying unit;

FIG. 55 is a flowchart for describing action control processing to be performed by a planning unit of an intermediate layer unit;

FIG. 56 is a flowchart for describing action control processing to be performed by a planning unit of a lowermost layer unit;

FIG. 57 is a diagram schematically illustrating the ACHMM of each hierarchical level in the case that a hierarchical ACHMM is configured of ACHMM units of three hierarchical levels;

FIG. 58 is a flowchart for describing another example of module learning processing to be performed by a module learning unit;

FIG. 59 is a flowchart for describing sample saving processing;

FIG. 60 is a flowchart for describing object module determining processing;

FIG. 61 is a flowchart for describing temporary learning processing;

FIG. 62 is a flowchart for describing ACHMM entropy calculating processing;

FIG. 63 is a flowchart for describing processing for determining an object module based on a posterior probability;

FIG. 64 is a block diagram illustrating a configuration example of a third embodiment of a learning device to which the information processing device according to the present invention has been applied;

FIG. 65 is a diagram illustrating an example of RNN serving as a time series pattern storage model that becomes a module of a module additional architecture-type learning model;

FIG. 66 is a flowchart for describing learning processing (module learning processing) of a module additional architecture-type learning model to be performed by a module learning unit; and

FIG. 67 is a block diagram illustrating a configuration example of an embodiment of a computer to which the present invention has been applied.

### DESCRIPTION OF THE PREFERRED EMBODIMENTS

### 1. First Embodiment

### Configuration Example of Learning Device

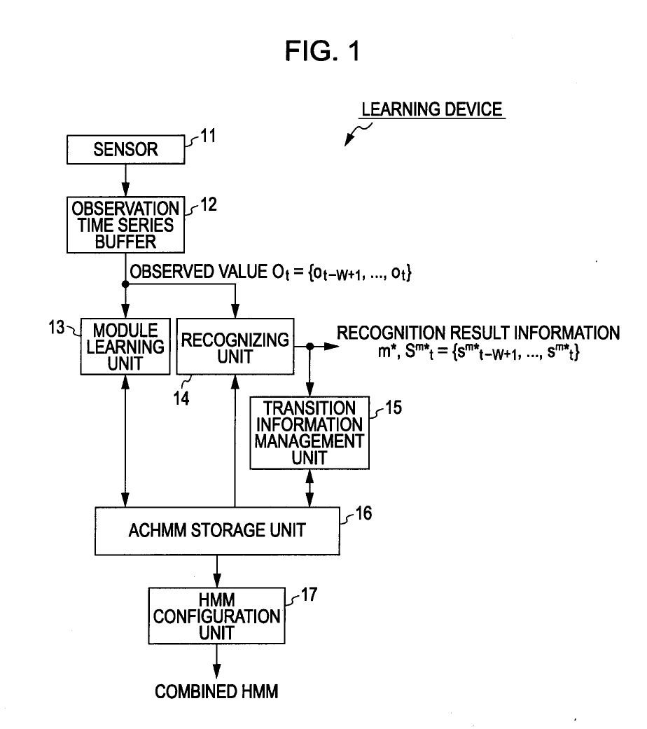

FIG. 1 is a block diagram illustrating a configuration example of a first embodiment of a learning device to which an information processing device according to the present invention has been applied.

In FIG. 1, based on an observed value to be observed from a modeling object, the learning device learns a learning model (performs modeling) for providing statistical dynamic property of the modeling object.

Now, let us say that the learning device has no preliminary knowledge as to the modeling object, but may have preliminary knowledge.

The learning device includes a sensor 11, an observation time series buffer 12, a module learning unit 13, a recognizing unit 14, a transition information management unit 15, an ACHMM storage unit 16, and an HMM configuration unit 17.

The sensor 11 senses the modeling object at each point in time to output an observed value that is a sensor signal to be observed from the modeling object in time series.

The observation time series buffer 12 temporarily stores the time series of the observed value output from the sensor 11. The time series of the observed value stored in the observation time series buffer 12 are successively supplied to the module learning unit 13 and the recognizing unit 14.

Note that the observation time series buffer 12 has at least storage capacity enough for storing later-described observed values of window length W, and after storing the storage capacity of observed values thereof, the oldest observed value is eliminated, and a new observed value is stored.

The module learning unit 13 is a learning model having the HMM stored in the ACHMM storage unit 16 using the time series of an observed value to be successively supplied from the observation time series buffer 12 as a module that is the minimum component, and performs learning of a later-described ACHMM (Additional Competitive Hidden Markov Model).

The recognizing unit 14 uses the ACHMM stored in the ACHMM storage unit 16 to recognize (identify) the time series of an observed value to be successively supplied from the observation time series buffer 12, and outputs recognition result information representing the recognition result thereof.

The recognition result information output from the recognizing unit 14 is supplied to the transition information management unit 15. Note that the recognition result information may be output outside (of the learning device).

The transition information management unit 15 generates transition information that is the information of frequency of each state transition of the ACHMM stored in the ACHMM storage unit 16, and supplies this to the ACHMM storage unit 16.

The ACHMM storage unit 16 stores (the model parameters of) an ACHMM that is a learning model having an HMM as a module that is the minimum component.

The ACHMM stored in the ACHMM storage unit 16 is referenced by the module learning unit 13, recognizing unit 14, and transition information management unit 15 as appropriate.

Note that the model parameters of an HMM (HMM parameters) that is a module making up an ACHMM, and the transition information to be generated by the transition information management unit 15 are included in the model parameters of the ACHMM.

The HMM configuration unit 17 configures (reconfigures) a larger-scale HMM (hereafter, also referred to as combined HMM) (than an HMM that is a module making up the ACHMM) from the ACHMM stored in the ACHMM storage unit 16.

That is to say, the HMM configuration unit 17 combines multiple modules making up the ACHMM stored in the ACHMM storage unit 16 using the transition information stored in the ACHMM storage unit 16, thereby configuring a combined HMM that is a single HMM.

### Observed Values

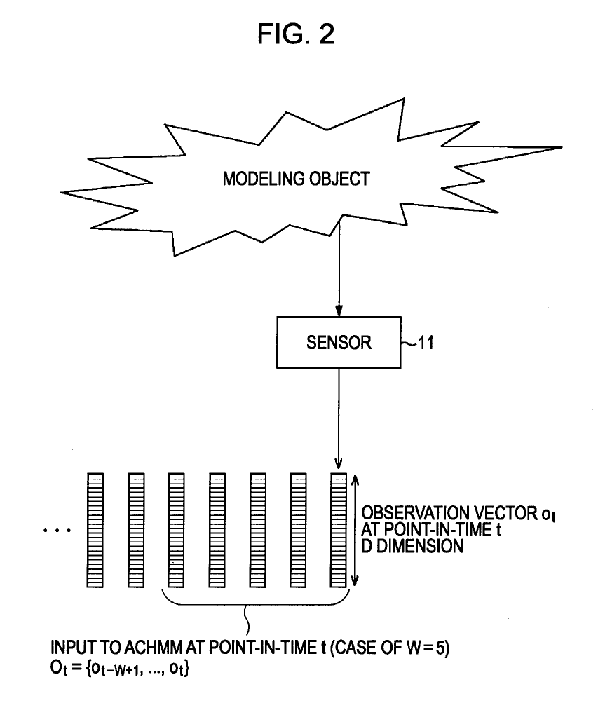

FIG. 2 is a diagram for describing the times series of an observed value to be supplied from the observation time series buffer 12 to the module learning unit 13 (and recognizing unit 14) in FIG. 1.

As described above, the sensor 11 (FIG. 1) outputs an observed value that is a sensor signal to be observed from a modeling object (environment, system, phenomenon, or the like) in time series, and the time series of the observed value are supplied from the observation time series buffer 12 to the module learning unit 13.

Now, if we say that the sensor 11 has output an observed value oₜ at point in time t, the times series of the latest observed value, i.e., time series data Oₜ={o_{t-W+1}, . . . , oₜ} at the point in time t that is the time series of the observed value for the past W points in time since the point in time t are supplied from the observation time series buffer 12 to the module learning unit 13.

Now, the length W (hereafter, also referred to as window length W) of the time series data Oₜ to be supplied to the module learning unit 13 is an index regarding how much time granularity the dynamic property of the modeling object is divided into states as a probability statistical state transition model (here, HMM), and is set beforehand.

In FIG. 2, the window length W is 5. The window length W is conceived to be set to a value of 1.5 through 2 times of the number of the states of an HMM that is a module of the ACHMM, and for example, in the case that the number of the states of the HMM is 9, 15 or the like may be employed as the window length W.

Note that the observed value to be output from the sensor 11 may be a vector (including one-dimensional vector scalar value) that takes a continuous value, or may be a symbol that takes a discrete value.

In the case that the observed value is a vector (observation vector), a continuous HMM having probability density where the observed value may be observed as a parameter (HMM parameter) is employed as an HMM serving as a module of the ACHMM. Also, in the case that the observed value is a symbol, a discrete HMM having a probability that the observed value may be observed as an HMM parameter is employed as an HMM serving as a module of the ACHMM.

### ACHMM

Next, the ACHMM will be described, but before that, an HMM serving as a module of the ACHMM will briefly be described.

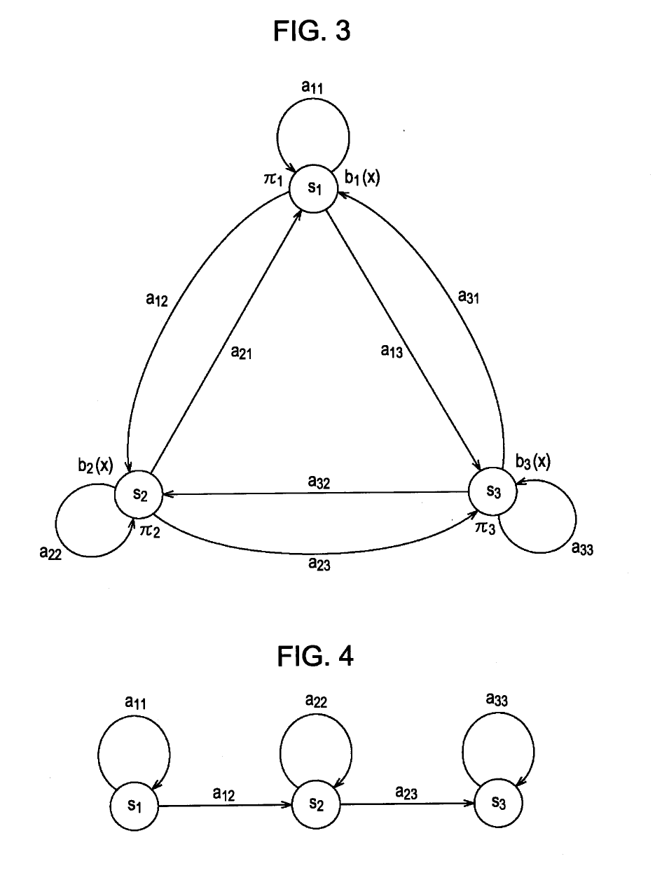

FIG. 3 is a diagram illustrating an example of an HMM.

The HMM is a state transition model made up of a state and a state transition.

The HMM in FIG. 3 is an HMM having three states s₁, s₂, and s₃, and in FIG. 3, circle marks represent a state, and arrows represent a state transition.

The HMM is defined with a state transition probability aᵢⱼ, the observation probability bⱼ( ) in each state sⱼ, and the initial (state) probability πᵢ in each state sᵢ.

The state transition probability aᵢⱼ represents a probability that a state transition from the state sᵢ to the state sⱼ may occur, and the initial probability πᵢ represents a probability that the first state before a state transition occurs may be the state sᵢ.

The observation probability bⱼ(x) represents a probability that an observed value x may be observed in the state sⱼ. In the case that the observed value x is a discrete value (symbol) (in the case that the HMM is a discrete HMM), a value serving as a probability is used as the observation probability bⱼ(x), but in the case that the observed value x is a continuous value (vector) (in the case that the HMM is a continuous HMM), a probability density function is used as the observation probability bᵢ(o).

As a probability density function (hereafter, also referred to as output probability density function) serving as an observation probability bⱼ(x), a contaminated normal probability distribution is employed, for example. For example, if we say that a contaminated distribution of a Gauss distribution is employed as an output probability density function (observation probability) bⱼ(x), the output probability density function bⱼ(x) is represented with

$$\begin{matrix}Expression ( 1 ) & \\ {b}_{j} ( x ) = {\sum }_{k = 1}^{V} {c}_{jk} N [ x , {μ}_{jk} , {Σ}_{jk} ] . & ( 1 )\end{matrix}$$

Now, if we say that, in Expression (1), with N[x, μⱼₖ, Σⱼₖ], the observed value x is a D-dimensional vector, a mean vector is represented with the D-dimensional vector μⱼₖ, and a covariance matrix represents a Gauss distribution represented with the matrix Σⱼₖ of D rows×D columns.

Also, V represents the total number of Gauss distributions to be mixed (the number of mixtures), cⱼₖ represents the weighting factor (mixed weighting factor) of the k'th Gauss distribution N[x, μⱼₖ, Σⱼₖ] when V Gauss distributions are mixed.

A state transition probability aᵢⱼ, an output probability density function (observation probability) bⱼ(x), and an initial probability πᵢ, which define an HMM, are the parameters of the HMM (HMM parameters), and hereafter, the HMM parameters are represented with λ=[aᵢⱼ, bⱼ(x), πᵢ, i=1, 2, . . . , N, j=1, 2, . . . , N]. Note that N represents the number of HMM states (the number of states).

Estimation of the HMM parameters, i.e., learning of an HMM is, in general, performed in accordance with the Baum-Welch algorithm (Baum-Welch reestimation method) described in L. Rabiner, B. Juang, “An introduction to hidden Markov models”, ASSP Magazine, IEEE, January 1986, Volume: 3, Issue: 1, Part 1, pp. 4-16, or the like.

The Baum-Welch algorithm is a parameter estimation method based on an EM algorithm wherein the HMM parameters λ are estimated so as to maximize logarithmic likelihood to be obtained from an occurrence probability where based on time series data x=x₁, x₂, . . . , x_{T}, the time series data x thereof is observed (occurs) from an HMM.

Here, with the time series data x=x₁, x₂, . . . , x_{T}, x represents an observed value at point-in-time t, and T represents the length of the time series data (the number of observed values xₜ making up the time series data).

Note that the Baum-Welch algorithm is a parameter estimation method for maximizing logarithmic likelihood, but does not ensure optimality, and accordingly, a problem occurs wherein the HMM parameters converges on a local solution depending on the configuration (the number of HMM states, or available state transitions) of the HMM or the initial values of the HMM parameters.

The HMM has widely been employed for audio recognition, but with the HMM employed for audio recognition, the number of states, a state transition, and the like are often adjusted beforehand.

FIG. 4 is a diagram illustrating an example of the HMM employed for audio recognition.

The HMM in FIG. 4 is an HMM called a left-to-right type wherein only the self transition and a state transition to the right state from the current state are allowed as a state transition.

The HMM in FIG. 4 includes three states s₁ through s₃ in the same way as with the HMM in FIG. 3, but the state transition thereof is restricted to a configuration where only the self transition and a state transition to the right state from the current state are allowed.

Here, with the above HMM in FIG. 3, state transitions are not restricted, a state transition to an arbitrary state is available, but such an HMM whereby a state transition to an arbitrary state is available is referred to as an ergodic HMM (ergodic-type HMM).

(Suitable) modeling may be performed even when the state transition of the HMM is restricted to partial state transitions alone depending on a modeling object, but here, it is taken into consideration that preliminary knowledge such as scaling of a modeling object and the like, i.e., information for determining the configuration of an HMM, such as the number of suitable states as to a modeling object, how to apply restriction of state transitions, may not be known beforehand, and accordingly, let us say that such information is not provided.

In this case, with regard to modeling of a modeling object, it is desirable to employ an ergodic-type HMM having the highest configurational flexibility.

However, with the ergodic-type HMM, increase in the number of states prevents estimation of the HMM parameters from being readily performed.

For example, in the case that the number of states is 1000, the number of state transitions is one million ways, and accordingly, one million probabilities have to be estimated as state transition probabilities.

Accordingly, in the case that there are many HMM states used for suitably (accurately) modeling a modeling object, huge calculation cost has to be spent for estimation of the HMM parameters, and as a result thereof, HMM learning is not readily performed.

Therefore, with the learning device in FIG. 1, the ACHMM including an HMM as a module is employed instead of an HMM itself as a learning model used for modeling of a modeling object.

The ACHMM is a learning model based on a hypothesis to the effect that most of natural phenomena may be represented with a small world network.

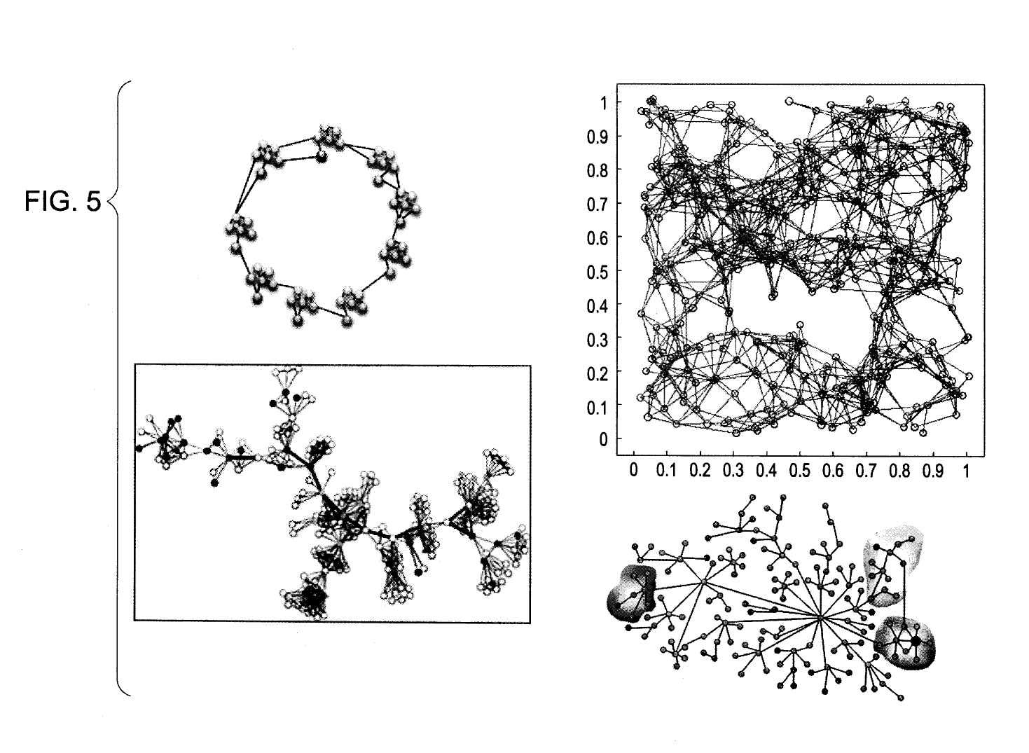

FIG. 5 is a diagram illustrating an example of the small world network.

The small world network is made up of a repetitively available network (small world) locally configured, and a thinned network connecting between the small worlds (local configurations) thereof.

With the ACHMM, estimation of the model parameters of a state transition model for providing the probability statistical dynamic property of a modeling object is performed with a small-scale HMM (having a few states) that is a module equivalent to the local configuration of the small world network instead of a large-scale ergodic HMM.

Further, with the ACHMM, as model parameters relating to a transition (state transition) between local configurations equivalent to a network for connecting the local configurations of the small world network, the frequency of state transitions between modules, and the like are demanded.

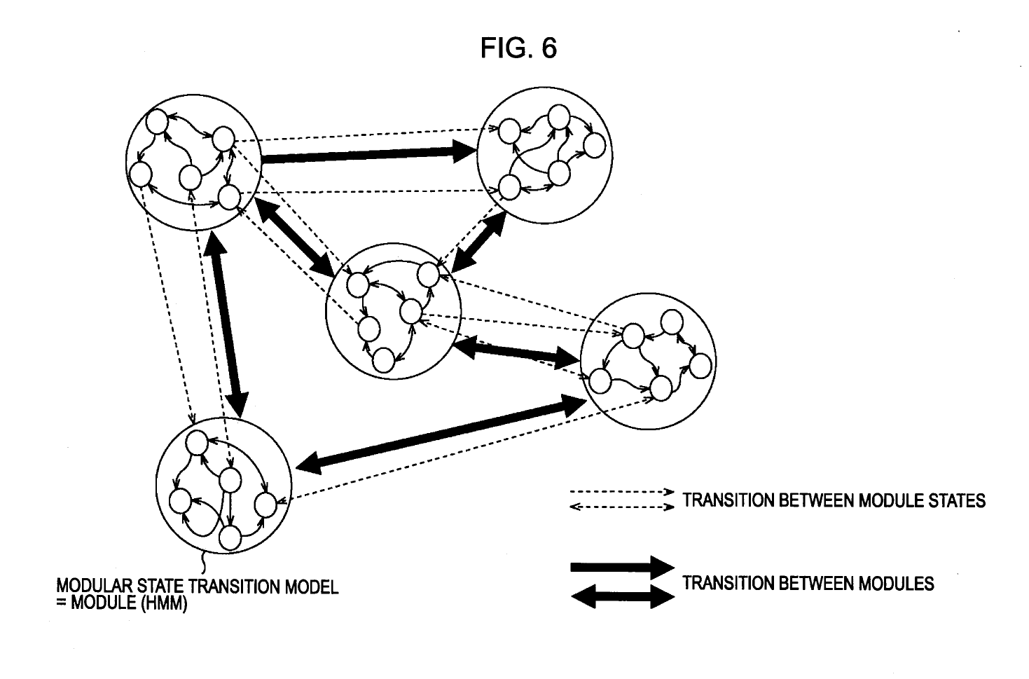

FIG. 6 is a diagram illustrating an example of the ACHMM.

The ACHMM includes an HMM as a module that is the minimum component.

With the ACHMM, there can be conceived a total of three types of state transitions of a state transition between the states making up an HMM serving as a module (transition between states), a state transition between the state of a certain module and the state of an arbitrary module including that module (transition between module states), and a state transition between (the arbitrary state of) a certain module, and (the arbitrary state of) an arbitrary module including that module (transition between modules).

Note that the state transition of the HMM of a certain module is a state transition between the state of a certain module, and the state of the module thereof, and hereafter, this is included in the transition between module states as appropriate.

As a module serving as a module, a small-scale HMM is employed.

With a large-scale HMM, i.e., an HMM wherein the number of states, and the number of state transitions are great, huge calculation cost has to be spent for estimation of the HMM parameters, and also, accurate estimation of the HMM parameters is prevented from suitably expressing a modeling object.

A small-scale HMM is employed as an HMM serving as a module, and an ACHMM that is a group of such modules is employed as a learning model for modeling a modeling object, calculation cost can be reduced, and also accurate estimation of the HMM parameters can be performed as compared to a case where a large-scale HMM is employed as a learning model.

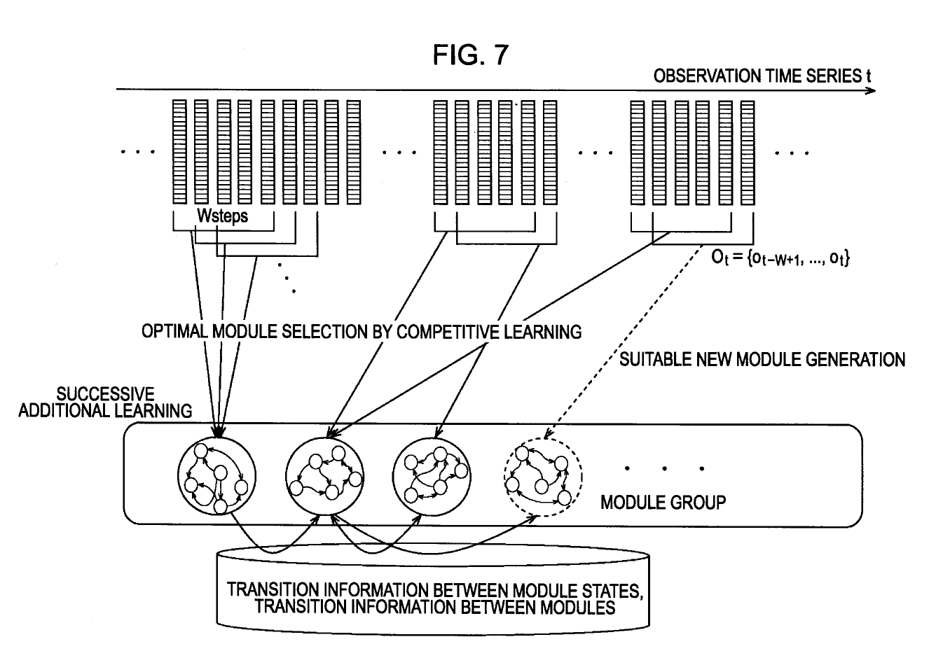

FIG. 7 is a diagram for describing the outline of ACHMM learning (module learning).

With ACHMM learning (module learning), for example, time series data Oₜ of window length W is taken as learned data to be used for learning at each point-in-time t, one optimal module as to the learned data Oₜ is selected from modules making up an ACHMM by a competitive learning mechanism.

Subsequently, the one module selected out of the modules making up the ACHMM, or a new module is determined to be the object module that is a module of which the HMM parameters are to be updated, and additional learning of the object module thereof is successively performed.

Accordingly, with ACHMM learning, additional learning of one module making up the ACHMM may be performed, or a new module may be generated to perform additional learning of the new module thereof.

Note that, at the time of ACHMM learning, later-described transition information generating processing is performed at the transition information management unit 15, transition information that is the information of frequency of each state transition with the ACHMM is also obtained, such as the information of transition between module states described in FIG. 6 (transition information between module states), or the information of transition between modules (transition information between modules).

As a module (HMM) making up an ACHMM, a small-scale HMM (HMM having a few states) is employed. With the present embodiment, for example, an ergodic HMM of which the number of states is 9 will be employed.

Further, with the present embodiment, let us say that a Gauss distribution of which the number of mixtures is 1 (i.e., single probability density) is employed as the output probability density function bⱼ(x) of an HMM serving as a module, and the covariance matrix Σⱼ of a Gauss distribution serving as the output probability density function bⱼ(x) of each state sⱼ is, such as indicated in Expression (2), is a matrix of which the components other than diagonal components are all zero.

$${Σ}_{j} = [ \begin{matrix}{σ}_{j 1}^{2} & 0 & ⋯ & 0 \\ 0 & {σ}_{j 2}^{2} & 0 & ⋮ \\ ⋮ & & ⋱ & 0 \\ 0 & ⋯ & 0 & {σ}_{jD}^{2}\end{matrix} ] \qquad ( 2 )$$

Also, if a vector with the diagonal components σ²ⱼ₁, σ²ⱼ₂, . . . , σ²_{jD} of the covariance matrix Σⱼ as components will be referred to as a dispersion (vector) σ²ⱼ, and also the mean vector of a Gauss distribution serving as the output probability density function bⱼ(x) will be represented with a vector μⱼ, the HMM parameters λ are represented with λ={aᵢⱼ, μᵢ, σ²ⱼ, πᵢ, i=1, 2, . . . , N, j=1, 2, . . . , N} instead of the output probability density function bⱼ(x) using the mean vector μᵢ, and dispersion σ²ⱼ.

With ACHMM learning (module learning), the HMM parameters λ={aᵢⱼ, μᵢ, σ²ⱼ, πᵢ, i=1, 2, . . . , N, j=1, 2, . . . , N} are estimated.

### Configuration Example of Module Learning Unit 13

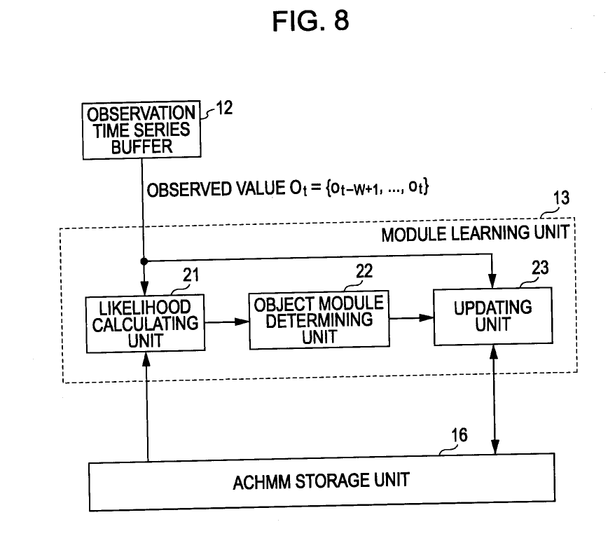

FIG. 8 is a block diagram illustrating a configuration example of the module learning unit 13 in FIG. 1.

The module learning unit 13 performs learning (module learning) of an ACHMM that is a learning model having a small-scale HMM (modular state transition model) as a modular.

With the module learning by the module learning unit 13, a module architecture is employed wherein the likelihood of each module making up an ACHMM is obtained as to the learned data Oₜ at each point-in-time, competitive learning type learning (competitive learning) for updating the HMM parameters of a module having the maximum likelihood (hereafter, also referred to as maximum likelihood module), or module additional type learning for updating the HMM parameters of a new module is successively performed.

Thus, with the module learning, a case where the competitive learning type learning is performed, and a case where module additional type learning is performed are mixed, and accordingly, with the present embodiment, a learning model having an HMM as a module serving as such a module learning object is referred to as an Additional Competitive HMM (ACHMM).

Such a module architecture is employed, whereby a modeling object that is not expressed without using a large-scale HMM (thus, estimation of the parameters is prevented) can be represented with an ACHMM that is a group of small-scale HMMs (thus, estimation of the parameters is facilitated).

Also, with the module learning, in addition to the competitive learning type learning, the module additional type learning is performed, and accordingly, in the event that with the observation space (the signal space of a sensor signal to be output from the sensor 11 (FIG. 1)) of an observed value to be observed from a modeling object, the range of an observed value that can actually be observed is not known beforehand, and as the ACHMM learning advances, the range of an observed value to be actually observed is extended, the learning can be performed so that a person builds up his/her experience.

In FIG. 8, the module learning unit 13 includes a likelihood calculating unit 21, an object module determining unit 22, and an updating unit 23.

The time series of an observed value stored in the observation time series buffer 12 are supplied to the likelihood calculating unit 12.

The likelihood calculating unit 21 takes the times series of an observed value to be successively supplied from the observation time series buffer 12 as learned data to be used for learning, and regarding each module making up the ACHMM stored in the ACHMM storage unit 16, obtains likelihood that learned data may be observed with the module, and supplies this to the object module determining unit 22.

Here, if the τ'th sample from the head of the time series data will be represented with o_{τ}, the times series data O having certain length L can be represented with O={o_{τ=1}, . . . , O_{τ=L}}.

With the likelihood calculating unit 21, likelihood P(O|λ) as to the times series data O of the module λ that is an HMM (the HMM defined with the HMM parameters λ) is obtained in accordance with a forward algorithm (forward processing).

The object module determining unit 22 determines, based on the likelihood of each module making up the ACHMM supplied from the likelihood calculating unit 21, one module of the ACHMM or a new module to be the object module having the HMM parameters to be updated, and supplies a module index representing (specifying) the object module thereof to the updating unit 23.

The learned data, i.e., the times series of the same observed value as the observed value to be supplied from the observation time series buffer 12 to the likelihood calculating unit 21 is supplied from the observation time series buffer 12 to the updating unit 23.

The updating unit 23 uses the learned data from the observation time series buffer 12 to perform learning for updating the HMM parameters of, the object module, i.e., the module that the module index to be supplied from the object module determining unit 22 represents to update the storage content of the ACHMM storage unit 16 using the HMM parameters after updating.

Here, with the updating unit 23, additional learning (learning for the HMM affecting new times series data (learned data) as to an already obtained (time series) pattern) is performed as learning for updating the HMM parameters.

In general, the additional learning at the updating unit 23 is performed by processing (hereafter, also referred to as successive learning Baum-Welch algorithm processing) for expanding HMM parameter estimation processing in accordance with the Baum-Welch algorithm to be performed in batch processing to processing to be successively performed (on-line processing).

With the successive learning Baum-Welch algorithm processing, with the Baum-Welch algorithm (Baum-Welch reestimation method), new internal parameters ρᵢ^{new}, νⱼ^{new}, ξⱼ^{new}, χᵢⱼ^{new}, and ψᵢ^{new} to be used for this estimation of the HMM parameters are obtained by weighting addition of a forward probability αᵢ(τ) to be calculated from the learned data, the learned data internal parameters ρᵢ, νⱼ, ξⱼ, χᵢⱼ, and ψᵢ that are internal parameters to be obtained using a backward probability βᵢ(τ), and the previous internal parameters ρᵢ^{old}, νⱼ^{old}, ξⱼ^{old}, χᵢⱼ^{old}, and ψᵢ^{old} that are internal parameters used for the previous estimation of the HMM parameters, which are internal parameters to be used for estimation of the HMM parameters λ, and the HMM parameters λ of the object module are (re)estimated using the new internal ρᵢ^{new}, νⱼ^{new}, ξⱼ^{new}, χᵢⱼ^{new}, and ψᵢ^{new}.

That is to say, the updating unit 23 stores the previous internal parameters ρᵢ^{old}, νⱼ^{old}, ξⱼ^{old}, χᵢⱼ^{old}, and ψᵢ^{old}, i.e., the internal parameters ρᵢ^{old}, νⱼ^{old}, ξⱼ^{old}, χᵢⱼ^{old}, and ψᵢ^{old}, used for estimation of the HMM parameters λ^{old} before updating at the time of estimation thereof, for example, in the ACHMM storage unit 16 beforehand.

Further, the updating unit 23 obtains the forward probability αᵢ(τ) and the backward probability βᵢ(τ) from the time series data O={o_{τ=1}, . . . , o_{τ=L}} that is the learned data, and the HMM (λ^{old}) of the HMM parameters λ^{old} before updating.

Here, the forward probability αᵢ(τ) is a probability that the times series data o₁, o₂, . . . , o_{τ} are observed in the HMM (λ^{old}), and a state sᵢ may be at point-in-time τ.

Also, the backward probability βᵢ(τ) is a probability that a state sᵢ is at point-in-time τ in the HMM (λ^{old}), and thereafter the times series data o_{τ=1}, o_{τ+2}, . . . , o_{L} may be observed.

After obtaining the forward probability αᵢ(τ) and the backward probability βᵢ(τ), the updating unit 23 uses the forward probability αᵢ(τ) and backward probability βᵢ(τ) thereof to obtain the learned data internal parameters ρᵢ, νⱼ, ξⱼ, χᵢⱼ, and ψᵢ in accordance with Expressions (3), (4), (5), (6), and (7), respectively.

$$\begin{matrix}{ρ}_{i} = {\sum }_{τ = 1}^{L} {α}_{i} ( τ ) {β}_{i} ( τ ) / {\sum }_{n = 1}^{N} {α}_{n} ( L ) & ( 3 ) \\ {ν}_{j} = {\sum }_{τ = 1}^{L} {α}_{j} ( τ ) {β}_{j} ( τ ) {ο}_{τ} / {\sum }_{n = 1}^{N} {α}_{n} ( L ) & ( 4 ) \\ {ξ}_{j} = {\sum }_{τ = 1}^{L} {α}_{j} ( τ ) {β}_{j} ( τ ) {( {ο}_{τ} )}^{2} / {\sum }_{n = 1}^{N} {α}_{n} ( L ) & ( 5 ) \\ {χ}_{ij} = {\sum }_{τ = 1}^{L - 1} {α}_{j} ( τ ) {a}_{ij} N [ {ο}_{τ + 1} , {μ}_{j} , {σ}_{j}^{2} ] {β}_{j} ( τ + 1 ) / {\sum }_{n = 1}^{N} {α}_{n} ( L ) & ( 6 ) \\ {ψ}_{i} = {α}_{j} ( 1 ) {β}_{j} ( 1 ) / {\sum }_{n = 1}^{N} {α}_{n} ( L ) & ( 7 )\end{matrix}$$

Here, the learned data internal parameters ρᵢ, νⱼ, ξⱼ, χᵢⱼ, and ψᵢ to be obtained in accordance with Expressions (3) through (7) match the internal parameters to be obtained in the case that the HMM parameters are estimated in accordance with the Baum-Welch algorithm to be performed in batch processing.

Subsequently, the updating unit 23 obtains new internal parameters ρᵢ^{new}, νⱼ^{new}, ξⱼ^{new}, χᵢⱼ^{new}, and ψᵢ^{new} to be used for this estimation of the HMM parameters by weighting addition in accordance with Expressions (8), (9), (10), (11), and (12), i.e., by weighting addition of the learned data internal parameters ρᵢ, νⱼ, ξⱼ, χᵢⱼ, and ψᵢ, the previous internal parameters ρᵢ^{old}, νⱼ^{old}, ξⱼ^{old}, χᵢⱼ^{old}, and ψᵢ^{old} used for the previous estimation of the HMM parameters, and stored in the ACHMM storage unit 16.

ρᵢ^{new}=(1−γ)ρᵢ^{old}+γρᵢ (8)

νⱼ^{new}=(1−γ)νⱼ^{old}+γνᵢ (9)

ξⱼ^{new}=(1−γ)ξⱼ^{old}+γξⱼ (10)

χᵢⱼ^{new}=(1−γ)χᵢⱼ^{old}+γχᵢⱼ (11)

ψᵢ^{new}=(1−γ)ψᵢ^{old}+γψᵢ (12)

Here, γ in Expressions (8) through (12) is weight to be used for weighting addition, and takes a value of 0≦γ≦1. A learning rate representing a degree for affecting new time series data (learned data) O as to the (time series) pattern already obtained for the HMM may be employed as the weight γ. A method for obtaining the learning rate γ will be described later.

After obtaining the new internal parameters ρᵢ^{new}, νⱼ^{new}, ξⱼ^{new}, χᵢⱼ^{new}, and ψᵢ^{new}, the updating unit 23 uses the new internal parameters ρᵢ^{new}, νⱼ^{new}, ξⱼ^{new}, χᵢⱼ^{new}, and ψᵢ^{new} to obtain the HMM parameters λ^{new}={aᵢⱼ^{new}, μᵢ, σ²ᵢ, πᵢ, i=1, 2, . . . , N, j=1, 2, . . . , N} in accordance with Expressions (13), (14), (15), and (16), thereby updating the HMM parameters λ^{old} to HMM parameters λ^{new}.

$$\begin{matrix}{π}_{j}^{new} = {ψ}_{j}^{new} / {\sum }_{n = 1}^{N} {ψ}_{n}^{new} & ( 13 ) \\ {μ}_{j}^{new} = \frac{{ν}_{j}^{new}}{{ρ}_{j}^{new}} & ( 14 ) \\ {σ}_{j}^{new} = \frac{{ξ}_{j}^{new}}{{ρ}_{j}^{new}} - {( {μ}_{j}^{new} )}^{2} & ( 15 ) \\ {a}_{ij}^{new} = ( {χ}_{ij}^{new} / {ρ}_{i}^{new} ) / {\sum }_{n = 1}^{N} ( {χ}_{in}^{new} / {ρ}_{i}^{new} ) & ( 16 )\end{matrix}$$

### Module Learning Processing

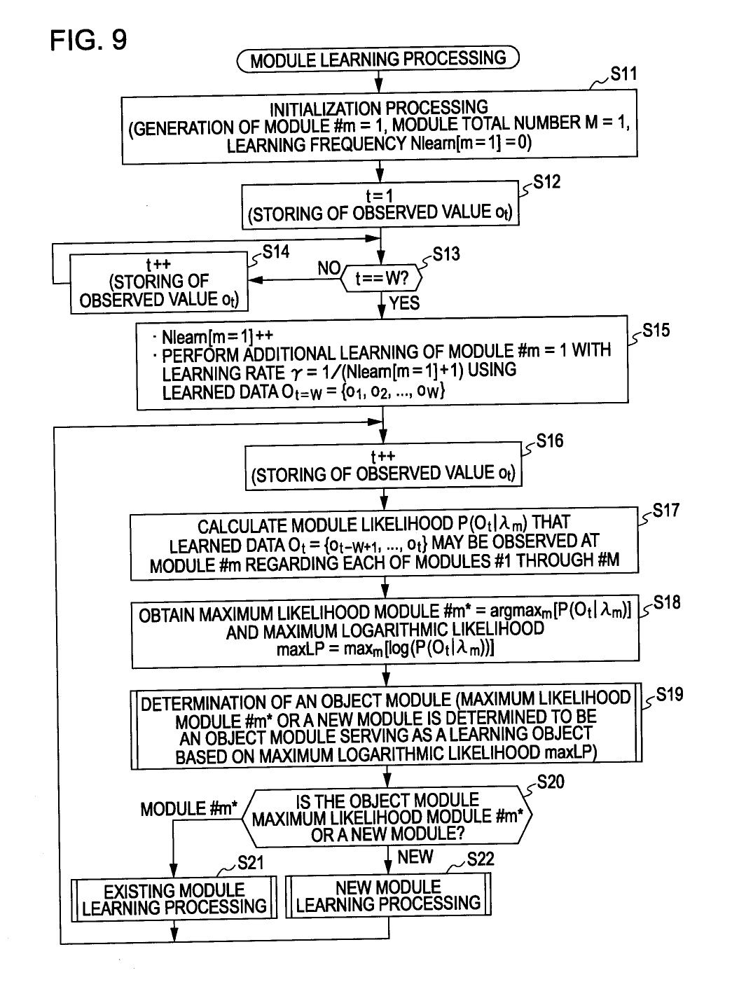

FIG. 9 is a flowchart for describing the processing of module learning (module learning processing) to be performed by the module learning unit 13 in FIG. 8.

In step S11, the updating unit 23 performs initialization processing.

Here, with the initialization processing, the updating unit 23 generates an ergodic HMM of a predetermined number of states N (e.g., N=9) as the first module #1 making up an ACHMM.

That is to say, regarding the HMM parameters λ={aᵢⱼ, μᵢ, σ²ᵢ, πᵢ, i=1, 2, . . . , N, j=1, 2, . . . , N} of the HMM (ergodic HMM) that is the module #1, the updating unit 23 sets the N×N state transition probabilities aᵢⱼ to, for example, 1/N serving as an initial value, and also sets the N initial probabilities πᵢ to, for example, 1/N serving as an initial value.

Further, the updating unit 23 sets the N mean vectors to the coordinates of a proper point within observation space (e.g., random coordinates), and sets the N dispersions σ²ᵢ (D-dimensional vector with the σ²ⱼ₁, σ²ⱼ₂, . . . , σ²_{jD} in Expression (2) as components) to a proper value (e.g., a random value) serving as an initial value.

Note that in the case that the sensor 11 can normalize the observed value oₜ to output this, i.e., in the case that each of the D components of the D-dimensional vector that is the observed value oₜ that the sensor 11 (FIG. 1) outputs has been normalized to, for example, a value in a range between 0 and 1, each component may employ the D-dimensional vector, for example, 0.5 as the initial value of the mean vector μᵢ. Also, each component may employ the D-dimensional vector, for example, 0.01 as the initial value of the dispersions σ²ᵢ.

Here, the m'th module making up the ACHMM will also be referred to as a module #m, and the HMM parameters of an HMM that is the module #m will also be referred to as λₘ. Also, with the present embodiment, m will be used as the module index of the module #m.

After generating the module #1, the updating unit 23 sets a module total M that is a variable representing a total number of modules making up the ACHMM to 1, and also sets learning frequency (or learning amount) Nlearn[m=1] that is a (array) variable representing a number of times (or amount) wherein learning of the module #1 has been performed to 0 serving as an initial value.

Subsequently, after the observed value oₜ is output form the sensor 11, and is stored in the observation time series buffer 12, the processing proceeds from step S11 to step S12, and the module learning unit 13 sets the point-in-time t to 1, and the processing proceeds to step S13.

In step S13, the module learning unit 13 determines whether or not the time-in-point t is equal to the window length W.

In the event that determination is made in step S13 that the time-in-point t is not equal to the window length W, i.e., in the event that the point-in-time t is less than the window length W, the processing proceeds to step S14 after awaiting that the next observed value oₜ is output from the sensor 11, and is stored in the observation time series buffer 12.

In step S14, the module learning unit 13 increments the point-in-time t by one, and the processing returns to step S13, and hereafter, the same processing is repeated.

Also, in the event that determination is made in step S13 that the time-in-point t is equal to the window length W, i.e., in the event that the time series data O_{t=W}={o₁, . . . , o_{W}} that is the window length W for the time series of an observed value is stored in the observation time series buffer 12, the object module determining unit 22 determines of the ACHMM made up of the singular module #1, the module #1 thereof to be the object module.

Subsequently, the object module determining unit 22 supplies a module index m=1 representing the module #1 that is the object module to the updating unit 23, and the processing proceeds from step S13 to step S15.

In step S15, the updating unit 23 increments the learning frequency Nlearn[m=1] of the module #1 that is the object module represented with the module index m=1 from the object module determining unit 22, for example, by one.

Further, in step S15, the updating unit 23 obtains the learning rate γ of the module #1 that is the object module in accordance with Expression γ=1/(Nlearn[m=1]+1).

Subsequently, the updating unit 23 takes the time series data O_{t=W}={o₁, . . . , o_{W}} of the window length W stored in the observation time series buffer 12 as learned data, and uses this learned data O_{t=W} to perform the additional learning of the module #1 that is the object module with the learning rate γ=1/(Nlearn[m=1]+1).

That is to say, the updating unit 23 updates the HMM parameters λₘ₌₁ of the module #1 that is the object module, stored in the ACHMM storage unit 16 in accordance with the above Expressions (3) through (16).

Subsequently, after awaiting that the next observed value oₜ is output from the sensor 11, and is stored in the observation time series buffer 12, the processing proceeds from step S15 to step S16. In step S16, the module learning unit 13 increments the point-in-time t by one, and the processing proceeds to step S17.

In step S17, the likelihood calculating unit 21 takes the latest time series data Oₜ={o_{t-W+1}, . . . , oₜ} of the window length W stored in the observation time series buffer 12 as learned data, and obtains likelihood (hereafter, also referred to as module likelihood) P(Oₜ|λₘ) that the learned data Oₜ may be observed with the module #m regarding each of all the modules #1 through #M making up the ACHMM stored in the ACHMM storage unit 16.

Further, in step S17, the likelihood calculating unit 21 supplies the module likelihood P(Oₜ|λ₁), P(Oₜ|λ₂), . . . , P(Oₜ|λ_{M}) of the modules #1 through #M to the object module determining unit 22, and the processing proceeds to step S18.

In step S18, the object module determining unit 22 obtains maximum likelihood module #m*=argmaxₘ[P(Oₜ|λₘ)] that is a module of which the module likelihood P(Oₜ|λₘ) from the likelihood calculating unit 21 is the maximum, of the modules #1 through #M making up the ACHMM.

Here, argmaxₘ[ ] represents an index m=m* that maximizes the value within the parentheses [ ] that changes as to the index (module index) m.

The object module determining unit 22 further obtains maximum likelihood (most logarithmic likelihood) (the maximum value of logarithm of likelihood) maxLP=maxₘ[P(Oₜ|λₘ)] that is the maximum value of the module likelihood P(Oₜ|λₘ) from the likelihood calculating unit 21.

Here, maxₘ[ ] represents the maximum value of the value within the parentheses [ ] that changes as to the index m.

In the case that the maximum likelihood module is the module #m*, the most logarithmic likelihood maxLP becomes the logarithm of the module likelihood P(Oₜ|λ_{m*}) of the module #m*.

After the object module determining unit 22 obtains the maximum likelihood module #m*, and the most logarithmic likelihood maxLP, the processing proceeds from step S18 to step S19, where the object module determining unit 22 performs later-described object module determining processing for determining the maximum likelihood module #m* or a new module that is an HMM to be newly generated to be the object module having the HMM parameters to be updated, based on the most logarithmic likelihood maxLP.

Subsequently, the object module determining unit 22 supplies the module index of the object module to the updating unit 23, and the processing proceeds from step S19 to step S20.

In step S20, the updating unit 23 determines whether the object module represented by the module index from the object module determining unit 22 is either the maximum likelihood module #m* or a new module.

In the event that determination is made in step S20 that the object module is the maximum likelihood module #m*, the processing proceeds to step S21, where the updating unit 23 performs existing module learning processing for updating the HMM parameters λ_{m*} of the maximum likelihood module #m*.

Also, in the event that determination is made in step S20 that the object module is a new module, the processing proceeds to step S22, where the updating unit 23 performs new module learning processing for updating the HMM parameters of the new module.

After the existing module learning processing in step S21 and the new module learning processing in step S22, in either case, the processing returns to step S16 after awaiting that the next observed value oₜ is output from the sensor 11, and is stored in the observation time series buffer 12, and hereafter, the same processing is repeated.

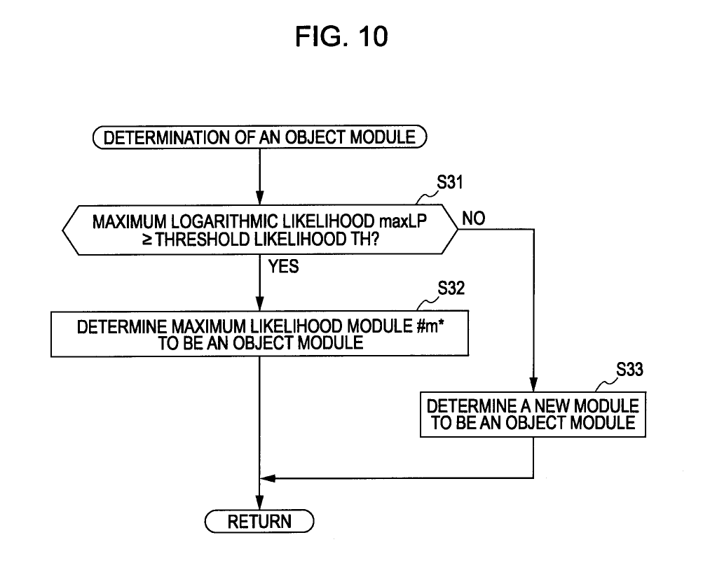

FIG. 10 is a flowchart for describing the object module determining processing to be performed in step S19 in FIG. 9.

With the object module determining processing, in step S31 the object module determining unit 22 (FIG. 8) determines whether or not the most logarithmic likelihood maxLP that is the logarithmic likelihood of the maximum likelihood module #m* is, for example, equal to or greater than a threshold likelihood TH that is a predetermined threshold.

In the event that determination is made in step S31 that the most logarithmic likelihood maxLP is equal to or greater than the threshold likelihood TH, i.e., in the event that the most logarithmic likelihood maxLP that is the logarithm of likelihood of the maximum likelihood module #m* is a great value to some extent, the processing proceeds to step S32, where the object module determining unit 22 determines the maximum likelihood module #m* to be the object module, and the processing returns.

Also, in the event that determination is made in step S31 that the most logarithmic likelihood maxLP is smaller than the threshold likelihood TH, i.e., in the event that the most logarithmic likelihood maxLP that is the logarithm of likelihood of the maximum likelihood module #m* is a small value, the processing proceeds to step S33, where the object module determining unit 22 determines the new module to be the object module, and the processing returns.

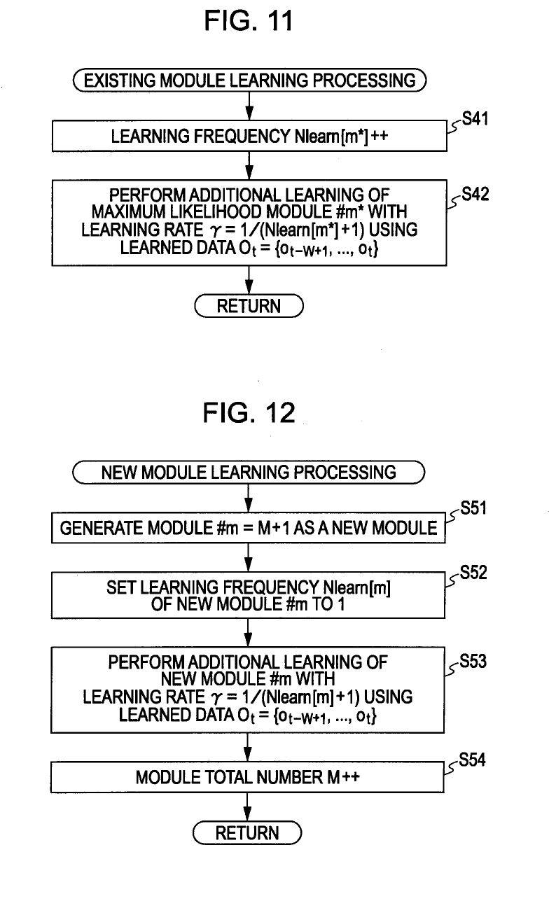

FIG. 11 is a flowchart for describing the existing module learning processing to be performed in step S21 in FIG. 9.

With the existing module learning processing, in step S41 the updating unit 23 (FIG. 8) increments the learning frequency Nlearn[m*] of the maximum likelihood module #m* that is the object module by one for example, and the processing proceeds to step S42.

In step S42, the updating unit 23 obtains the learning rate γ of the maximum likelihood module #m* that is the object module in accordance with Expression γ=1/(Nlearn[m*]+1).

Subsequently, the updating unit 23 takes the latest time series data Oₜ of the window length W stored in the observation time series buffer 12 as learned data, uses the learned data Oₜ thereof to perform the additional learning of the maximum likelihood module #m* that is the object module with the learning rate γ=1/(Nlearn[m*]+1), and the processing returns.

That is to say, the updating unit 23 updates the HMM parameters λ_{m*} of the maximum likelihood module #m* stored in the ACHMM storage unit 16 in accordance with the above Expressions (3) through (16).

FIG. 12 is a flowchart for describing the new module learning processing to be performed in step S22 in FIG. 9.

With the new module learning processing, in step S51 the updating unit 23 (FIG. 8) generates an HMM that is the new module serving as the M+1'th module #M+1 making up the ACHMM in the same way as with the case in step S11 in FIG. 9, stores (the HMM parameters λ_{M+1} of) the new module #m=M+1 thereof in the ACHMM storage unit 16 as a module making up the ACHMM, and the processing proceeds to step S52.

In step S52, the updating unit 23 sets the learning frequency Nlearn[m=M+1] of the new module #m=M+1 to 1 serving as an initial value, and the processing proceeds to step S53.

In step S53, the updating unit 23 obtains the learning rate γ of the new module #m=M+1 that is the object module in accordance with Expression y=1/(Nlearn[m=M+1]+1).

Subsequently, the updating unit 23 takes the latest time series data Oₜ of the window length W stored in the observation time series buffer 12 as learned data, and uses the learned data Oₜ thereof to perform the additional learning of the new module #m=M+1 that is the object module with the learning rate γ=1/(Nlearn[m=M+1]+1).

That is to say, the updating unit 23 updates the HMM parameters λ_{M+1} of the new module #m=M+1 stored in the ACHMM storage unit 16 in accordance with the above Expressions (3) through (16).

Subsequently, the processing proceeds from step S53 to step S54, where the updating unit 23 increments the module total number M by one along with the new module being generated as a module making up the ACHMM, and the processing returns.

As described above, with the module learning unit 13, the time series of an observed value to be successively supplied is taken as the learned data to be used for learning, with regard to each module making up an ACHMM having an HMM as a module that is the minimum component, likelihood that the learned data may be observed with the module is obtained, and based on the likelihood thereof, the maximum likelihood module serving as one module of the ACHMM, or a new module is determined to be the object module that is a module having the HMM parameters to be updated, and learning for updating the HMM parameters of the object module is performed using the learned data, and accordingly, even when the scale of a modeling object is not known beforehand, an ACHMM having a scale suitable for the modeling object can be obtained.

In particular, with regard to a modeling object which has to have a large-scale HMM for modeling, with a local configuration thereof being obtained with the HMM that is a module, an ACHMM of a suitable scale (number of modules) can be obtained.

### Setting of Threshold Likelihood TH

With the object module determining processing in FIG. 10, the object module determining unit 22 determines the maximum likelihood module m* or the new module to be the object module according to magnitude correlation between the most logarithmic likelihood maxLP and the threshold likelihood TH.

In general, branching of processing according to a threshold greatly influences the performance of the processing depending on what kind of value the threshold being set to.

With the object module determining processing, the threshold likelihood TH is a decision criterion regarding whether to generate the new module, and in the event that this threshold likelihood TH is not a suitable value, modules making up an ACHMM are generated in an excessive manner or in an extremely-moderate manner, and accordingly, an ACHMM having a scale suitable for the modeling object may not be obtained.

That is to say, in the event that the threshold likelihood TH is excessively great, an HMM having excessively small dispersion of an observed value to be observed in each state may excessively be generated.

On the other hand, in the event that the threshold likelihood TH is too small, an HMM having excessively great dispersion of an observed value to be observed in each state may be generated in an extremely-moderate manner, i.e., the new modules sufficient for modeling of the modeling object are not generated, and as a result thereof, the number of modules making up an ACHMM may become excessively small, and an HMM that is a module making up may become an HMM having excessively great dispersion of an observed value to be observed in each state.

Therefore, the threshold likelihood TH of an ACHMM may be set as follows, for example.

That is to say, with regard to the threshold likelihood TH of an ACHMM, with observation space, (the distribution of) the threshold likelihood TH suitable for setting a particle size for clustering an observed value (clustering particle size) to a certain desired particle size may be obtained from experiment experience.

Specifically, let us assume that a vector serving as an observed value oₜ is independent between components, and also, the time series of an observe value to be used as the learned data are independent between different points-in-time.

The threshold likelihood TH is compared with the most logarithmic likelihood maxLP, so is the logarithm (logarithmic likelihood) of likelihood (probability), and when assuming the above independency, the logarithmic likelihood as to the time series of an observed value linearly changes as to the dimensional number D of a vector serving as the observed value, and the window length W that is the length of the time series of the observed value (time series length).

Accordingly, the threshold likelihood TH can be represented with Expression TH=coef_th_new×D×W wherein a predetermined coefficient coef_th_new that is a proportional constant is used, which is proportional as to the number of dimensions D, and the window length W, and accordingly, determining of the coefficient coef_th_new determines the threshold likelihood.

With an ACHMM, in order to suitably generate a new module, the coefficient coef_th_new has to be determined to be a suitable value, and accordingly, relationship between the coefficient coef_th_new, the ACHMM, and a case where a new module is generated causes a problem.

The relationship between the coefficient coef_th_new, the ACHMM, and a case where a new module is generated can be obtained by the following simulation.

Specifically, with simulation, for example, let us assume that within the two-dimensional space serving as observation space, dispersion is 1, distance between mutual mean vectors (distance between mean vectors) H is a predetermined value, and Gauss distributions are three of G1, G2, and G3.

The observation space is two-dimensional space, and accordingly, the number of dimensions of an observed value is 2.

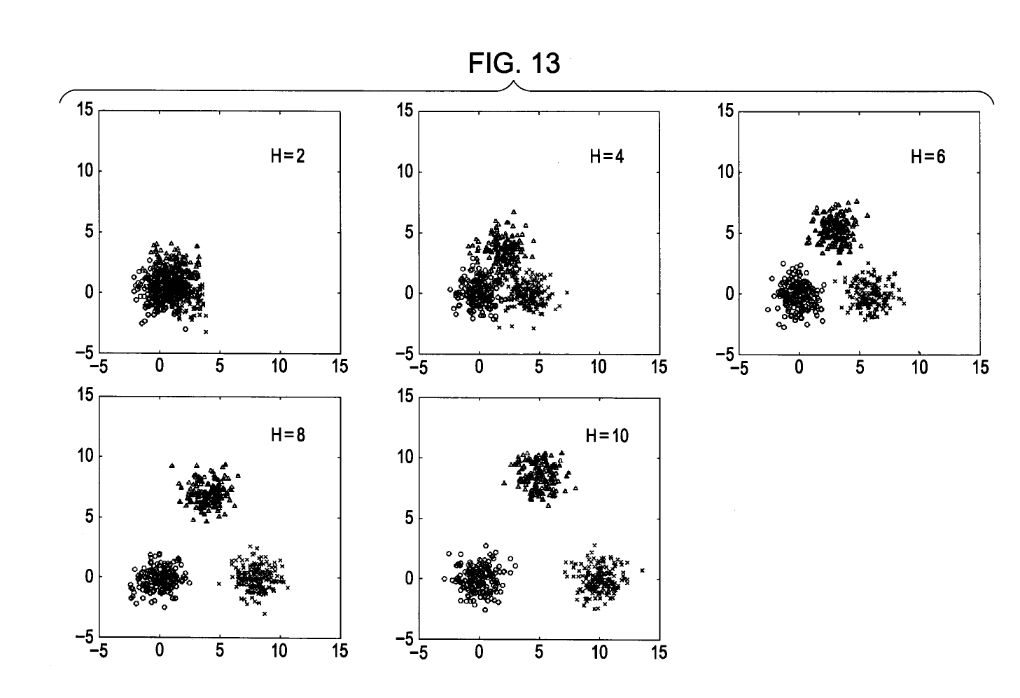

FIG. 13 is a diagram illustrating an example of observed values following each of the Gauss distributions G1 through G3.

FIG. 13 illustrates observed values wherein the distance between mean vectors H=2, 4, 6, 8, and 10 follows each of the Gauss distributions G1 through G3.

Note that in FIG. 13, circle marks represent the Gauss distribution G1, triangular marks represent the Gauss distribution G2, and x-marks represent the Gauss distribution G3, respectively.

The greater the distance between mean vectors is great, (Observed values following) each of the Gauss distributions G1 through G3 is distributed in a mutually separated position.

With the simulation, only one of the Gauss distributions of the Gauss distributions G1 through G3 is activated, and an observed value following the activated Gauss distribution thereof is generated.

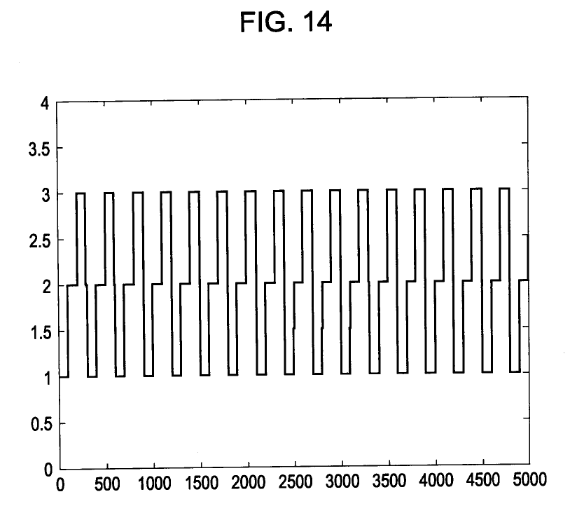

FIG. 14 is a diagram illustrating an example of timing for activating the Gauss distributions G1 through G3.

In FIG. 14, the horizontal axis represents point-in-time, and the vertical axis represents a Gauss distribution to be activated.

According to FIG. 14, the Gauss distributions G1 through G3 are repeatedly activated in the order of G1, G2, G3, G1, and so on at every 100 point-in-time.

With the simulation, the Gauss distributions G1 through G3 are activated, such as illustrated in FIG. 14, and for example, the time series of two-dimensional vector serving as 5000 points-in-time of observed value are generated.

Further, with the simulation, as a module of an ACHMM, an HMM having the number of states N of 1 is employed, the window length W is 5 for example, the time series data of the window length W=5 from the time series of 5000 points-in-time of observed value generated from the Gauss distributions G1 through G3 is successively extracted as the learned data while shifting the point-in-time t one point-in-time at a time, thereby performing ACHMM learning.

Note that ACHMM learning is performed by changing each of the coefficient coef_th_new and the distance between mean vectors H as appropriate.

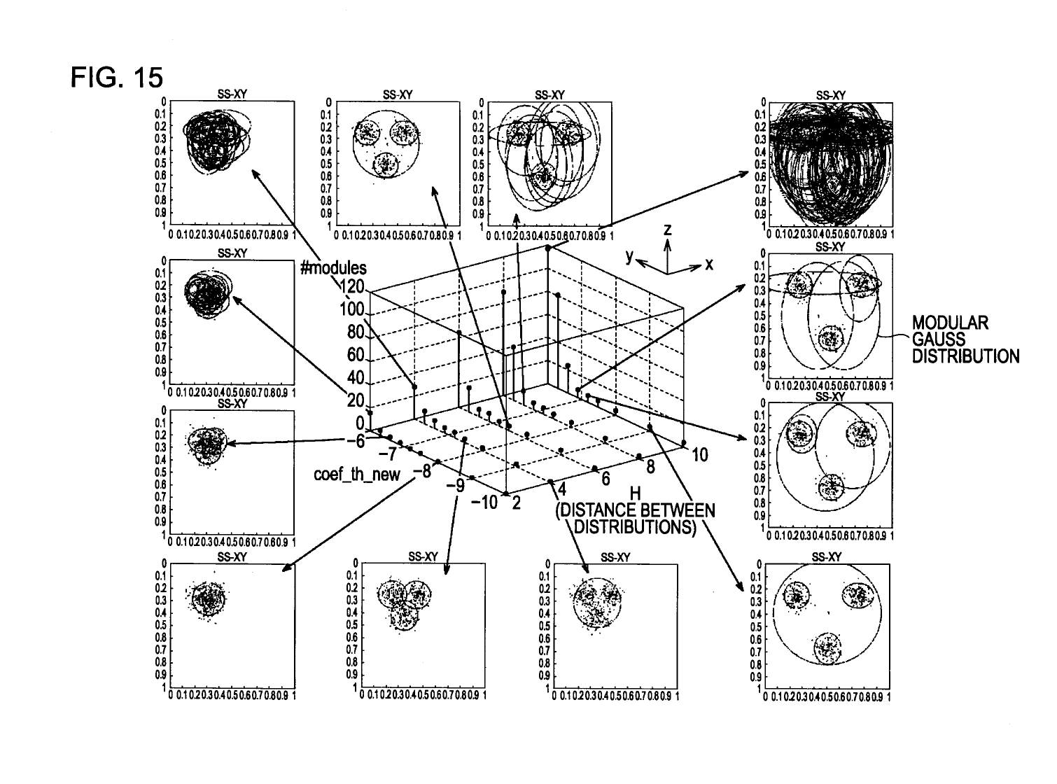

FIG. 15 is a diagram illustrating relationship between the coefficient coef_th_new, the distance between mean vectors H, and the number of modules making up an ACHMM after learning, which have been obtained as the above simulation results.

Note that FIG. 15 also illustrates a Gauss distribution serving as an output probability density function wherein an observed value is observed in a single module (HMM) state regarding several ACHMMs after learning.

Here, with the simulation, a single state of HMM is employed as a module, and accordingly, in FIG. 15, a single Gauss distribution is equivalent to a single module.

How to generate a module differs depending on the coefficient coef_th_new can be confirmed from FIG. 15.

The learned data used for the simulation is the time series data generated from the three Gauss distributions G1 through G3, and accordingly, it is desirable to make up an ACHMM after learning using three modules equivalent to the three Gauss distributions G1 through G3 respectively, but here, it is conceived that 3 through 5 is desirable as the number of modules of an ACHMM after learning while taking a somewhat margin into consideration.

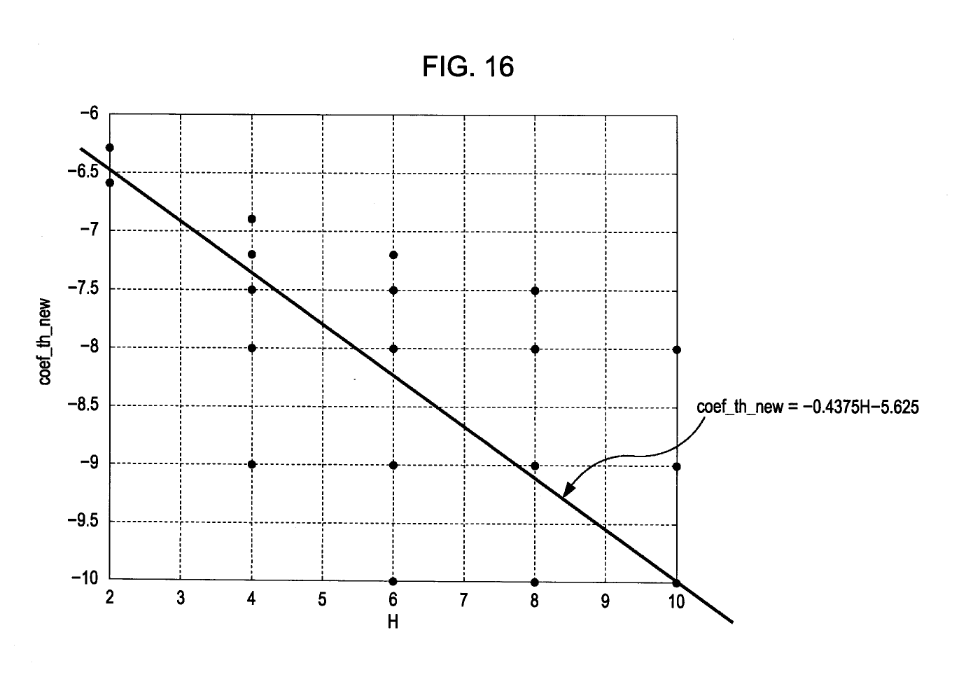

FIG. 16 is a diagram illustrating the coefficient coef_th_new and the distance between mean vectors H in the case that the number of modules of an ACHMM after learning is 3 through 5.

According to FIG. 16, it can be confirmed in an experiment expected-value manner that there is relationship represented with Expression coef_th_new=−0.4375H−5.625 regarding the coefficient coef_th_new, and the distance between mean vectors H in the case that the number of modules of an ACHMM after learning is a desirable number 3 through 5.

That is to say, the distance between mean vectors H corresponding to the clustering particle size of an observed value, and the coefficient coef_th_new that is a proportional constant wherein the threshold likelihood TH is proportional, may be correlated with Linear expression coef_th_new=−0.4375H−5.625.

Note that, with the simulation, even in the event that the window length W has been set to, for example, 15 other than 5, it has been confirmed that there is relationship represented with Expression coef_th_new=−0.4375H−5.625 regarding the coefficient coef_th_new, and the distance between mean vectors H.

As described above, if we say that a clustering particle size whereby the distance between mean vectors H becomes, for example, 4.0 or so is a desired particle size, the coefficient coef_th_new is determined to be −7.5 through −7.0 or so, and the threshold likelihood TH (the threshold likelihood TH proportional to the coefficient coef_th_new) to be obtained following Expression TH=coef_th_new×D×W using this coefficient coef_th_new becomes a value suitable for obtaining a desired clustering size.

A value to be obtained as described above can be set as the threshold likelihood TH.

### Module Learning Processing Using Variable Length Learned Data

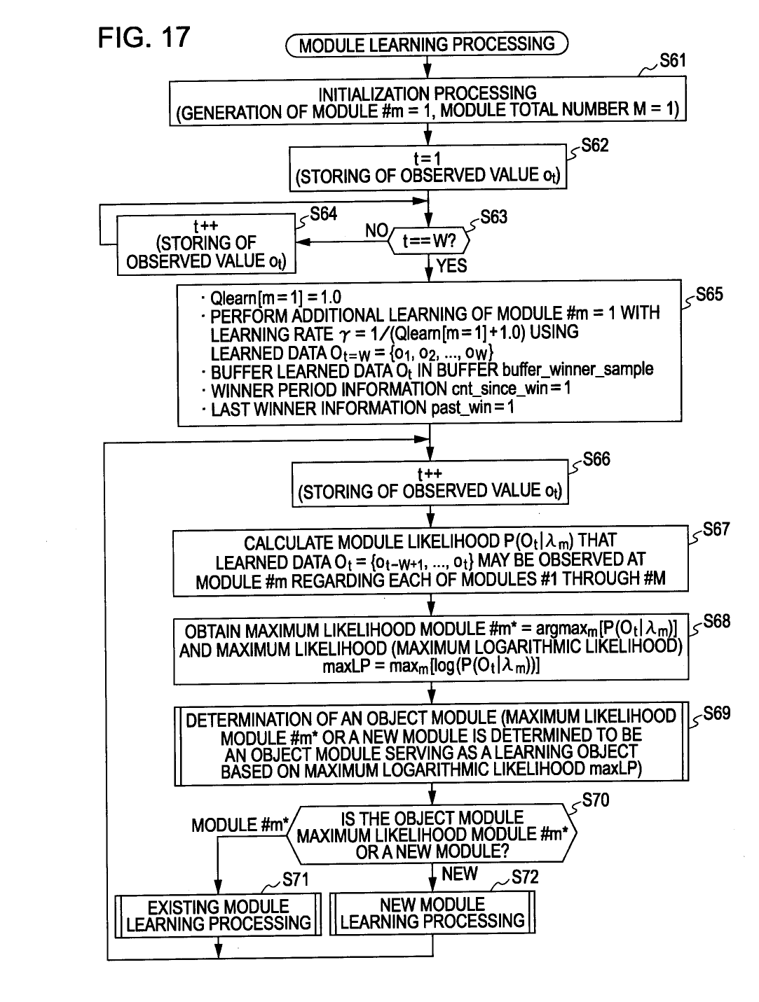

FIG. 17 is a flowchart for describing an other example of the module learning processing.

Now, with the module learning processing in FIG. 9, the time series of the latest observed value of the window length W that is fixed length are taken as the learned data, and ACHMM learning at each point-in-time t is successively performed.

In this case, with the learned data at point-in-time t, and the learned data at point-in-time t−1, W−1 observed values of the point-in-time t−W+1 through point-in-time t−1 are duplicated, and accordingly, a module that become the maximum likelihood module #m* at point-in-time t−1 also readily becomes the maximum likelihood module #m* even at point-in-time t.

Therefore, excessive learning as to the time series of the latest observed value of a single module is performed wherein a module that become the maximum likelihood module #m* at certain point-in-time will subsequently become the maximum likelihood module #m*, and consequently, the object module, and only the HMM parameters of the module thereof are gradually updated so that likelihood is maximized (error is minimized) as to the time series of the latest observed value of the window length W.

Subsequently, with a module where excessive learning is performed, in the event that the time series of an observed value corresponding to the time series pattern obtained in the past learning have not been included in the learned data of the window length W, the time series pattern thereof is rapidly forgotten.

With an ACHMM, in order to add the storage of a new time series pattern while maintaining the past storage (the storage of time series patterns obtained in the past), an arrangement has to be made wherein a new module is generated as appropriate, and a different time series pattern is stored in a separate module.

Note that excessive learning can be prevented from being performed, for example, by taking the time series of the latest observed value of the window length W at point-in-time for every W point-in-time of the same length as the window length W, as the learned data, instead of taking the time series of the latest observed value of the window length W for each one point-in-time as the learned data.

However, in the event of taking the time series of the latest observed value of the window length W at point-in-time for every W point-in-time of the same length as the window length W, as the learned data, i.e., in the event of sectionalizing (dividing) the time series of an observed value into the unit of the window length W, and taking this as the learned data, a dividing point for dividing the time series of an observed value into the unit of the window length W, and a dividing point of the time series corresponding to the time series pattern included in the time series of the observed value do not match, and as a result thereof, this prevents a time series pattern included in the time series of an observed value from suitably being divided and stored in a module.

Therefore, with the module learning processing, the time series of the latest observed value having a variable length is employed as the learned data instead of the time series of the latest observed value of the window length W that is fixed length, whereby ACHMM learning can be performed.

Here, ACHMM learning employing the time series of the latest observed value having a variable length as the learned data, i.e., module learning employing the learned data having a variable length will also be referred to as variable window learning. Further, ACHMM module learning employing the time series of the latest observed value of the window length W that is fixed length as the learned data will also be referred to as fixed window learning.

FIG. 17 is a flowchart for describing the module learning processing according to the variable window learning.

With the module learning processing according to the variable window learning, in steps S61 through S64, almost the same processing as steps S11 through S14 in FIG. 9 is performed.

Specifically, in step S61, the updating unit 23 (FIG. 8) performs generation of an ergodic HMM serving as the first module #1 making up an ACHMM, and setting of the module total number M to 1 serving as an initial value.

Subsequently, after awaiting that the observed value oₜ is output from the sensor 11, and is stored in the observation time series buffer 12, the processing proceeds from step S61 to step S62, where the module learning unit 13 (FIG. 8) sets the point-in-time t to 1, and the processing proceeds to step S63.

In step S63, the module learning unit 13 determines whether or not the point-in-time t is equal to the window length W.

In the event that determination is made in step S63 that the point-in-time t is not equal to the window length W, the processing proceeds to step S64 after awaiting that the next observed value oₜ is output from the sensor 11, and is stored in the observation time series buffer 12.

In step S64, the module learning unit 13 increments the point-in-time t by one, and the processing returns to step S63, and hereafter, the same processing is repeated.

Also, in the event that determination is made in step S63 that the point-in-time t is equal to the window length W, i.e., in the event that the time series data O_{t=W}={o₁, . . . , o_{W}} that is the window length W for the time series of an observed value is stored in the observation time series buffer 12, the object module determining unit 22 determines, of the ACHMM made up of only the single module #1, the module #1 thereof to be the object module.

Subsequently, the object module determining unit 22 supplies the module index m=1 representing the module #1 that is the object module to the updating unit 23, and the processing proceeds from step S63 to step S65.

In step S65, the updating unit 23 sets (array) variable Qlearn[m=1] representing frequency (or amount) of learning of the module #1 that is the object module represented with the module index m=1 from the object module determining unit 22 to 1.0 serving as an initial value.

Here, the learning frequency Nlearn[m] of the module #m described in the above FIG. 9 will be incremented by one as to learning of the module #m employing the learned data of the window length W that is fixed length.

Subsequently, in FIG. 9, the learned data to be employed for learning of the module #m is the time series data of the window length W that is fixed length, and accordingly, the learning frequency Nlearn[m] is incremented by one at a time, i.e., becomes an integer value.

On the other hand, in FIG. 17, learning of the module #m is performed by employing the time series of the latest observed value of a variable length as the learned data.

With incrementing by one as to learning of the module #m employing the learned data of the window length W that is fixed length as a reference, the variable Qlearn[m]representing the frequency wherein learning of the module #m has been performed as to learning of the module #m performed employing the time series of an observe value of an arbitrary length W′ as the learned data has to be incremented by W′/W.

Accordingly, the variable Qlearn[m] becomes a real number.

Now, if we say that learning of the module #m employing the learned data of the window length W is counted as one-time learning, learning of the module #m employing the learned data of the arbitrary length W′ has a practical effect of learning of W′/W, and accordingly, the variable Qlearn[m] will also be referred to as effective learning frequency.

In step S65, the updating unit 23 obtains the learning rate γ of the module #1 that is the object module in accordance with Expression γ=1/(Qlearn[m=1]+1.0).

Subsequently, the updating unit 23 takes the time series data O_{t=W}={o₁, . . . , o_{W}} of the window length W stored in the observation time series buffer 12 as learned data, and uses this learned data O_{t=W} to perform the additional learning of the module #1 that is the object module with the learning rate γ=1/(Qlearn[m=1]+1.0).

That is to say, the updating unit 23 updates the HMM parameters λₘ₌₁ of the module #1 that is the object module, stored in the ACHMM storage unit 16 in accordance with the above Expressions (3) through (16).

Further, the updating unit 23 buffers the learned data O_{t=W} in a buffer buffer_winner_sample that is a variable for buffering an observed value, which is saved in built-in memory (not illustrated) thereof.

Also, the updating unit 23 sets the winner period information cnt_since_win that is a variable representing a period when a module that has been the maximum likelihood module at one point-in-time ago, which is saved in the built-in memory thereof, to 1 serving as an initial value.

Further, the updating unit 23 sets the last winner information past_win that is a variable representing (a module that has been) the maximum likelihood module at one point-in-time ago, which is saved in the built-in memory thereof, to 1 serving as the module index of the module #1 serving as an initial value.

Subsequently, the processing proceeds from step S65 to step S66 after awaiting that the next observed value oₜ is output from the sensor 11, and is stored in the observation time series buffer 12, and hereafter, in steps S66 through S70 the same processing as steps S16 through S20 in FIG. 9 is performed.

That is to say, in step S66 the module learning unit 13 increments the point-in-time by one, and the processing proceeds to step S67.

In step S67, the likelihood calculating unit 21 takes the latest time series data Oₜ={o_{t-W+1}, . . . , oₜ} of the window length W stored in the observation time series buffer 12 as the learned data, and obtains module likelihood P(Oₜ|λₘ) regarding each of all the modules #1 through #M making up the ACHMM stored in the ACHMM storage unit 16, and supplies this to the object module determining unit 22.

Subsequently, the processing proceeds from step S67 to step S68, where the object module determining unit 22 obtains, of the modules #1 through #M making up the ACHMM, maximum likelihood module #m*=argmaxₘ[P(Oₜ|λₘ)] that is a module of which the module likelihood P(Oₜ|λₘ) from the likelihood calculating unit 21 is the maximum.

Further, the object module determining unit 22 obtains most logarithmic likelihood maxLP=maxₘ[P(Oₜ|λₘ)] (the logarithm of the module likelihood P(Oₜ|λ_{m*}) of the maximum likelihood module #m*) from the module likelihood P(Oₜ|λₘ) from the likelihood calculating unit 21, and the processing proceeds from step S68 to step S69.

In step S69, the object module determining unit 22 performs object module determining processing wherein the maximum likelihood module #m* or a new module that is an HMM to be newly generated is determined to be the object module having the HMM parameters to be updated, based on the most logarithmic likelihood maxLP.

Subsequently, the object module determining unit 22 supplies the module index of the object module to the updating unit 23, and the processing proceeds from step S69 to step S70.

In step S70, the updating unit 23 determines whether the object module represented by the module index from the object module determining unit 22 is either the maximum likelihood module #m* or a new module.

In the event that determination is made in step S70 that the object module is the maximum likelihood module #m*, the processing proceeds to step S71, where the updating unit 23 performs existing module learning processing for updating the HMM parameters λ_{m*} of the maximum likelihood module #m*.

Also, in the event that determination is made in step S70 that the object module is a new module, the processing proceeds to step S72, where the updating unit 23 performs new module learning processing for updating the HMM parameters of the new module.

After the existing module learning processing in step S71 and the new module learning processing in step S72, in either case, the processing returns to step S66 after awaiting that the next observed value oₜ is output from the sensor 11, and is stored in the observation time series buffer 12, and hereafter, the same processing is repeated.

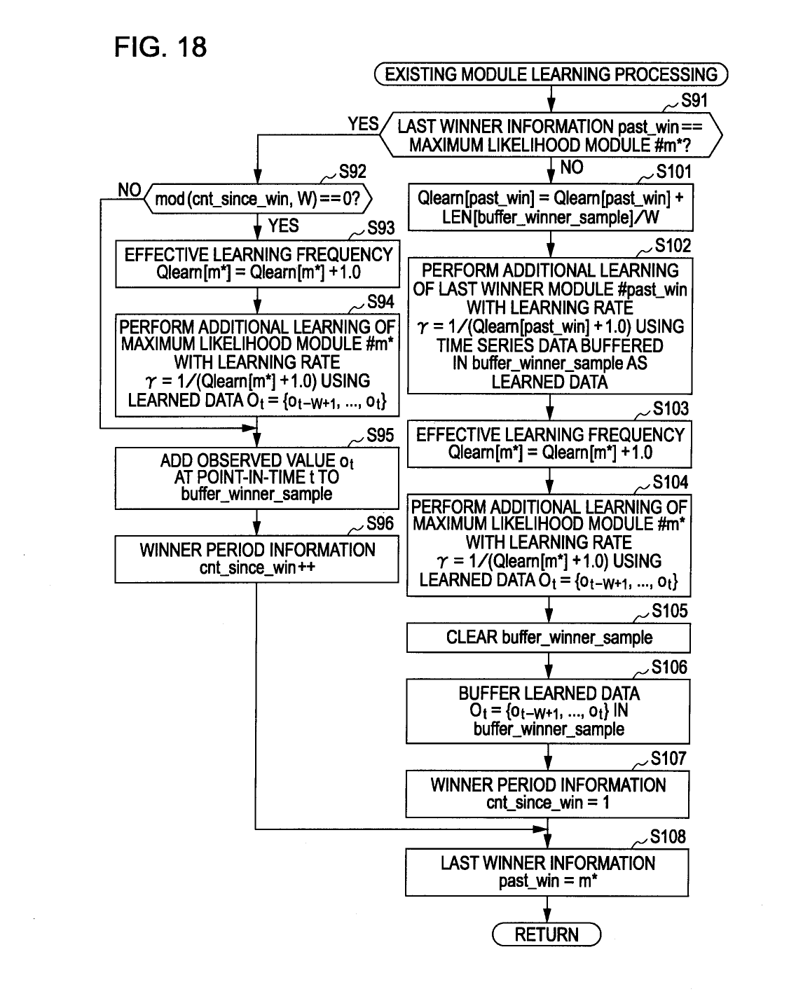

FIG. 18 is a flowchart for describing the existing module learning processing to be performed in step S71 in FIG. 17.

With the existing module learning processing, in step S91 the updating unit 23 (FIG. 8) determines whether or not the last winner information past_win, and the module index of the maximum likelihood module #m* serving as the object module match.

In the event that determination is made in step S91 that the last winner information past_win, and the module index of the maximum likelihood module #m* serving as the object module match, i.e., in the event that the module that has been the maximum likelihood module at the point-in-time t−1 that is one point-in-time ago of the current point-in-time t becomes the maximum likelihood module even at the current point-in-time t, and consequently, becomes the object module, the processing proceeds to step S92, where the updating unit 23 determines whether or not Expression mod(cnt_since_win, W)=0 is satisfied.

Here, mod(A, B) represents a reminder at the time of dividing A by B.

In the event that determination is made in step S92 that Expression mod(cnt_since_win, W)=0 is not satisfied, the processing skips steps S93 and S94 to proceed to step S95.

Also, in the event that determination is made in step S92 that Expression mod(cnt_since_win, W)=0 is satisfied, i.e., in the event that the winner period information cnt_since_win is divided by the window length W without a remainder, and accordingly, the module #m* that has been the maximum likelihood module at the current point-in-time t has continuously been the maximum likelihood module during a period of integer multiple of the window length W, the processing proceeds to step S93, where the updating unit 23 increments the effective learning frequency Qlearn[m*] of the maximum likelihood module #m* at the current point-in-time t serving as the object module by 1.0 for example, and the processing proceeds to step S94.

In step S94, the updating unit 23 obtains the learning rate γ of the maximum likelihood module #m* that is the object module in accordance with Expression γ=1/(Qlearn[m*]+1.0).

Subsequently, the updating unit 23 takes the latest time series data Oₜ of the window length W stored in the observation time series buffer 12 as learned data, uses the learned data Oₜ thereof to perform the additional learning of the maximum likelihood module #m* that is the object module with the learning rate γ=1/(Qlearn[m*]+1.0).

That is to say, the updating unit 23 updates the HMM parameters λ_{m*} of the maximum likelihood module #m* stored in the ACHMM storage unit 16 in accordance with the above Expressions (3) through (16).

Subsequently, the processing proceeds from step S94 to step S95, where the updating unit 23 buffers the observed value oₜ at the current point-in-time t stored in the observation time series buffer 12 in the buffer buffer_winner_sample in an additional manner, and the processing proceeds to step S96.

In step S96, the updating unit 23 increments the winner period information cnt_since_win by one, and the processing proceeds to step S108.

On the other hand, in the event that determination is made in step S91 that the last winner information past_win, and the module index of the maximum likelihood module #m* serving as the object module do not match, i.e., in the event that the maximum likelihood module #m* at the current point-in-time t differs from the maximum likelihood module at the point-in-time t−1 that is one point-in-time ago of the current point-in-time t, the processing proceeds to step S101, and hereafter, learning of the module that has been the maximum likelihood module until the point-in-time t−1, and the maximum likelihood module #m* at the current point-in-time t is performed.

Specifically, in step S101, the updating unit 23 increments the effective learning frequency Qlearn[past_win]of a module that has been the maximum likelihood module until the point-in-time t−1, i.e., the module (hereafter, also referred to as “last winner module”) #past_win with the last winner information past_win as the module index, for example, by LEN[buffer_winner_sample]/W, and the processing proceeds to step S102.

Here, LEN[buffer_winner_sample] represents the length (number) of observed values buffered in the buffer buffer_winner_sample.

In step S102, the updating unit 23 obtains the learning rate γ of the last winner module #past_win in accordance with Expression γ=1/(Qlearn[past_win]+1.0).

Subsequently, the updating unit 23 takes the time series of an observed value buffered in the buffer buffer_winner_sample as learned data, and uses the learned data thereof to perform additional learning of the last winner module #past_win with the learning rate γ=1/(Qlearn[past_win]+1.0).

That is to say, the updating unit 23 updates the HMM parameter λₚₐₛₜ_{_{—}}_{win} of the last winner module #past_win stored in the ACHMM storage unit 16 in accordance with the above Expressions (3) through (16).

Subsequently, the processing proceeds from step S102 to step S103, where the updating unit 23 increments the effective learning frequency Qlearn[m*] of the maximum likelihood module #m* at the current point-in-time t that is the object module, for example, by 1.0, and the processing proceeds to step S104.

In step S104, the updating unit 23 obtains the learning rate γ of the maximum likelihood module #m* that is the object module in accordance with Expression γ=1/(Qlearn[m*]+1.0).

Subsequently, the updating unit 23 takes the latest time series data Oₜ of the window length W stored in the observation time series buffer 12 as learned data, and uses the learned data Oₜ thereof to perform additional learning of the maximum likelihood module #m* that is the object module with the learning rate γ=1/(Qlearn[m*]+1.0).

That is to say, the updating unit 23 updates the HMM parameter λ_{m*} of the maximum likelihood module #m* that is the object module, stored in the ACHMM storage unit 16 in accordance with the above Expressions (3) through (16).

Subsequently, the processing proceeds from step S104 to step S105, where the updating unit 23 clears the buffer buffer_winner_sample, and the processing proceeds to step S106.

In step S106, the updating unit 23 buffers the latest learned data Oₜ of the window length W in the buffer buffer_winner_sample, and the processing proceeds to step S107.

In step S107, the updating unit 23 sets the winner period information cnt_since_win to 1 serving as an initial value, and the processing proceeds to step S108.

In step S108, the updating unit 23 sets the last winner information past_win to the module index m* of the maximum likelihood module #m* at the current point-in-time t, and the processing returns.

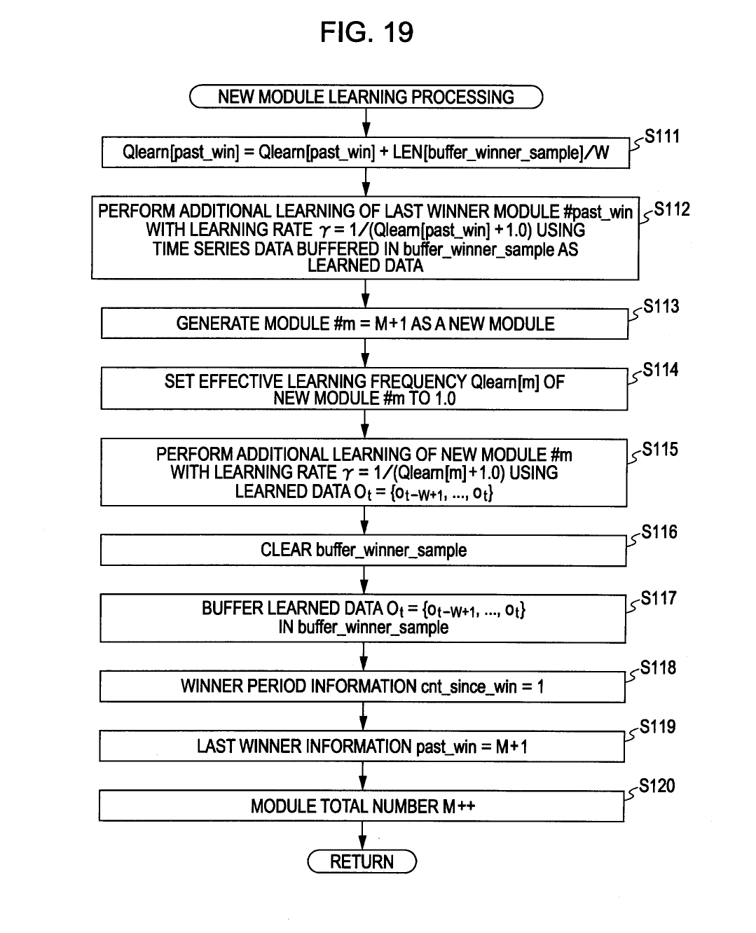

FIG. 19 is a flowchart for describing the new module learning processing to be performed in step S72 in FIG. 17.

With the new module learning processing, a new module is generated, learning is performed with the new module thereof as the object module, but before learning of a new module, learning of the module that has been the maximum likelihood module so far (until the point-in-time t−1) is performed.

Specifically, in step S111, the updating unit 23 increments the effective learning frequency Qlearn[past_win] of a module that has been the maximum likelihood module until the point-in-time t−1, i.e., the last winner module #past_win that is a module with the last winner information past_win as the module index, for example, by LEN[buffer_winner_sample]/W, and the processing proceeds to step S112.

In step S112, the updating unit 23 obtains the learning rate γ of the last winner module #past_win in accordance with Expression γ=1/(Qlearn[past_win]+1.0).

Subsequently, the updating unit 23 takes the time series of an observed value buffered in the buffer buffer_winner_sample as learned data, and uses the learned data thereof to perform additional learning of the last winner module #past_win with the learning rate γ=1/(Qlearn[past_win]+1.0).

That is to say, the updating unit 23 updates the HMM parameter λₚₐₛₜ_{_{—}}_{win} of the last winner module #past_win stored in the ACHMM storage unit 16 in accordance with the above Expressions (3) through (16).

Subsequently, the processing proceeds from step S112 to step S113, where the updating unit 23 (FIG. 8) generates an HMM that is a new module serving as the M+1'th module #M+1 making up the ACHMM in the same way as with the case in step S11 in FIG. 9. Further, the updating unit 23 stores (the HMM parameters λ_{M+1} of) the new module #m=M+1 in the ACHMM storage unit 16, and the processing proceeds from step S113 to step S114.

In step S114, the updating unit 23 sets the effective learning frequency Qlearn[m=M+1] of the new module #m=M+1 to 1.0 serving as an initial value, and the processing proceeds to step S115.

In step S115, the updating unit 23 obtains the learning rate γ of the new module #m=M+1 that is the object module in accordance with Expression γ=1/(Qlearn[m=M+1]+1.0).

Subsequently, the updating unit 23 takes the time series data Oₜ of the window length W stored in the observation time series buffer 12 as learned data, and uses the learned data Oₜ thereof to perform additional learning of the new module #m=M+1 that is the object module with the learning rate γ=1/(Qlearn[m=M+1]+1.0).

That is to say, the updating unit 23 updates the HMM parameter λ_{M+1} of the new module #m=M+1 that is the object module, stored in the ACHMM storage unit 16 in accordance with the above Expressions (3) through (16).

Subsequently, the processing proceeds from step S115 to step S116, where the updating unit 23 clears the buffer buffer_winner_sample, and the processing proceeds to step S117.

In step S117, the updating unit 23 buffers the latest learned data Oₜ of the window length W in the buffer buffer_winner_sample, and the processing proceeds to step S118.

In step S118, the updating unit 23 sets the winner period information cnt_since_win to 1 serving as an initial value, and the processing proceeds to step S119.

In step S119, the updating unit 23 sets the last winner information past_win to the module index M+1 of the new module #M+1, and the processing proceeds to step S120.

In step S120, the updating unit 23 increments the module total number M by one along with the new module being generated as a module making up the ACHMM, and the processing returns.

As described above, with the module learning processing according to the variable window learning (FIGS. 17 through 19), while the maximum likelihood module #m* that is the object module, and the last winner module #past_win that is a module having the maximum likelihood as to the learned data of one point-in-time ago match, learning of the maximum likelihood module #m* that is the object module is performed (step S94 in FIG. 18) with the time series of the latest observed value of the window length W as learned data for each window length W that is fixed time, and the latest observed value oₜ is buffered in the buffer buffer_winner_sample.

Subsequently, in the event that the object module, and the last winner module #past_win do not match, i.e., in the event that the object module has become a module other than the last winner module #past_win of the new module or a module making up the ACHMM, learning of the last winner module #past_win is performed (step S102 in FIG. 18, and step S112 in FIG. 19) with the time series of an observed value buffered in the buffer buffer_winner_sample as learned data, and learning of the object module is performed (step S104 in FIG. 18, and step S115 in FIG. 19) with the time series of the latest observed value of the window length W as learned data.

That is to say, with regard to a module that become the object module, as long as this module is (continuously) the object module, since the object module appeared for the first time, learning has been performed with the time series of an observed value of the window length W as learned data, and the observed values during that time are buffered in the buffer buffer_winner_sample.

Subsequently, when the object module becomes another module from the module that has been the object module so far, learning of the module that has been the object module so far is performed with the time series of an observed value buffered in the buffer buffer_winner_sample as learned data.

As a result thereof, according to the module learning processing according to the variable window learning, evil effects caused in the case of successively performing ACHMM learning at each point-in-time t with the time series of the latest observed value of the window length W that is fixed length as learned data, and evil effects caused in the case of taking the time series of an observed value as learned data by dividing into the units of the window length W, can be improved.

Now, with the module learning processing in FIG. 9, the learning frequency Nlearn[m] of the module #m will be incremented by one as to learning employing the learned data of the window length W that is fixed length.

On the other hand, with the module learning processing in FIG. 17, in the event that the object module has become a module other than the last winner module #past_win, learning of the last winner module #past_win is performed with the time series of an observed value buffered in the buffer buffer_winner_sample, i.e., variable-length time series data as learned data, and accordingly, adaptive control (adaptive control following the length LEN[buffer_winner_sample] of an observed value buffered in the buffer buffer_winner_sample) for increasing the effective learning frequency Qlearn[m] by a division value obtained by dividing the length LEN[buffer_winner_sample] of an observed value buffered in the buffer buffer_winner_sample by the window length W (step S101 in FIG. 18, and step S111 in FIG. 19).

For example, in the event that the window length W is 5, and the length LEN[buffer_winner_sample] of an observed value buffered in the buffer buffer_winner_sample to be used for learning of the last winner module #past_win is 10, the effective learning frequency Qlearn[m] of the last winner module #past_win is incremented by 2.0 (=LEN[buffer_winner_sample]/W).

### Configuration Example of Recognizing Unit 14

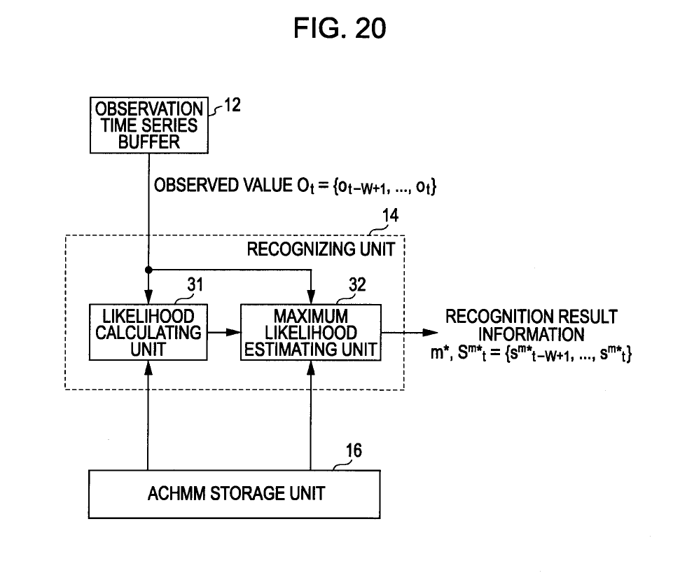

FIG. 20 is a block diagram illustrating a configuration example of the recognizing unit 14 in FIG. 1.

The recognizing unit 14 performs recognition processing wherein the time series data of an observed value to be successively supplied from the observation time series buffer 12, i.e., the time series data that is learned data Oₜ={o_{t-W+1}, . . . , oₜ} to be used for learning by the module learning unit 13 is recognized (identified) (classified) using the ACHMM stored in the ACHMM storage unit 16, and recognition result information representing the recognition results thereof is output.

Specifically, the recognizing unit 14 includes a likelihood calculating unit 31, and a maximum likelihood estimating unit 32, recognizes time series data that is learned data Oₜ={o_{t-W+1}, . . . , oₜ} to be used for learning by the module learning unit 13, and as recognition result information representing the recognition results thereof, obtains (the module index m* of) maximum likelihood module #m* that is a module having the maximum likelihood that the times series data (learned data) Oₜ may be observed, and maximum likelihood state series S^{m}*ₜ that are the series of the state of an HMM, where a state transition occurs with the maximum likelihood that the time series data Oₜ may be observed, of modules making up the ACHMM.

Here, with the recognizing unit 14, recognition of the learned data Oₜ to be used for learning by the module learning unit 13 can be performed using the ACHMM to be successively updated by the module learning unit 13 performing learning, and also after ACHMM learning by the module learning unit 13 sufficiently advances, and updating of the ACHMM is not performed, recognition (state recognition) of time series data (the time series of an observed value) having an arbitrary length, stored in the observation time series buffer 12 can be performed using the ACHMM thereof.

The same time series of an observed value (the time series data of the window length W) Oₜ={o_{t-W+1}, . . . , oₜ} as those to be supplied to the likelihood calculating unit 21 (FIG. 8) of the module learning unit 13 as learned data are successively supplied from the observation time series buffer 12 to the likelihood calculating unit 31.

The likelihood calculating unit 31 uses the time series data (here, serving as learned data) to be successively supplied from the observation time series buffer 12 to obtain likelihood (module likelihood) P(Oₜ|λₘ) that the time series data Oₜ may be observed at the module #m regarding the modules #1 through #M making up the ACHMM stored in the ACHMM storage unit 16 in the same way as with the likelihood calculating unit 21 in FIG. 8, and supplies this to the maximum likelihood estimating unit 32.

Here, the likelihood calculating unit 31, and the likelihood calculating unit 21 of the module learning unit 13 in FIG. 8 may be served by a single likelihood calculating unit.

The module likelihood P(Oₜ|λ₁) through P(Oₜ|λ_{M}) of the modules #1 through #M making up the ACHMM is supplied from the likelihood calculating unit 31 to the maximum likelihood estimation unit 32, and also the time series data (learned data) Oₜ={o_{t-W+1}, . . . , oₜ} of the window length W is supplied from the observation time series buffer 12 to the maximum likelihood estimating unit 32.

The maximum likelihood estimating unit 32 obtains, of the modules #1 through #M making up the ACHMM, maximum likelihood module #m*=argmaxₘ[P(Oₜ|λₘ)] that is a module of which the module likelihood P(Oₜ|λₘ) from the likelihood calculating unit 31 is the maximum.

Here, that the module #m* is the maximum likelihood module is equivalent to that in the event that the observation space has been divided into partial space equivalent to modules in a self-organized manner, and of the partial space thereof, the time series data Oₜ at the point-in-time t has been recognized (classified) in the partial space corresponding to the module #m*.

After obtaining the maximum likelihood module #m*, with the maximum likelihood module #m*, the maximum likelihood estimating unit 32 obtains maximum likelihood state series S^{m}*ₜ that are the series of the state of an HMM where a state transition of which the likelihood of the time series data Oₜ being observed is the maximum occurs, in accordance with the Viterbi algorithm.

Here, the maximum likelihood state series as to the time series data Oₜ={o_{t-W+1}, . . . , oₜ} of an HMM that is the maximum likelihood module #m* are represented with S^{m}*ₜ={s^{m}*_{t-W+1}(o_{t-W+1}) . . . , s^{m}*ₜ(oₜ)} or simply S^{m}*ₜ={s^{m}*_{t-W+1}, . . . , s^{m}*ₜ}, or Sₜ={s_{t-W+1}, . . . , sₜ} in the case that the maximum likelihood module #m* is apparent.

The maximum likelihood estimating unit 32 outputs a set [m*, S^{m}*ₜ={s^{m}*_{t-W+1}, . . . , s^{m}*ₜ}] of (the module index m* of) the maximum likelihood module #m*, and (an index representing a state making up) the maximum likelihood state series S^{m}*ₜ={s^{m}*_{t-W+1}, . . . , s^{m}*ₜ} as the recognition result information of the time series data Oₜ={o_{t-W+1}, . . . , oₜ} at the point-in-time t.

Note that the maximum likelihood estimating unit 32 may output a set [m*, s^{m}*ₜ] of the maximum likelihood module #m*, and the final state s^{m}*ₜ of the maximum likelihood state series S^{m}*ₜ={s^{m}*_{t-W+1}, . . . , s^{m}*ₜ} as the recognition result information of the observed value oₜ at the point-in-time t.

Also, in the case that there is a subsequent block with the recognition result information as input, when the subsequent block thereof requests a one-dimensional symbol as input, the recognition result information [m*, s^{m}*ₜ] that is a two-dimensional symbol may be converted into a one-dimensional symbol value not duplicated with all of the modules making up the ACHMM, such as a value N×(m*−1)+s^{m}*ₜ, for output, using numbers as the index m* and s^{m}*ₜ.

### Recognition Processing

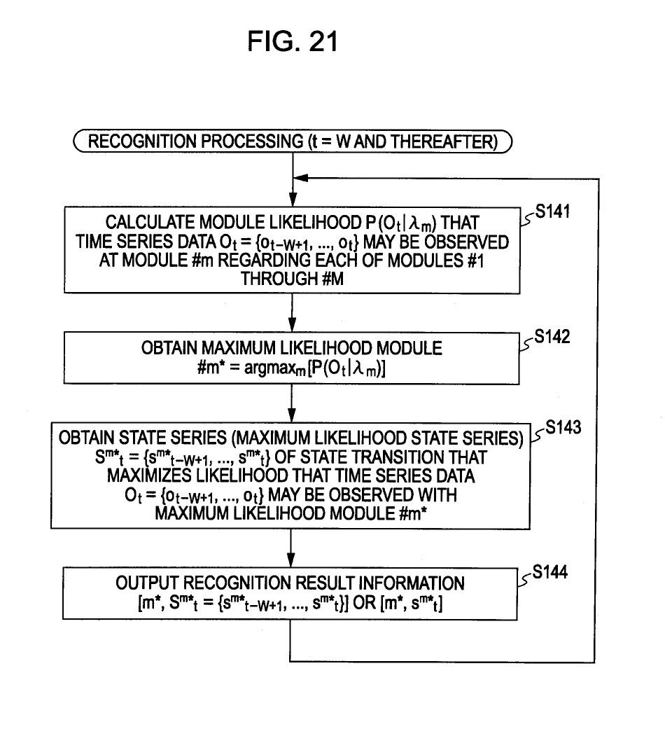

FIG. 21 is a flowchart for describing the recognition processing to be performed by the recognizing unit 14 in FIG. 20.

The recognition processing is started after the point-in-time t reaches the point-in-time W.

In step S141, the likelihood calculating unit 31 uses the latest (point-in-time t) time series data Oₜ={o_{t-W+1}, . . . , oₜ} of the window length W stored in the observation time series buffer 12 to obtain the module likelihood P(Oₜ|λₘ) of each module #m making up the ACHMM stored in the ACHMM storage unit 16, and supplies this to the maximum likelihood estimating unit 32.

Subsequently, the processing proceeds from step S141 to step S142, where the maximum likelihood estimating unit 32 obtains maximum likelihood module #m*=argmaxₘ[P(Oₜ|λₘ)] of which the module likelihood P(Oₜ|λₘ) from the likelihood calculating unit 31 is the maximum, of the modules #1 through #M making up the ACHMM, and the processing proceeds to step S143.

In step S143, with maximum likelihood module #m*, the maximum likelihood estimating unit 32 obtains maximum likelihood state series S^{m}*ₜ={s^{m}*_{t-W+1}, . . . , s^{m}*ₜ} where a state transition of which the likelihood of the time series data Ot being observed is the maximum occurs, and the processing proceeds to step S144.

In step S144, the maximum likelihood estimating unit 32 outputs a W+1-dimensional symbol [m*, S^{m}*ₜ={s^{m}*_{t-W+1}, . . . , s^{m}*ₜ}] that is a set of the maximum likelihood module #m*, and the maximum likelihood state series S^{m}*ₜ={s^{m}*_{t-W+1}, . . . , s^{m}*ₜ} as the recognition result information of the time series data Oₜ={o_{t-W+1}, . . . , oₜ} at the point-in-time t, or a two-dimensional symbol [m*, s^{m}*ₜ] that is a set of the maximum likelihood module #m*, and the final state s^{m}*ₜ of the maximum likelihood state series S^{m}*ₜ={s^{m}*_{t-W+1}, . . . , s^{m}*ₜ} as the recognition result information of the observed value oₜ at the point-in-time t.

Subsequently, after awaiting that the latest observed value is stored in the observation time series buffer 12, the processing returns to step S141, and hereafter, the same processing is repeated.

### Configuration Example of Transition Information Management Unit 15

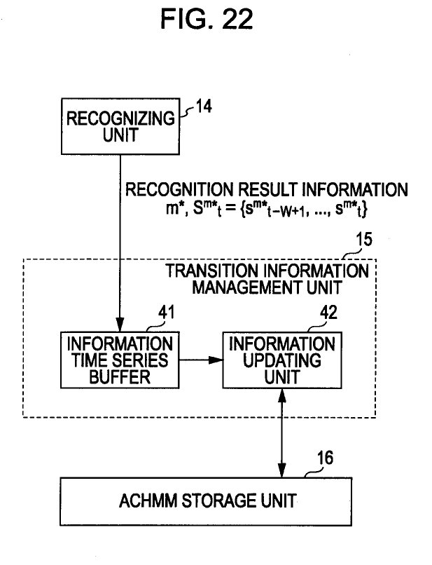

FIG. 22 is a block diagram illustrating a configuration example of the transition information management unit 15 in FIG. 1.

The transition information management unit 15 generates transition information that is the information of frequency of each state transition at the ACHMM stored in the ACHMM storage unit 16 based on the recognition result information from the recognizing unit 14, and supplies this to the ACHMM storage unit 16 to update the transition information stored in the ACHMM storage unit 16.

Specifically, the transition information management unit 15 includes an information time series buffer 41, and an information updating unit 42.

The information time series buffer 41 temporarily stores the recognition result information [m*, S^{m}*ₜ={_{t-W+1}, . . . , s^{m}*ₜ}] output from the recognizing unit 14.

Note that the information time series buffer 41 has at least storage capacity used for storing two points-in-time of recognition result information regarding later-described phases of which the number is equal to the window length W.

Also, the recognition result information [m*, S^{m}*ₜ={s^{m}*_{t-W+1}, . . . , s^{m}*ₜ}] of the time series data Oₜ={o_{t-W+1}, . . . , oₜ} of the window length W is supplied from the recognizing unit 14 to the information time series buffer 41 of the transition information management unit 15 instead of an observed value at certain one point-in-time.

The information updating unit 42 generates new transition information from the recognition result information stored in the information time series buffer 41, and the transition information stored in the ACHMM storage unit 16, and uses the new transition information thereof to update a later-described inter-module state transition frequency table where the transition information stored in the ACHMM storage unit 16 are registered.

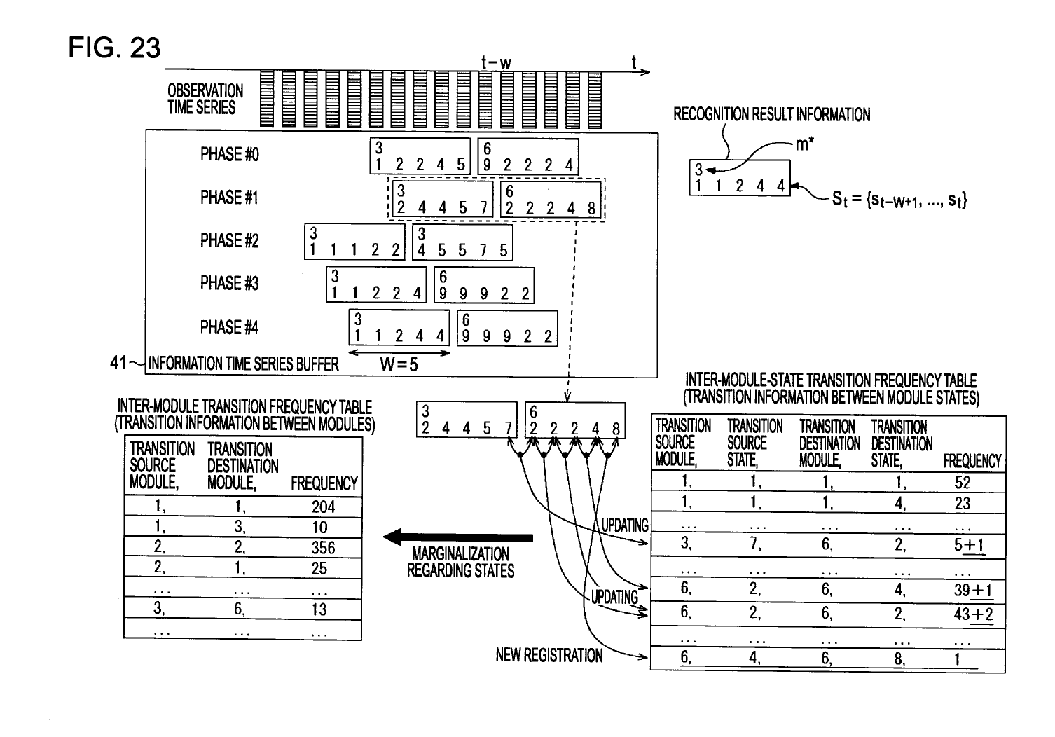

FIG. 23 is a diagram for describing the transition information generating processing for the transition information management unit 15 in FIG. 22 generating transition information.

According to the module learning at the module learning unit 13 (FIG. 1), the observation space of an observed value to be observed from a modeling object is divided into local configurations (small worlds) (partial space) equivalent to modules, and a certain time series pattern is obtained by an HMM within a local configuration.

In order to express the modeling object through a small world network, (state) transition between local configurations, i.e., a model of transition (transition model) between modules has to be obtained by learning.

On the other hand, according to the recognition result information output from the recognizing unit 14, the state (of an HMM) in which an observed value oₜ at arbitrary point-in-time t is observed can be determined, and accordingly, not only a state transition within a module but also a state transition between modules can be obtained.

Therefore, the transition information management unit 15 uses the recognition result information output from the recognizing unit 14 to obtain transition information serving as (the parameters of) a transition model.

Specifically, the transition information management unit 15 determines a module and a state (of an HMM) at each of certain continuous point-in-time t−1, and point-in-time t, based on the recognition result information output from the recognizing unit 14, takes a module and a state at the temporally preceding point-in-time t−1 as a transition source module and a transition source state, and takes a module and a state at the temporally following point-in-time t as a transition destination module and a transition destination state.

Further, the transition information management unit 15 generates (indexes representing) a transition source module, a transition source state, a transition destination module, and a transition destination state, and 1 as the (emergence) frequency of state transitions from the transition source state of the transition source module to the transition destination state of the transition destination module as transition information between module states that is one of transition information, and registers the transition information between module states thereof as one record (one entry) (one row) of the inter-module-state transition frequency table.

Subsequently, in the event that the same transition source module, transition source state, transition destination module, and transition destination state as the transition information between module states already registered in the inter-module-state transition frequency table have emerged, the transition information management unit 15 increments by 1 the frequency of the transition information between module states thereof to generate transition information between module states, and updates the inter-module-state transition frequency table by the transition information between module states thereof.

Specifically, with the transition information management unit 15 (FIG. 22), the point-in-time t is classified into phases by a remainder f in the case of dividing the point-in-time t by the window length W, and accordingly, a storage region equivalent to the number of phases (equivalent to the window length W) are secured in the information time series buffer 41 (FIG. 22).

The storage region of a phase #f(f=0, 1, . . . , W−1) has at least storage capacity used for storing two points-in-time of recognition result information, and if we say that the latest two points-in-time of recognition result information of the phase #f, i.e., the latest point-in-time t of the phase #f is point-in-time t=τ, the recognition result information at the point-in-time τ, and the recognition result information at point-in-time τ−W is stored.

Now, FIG. 23 illustrates the storage content of the information time series buffer 41 in the case that the window length W is 5, and accordingly, the recognition result information is stored by being divided into five phases #0, #1, #2, #3, and #4.

Note that in FIG. 23, a rectangle in which numerals are described in a manner divided into two stages represents the recognition result information at one point-in-time. Also, of the numerals in two stages within a rectangle serving as the recognition result information at one point-in-time, one numeral on the upper stage represents (the module index of) a module that has been the maximum likelihood module, and five numerals on the lower stage represents (the index of the state making up) maximum likelihood state series with the right edge as the state of the latest point-in-time.

In the event that the current point-in-time (latest point-in-time) t is, for example, point-in-time classified into the phase #1, the recognition result information at the current point-in-time t is supplied from the recognizing unit 14 to the information time series buffer 41, and is stored in the storage region of the phase #1 of the information time series buffer 41 in an additional manner.

As a result thereof, at least the recognition result information at the current point-in-time t, and the recognition result information at the point-in-time t−W are stored in the storage region of the phase #1 of the information time series buffer 41.

Here, the recognition result information at the point-in-time t to be output from the recognizing unit 14 to the information time series buffer 41 is, as described above, not the observed value oₜ at the point-in-time t but the recognition result information [m*, S^{m}*ₜ={s^{m}*_{t-W+1}, . . . , s^{m}*ₜ}] of the time series data Oₜ={o_{t-W+1}, . . . , oₜ} at the point-in-time t, which includes (the information of) a module and a state at each point-in-time of the point-in-time t−W+1 through the point-in-time t.

(The information of) a module and a state at certain point-in-time included in the recognition result information [m*, S^{m}*ₜ={s^{m}*_{t-W+1}, . . . , s^{m}*ₜ}] of the time series data Oₜ={o_{t-W+1}, . . . , oₜ} at the point-in-time t will also be referred to as the recognition value at the point-in-time thereof.

In the event that the recognition result information at the current point-in-time t, and the recognition result information at the point-in-time t−W have been stored in the storage region of the phase #1, the information updating unit 42 (FIG. 22) connects the recognition result information at the current point-in-time t, and the recognition result information at the point-in-time t−W in the point-in-time order such as illustrated in a dotted-line arrow in FIG. 23.

Further, of the recognition result information after connection, i.e., of the array of the time series sequence of the recognition value at each point-in-time of the point-in-time t−2W+1 through the point-in-time t (hereafter, also referred to as connected information), regarding W sets (hereafter, also referred to as recognition value set) of adjacent recognition values of the W+1 recognition values at the point-in-time t−W through the point-in-time t, the information updating unit 42 checks whether or not transition information between module states that takes the recognition value sets thereof as a set of a transition source module and a transition source state, and a set of a transition destination module and a transition destination state are registered in the inter-module-state transition frequency table stored in the ACHMM storage unit 16.

In the event that transition information between module states that takes the recognition value sets thereof as a set of a transition source module and a transition source state, and a set of a transition destination module and a transition destination state are not registered in the inter-module-state transition frequency table stored in the ACHMM storage unit 16, the information updating unit 42 newly generates transition information between module states wherein of the recognition value sets, a temporally preceding module and state set, and a temporally following module and state set are taken as a transition source module and transition source state set, and a transition destination module and transition destination state set respectively, and also frequency is set to 1 serving as an initial value.

Subsequently, the information updating unit 42 registers the newly generated transition information between module states as a new one record of the inter-module-state transition frequency table stored in the ACHMM storage unit 16.

Now, let us say that when the module learning processing at the module learning unit 13 (FIG. 1) is started, the inter-module-state transition frequency table having no record is stored in the ACHMM storage unit 16.

Also, in the event that a transition source module and transition source state set, and a transition destination module and transition destination state set match, i.e., even in the event of the self transition, such as described above, the information updating unit 42 newly generates transition information between module states, and registers this in the inter-module-state transition frequency table.

On the other hand, in the event that transition information between module states that takes the recognition value sets thereof as a set of a transition source module and a transition source state, and a set of a transition destination module and a transition destination state are registered in the inter-module-state transition frequency table stored in the ACHMM storage unit 16, the information updating unit 42 increments the frequency of the transition information between module states thereof by one to generate transition information between module states, and updates the inter-module-state transition frequency table stored in the ACHMM storage unit 16 by the generated inter-module-state transition frequency table.

Here, of the connected information obtained by connecting the recognition result information at the current point-in-time t, and the recognition result information at the point-in-time t−W, of W recognition values at the point-in-time t−2W+1 through point-in-time t−W, W−1 recognition value sets between adjacent recognition values are not employed for counting (incrementing) of frequency in the transition information generating processing to be performed by the transition information management unit 15.

This is because of W recognition values at the point-in-time t−2W+1 through point-in-time t−W, W−1 recognition value sets between adjacent recognition values have already been employed for counting of frequency in the transition information generating processing employing the connected information obtained by connecting the recognition result information at the point-in-time t−W and the recognition result information at the point-in-time t−2W, and accordingly, counting of frequency has to be prevented from being redundantly performed.

Note that, with the information updating unit 42, after updating of the inter-module-state transition frequency table, the transition information between module states of the updated inter-module-state transition frequency table is marginalized such as illustrated in FIG. 23 with regard to state (information), whereby an inter-module transition frequency table can be generated wherein transition information between modules that is the transition information of a state transition (transition between modules) between (an arbitrary state of) a certain module, and (an arbitrary state of) an arbitrary module including that module is registered, and can be stored in the ACHMM storage unit 16.

Here, the transition information between modules is made up of (the indexes representing) a transition source module, and a transition destination module, and the frequency of state transitions from the transition source module to the transition destination module.

### Transition Information Generating Processing

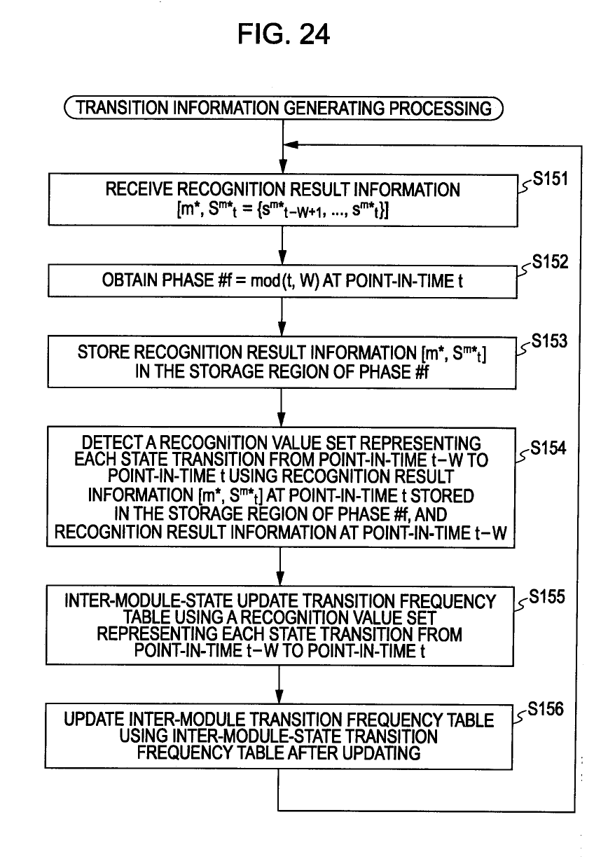

FIG. 24 is a flowchart for describing the transition information generating processing to be performed by the transition information management unit 15 in FIG. 22.

After awaiting that the recognition result information [m*, S^{m}*ₜ={s^{m}*_{t-W+1}, . . . , s^{m}*ₜ}] at the point-in-time t that is the current point-in-time is output from the recognizing unit 14, in step S151 the transition information management unit 15 receives this, and the processing proceeds to step S152.

In step S152, the transition information management unit 15 obtains the phase #f=mod(t, W) at the point-in-time t, and the processing proceeds to step S153.

In step S153, the transition information management unit 15 stores the recognition result information [m*, S^{m}*ₜ] at the point-in-time t from the recognizing unit 14 in the storage region of the phase #f of the information time series buffer 41 (FIG. 22), and the processing proceeds to step S154.

In step S154, the information updating unit 42 of the transition information management unit 15 uses the recognition result information at the point-in-time t stored in the storage region of the phase #f of the information time series buffer 41, and the recognition result information at the point-in-time t−W to detect W recognition value sets representing each state transition from the point-in-time t−W to the point-in-time t.

That is to say, such as described in FIG. 23, the information updating unit 42 connects the recognition result information at the point-in-time t, and the recognition result information at the point-in-time t−W in the point-in-time sequence to generate connected information that is the array of the time series sequence of the recognition value at each point-in-time of the point-in-time t−2W+1 through the point-in-time t.

Further, with the array of recognition values serving as the connected information, the information updating unit 42 detects, of W+1 recognition values at the point-in-time t−W through the point-in-time t, W sets between adjacent recognition values as W recognition value sets representing each state transition from the point-in-time t−W to the point-in-time t.

Subsequently, the processing proceeds from step S154 to step S155, where the information updating unit 42 uses the W recognition value sets representing each state transition from the point-in-time t−W to the point-in-time t to generate transition information between module states, and updates the inter-module-state transition frequency table (FIG. 23) stored in the ACHMM storage unit 16 by the generated transition information between module states.

That is to say, the information updating unit 42 has an interest in a certain recognition value set of W recognition value sets as a recognition value set of interest, and checks whether or not transition information between module states (hereafter, also referred to as transition information between module states corresponding to the recognition value set of interest) wherein of the recognition value set of interest, a temporally preceding recognition value is taken as a transition source module and transition source state, and a temporally following recognition value is taken as a transition destination module and transition destination state, has been registered in the inter-module-state transition frequency table stored in the ACHMM storage unit 16.

Subsequently, in the event that the transition information between module states corresponding to the recognition value set of interest has not been registered in the inter-module-state transition frequency table, the information updating unit 42 newly generates transition information between module states wherein of the recognition value sets of interest, a temporally preceding module and state, and a temporally following module and state are taken as a transition source module and transition source state, and a transition destination module and transition destination state respectively, and frequency is set to 1 serving as an initial value.

Further, the information updating unit 42 registers the newly generated transition information between module states as a new one record of the inter-module-state transition frequency table stored in the ACHMM storage unit 16.

Also, in the event that the transition information between module states corresponding to the recognition value set of interest has been registered in the inter-module-state transition frequency table, the information updating unit 42 generates transition information between module states wherein the frequency of the transition information between module states corresponding to the recognition value sets of interest has been incremented by one, and updates the inter-module-state transition frequency table stored in the ACHMM storage unit 16 by the transition information between module states.

After updating of the inter-module-state transition frequency table, the processing proceeds from step S155 to step S156, where the information updating unit 42 performs marginalization regarding the states of the transition information between module states of the updated inter-module-state transition frequency table to generate transition information between modules that is transition information of a state transition (transition between modules) between (an arbitrary state of) a certain module and (an arbitrary state of) an arbitrary module including that module.

Subsequently, the information updating unit 42 generates transition information table between modules (FIG. 23) in which the transition information between modules generated with the updated inter-module-state transition frequency table has been registered, and stores (overwrites in the case that the old transition information table between modules has been stored) the transition information table between modules thereof in the ACHMM storage unit 16.

Subsequently, after awaiting that the recognition result information at the next point-in-time is output from the recognizing unit 14 to the transition information management unit 15, the processing returns from step S156 to step S151, and hereafter, the same processing is repeated.

Note that, with the transition information generating processing in FIG. 24, step S156 may be skipped.

### Configuration Example of HMM Configuration Unit 17

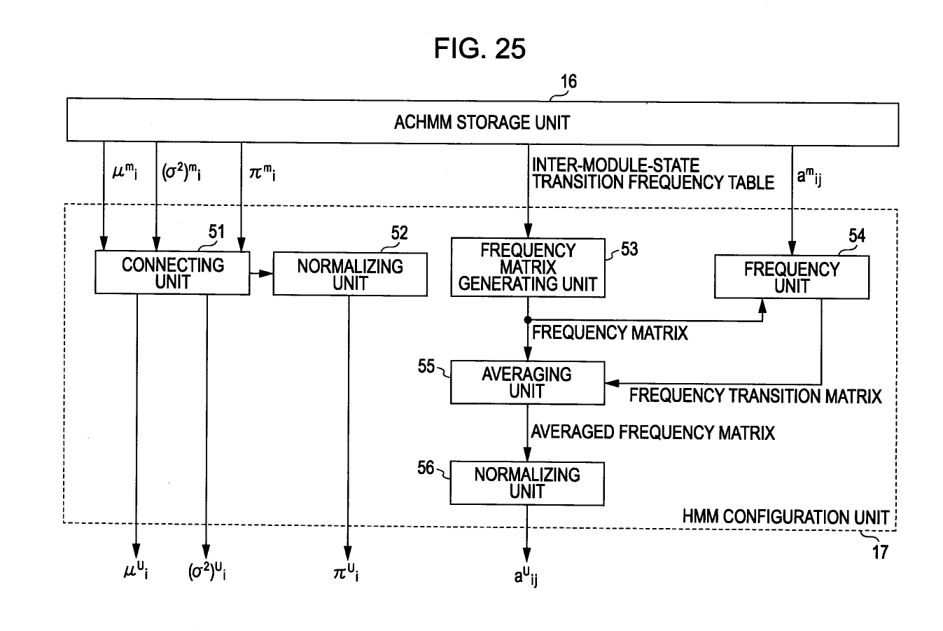

FIG. 25 is a block diagram illustrating a configuration example of the HMM configuration unit 17 in FIG. 1.

Now, as the local configuration (small world), with ACHMM learning employing a small-scale HMM, competitive learning type learning (competitive learning), or module additional type learning in which HMM parameters of a new module are updated is performed in an adaptive manner, and accordingly, even when a modeling object is an object that has to have a large-scale HMM for modeling, the convergence of ACHMM learning is extremely excellent (high) as compared to learning of a large-scale HMM.

Also, with an ACHMM, the observation space of an observed value to be observed from a modeling object is divided into partial space equivalent to modules, and further, the partial space is more finely divided (state division) into units equivalent to the state of an HMM that is a module equivalent to the partial space thereof.

Therefore, according to an ACHMM, with regard to observed values, recognition of a rough-density two-level configuration (state recognition), i.e., rough recognition in increments of modules, and fine (dense) recognition in increments of HMM states may be performed.

On the other hand, the HMM parameters of an HMM that is a module for learning the local configuration, and transition information that is the information of frequency of each state transition in an ACHMM, serving as the model parameters of the ACHMM, are obtained with the module learning processing (FIGS. 9 and 17), and the transition information generating processing (FIG. 24), which are learning having a different nature, respectively, but it may be convenient for a block which performs processing on the subsequent stage of the learning device in FIG. 1 to integrate these HMM parameters and transition information to re-express the whole ACHMM as a probabilistic state transition model.

Examples of such a convenient case include a case where the learning device in FIG. 1 is applied to an agent which autonomously acts (perform actions), such as described later.

Therefore, the HMM configuration unit 17 configures (reconfigures) a combined HMM that is a single HMM having a greater scale than an HMM that is a single module by combining the modules of the ACHMM.

Specifically, the HMM configuration unit 17 includes a connecting unit 51, a normalizing unit 52, a frequency matrix generating unit 53, a frequency unit 54, an averaging unit 55, and a normalizing unit 56.

Here, let us say that the model parameters λ^{U} of a combined HMM is represented with λ^{U}={a^{U}ᵢⱼ, μ^{U}ᵢ, (σ²)^{U}ᵢ, π^{U}ᵢ, i=1, 2, . . . , N×M, j=1, 2, . . . , N×M}. a^{U}ᵢⱼ, μ^{U}ᵢ, (σ²)^{U}ᵢ, and π^{U}ᵢ represent the state transition probability, mean vector, dispersion, and initial probability of the combined HMM, respectively.

The mean vectors μ^{m}ᵢ, dispersions (σ²)^{m}ⱼ, and initial probabilities π^{m}ᵢ of the HMM parameters λₘ of an HMM that is a module of the ACHMM stored in the ACHMM storage unit 16 are supplied to the connecting unit 51.

The connecting unit 51 obtains and outputs the mean vector μ^{U}ᵢ of the combined HMM by connecting the mean vectors μ^{m}ᵢ of all of the modules of the ACHMM, from the ACHMM storage unit 16.

Also, the connecting unit 51 obtains and outputs the dispersion (σ²)^{U}ᵢ of the combined HMM by connecting the dispersions (σ²)^{m}ᵢ of all of the modules of the ACHMM, from the ACHMM storage unit 16.

Further, the connecting unit 51 connects the initial probability π^{m}ᵢ of all of the modules of the ACHMM, from the ACHMM storage unit 16 to supply the connection results thereof to the normalizing unit 52.

The normalizing unit 52 obtains and outputs the initial probability π^{U}ᵢ of the combined HMM by normalizing the connected result of the initial probabilities π^{m}ᵢ of all of the modules of the ACHMM, from the connecting unit 51 so that the summation becomes 1.0.

Of the model parameters of the ACHMM stored in the ACHMM storage unit 16, the inter-module-state transition frequency table (FIG. 23) in which the transition information (transition information between module states) has been registered is supplied to the frequency matrix generating unit 53.

The frequency matrix generating unit 53 references the inter-module-state transition frequency table from the ACHMM storage unit 16 to generate a frequency matrix that is a matrix that takes the frequency (number of times) of state transitions between arbitrary states (of each module) of the ACHMM as a component, and supplies this to the frequency unit 54 and the averaging unit 55.

In addition to the frequency matrix, the state transition probabilities a^{m}ᵢⱼ of the HMM parameters λₘ of an HMM that is a module of the ACHMM stored in the ACHMM storage unit 16 are supplied from the frequency matrix generating unit 53 to the frequency unit 54.

The frequency unit 54 converts the state transition probabilities a^{m}ᵢⱼ from the ACHMM storage unit 16 into the frequencies of the corresponding state transition based on the frequency matrix from the frequency matrix generating unit 53, and supplies the frequency transition matrix that takes the frequencies thereof as components to the averaging unit 55.

The averaging unit 55 averages the frequency matrix from the frequency matrix generating unit 53, and the frequency transition matrix from the frequency unit 54, and supplies an averaged frequency matrix obtained as a result thereof to the normalizing unit 56.

The normalizing unit 56 normalizes the frequencies serving as components of the averaged frequency matrix so that the summation of the frequencies of state transitions from one state of the ACHMM to each of all of the states of the ACHMM becomes 1.0, of the frequencies serving as a component of the averaged frequency matrix from the averaging unit 55, thereby randomizing the frequencies to probabilities, and accordingly obtaining and outputting the state transition probability a^{U}ᵢⱼ of the combined HMM.

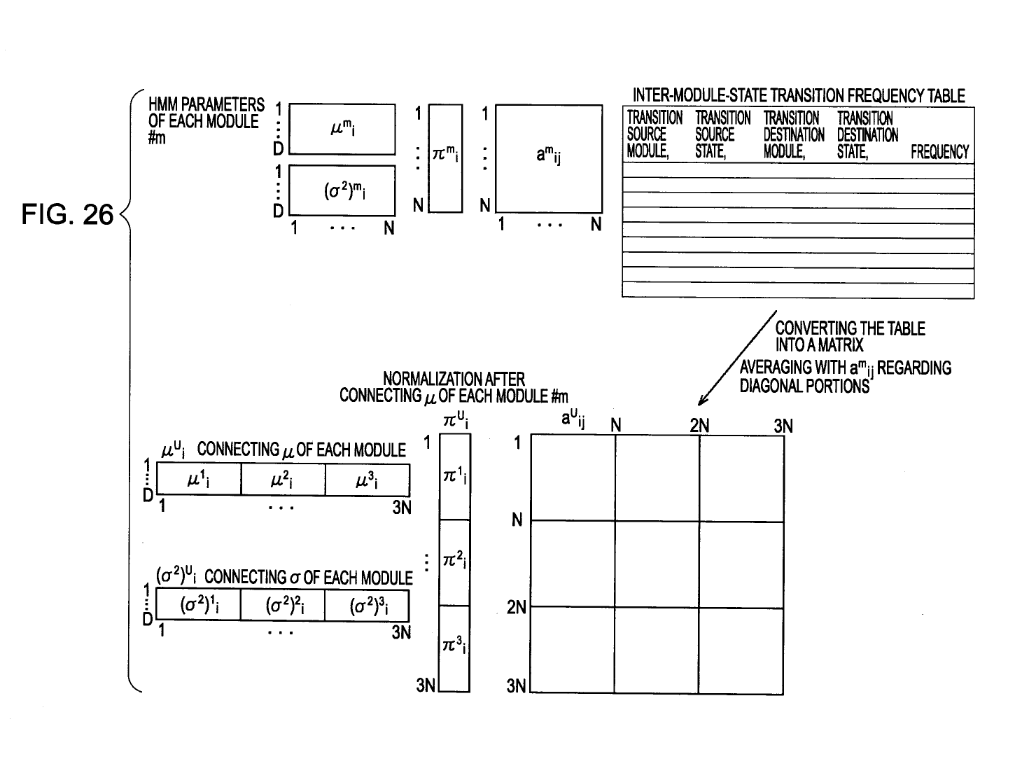

FIG. 26 is a diagram for describing a method for configuring a combined HMM by the HMM configuration unit 17 in FIG. 25, i.e., a method for obtaining the state transition probability a^{U}ᵢⱼ, mean vector μ^{U}ᵢ, dispersion (σ²)^{U}ᵢ, and initial probability π^{U}ᵢ, which are the HMM parameters of a combined HMM.

Note that in FIG. 26, let us assume that the ACHMM is configured of three modules #1, #2, and #3.

First, description will be made regarding how to obtain the mean vector μ^{U}ᵢ, and dispersion (σ²)^{U}ᵢ for stipulating the observation probability of a combined HMM.

In the event that an observed value is a D-dimensional vector, the mean vectors μ^{m}ᵢ, and dispersions (σ²)^{m}ᵢ for stipulating the observation probability of a single module #m can be represented with a D-dimensional column vector that takes the components in the d'th row as the d-dimensional components of the vectors μ^{m}ᵢ, and dispersions (σ²)^{m}ᵢ respectively.

Further, in the event that the number of HMM states of the single module #m is N, the group of the mean vectors μ^{m}ᵢ (regarding all of states sᵢ) of the single module #m can be represented with a D-row N-column matrix that takes the components in the i'th column as the mean vectors μ^{m}ᵢ that are D-dimensional column vectors.

Similarly, the group of the dispersions (σ²)^{m}ᵢ (regarding all of the states sᵢ) of the single module #m can be represented with a D-row N-column matrix that takes the components in the i'th column as the dispersions (σ²)^{m}ᵢ that are D-dimensional column vectors.

The connecting unit 51 (FIG. 25) obtains the matrix of the mean vector μ^{U}ᵢ of a combined HMM by connecting the D-row N-column matrices of the mean vectors μ¹ᵢ through μ³ᵢ of all the modules #1 through #3 of the ACHMM, such as illustrated in FIG. 26, in the ascending order of the module index m in an array in the column direction (horizontal direction).

Similarly, the connecting unit 51 obtains the matrix of the dispersion (σ²)^{U}ᵢ of a combined HMM by connecting the D-row N-column matrices of the dispersions (σ²)¹ᵢ through (σ²)³ᵢ of all the modules #1 through #3 of the ACHMM, such as illustrated in FIG. 26, in the ascending order of the module index m in an array in the column direction.

Here, the matrix of the mean vector μ^{U}ᵢ of a combined HMM, and the matrix of the dispersion (σ²)^{U}ᵢ of a combined HMM are both made up of a D-row 3×N-column matrix.

Next, description will be made regarding how to obtain the initial probability π^{U}ᵢ of a combined HMM.

As described above, in the event that the number of HMM states of the single module #m is N, the group of the initial probabilities π^{m}ᵢ of the single module #m can be represented with a N-dimensional column vector that takes the initial probabilities π^{m}ᵢ of the states sᵢ as the components in the i'th row.

The connecting unit 51 (FIG. 25) connects the N-dimensional column vectors that are the initial probabilities π¹ᵢ through π³ᵢ of all the modules #1 through #3 of the ACHMM in the ascending order of the module index m in an array in the row direction (vertical direction) such as illustrated in FIG. 26, and supplies the 3×N-dimensional column vectors that are the connection result thereof to the normalizing unit 52.

The normalizing unit 52 (FIG. 25) obtains the 3×N-dimensional column vector that is the group of the initial probability π^{U}ᵢ of a combined HMM by normalizing the components of the 3×N-dimensional column vectors that are the connection result from the connecting unit 51 so that the summation of the components thereof becomes 1.0.

Next, description will be made regarding how to obtain the state transition probability a^{U}ᵢⱼ of a combined HMM.

As described above, in the event that the number of HMM states of the single module #m is N, the total number of the states of the ACHMM made up of the three modules #1 through #3 is 3×N, and accordingly, there are state transitions from 3×N states to 3×N states.

The frequency matrix generating unit 53 (FIG. 25) references the inter-module-state transition frequency table to generate a frequency matrix that is a matrix that takes the frequencies of state transitions as components wherein each of the 3×N states is taken as a transition source state, and each of the 3×N states from the transition source states thereof is taken as a transition destination state.

The frequency matrix is a 3×N-row 3×N-column matrix with the frequencies of state transitions from the i'th state to the j'th state of the 3×N states as components in the i'th row and the j'th column.

Now, let us say that, with regard to the order of the 3×N states, the states of the three modules #1 through #3 are arrayed in the ascending order of the module index m, and are counted.

In this case, with the frequency matrix of 3×N-row 3×N-column, the components of the first row through the N'th row represent the frequencies of state transitions with the state of the module #1 as a transition source state. Similarly, the components of the N+1'th row through the 2×N'th row represent the frequencies of state transitions with the state of the module #2 as a transition source state, and the components of the 2×N+1'th row through the 3×N'th row represent the frequencies of state transitions with the state of the module #3 as a transition source state.

On the other hand, the frequency unit 54 converts the state transition probabilities a¹ᵢⱼ through a³ᵢⱼ of the three modules #1 through #3 making up the ACHMM into the frequencies of the corresponding state transition based on the frequency matrix generated at the frequency matrix generating unit 53, and generates a frequency transition matrix that is a matrix that takes the frequencies thereof as components.

The averaging unit 55 generates a 3×N-row 3×N-column averaged frequency matrix by averaging the frequency matrix generated at the frequency matrix generating unit 53, and the frequency transition matrix generated at the frequency unit 54.

The normalizing unit 56 randomizes the frequency that is a component of the averaged frequency matrix generated at the averaging unit 55 to a probability, thereby obtaining a 3×N-row 3×N-column matrix that takes the state transition probability a^{U}ᵢⱼ of combined HMM as the component in the i'th row and the j'th column.

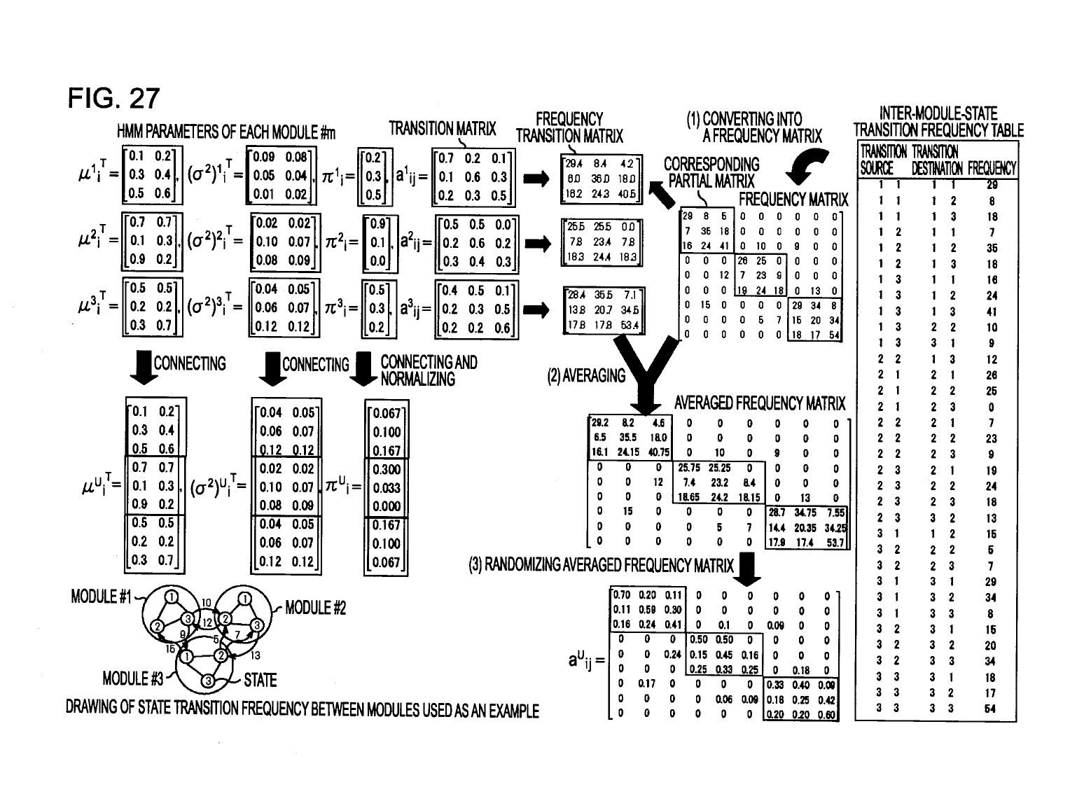

FIG. 27 is a diagram for describing a specific example of a method for obtaining the state transition probability a^{U}ᵢⱼ, mean vector μ^{U}ᵢ, dispersion (σ²)^{U}ᵢ, and initial probability π^{U}ᵢ, which are the HMM parameters of a combined HMM by the HMM configuration unit 17 in FIG. 25.

Note that in FIG. 27, in the same way as with FIG. 26, let us say that the ACHMM is configured of the three modules #1, #2, and #3.

Further, in FIG. 27, let us say that the number of dimensions D of observed values is two dimensions, and the number of HMM states N of the single module #m is 3.

Also, in FIG. 27, superscripts T represent transposition.

First, description will be made regarding how to obtain the mean vector μ^{U}ᵢ, and dispersion (σ²)^{U}ᵢ for stipulating the observation probability of a combined HMM.

In the event that the number of dimensions D of observed values is two dimensions, and the number of HMM states N of the single module #m is 3, such as described in FIG. 26, the mean vectors μ^{m}ᵢ of the single module #m are represented with a two-dimensional column vector that takes the components in the d'th row as the d-dimensional components of the mean vectors μ^{m}ᵢ, and the group of the mean vectors μ^{m}ᵢ (regarding all the states sᵢ) of the single module #m is represented with a 2-row 3-column matrix that takes the components in the i'th column as the mean vectors μ^{m}ᵢ that are two-dimensional column vectors.

Similarly, the dispersions (σ²)^{m}ᵢ of the single module #m are represented with a two-dimensional column vector that takes the components in the d'th row are taken as the d-dimensional components of the dispersions (σ²)^{m}ᵢ, and the group of the dispersions (σ²)^{m}ᵢ (regarding all the states sᵢ) of the single module #m is represented with a 2-row 3-column matrix that takes the components in the i'th column as the dispersions (σ²)^{m}ᵢ that are two-dimensional column vectors.

Note that in FIG. 27, the matrix serving as the group of the mean vectors μ^{m}ᵢ, and the matrix serving as the group of the dispersions (σ²)^{m}ᵢ are both transposed, and are represented with a 3-row 2-column matrix.

The connecting unit 51 (FIG. 25) obtains a 2-row 9(=3×3)-column matrix that is the matrix of the mean vector μ^{U}ᵢ of a combined HMM by connecting the 2-row 3-column matrices of the mean vectors μ¹ᵢ through μ³ᵢ of all the modules #1 through #3 of the ACHMM in the ascending order of the module index m in an array in the column direction (horizontal direction).

Similarly, the connecting unit 51 obtains a 2-row 9-column matrix that is the matrix of the dispersion (σ²)^{U}ᵢ of a combined HMM by connecting the 2-row 3-column matrices of the dispersions (σ²)¹ᵢ through (σ²)³ᵢ of all the modules #1 through #3 of the ACHMM in the ascending order of the module index m in an array in the column direction.

Note that in FIG. 27, the matrix serving as the group of the mean vectors μ^{m}ᵢ, and the matrix serving as the group of the dispersions (σ²)^{m}ᵢ are both transposed, and accordingly, connection has been performed in the row direction (vertical direction). Further, as a result thereof, the matrix of the mean vector μ^{U}ᵢ, and the matrix of the dispersion (σ²)^{U}ᵢ of a combined HMM are made up of a 9-row 2-column matrix transposed from a 2-row 9-column matrix.

Next, description will be made regarding how to obtain the initial probability π^{U}ᵢ of a combined HMM.

In the event that the number of HMM states N of the single module #m is 3, such as described in FIG. 26, the group of the initial probabilities π^{m}ᵢ of the single module #m is represented with a three-dimensional column vector that takes the initial probabilities π^{m}ᵢ of the states sᵢ as the components in the i'th row.

The connecting unit 51 (FIG. 25) connects the three-dimensional column vectors that are the initial probabilities π¹ᵢ through π³ᵢ of all the modules #1 through #3 of the ACHMM in the ascending order of the module index m in an array in the row direction (vertical direction), and supplies the 9 (3×3)-dimensional column vectors that are the connection result thereof to the normalizing unit 52.

The normalizing unit 52 (FIG. 25) obtains a 9-dimensional column vector that is the group of the initial probability π^{U}ᵢ of a combined HMM by normalizing the components of the 9-dimensional column vector that are the connection result from the connecting unit 51 so that the summation of the components thereof becomes 1.0.

Next, description will be made regarding how to obtain the state transition probability a^{U}ᵢⱼ of a combined HMM.

In the event that the number of HMM states N of the single module #m is 3, the total number of the states of the ACHMM made up of the three modules #1 through #3 is 9 (3×3), and accordingly, there are state transitions from 9 states to 9 states.

The frequency matrix generating unit 53 (FIG. 25) references the inter-module-state transition frequency table to generate a frequency matrix that is a matrix that takes the frequencies of state transitions as components wherein each of the 9 states is taken as a transition source state, and each of the 9 states from the transition source states thereof is taken as a transition destination state.

The frequency matrix is a 9-row 9-column matrix with the frequencies of state transitions from the i'th state to the j'th state of the 9 states as components in the i'th row and the j'th column.

Now, an N-row N-column matrix that takes the state transition probabilities a^{m}ᵢⱼ from the i'th state to the j'th state of the single module #m making up the ACHMM as the components in the i'th row and the j'th column will be referred to as a transition matrix.

In the event that the number of HMM states N of the single module #m is 3, the transition matrix of the module #m is a 3-row 3-column matrix.

Such as described in FIG. 26, if we say that the states of the three modules #1 through #3 are arrayed in the ascending order of the module index m, and the order of the 9 states of the ACHMM are counted, with a 9-row 9-column frequency matrix, the first row through the third row, and a 3-row 3-column matrix (hereafter, also referred to as “partial matrix”) that is a duplicated portion with the first column through the third column correspond to the transition matrix of the module #1.

Similarly, with a 9-row 9-column frequency matrix, the fourth row through the sixth row, and a 3-row 3-column partial matrix that is a duplicated portion with the fourth column through the sixth column correspond to the transition matrix of the module #2, and the seventh row through the ninth row, and a 3-row 3-column partial matrix that is a duplicated portion with the seventh column through the ninth column correspond to the transition matrix of the module #3.

With the frequency matrix, based on the 3-row 3-column partial matrix corresponding to the transition matrix of the module #1 (hereafter, also referred to as “corresponding partial matrix of module #1”), the frequency unit 54 converts the state transition probability a¹ᵢⱼ that are the components of the transition matrix of the module #1 into frequencies equivalent to frequencies that are the components of the corresponding partial matrix of the module #1, and generates a 3-row 3-column frequency transition matrix of the module #1 that takes the frequencies thereof as components.

That is to say, the frequency unit 54 obtains the summation of frequencies that are the components in the i'th row of the corresponding partial matrix of the module #1, and multiplies the state transition probabilities a¹ᵢⱼ that are the components in the i'th row of the transition matrix of the module #1 by the summation thereof, thereby converting the state transition probabilities a¹ᵢⱼ that are the components in the i'th row of the transition matrix of the module #1 into frequencies.

Therefore, for example, such as illustrated in FIG. 27, in the event that, of a duplicated portion between the first row through the third row, and the first column through the third column, of the frequency matrix, the frequencies that are the components in the first row of the corresponding partial matrix of the module #1 are 29, 8, and 5, and the state transition probabilities a¹ᵢⱼ that are the components in the first row of the transition matrix of the module #1 are 0.7, 0.2, and 0.1, the summation of the frequencies in the first row of the corresponding partial matrix of the module #1 is 42 (=29+8+5), and accordingly, 0.7, 0.2, and 0.1 that are the state transition probabilities a¹ᵢⱼ of the first row of the transition matrix of the module #1 are converted into frequencies 29.4 (=0.7×42), 8.4 (=0.2×42), and 4.2 (=0.1×42), respectively.

The frequency unit 54 also generates, in the same way as with the frequency transition matrix of the module #1, frequency transition matrices of the modules #2 and #3 that are the other modules making up the ACHMM.

Subsequently, the averaging unit 55 averages the 9-row 9-column frequency matrix generated at the frequency matrix generating unit 53, and the frequency transition matrices of the modules #1 through #3 generated at the frequency unit 54, thereby generating a 9-row 9-column averaged frequency matrix.

That is to say, with the 9-row 9-column frequency matrix, the averaging unit 55 updates (overwrites) each component of the corresponding partial matrix of the module #1 using an average value of the component thereof, the component of the frequency transition matrix of the module #1 corresponding to that component.

Similarly, with the 9-row 9-column frequency matrix, the averaging unit 55 updates each component of the corresponding partial matrix of the module #2 using an average value of the component thereof, the component of the frequency transition matrix of the module #2 corresponding to that component, and also updates each component of the corresponding partial matrix of the module #3 using an average value of the component thereof, the component of the frequency transition matrix of the module #3 corresponding to that component.

The normalizing unit 56 randomizes the frequencies that are the components of the 9-row 9-column averaged frequency matrix that is the frequency matrix updated with the average values at the averaging unit 55 such as described above to probabilities, thereby obtaining a 9-row 9-column matrix with the state transition probability a^{U}ᵢⱼ of a combined HMM as a component in the i'th row and the j'th column.

That is to say, the normalizing unit 56 normalizes the components of each row of the 9-row 9-column averaged frequency matrix so that the summation of the row thereof becomes 1.0, thereby obtaining a 9-row 9-column matrix with the state transition probability a^{U}ᵢⱼ of a combined HMM as a component in the i'th row and the j'th column (this matrix is also called a transition matrix).

Note that in FIGS. 26 and 27, the state transition probability a^{U}ᵢⱼ of a combined HMM has been obtained using the inter-module-state transition frequency table, and the state transition probability of the HMM of the module, but the state transition probability a^{U}ᵢⱼ of a combined HMM may be generated using only the inter-module-state transition frequency table.

That is to say, in FIGS. 26 and 27, the frequency matrix generated from the inter-module-state transition frequency table, and the frequency transition matrices generated from the transition matrices of the modules #1 through #3 have been averaged, and the averaged frequency matrix obtained as a result thereof has been randomized to probabilities, thereby obtaining the state transition probability a^{U}ᵢⱼ of a combined HMM, but the state transition probability a^{U}ᵢⱼ of a combined HMM may be obtained only by randomizing the frequency matrix itself generated from the inter-module-state transition frequency table to probabilities.

As described above, a combined HMM can be reconfigured from an ACHMM, and accordingly, a modeling object that is readily expressed only by a large-scale (high expression performance) HMM is first effectively learned by an ACHMM, and a combined HMM is reconfigured from this ACHMM, whereby a statistical (probability) state transition model of a modeling object can effectively be obtained in the form of an HMM having a suitable scale, and a suitable network configuration (state transition).

Note that, potentially, after a combined HMM is reconfigured, common HMM learning following the Baum-Welch reestimation method or the like is performed with (the HMM parameters of) the combined HMM thereof as initial values, whereby a higher-precision HMM for expressing a modeling object in a more suitable manner can be obtained.

Also, a combined HMM is a larger-scale HMM than a single-module HMM, and additional learning of a large-scale HMM is not effectively performed due to the large scale. Therefore, in the case that additional learning has to be performed, additional learning is performed with an ACHMM, and in the event that state series (maximum likelihood state series) have to be estimated with high precision while taking a state transition with all the states of the ACHMM as objects into consideration, such as later-described planning processing, estimation of such state series can be performed with a combined HMM to be reconfigured of the ACHMM (after the additional learning).

Here, in the above case, a combined HMM which connects all of the modules making up the ACHMM has been configured at the HMM configuration unit 17, but with the HMM configuration unit 17, a combined HMM which connects multiple modules that are a part of modules making up the ACHMM may be configured.

Configuration Example of an Agent to which the Learning Device has been Applied

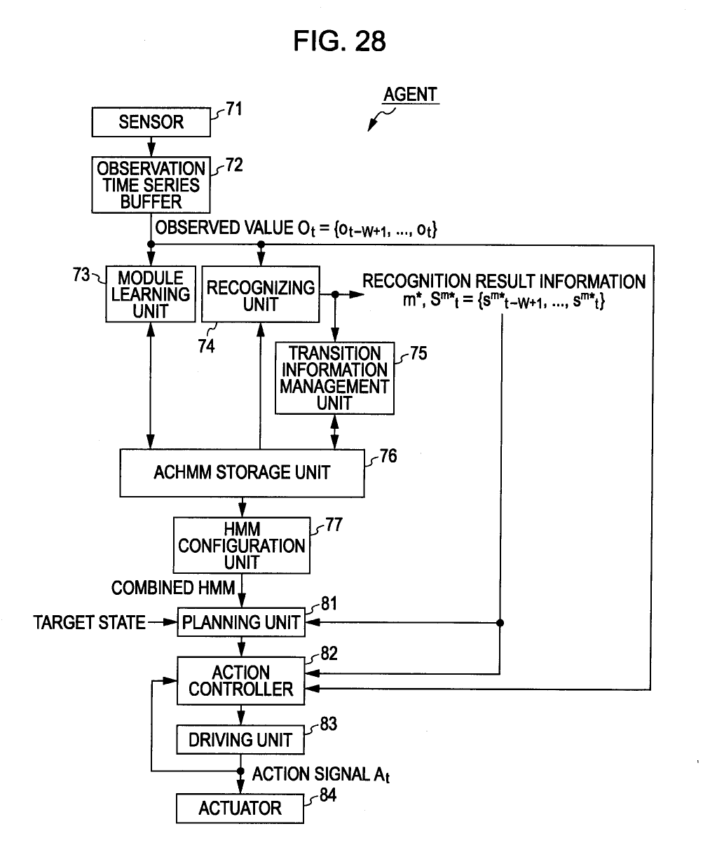

FIG. 28 is a block diagram illustrating a configuration example of an embodiment (first embodiment) of an agent to which the learning device in FIG. 1 has been applied.

The agent in FIG. 28 is an agent capable of actions in an autonomous manner, for example, such as a movable robot for sensing an observed value to be observed from a movable environment (motion environment) to perform actions such as movement based on the sensed observed value, a motion environment model is built based on the observed values observed from the motion movement, and an action signal to be given to an actuator such as a motor, which is used for the agent performing actions, and an action for realizing an arbitrary internal sense state is performed on the model thereof.

Subsequently, the agent in FIG. 28 uses an ACHMM to perform construction of a motion environment model.

In the event of performing construction of a motion environment model using an ACHMM, the agent does not have to obtain preliminary knowledge regarding the scale and configuration of a motion environment where the agent itself is disposed. The agent moves within a motion environment, performs ACHMM learning (module learning) as process for acquiring experience, and constructs the ACHMM serving as a state transition model of the motion environment, made up modules of which the number is a number suitable for the scale of the motion environment.

That is to say, the agent successively learns an observed value to be observed from the motion environment by the ACHMM while moving within the motion environment. Information used for determining a state (internal state) where the agent is located at the time of the time series of various observed values being observed is obtained as the HMM parameters of a module, and transition information, by ACHMM learning.

Also, simultaneously with ACHMM learning, regarding each state transition (or each state), the agent learns relationship between an observed value observed at the time of a state transition thereof occurring, and the action signal of a performed action (a signal to be given to the actuator for performing a certain action).

Subsequently, upon one state of the ACHMM states being given as a target state serving as a target, the agent uses a combined HMM to be reconfigured from the ACHMM to perform planning for obtaining certain state series from a state corresponding to the current location of the agent within the motion environment (the current state) to a target state as a plan to get the target state from the current state.

Further, the agent moves to the position within the motion environment corresponding to the target state from the current location by performing an action causing the state transition of state series serving as a plan based on relationship between an observed value and an action signal regarding each state transition, obtained by learning.

In order to perform learning of such a motion environment by an ACHMM, learning of relationship between an observed value and an action signal regarding each state transition, planning, and actions following a plan, the agent in FIG. 28 includes a sensor 71, an observation time series buffer 72, a module learning unit 73, a recognizing unit 74, a transition information management unit 75, an ACHMM storage unit 76, an HMM configuration unit 77, a planning unit 81, an action controller 82, a driving unit 83, and an actuator 84.

The sensor 71 through the HMM configuration unit 77 are configured in the same way as with the sensor 11 through the HMM configuration unit 17 of the learning device in FIG. 1, respectively.

Note that as for the sensor 71, a distance sensor may be employed, which measures distance from the agent to an imminent wall within the motion environment in multiple directions including four directions of front, rear, left, and right. In this case, the sensor 71 outputs a vector with distances in the multiple directions as components as an observed value.

(The index representing) the target state is supplied from a block not illustrated to the planning unit 81, and also the recognition result information [m*, s^{m}*ₜ] of an observed value oₜ at the current point-in-time t to be output from the recognizing unit 74 is supplied to the planning unit 81.

Further, a combined HMM is supplied from the HMM configuration unit 77 to the planning unit 81.

Here, the target state is supplied to the planning unit 81, for example, according to a user's operation or the like, by being externally specified, or by housing in the agent a motivation system for setting a target state in accordance with a motivation or the like with a state where the observation probabilities of multiple observed values are high of ACHMM states, or the like as a target state, and setting a target state by the motivation system thereof, or the like.

Also, with recognition (state recognition) using an ACHMM, of ACHMM states, a state serving as the current state is determined by the module index of the maximum likelihood module #m* making up the recognition result information [m*, s^{m}*ₜ], and the index of the state s^{m}*ₜ of one of the HMM states that are the maximum likelihood module #m* thereof, but hereafter, (a state serving as) the current state of all the ACHMM states will also be represented with “state s^{m}*ₜ” using only s^{m}*ₜ of the recognition result information [m*, s^{m}*ₜ]

The planning unit 81 performs planning in a combined HMM for obtaining maximum likelihood state series that are state series where the likelihood of a state transition from the current state s^{m}*ₜ output from the recognizing unit 74 to the target state is the maximum as a plan to get to the target state from the current state s^{m}*ₜ.

The planning unit 81 supplies a plan obtained by the planning to the action controller 82.

Note here that the state s^{m}*ₜ of which the state probability is the maximum of the maximum likelihood module #m*, obtained as a result of recognition of the observed value oₜ at the current point-in-time t employing the ACHMM, is employed as the current state to be used for the planning, but a state of which the state probability is the maximum of a combined HMM, obtained as a result of recognition of the observed value oₜ at the current point-in-time t employing the combined HMM, may be employed as the current state to be used for the planning.

With the combined HMM, a state of which the state probability is the maximum becomes the final state of the maximum likelihood state series in the event that state series (maximum likelihood state series) where a state transition of which the likelihood that the time series data Oₜ at the current point-in-time t may be observed is the maximum occurs have been obtained following the Viterbi method.

In addition to the plan being supplied from the planning unit 81 to the action controller 82, the observed value oₜ at the current point-in-time t from the observation time series buffer 72, the recognition result information [m*, s^{m}*ₜ] of the observed value oₜ at the current point-in-time t from the recognizing unit 74, and an action signal Aₜ provided to the actuator 84 immediately after the observed value oₜ at the current point-in-time t is observed, from the driving unit 83 are each supplied to the action controller 82.

For example, at the time of ACHMM learning or the like, regarding each state transition, the action controller 82 learns relationship between an observed value observed at the time of the state transition occurring, and an action signal of a performed action.

Specifically, the action controller 82 uses the recognition result information [m*, s^{m}*ₜ] from the recognizing unit 74 to recognize a state transition occurred from point-in-time t−1 that is one point-in-time ago to the current point-in-time t (state transition from the current state s^{m}*ₜ₋₁ at the point-in-time t−1 that is one point-in-time ago to the current state s^{m}*ₜ at the current point-in-time t) (hereafter, also referred to as “state transition at the point-in-time t−1”).

Further, the action controller 82 stores a set of an observed value oₜ₋₁ at the point-in-time t−1 from the observation time series buffer 72, and an action signal Aₜ₋₁ at the point-in-time t−1 from the driving unit 83, i.e., a set of the observed value oₜ₋₁ observed at the time of the state transition of the point-in-time t−1 occurring, and the action signal Aₜ₋₁ of the performed action in a manner correlated with the state transition at the point-in-time t−1.

Subsequently, while advancing ACHMM learning, regarding each state transition, after collecting a great number of sets between an observed value observed at the time of the state transition thereof occurring, and an action signal of a performed action has been performed, the action controller 82 uses, regarding each state transition, the set of the observed value and the action signal correlated with the state transition thereof to obtain an action function that is a function for inputting an observed value to output an action signal.

That is to say, for example, in the event that a certain observed value o makes up a set only with one action signal A, the action controller 82 obtains an action function for outputting the action signal A as to the observed value o.

Also, for example, in the event that a certain observed value o makes up a set with a certain action signal A, and makes up a set with another action signal A′, the action controller 82 counts the number of sets c between the observed value o and the action signal A, counts the number of sets c′ between the observed value o and the other action signal A′, and also obtains an action function for outputting the action signal A with the percentage of c/(c+c′) as to the observed value o, and outputting the other action signal A′ with the percentage of c′/(c+c′).

After obtaining the action function regarding each state transition, in order to cause a state transition of the maximum likelihood state series serving as the plan to be supplied from the planning unit 81, the action controller 82 provides as input the observed value oₜ from the observation time series buffer 72 to the action function regarding the state transition thereof, thereby obtaining the action signal to be output from the action function as the action signal of an action to be performed next by the agent.

Subsequently, the action controller 82 supplies the action signal thereof to the driving unit 83.

In the event that no action signal has been supplied from the action controller 82, i.e., in the event that no action function has been obtained at the action controller 82, for example, the driving unit 83 supplies an action signal following a predetermined rule to the actuator 84, thereby driving the actuator 84.

That is to say, with a predetermined rule, for example, a direction where the agent is moved is stipulated at the time of each observed value being observed, and accordingly, the driving unit 83 supplies an action signal for performing an action for moving in the direction stipulated by the rule to the actuator 84.

Note that the driving unit 83 also supplies an action signal following a predetermined rule to the action controller 82 in addition to the actuator 84.

Also, in the event that an action signal is supplied from the action controller 82, the driving unit 83 supplies the action signal thereof to the actuator 84, thereby driving the actuator 84.

The actuator 84 is, for example, a motor for driving wheels and legs for moving the agent, and drives these in accordance with the action signal from the driving unit 83. Processing of learning for obtaining an action function

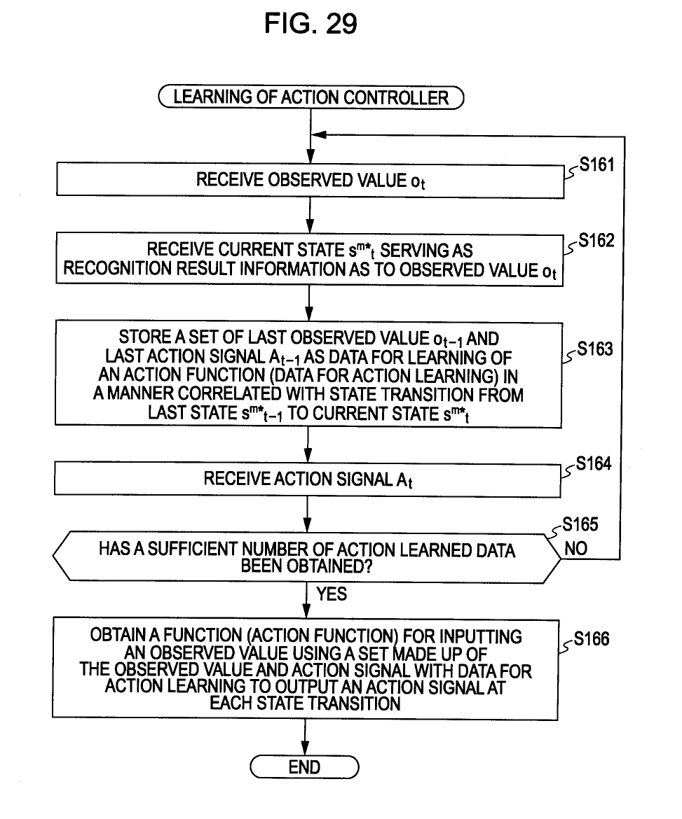

FIG. 29 is a flowchart for describing learning processing for the action controller 82 in FIG. 28 obtaining an action function.

In step S161, after awaiting that the (latest) observed value oₜ at the current point-in-time t is supplied from the observation time series buffer 72, the action controller 82 receives the observed value oₜ thereof, and the processing proceeds to step S162.

In step S162, after awaiting that the recognizing unit 74 outputs, as to the observed value oₜ, the recognition result information [m*, s^{m}*ₜ] of the observed value oₜ thereof, the action controller 82 receives the recognition result information [m*, s^{m}*ₜ] thereof, and the processing proceeds to step S163.

In step S163, the action controller 82 correlates a set of the observed value (hereafter, also referred to as “last observed value”) oₜ₋₁ received from the observation time series buffer 72 in step S161 of one point-in-time ago, and the action signal (hereafter, also referred to as “last action signal”) Aₜ₋₁ received from the driving unit 83 in step S164 (to be described later) of one point-in-time ago, with a state transition (state transition at the point-in-time t−1) from the current state (hereafter, also referred to as “last state”) s^{m}*ₜ₋₁ of one point-in-time ago determined from the recognition result information [m*, s^{m}*ₜ₋₁] received from the recognizing unit 74 in step S162 of one point-in-time ago, to the current state s^{m}*ₜ determined from the recognition result information [m*, s^{m}*ₜ] received from the recognizing unit 74 in immediately previous step S162, and temporarily stores this as data for learning of an action function (hereafter, also referred to as “action learned data”).

Subsequently, after awaiting that the action signal Aₜ at the current point-in-time t is supplied from the driving unit 83 to the action controller 82, the processing proceeds from step S163 to step S164, where the action controller 82 receives the action signal Aₜ at the current point-in-time t that the driving unit 83 outputs in accordance with a predetermined rule, and the processing proceeds to step S165.

In step S165, the action controller 82 determines whether or not a sufficient number (e.g., a predetermined number) of action learned data has been obtained for obtaining an action function.

In the event that determination is made in step S165 that a sufficient number of action learned data has not been obtained, the processing returns to step S161, and hereafter the same processing is repeated.

Also, in the event that determination is made in step S165 that a sufficient number of action learned data has been obtained, the processing proceeds to step S166, where the action controller 82 uses, regarding each state transition, an observed value and an action signal making up a set in the action learned data, correlated with the state transition thereof, to obtain an action function for inputting the observed value to output the action signal, and the processing ends.

### Action Control Processing

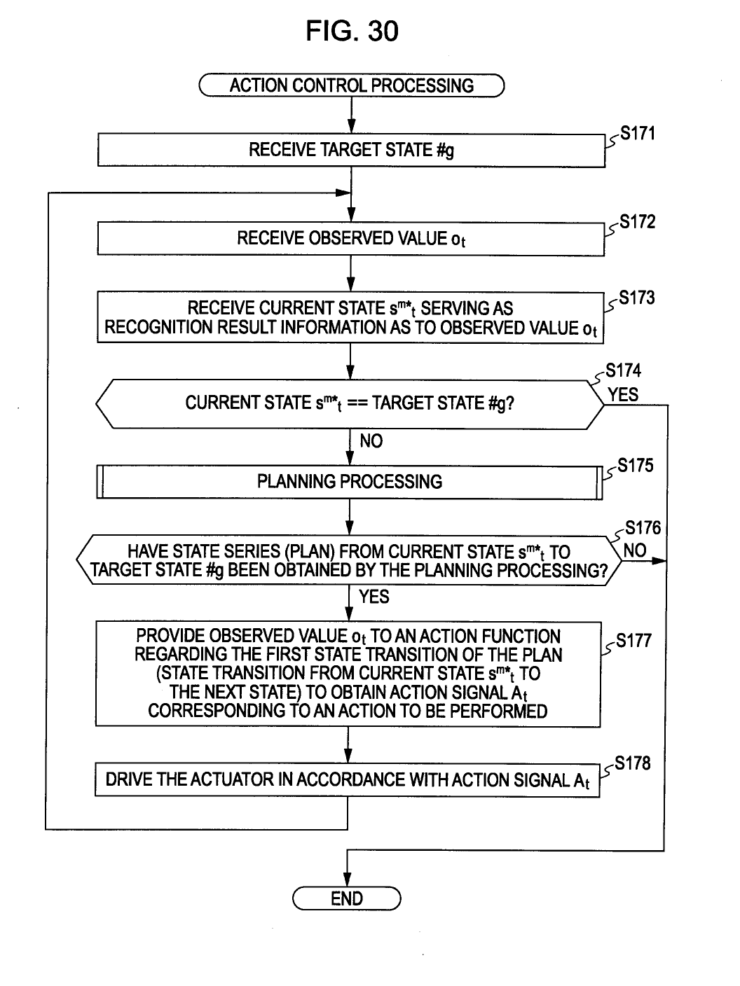

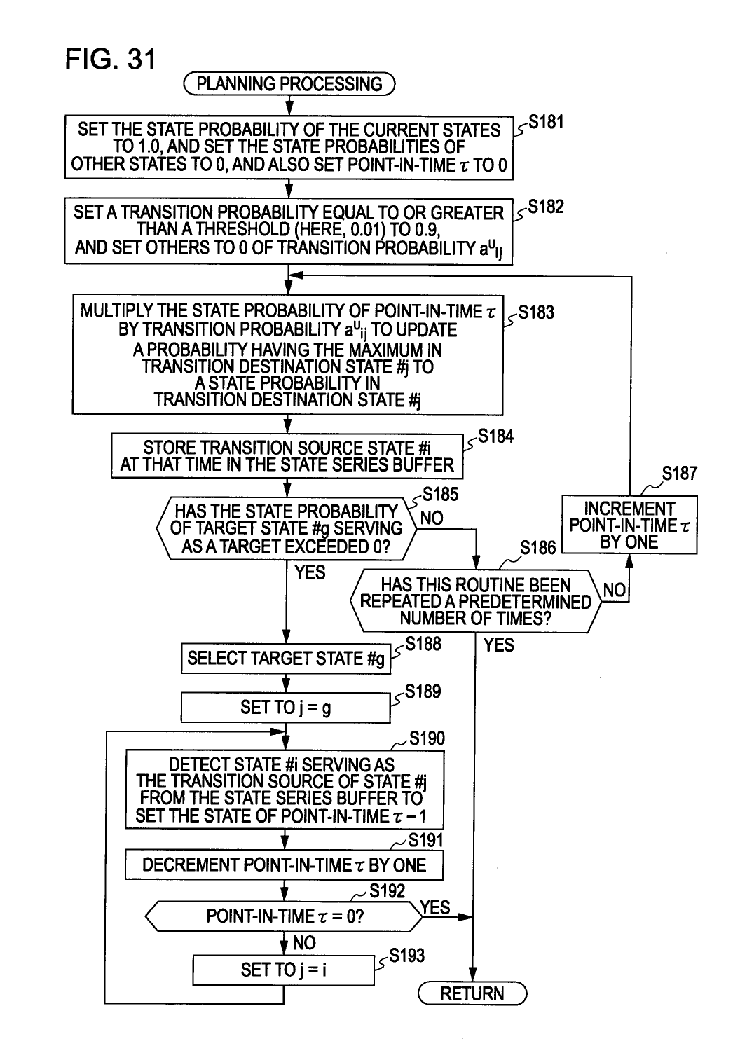

FIG. 30 is a flowchart for describing action control processing for controlling the agent's action that the planning unit 81, action controller 82, driving unit 83, and actuator 84 perform in FIG. 28.

In step S171, after awaiting that one state of the states of a combined HMM to be supplied from the HMM configuration unit 77 is provided as a target state #g (state of which the index is g), the planning unit 81 receives the target state #g, and the processing proceeds to step S172.

In step S172, after awaiting that the observed value oₜ at the current point-in-time t is supplied from the observation time series buffer 72, the planning unit 81 receives the observed value oₜ thereof, and the processing proceeds to step S173.

In step S173, after awaiting that the recognizing unit 74 outputs the recognition result information [m*, s^{m}*ₜ] as to the observed value oₜ, the planning unit 81 and the action controller 82 receive the recognition result information [m*, s^{m}*ₜ] thereof to determine the current state s^{m}*ₜ.

Subsequently, the processing proceeds from step S173 to step S174, where the planning unit 81 determines whether or not the current state s^{m}*ₜ matches the target state #g.

In the event that determination is made in step S174 that the current state s^{m}*ₜ does not match the target state #g, the processing proceeds to step S175, where the planning unit 81 performs processing of planning (planning processing) for obtaining state series (maximum likelihood state series) where the likelihood of a state transition from the current state s^{m}*ₜ to the target state #g is the maximum in the combined HMM supplied from the HMM configuration unit 77 as a plan to get to the target state #g from the current state s^{m}*ₜ, for example, in accordance with the Viterbi method.

The planning unit 81 supplies the plan obtained by the planning processing to the action controller 82, and the processing proceeds from step S175 to step S176.

Note that, with the planning processing, no plan may be obtained. In the event that no plan has not been obtained, the planning unit 81 supplies a message to the effect that to the action controller 82.

In step S176, the action controller 82 determines whether or not a plan has been obtained in the planning processing.

In the event that determination is made in step S176 that no plan has been obtained, i.e., in the event that no plan has been supplied from the planning unit 81 to the action controller 82, the processing ends.

Also, in the event that determination is made in step S176 that a plan has been obtained, i.e., in the event that a plan has been supplied from the planning unit 81 to the action controller 82, the processing proceeds to step S177, where the action controller 82 provides as input the observed value oₜ from the observation time series buffer 72 is given to an action function regarding the initial state transition of the plan, i.e., a state transition from the current state s^{m}*ₜ to the next state, thereby obtaining the action signal output from the action function as the action signal of an action to be performed by the agent.

Subsequently, the action controller 82 supplies the action signal thereof to the driving unit 83, and the processing proceeds from step S177 to step S178.

In step S178, the driving unit 83 supplies the action signal from the action controller 82 to the actuator 84, thereby driving the actuator 84, and the processing returns to step S172.

As described above, the agent performs an action for moving to the position corresponding to the target state #g within the motion environment by the actuator 84 being driven.

On the other hand, in the event that determination is made in step S174 that the current state s^{m}*ₜ matches the target state #g, i.e., for example, in the event that the agent has moved within the motion environment, and has got to the position corresponding to the target state #g, the processing ends.

Note that, with the action control processing in FIG. 30, each time the latest observed value oₜ is obtained (step S172), i.e., at every point-in-time t, determination is made whether or not the current state s^{m}*ₜ matches the target state #g (step S174), and in the event that the current state s^{m}*ₜ, does not match the target state #g, the planning processing is performed so as to obtain a plan (step S175), but an arrangement may be made wherein the planning processing is performed not at every point-in-time t but only once at the time of the target state #g being provided, and thereafter, an action signal causing a state transition from the first state to the last state of the plan to be obtained in the one-time planning processing is output at the action controller 82.

FIG. 31 is a flowchart for describing the planning processing in step S175 in FIG. 30.

Note that, with the planning processing in FIG. 31, the maximum likelihood state series from the current state s^{m}*ₜ to the target state #g are obtained in accordance with (an algorithm for applying) the Viterbi method, but the method for obtaining the maximum likelihood state series is not restricted to the Viterbi method.

In step S181, the planning unit 81 (FIG. 28) sets, of the sates of the combined HMM from the HMM configuration unit 77, the state probability of the current state s^{m}*ₜ determined from the recognition result information [m*, s^{m}*ₜ] from the recognizing unit 74 to 1.0 serving as an initial value.

Further, the planning unit 81 sets, of the states of the combined HMM, the state probabilities of states other than the current state s^{m}*ₜ to 0.0 serving as an initial value, sets the variable τ representing the point-in-time of the maximum likelihood state series to 0 serving as an initial value, and the processing proceeds from step S181 to step S182.

In step S182, the planning unit 81 sets, of the state transition probability a^{U}ᵢⱼ of the combined HMM, the state transition probability a^{U}ᵢⱼ equal to or greater than a predetermined threshold (e.g., 0.01) to 0.9 serving as a high probability for example, and also sets the other state transition probability a^{U}ᵢⱼ to 0.0 serving as a low probability for example.

After step S182, the processing proceeds to step S183, where the planning unit 81 multiplies the state probability of each state #i at the point-in-time τ, and the state transition probability a^{U}ᵢⱼ regarding each state #j (state of which the index is j) of the combined HMM, and sets the state probability of the state #j at the point-in-time τ+1 to the maximum value of the multiplication values obtained as results thereof.

That is to say, the planning unit 81 takes, regarding the state #j, each state #i at the point-in-time τ as a transition source state, and at the time of a state transition to the state #j, detects a state transition that maximizes the state probability of the state #1, and takes a multiplication value between the state probability of the transition source state #i of the state transition thereof, and the state transition probability a^{U}ᵢⱼ of the state transition thereof as the state probability of the state #j at the point-in-time τ+1.

Subsequently, the processing proceeds from step S183 to step S184, where the planning unit 81 stores, regarding each state #j at the point-in-time τ+1, the transition source state #i in a state series buffer (not illustrated) which is built-in memory, and the processing proceeds to step S185.

In step S185, the planning unit 81 determines whether or not the value of the state probability of the target state #g (at the point-in-time τ+1) has exceeded 0.0.

In the event that determination is made in step S185 that the value of the state probability of the target state #g has not exceeded 0.0, the processing proceeds to step S186, where the planning unit 81 determines whether or not the transition source state #i has been stored in the state series buffer a predetermined number of times equivalent to a value set beforehand as a length threshold of the maximum likelihood state series to be obtained as a plan.

In the event that determination is made in step S186 that the transition source state #i has not been stored in the state series buffer a predetermined number of times, the processing proceeds to step S187, where the planning unit 81 increments the point-in-time τ by one. Subsequently, the processing returns from step S187 to step S183, and hereafter, the same processing is repeated.

Also, in the event that determination is made in step S186 that the transition source state #i has been stored in the state series buffer a predetermined number of times, i.e., in the event that the length of the maximum likelihood state series from the current state s^{m}*ₜ to the target state #g is equal to or greater than a threshold, the processing returns.

Note that in this case, the planning unit 81 supplies a message to the effect that no plan has been obtained to the action controller 82.

On the other hand, in the event that determination is made in step S185 that the value of the state probability of the target state #g has exceeded 0.0, the processing proceeds to step S188, where the planning unit 81 selects the target state #g as the state at the point-in-time τ of the maximum likelihood state series from the current state s^{m}*ₜ to the target state #g, and the processing proceeds to step S189.

In step S189, the planning unit 81 sets the transition destination state #j (the state #j at the point-in-time τ) of the state transition of the maximum likelihood state series to the target state #g, and the processing proceeds to step S190.

In step S190, the planning unit 81 detects the transition source state #i of the state transition to the state #j at the point-in-time τ from the state series buffer, and selects this as the state at the point-in-time τ−1 of the maximum likelihood state series, and the processing proceeds to step S191.

In step S191, the planning unit 81 decrements the point-in-time τ by one, and the processing proceeds to step S192.

In step S192, the planning unit 81 determines whether or not the point-in-time τ is 0.

In the event that determination is made in step S192 that the point-in-time τ is not 0, the processing proceeds to step S193, where the planning unit 81 sets the state #i selected as the state of the maximum likelihood state series in the immediately-preceding step S190 as the transition destination state #j (the state #j at the point-in-time τ) of the transition state of the maximum likelihood state series, and the processing returns to step S190.

Also, in the event that determination is made in step S192 that the point-in-time τ is 0, i.e., in the event that the maximum likelihood state series from the current state s^{m}*ₜ to the target state #g have been obtained, the planning unit 81 supplies the maximum likelihood state series thereof to the action controller 82 (FIG. 28) as a plan, and the processing returns.

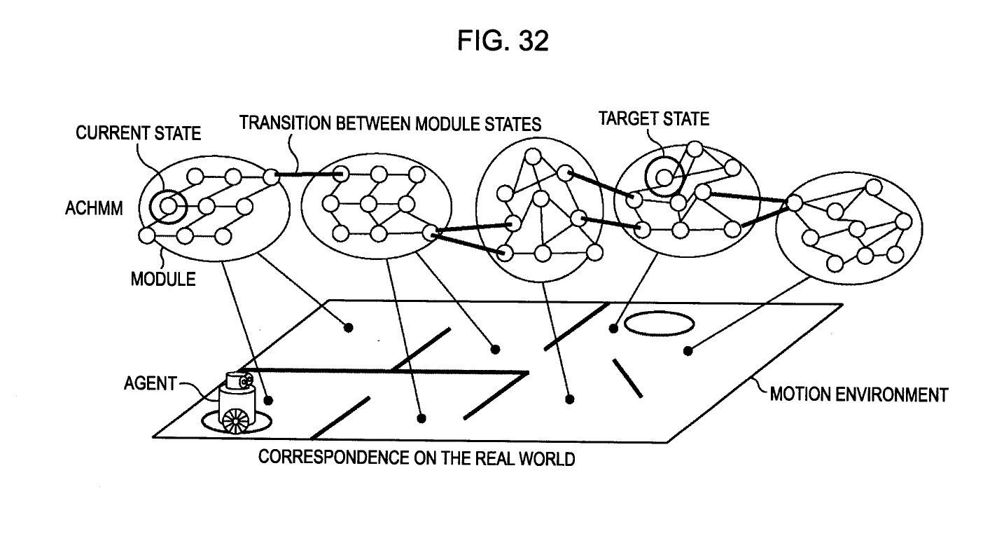

FIG. 32 is a diagram for describing the outline of ACHMM learning by the agent in FIG. 28.

The agent moves within the motion environment as appropriate, and at this time, uses an observed value to be observed from the motion environment, which is obtained through the sensor 71, to perform learning of an ACHMM, thereby obtaining the map of the motion environment by the ACHMM.

Here, the current state s^{m}*ₜ obtained by recognition (state recognition) using ACHMM employing the map of the motion environment corresponds to the current location of the agent within the motion environment.

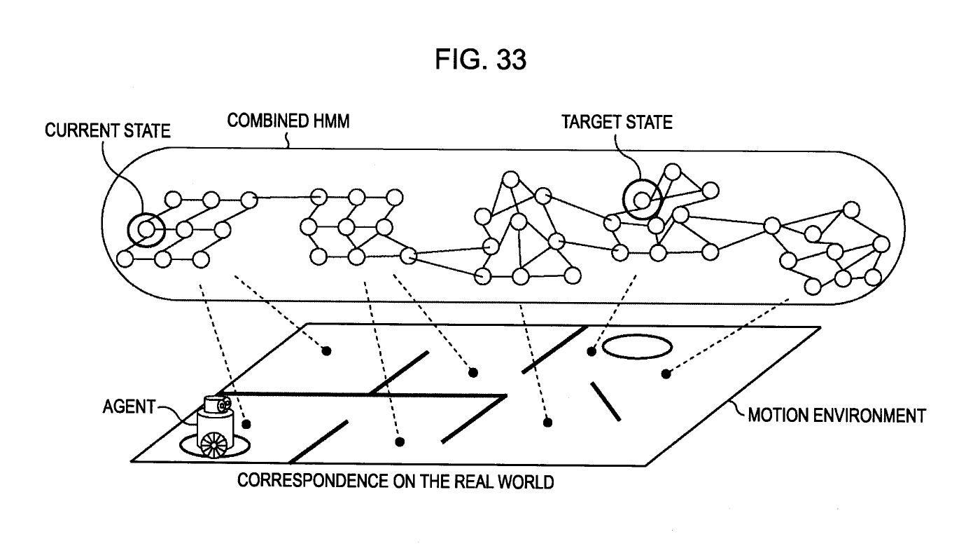

FIG. 33 is a diagram for describing the outline of reconfiguration of a combined HMM by the agent in FIG. 28.

For example, after the ACHMM learning advances to some extent, upon the target state being obtained, the agent reconfigures the combined HMM from the ACHMM. Subsequently, the agent uses the combined HMM to obtain a plan that is the maximum likelihood state series from the current state s^{m}*ₜ to the target state #g.

Note that reconfiguration of the combined HMM from the ACHMM may be performed, in addition to the case of the target state being provided, for example, at arbitrary timing such as periodical timing, timing when an event occurs such that the model parameters of the ACHMM are updated.

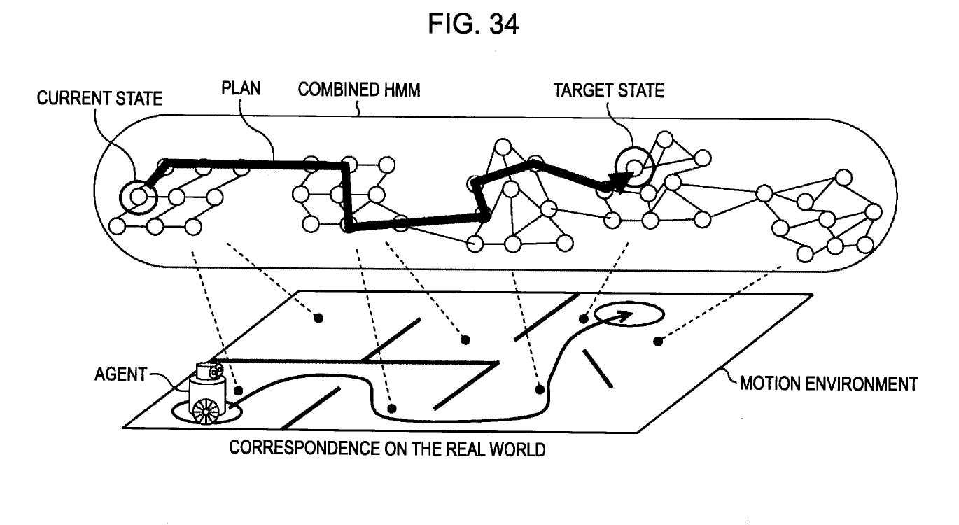

FIG. 34 is a diagram for describing the outline of planning by the agent in FIG. 28.

The agent obtains, such as described above, a plan that is the maximum likelihood state series from the current state s^{m}*ₜ to the target state #g employing the combined HMM.

The agent follows the plan to output an action signal causing the state transition of the plan thereof in accordance with the action function obtained beforehand regarding each state transition.

Thus, with the combined HMM, a state transition occurs whereby the maximum likelihood state series are obtained as a plan, and the agent moves from the current location corresponding to the current state s^{m}*ₜ to the position corresponding to the target state #g within the motion environment.

According to such an ACHMM, an HMM may be employed as to a configuration learning problem of an unknown modeling object wherein the configuration and initial value of the HMM are not determined beforehand. In particular, the configuration of a large-scale HMM may suitably be determined, and also the HMM parameters may be estimated. Further, calculation of reestimation of the HMM parameters, and calculation of state recognition may effectively be performed.

Also, according to the ACHMM being mounted on the agent which autonomously develops, the agent moves within the motion environment where the agent is located, and at process wherein the agent builds up its experience, repeats learning of an existing module already included in the ACHMM, or addition of a new module to be used, and as a result thereof, the ACHMM serving as a state transition model of the motion environment, which is configured of the number of modules adapted to the scale of the motion environment, is configured without preliminary knowledge regarding the scale and configuration of the motion environment.

Note that the ACHMM may widely be applied to model learning in identification of a system, control, artificial intelligence, and so forth, in addition to an agent capable of autonomously performing actions such as a mobile robot.

### Second Embodiment

As described above, the ACHMM is applied to the agent for autonomously performing actions, and ACHMM learning is performed at the agent using the time series of an observed value to be observed from the motion environment, whereby the map of the motion environment can be obtained by the ACHMM.

Further, with the agent, the combined HMM is reconfigured from the ACHMM, a plan that is the maximum likelihood state series from the current state s^{m}*ₜ to the target state #g is obtained using the combined HMM, an action is performed in accordance with the plan thereof, whereby the agent can move from the position corresponding to the current state s^{m}*ₜ to the position corresponding to the target state #g within the motion environment.

Incidentally, with the combined HMM reconfigured from the ACHMM, a state transition that is not really realized may be expressed as if it were realized in a probability manner.

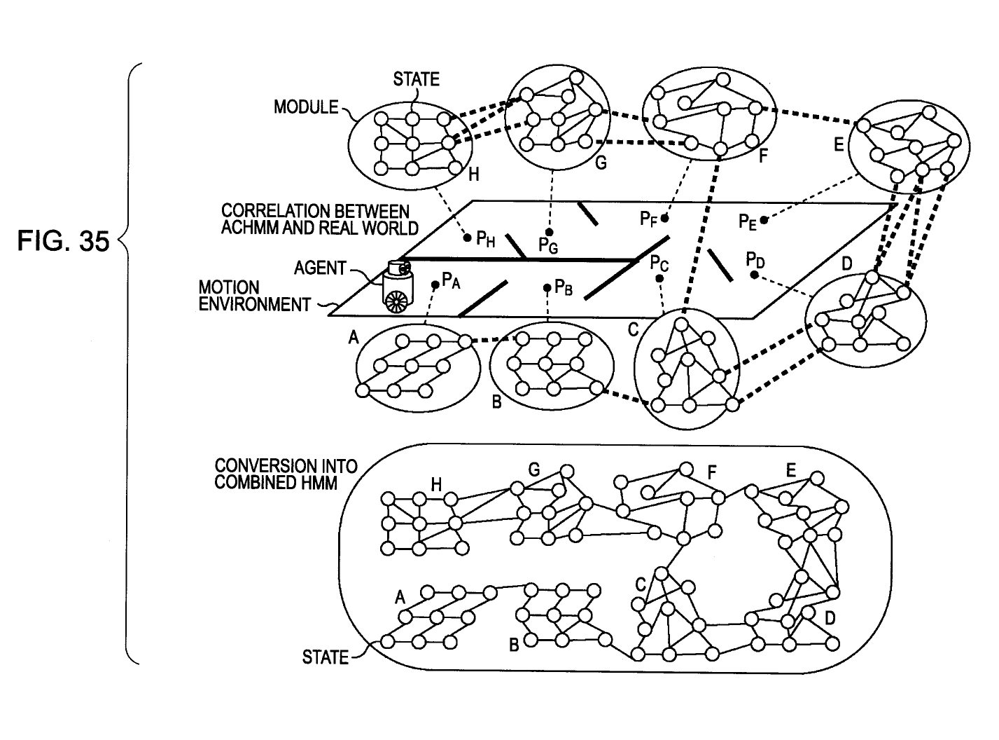

Specifically, FIG. 35 is a diagram illustrating an example of ACHMM learning by the agent which moves within a motion environment, and reconfiguration of a combined HMM.

The agent used the time series of an observed value to be observed from the motion environment performs ACHMM learning, whereby the configuration (map) of the motion environment can be obtained as transition information representing a state transition between a state network (HMM serving as a module) and (the state of) a module.

In FIG. 35, the ACHMM is configured of 8 modules A, B, C, D, E, F, G, and H. Further, the module A has obtained the configuration of a local region with a position P_{A} of the motion environment as the center, and the module B has obtained the configuration of a local region with a position P_{B} of the motion environment as the center.

Similarly, the modules C, D, E, F, G, and H have obtained the configuration of a local region with the positions P_{C}, P_{D}, P_{E}, P_{F}, P_{G}, and P_{H} of the motion environment as the center, respectively.

The agent may reconfigure the combined HMM from such an ACHMM to obtain a plan using the combined HMM thereof.

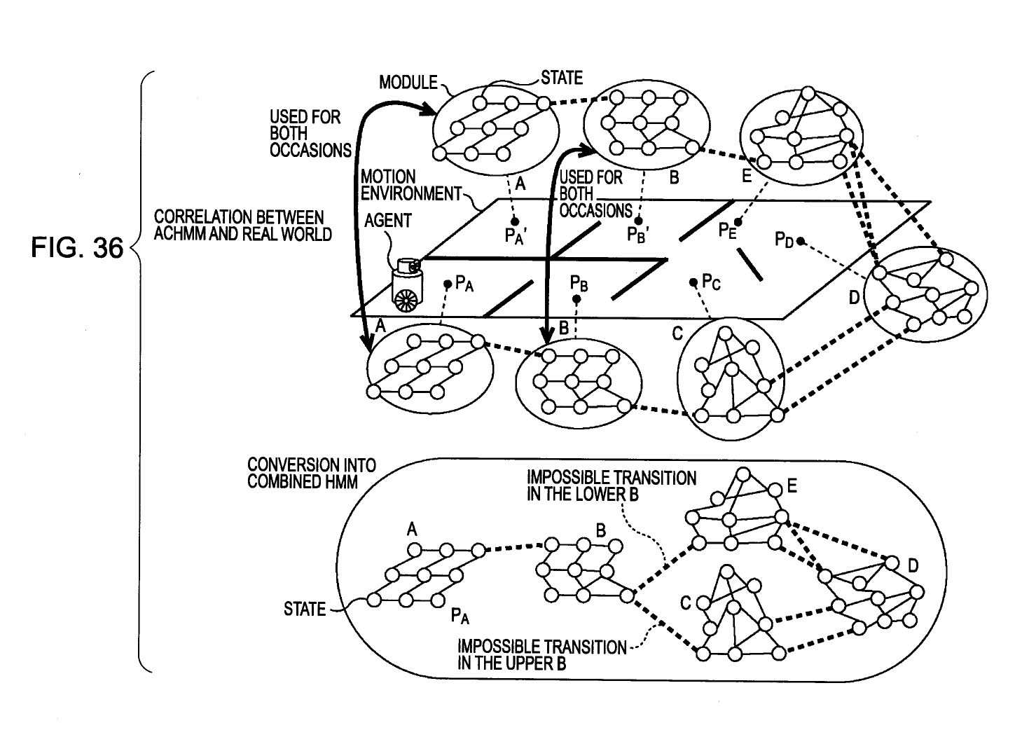

FIG. 36 is a diagram illustrating another example of ACHMM learning by the agent which moves within a motion environment, and reconfiguration of a combined HMM.

In FIG. 36, the ACHMM is configured of 5 modules A through E.

Further, in FIG. 36, the module A has obtained the configuration of a local region with a position P_{A} of the motion environment as the center, and the configuration of a local region with a position P_{A}′ of the motion environment as the center.

Also, the module B has obtained the configuration of a local region with a position P_{B} of the motion environment as the center, and the configuration of a local region with a position P_{B}′ of the motion environment as the center.

Further, the modules C, D, and E have obtained the configuration of a local region with the positions P_{C}, P_{D}, and P_{E} of the motion environment as the center, respectively.

Specifically, when the motion environment FIG. 36 is viewed with a certain particle size in a macroscopic manner, the local region (room) with the position P_{A} as the center, and the local region with the position P_{A}′ as the center match (are similar) in configuration.

Further, the local region with the position P_{B} as the center, and the local region with the position P_{B}′ as the center of the action environment match in configuration.

With ACHMM learning with the motion environment in FIG. 36 as an object, and with regard to the local region with the position P_{A} as the center, and the local region with the position P_{A}′ as the center wherein a merit of the ACHMM is taken advantage of, and the configurations match, the configurations have been obtained by the single module A.

Further, with regard to the local region with the position P_{B} as the center, and the local region with the position P_{B}′ as the center wherein the configurations match, the configurations have been obtained by the single module B.

As described above, with the ACHMM, with regard to multiple local regions wherein the positions differ, but the configurations match, the configurations (local configurations) are obtained by a single module.

That is to say, with ACHMM learning, in the event that the same local configuration as the configuration already obtained by a certain module of the ACHMM will be observed in the future (subsequently), the local configuration thereof is not learned (obtained) by a new module, and the module which has obtained the same configuration as the local configuration thereof is shared, and learning is incrementally performed.

As described above, with ACHMM learning, sharing of a module is performed, and accordingly, with a combined HMM reconfigured from the ACHMM, a state transition that is not really realized may be expressed as if it were realized in a probability manner.

Specifically, in FIG. 36, with the combined HMM reconfigured of the ACHMM, with regard to the state of the module B (which was the state thereof), both of a state transition as to the state of the module C (state transition of which the state transition probability is not 0.0 (including a value closely approximated to 0.0 that can be regarded as 0.0), and a state transition as to the state of the module E may occur.

However, in FIG. 36, the agent may directly move from the local region with the position P_{B} as the center (hereafter, also referred to as the local region of the position P_{B}) to the local region (room) of the position P_{C}, but may not directly move to the local region of the position P_{E}, and may not move thereto without passing through the local region of the position P_{C}.

Also, the agent may directly move from the local region of the position P_{B}′ to the local region of the position P_{E}, but may not directly move to the local region of the position P_{C}, and may not move thereto without passing through the local region of the position P_{E}.

On the other hand, in FIG. 36, even when the agent is located in either the local region of the position P_{B} or the local region of the position P_{B}′, the current state is the state of the module B.

Subsequently, in the event that the agent is located in the local region of the position P_{B}, the agent may directly move to the local region of the position P_{C}, and accordingly, a state transition occurs from the state of the module B which has obtained the configuration of the local region of the position P_{B} to the state of the module C which has obtained the configuration of the local region of the position P_{C}.

However, in the event that the agent is located in the local region of the position P_{B}, the agent may not directly move to the local region of the P_{E}, and accordingly, a state transition does not occur (should not occur) from the state of the module B which has obtained the configuration of the local region of the position P_{B} to the state of the module E which has obtained the configuration of the local region of the position P_{E}.

On the other hand, in the event that the agent is located in the local region of the position P_{B}′, the agent may directly move to the local region of the P_{E}, and accordingly, a state transition occurs from the state of the module B which has obtained the configuration of the local region of the position P_{B}′ to the state of the module E which has obtained the configuration of the local region of the position P_{E}.

However, in the event that the agent is located in the local region of the position P_{B}′, the agent may not directly move to the local region of the P_{C}, and accordingly, a state transition does not occur from the state of the module B which has obtained the configuration of the local region of the position P_{B}′ to the state of the module C which has obtained the configuration of the local region of the position P_{C}.

Also, as described above, with the configurations of multiple local regions of which the positions differ but the configurations are the same, in the event that a state (current state) to be obtained as a result of (state) recognition employing an ACHMM to be obtained by a single module, or the index of a module (maximum likelihood module) having the state thereof is output as an observed value (that can externally be observed), the same observed value is output to the multiple different local regions, and accordingly, a perceptual aliasing problem occurs.

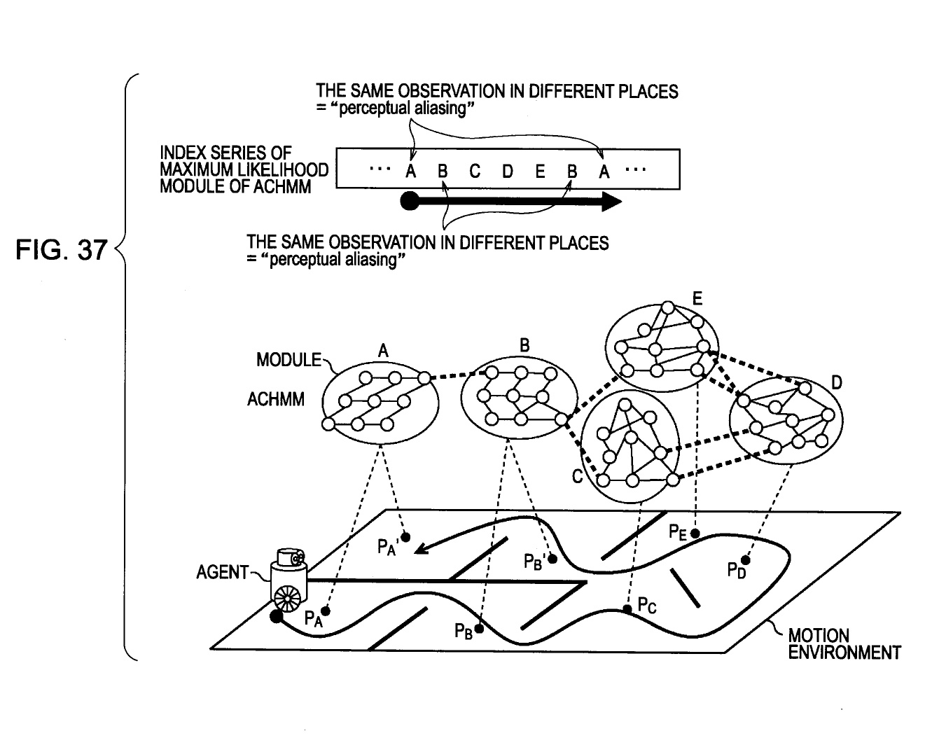

FIG. 37 is a diagram illustrating the time series of the index of the maximum likelihood module that is obtained by recognition employing an ACHMM in the event that the agent moves to the local region of the position P_{A}′ through the local regions of the positions P_{B}, P_{C}, P_{D}, P_{E}, and P_{B}′ from the local region of the position P_{A} within the same motion environment as with FIG. 36.

In the event that the agent is located in the local region of the position P_{A}, and in the event that the agent is located in the local region of the position P_{A}′, in either case, the module A is the maximum likelihood module, and accordingly, it is not determined whether the agent is located in the local region of the position P_{A} or the local region of the position P_{A}′.

Similarly, in the event that the agent is located in the local region of the position P_{B}, and in the event that the agent is located in the local region of the position P_{B}′, in either case, the module B is the maximum likelihood module, and accordingly, it is not determined whether the agent is located in the local region of the position P_{B} or the local region of the position P_{B}′.

Such as described above, as for a method for preventing an unlikelihood state transition from occurring, and also for eliminating a perceptual aliasing problem, there is a method wherein in addition to an ACHMM for learning an observed value to be observed from the motion environment, another ACHMM is prepared, the ACHMM for learning an observed value to be observed from the motion environment is taken as the ACHMM of a lower level (hereafter, also referred to as “lower ACHMM”), and the other ACHMM is taken as the ACHMM of an upper level (hereafter, also referred to as “upper ACHMM”), and the lower ACHMM and the upper ACHMM are connected in a hierarchical structure.

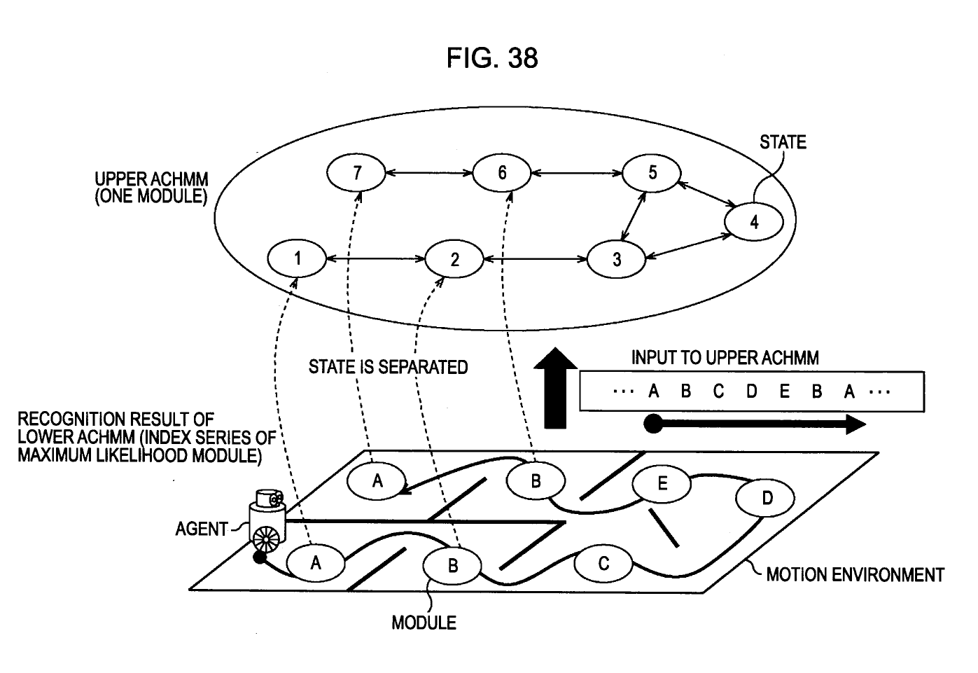

FIG. 38 is a diagram for describing an ACHMM having a hierarchical structure made up of two hierarchical levels wherein the lower ACHMM and the upper ACHMM are connected in a hierarchical structure.

In FIG. 38, with the lower ACHMM, an observed value to be observed from the motion environment is learned. Further, with the lower ACHMM, an observed value to be observed from the motion environment is recognized, and of the modules of the lower ACHMM as recognition results, the module index of the maximum likelihood module is output in time series.

With the upper ACHMM, the same learning as with the lower ACHMM is performed with the module index to be output from the lower ACHMM as an observed value.

Here, in FIG. 38, the upper ACHMM is configured of a single module, and the HMM that is the single module has 7 states #1, #2, #3, #4, #5, #6, and #7.

With the HMM that is a module of the upper ACHMM, according to temporal context relationship of the module index to be output from the lower ACHMM, a case where the agent is located in the local region of the position P_{A}, and a case where the agent is located in the local region of the position P_{A}′ may be obtained as different states.

As a result thereof, according to recognition at the upper ACHMM, it may be determined whether the agent is located in the local region of the position P_{A} or the local region of the position P_{A}′.

Incidentally, with the upper ACHMM, in the event that the recognition result at the upper ACHMM is output as an observed value that can externally be observed, a perceptual aliasing problem still occurs.

That is to say, even when the number of hierarchical levels of the ACHMM having a hierarchical structure is set to any number, in the event that the number of hierarchies has not reached a number suitable for the scale and configuration of the motion environment serving as a modeling object, a perceptual aliasing problem occurs.

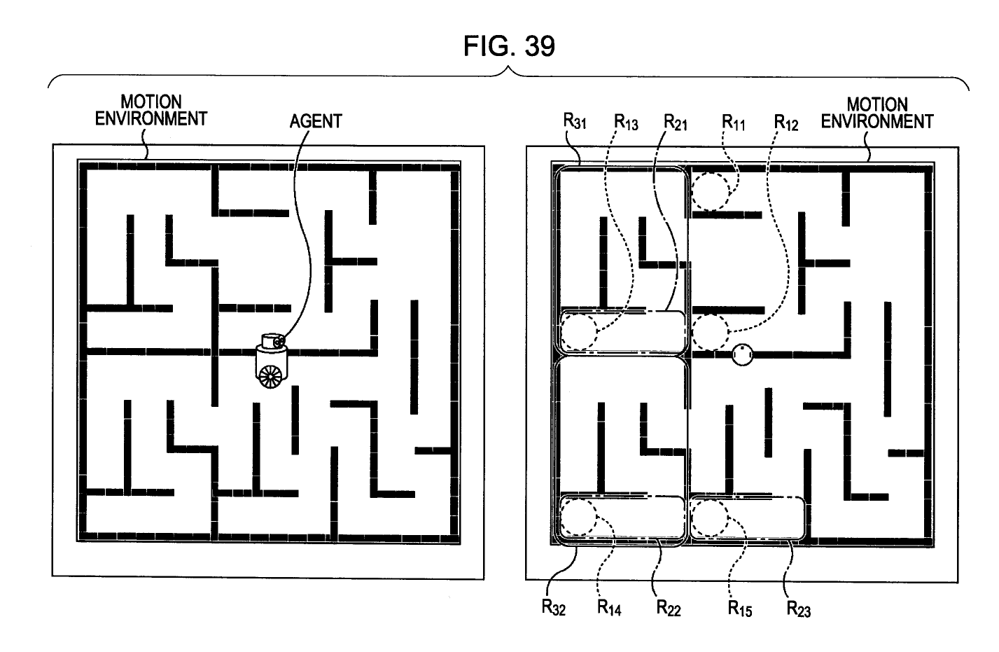

FIG. 39 is a diagram illustrating an example of the motion environment of the agent.

With the motion environment in FIG. 39, in the event that local regions R₁₁, R₁₂, R₁₃, R₁₄, and R₁₅ have the same configuration as viewed with the particle sizes of the local regions R₁₁ through R₁₅, and accordingly, the configurations of the local regions R₁₁ through R₁₅ may effectively be obtained by a single module.

However, with the local regions R₁₁ through R₁₅, as viewed with the particle sizes of the local regions R₂₁, R₂₂, and R₂₃ that are one-step more macroscopic than the particle sizes of the local regions R₁₁ through R₁₅ thereof, it is desirable to determine the local regions R₁₁ through R₁₅ to be a different local region so as not to cause a perceptual aliasing problem.

Further, with the local regions R₂₁, R₂₂, and R₂₃, as viewed with the particle sizes of the local regions R₂₁ through R₂₃ thereof, the local regions R₂₁, R₂₂, and R₂₃ have the same configuration, and accordingly, the configurations of the local regions R₂₁ through R₂₃ may effectively be obtained by a single module.

However, with the local regions R₂₁ through R₂₃, as viewed with the particle sizes of the local regions R₃₁ and R₃₂ that are one-step more macroscopic than the particle sizes of the local regions R₂₁ through R₂₃ thereof, it is desirable to determine the local regions R₂₁ through R₂₃ to be a different local region so as not to cause a perceptual aliasing problem.

Also, with the local regions R₃₁ and R₃₂, as viewed with the particle sizes of the local regions R₃₁ and R₃₂ thereof, the local regions R₃₁ and R₃₂ have the same configuration, and accordingly, the configurations of the local regions R₃₁ and R₃₂ may effectively be obtained by a single module.

Thus, in the event that local expressions are observed in multiple places in a hierarchical manner (a phenomenon of the real world is often fitted to such a case), it is difficult to suitably obtain an environmental configuration only by learning of the ACHMM of a single level, and accordingly, it is desirable to expand the ACHMM to a hierarchical architecture such that the particle size is gradually built up from a hierarchical level of which the time space particle size is fine, to that which is rough, in a hierarchical manner. Further, with such a hierarchical architecture, it is desirable to newly automatically generate a more upper level ACHMM as appropriate.

Note that examples of a method for hierarchically configuring an HMM include a hierarchical HMM described in S. Fine, Y. Singer, N. Tishby, “The Hierarchical Hidden Markov Model: Analysis and Applications”, Machine Learning, vol. 32, no. 1, pp. 41-62 (1998).

With the hierarchical HMM, each state of the HMM of each hierarchical level may not have an output probability (observation probability) but an HMM of a lower level.

The hierarchical HMM is premised on that the number of modules at each hierarchical level is fixed beforehand, and the number of hierarchical levels is fixed beforehand, and further employs a learning rule for performing optimization of the model parameters at the whole hierarchical HMM, and accordingly, (when developing the hierarchical levels, the hierarchical HMM becomes an HMM having a common loose coupling,) the flexibility of a model is increased by the number of hierarchical levels, and the number of modules increasing, and accordingly, the learning convergence of the model parameters may deteriorate.

Further, the hierarchical HMM is not a model suitable for modeling of an unknown modeling object of which the number of hierarchical levels and the number of modules are prevented from being determined beforehand.

Also, for example, with N. Oliver, A. Garg, E. Horvitz, “Layered representations for learning and inferring office activity from multiple sensory channels, Computer Vision and Image Understanding”, vol. 96, No. 2, pp. 163-180 (2004), the hierarchical architecture of an HMM called a layered HMM has been proposed.

With the layered HMM, the likelihood of a lower fixed number of HMM sets is taken as input to an upper HMM. Subsequently, lower HMMs each make up an event recognizer employing a different modal, and an upper HMM realizes an action recognizer which integrate these multi-modalities.

The layered HMM is premised on that the configurations of lower HMMs are determined beforehand, and are prevented from handling a situation where a lower HMM is newly added. Accordingly, the layered HMM is not a model suitable for modeling of an unknown modeling object of which the number of hierarchical levels and the number of modules are prevented from being determined beforehand.

### Configuration Example of Learning Device

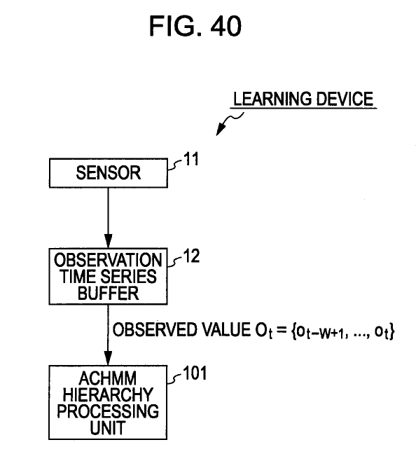

FIG. 40 is a block diagram illustrating a configuration example of the second embodiment of the learning device to which the information processing device according to the present invention has been applied.

Note that in the drawing, a portion corresponding to the case of FIG. 1 is appended with the same reference symbol, and hereafter, description thereof will be omitted as appropriate.

With the learning device in FIG. 40, a hierarchical ACHMM that is a hierarchical architecture for hierarchically combining (connecting) a unit with an ACHMM as a basic component is employed as a learning model used for modeling of a modeling object.

According to employment of the hierarchical ACHMM, as the hierarchy rises from a lower level to an upper level, the temporal space particle size of a state transition model (HMM) becomes rough, which is features, and accordingly, learning may be performed with storage efficiency and learning efficiency being both excellent as to a system where a great number of hierarchical and common local configurations are included such as a real world event.

That is to say, according to the hierarchical ACHMM, with the same local configuration (such as a different position) to be repeatedly observed from a modeling object, learning is performed at the same module by the ACHMM of each hierarchical level, and accordingly, learning may be performed with storage efficiency and learning efficiency being excellent.

Note that different positions of the same local configuration should be expressed with states being divided as viewed in one-step macroscopic manner, but with the hierarchical ACHMM, states are divided by the ACHMM of one-step upper hierarchical level.

In FIG. 40, the learning device includes the sensor 11, the observation time series buffer 12, and an ACHMM hierarchy processing unit 101.

The ACHMM hierarchy processing unit 101 generates a later-described ACHMM unit including an ACHMM, and further configures a hierarchical ACHMM by connecting the ACHMM unit in a hierarchical configuration.

Subsequently, with the hierarchical ACHMM, learning employing the time series (time series data Oₜ) of the observed value supplied from the observation time series buffer 12 is performed.

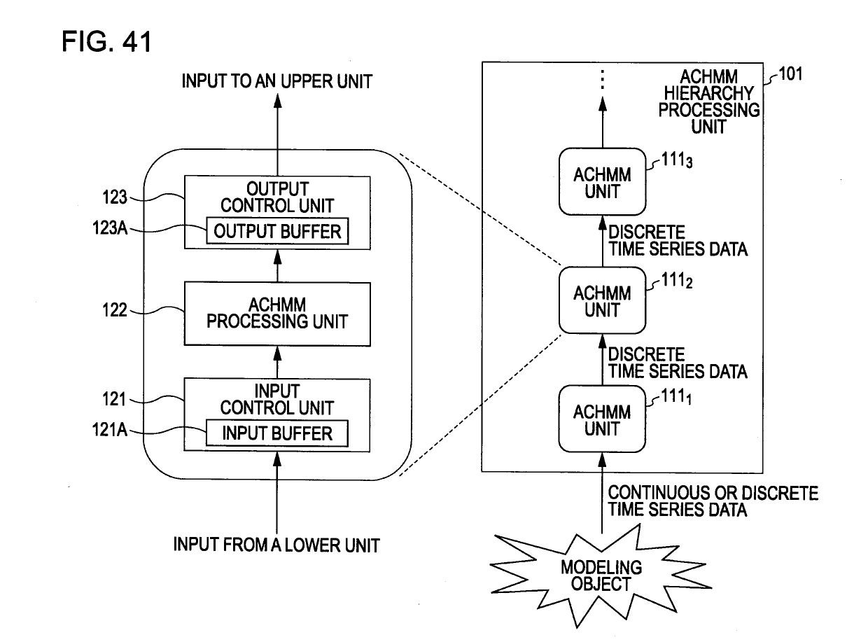

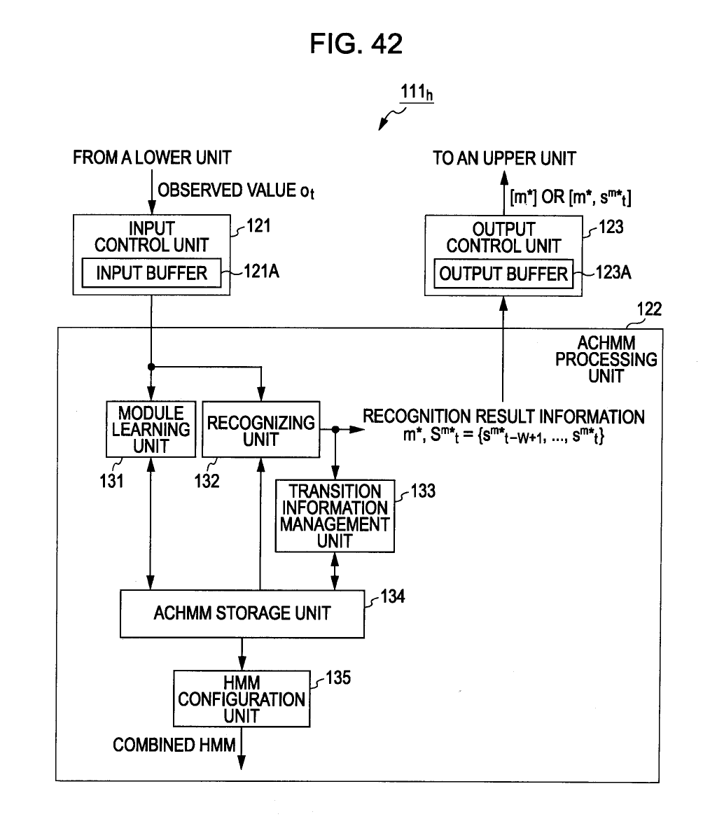

FIG. 41 is a block diagram illustrating a configuration example of the ACHMM hierarchy processing unit 101 in FIG. 40.

The ACHMM hierarchy processing unit 101 generates an ACHMM unit such as described above, and configures a hierarchical ACHMM by connecting the ACHMM unit in a hierarchical configuration.

In FIG. 41, three ACHMM units 111₁, 111₂, and 111₃ are generated, and the hierarchical ACHMM is configured with the ACHMM units 111₁, 111₂, and 111₃ as the ACHMM units of the lowermost level, the second hierarchical level from the lowermost level, and the uppermost level (here, the third hierarchical level from the lowermost level) respectively.

The ACHMM units 111ₕ is the ACHMM unit of the h'th hierarchical level (the h'th hierarchical level toward the uppermost level from the lowermost level), and includes an input control unit 121, an ACHMM processing unit 122, and an output control unit 123.

The observed value from the observation time series buffer 12 (FIG. 40), or the ACHMM recognition result information from the ACHMM units 111ₕ₋₁ (the ACHMM units 111ₕ₋₁ connected to the ACHMM units 111ₕ) lower hierarchical level than the ACHMM units 111ₕ by one hierarchical level are supplied to the input control unit 121 as an observed value to be externally supplied.

The input control unit 121 houses an input buffer 121A. The input control unit 121 temporarily stores the observed value to be externally supplied in the input buffer 121A, and performs input control for outputting the time series of the observed value stored in the input buffer 121A to the ACHMM processing unit 122 as input data to be provided to an ACHMM.

The ACHMM processing unit 122 performs ACHMM learning (module learning) employing the input data from the input control unit 121, and processing employing an ACHMM (hereafter, also referred to as “ACHMM processing”) such as recognition of input data employing an ACHMM.

Also, the ACHMM processing unit 122 supplies the recognition result information to be obtained as a result of recognition of input data employing an ACHMM to the output control unit 123.

The output control unit 123 houses an output buffer 123A. The output control unit 123 performs output control for temporarily storing the recognition result information to be supplied from the ACHMM processing unit 122 in the output buffer 123A, and outputting the recognition result information stored in the output buffer 123A as output data to be output outside (the ACHMM units 111ₕ)

The recognition result information to be output from the output control unit 123 as output data is supplied to the ACHMM units 111ₕ₊₁ upper than the ACHMM unit 111ₕ by one hierarchical level (the ACHMM units 111ₕ₊₁ connected to the ACHMM unit 111ₕ).

FIG. 42 is a block diagram illustrating a configuration example of the ACHMM processing unit 122 of the ACHMM unit 111ₕ in FIG. 41.

The ACHMM processing unit 122 includes a module learning unit 131, a recognizing unit 132, a transition information management unit 133, an ACHMM storage unit 134, and an HMM configuration unit 135.

The module learning unit 131 through the HMM configuration unit 135 are configured in the same way as the module learning unit 13 through the HMM configuration unit 17 of the learning device 1.

Accordingly, with the ACHMM processing unit 122, the same processing as the processing to be performed at the module learning unit 13 through the HMM configuration unit 17 in FIG. 1 is performed.

However, in order to perform ACHMM learning by the module learning unit 131, and recognition employing an ACHMM by the recognizing unit 132, the input data that is time series data to be provided to an ACHMM is supplied from (the input buffer 121A) of the input control unit 121 to the ACHMM processing unit 122.

That is to say, in the event that the ACHMM unit 111ₕ is the ACHMM unit 111₁ of the lowermost level, the observed value from the observation time series buffer 12 (FIG. 40) is supplied to the input control unit 121 as an observed value to be externally supplied.

The input control unit 121 temporarily stores the observed value from the observation time series buffer 12 (FIG. 40) serving as an observed value to be externally supplied, in the input buffer 121A.

Subsequently, after storing the observed value oₜ at the point-in-time t that is the latest observed value in the input buffer 121A, the input control unit 121 reads out the time series data Oₜ={o_{t-W+1}, . . . , oₜ} at the point-in-time t that is the time series of the observed value for the past W points-in-time that is the window length W from the point-in-time t, from the input buffer 121A as input data, and supplies this to the module learning unit 131 and recognizing unit 132 of the ACHMM processing unit 122.

Also, in the event that the ACHMM unit 111ₕ is an ACHMM unit other than the ACHMM unit 111₁ of the lowermost level, recognition result information is supplied from the ACHMM unit 111ₕ₋₁ (hereafter, also referred to as “lower unit”) lower hierarchical level than the ACHMM unit 111ₕ by one hierarchical level to the input control unit 121 as an observed value to be externally supplied.

The input control unit 121 temporarily stores the observed value from the lower unit 111ₕ₋₁ serving as an observed value to be externally supplied, in the input buffer 121A.

Subsequently, after storing the latest observed value in the input buffer 121A, the input control unit 121 reads out the time series data O={o₁, . . . , o_{L}} that is the L time series of the observed value of the past L samples (points-in-time) including the latest observed value from the input buffer 121A as input data, and supplies this to the module learning unit 131 and recognizing unit 132 of the ACHMM processing unit 122.

Now, if we pay attention to only the single ACHMM unit 111ₕ, and of the time series data O={o₁, . . . , o_{L}}, take the latest observed value o_{L} as the observed value oₜ at the point-in-time t, the time series data O={o₁, . . . , o_{L}} can be taken as the time series data Oₜ={o_{t-L+1}, . . . , oₜ} at the point-in-time t that is the time series of the observed value of the past L points-in-time from the point-in-time t.

Here, with the ACHMM unit 111ₕ of a hierarchical level other than the lowermost level, the length L of the time series data Oₜ={o_{t-L+1}, . . . , oₜ} that is the input data is variable length.

An ACHMM that takes an HMM as a module is stored in the ACHMM storage unit 134 of the ACHMM processing unit 122 in the same way as with the ACHMM storage unit 16 in FIG. 1.

However, with the ACHMM unit 111₁ of the lowermost level, a continuous HMM or discrete HMM is employed according to the observed value serving as the input data, i.e., the observed value to be output from the sensor 11 being a continuous value or discrete value, respectively, as an HMM that is a module.

On the other hand, with the ACHMM unit 111ₕ of a hierarchical level other than the lowermost level, the observed value serving as the input data is the recognition result information from the lower unit 111ₕ₋₁, which is a discrete value, and accordingly, the discrete HMM is employed as an HMM that is a module of the ACHMM.

Also, with the ACHMM processing unit 122, the recognition result information to be obtained as a result of recognition of the input data employing the ACHMM by the recognizing unit 132 is supplied to the transition information management unit 133 and also (the output buffer 123A) the output control unit 123.

However, of the time series of the observed value that is the input data at the point-in-time t, the recognizing unit 132 supplies the latest observed value, i.e., the recognition result information of the observed value at the point-in-time t to the output control unit 123.

That is to say, of the modules making up the ACHMM stored in the ACHMM storage unit 134, the recognizing unit 132 supplies a set [m*, s^{m}*ₜ] of (the module index m* of) the maximum likelihood module #m* of which the likelihood is the maximum as to the time series of the observed value that is the input data Oₜ={o_{t-L+1}, . . . , oₜ} at the point-in-time t, and (the index of) the last state s^{m}*ₜ of the maximum likelihood state series s^{m}*ₜ={s^{m}*_{t-L+1}, . . . , s^{m}*ₜ} of which the likelihood that the time series of the observed value that is the input data at the point-in-time t may be observed is the maximum, of the HMM that is the maximum likelihood module #m*, to the output control unit 123 as recognition result information.

Note that in the event that the input data O is represented with O={o₁, . . . , o_{L}}, the maximum likelihood state series as to the input data thereof is represented with s^{m}*={s^{m}*₁, . . . , s^{m}*_{L}}, and the recognition result information of the latest observed value o_{L} is represented with [m*, s^{m}*_{L}].

The recognizing unit 132 supplies the set [m*, s^{m}*_{L}] of the indexes of the maximum likelihood module #m*, and the last state s^{m}*_{L} of the maximum likelihood state series s^{m}*={s^{m}*₁, . . . , s^{m}*_{L}} to the output control unit 123 as recognition result information, and also may supply only the index (module index) [m*] of the maximum likelihood module #m* to the output control unit 123 as recognition result information.

Here, the recognition result information of a two-dimensional symbol that is the set [m*, s^{m}*_{L}] of the indexes of the maximum likelihood module #m* and the state s^{m}*_{L} will also be referred to as type 1 recognition result information, and the recognition result information of a one-dimensional symbol of only the module index [m*] of the maximum likelihood module #m* will also be referred to as type 2 recognition result information.

As described above, the output control unit 123 temporarily stores the recognition result information to be supplied from (the recognizing unit 132 of) the ACHMM processing unit 122 in the output buffer 123A. Subsequently, when a predetermined output condition is satisfied, the output control unit 123 outputs the recognition result information stored in the output buffer 123A as output data to be output outside (the ACHMM unit 111ₕ).

The recognition result information to be output from the output control unit 123 as output data is supplied to the ACHMM unit (hereafter, also referred to as “upper unit”) 111ₕ₊₁ upper than the ACHMM unit 111ₕ by one hierarchical level.

With the input control unit 121 of the upper unit 111ₕ₊₁, in the same way as with the case of the ACHMM unit 111ₕ, the recognition result information serving as the output data from the lower unit 111ₕ is stored in the input buffer 121A as an observed value to be externally supplied.

Subsequently, with the upper unit 111ₕ₊₁, ACHMM processing (processing employing an ACHMM such as ACHMM learning (module learning), recognition of input data employing an ACHMM) is performed with the time series of the observed value stored in the input buffer 121A of the input control unit 121 of the upper unit 111ₕ₊₁ thereof as input data.

### Output Control of Output Data

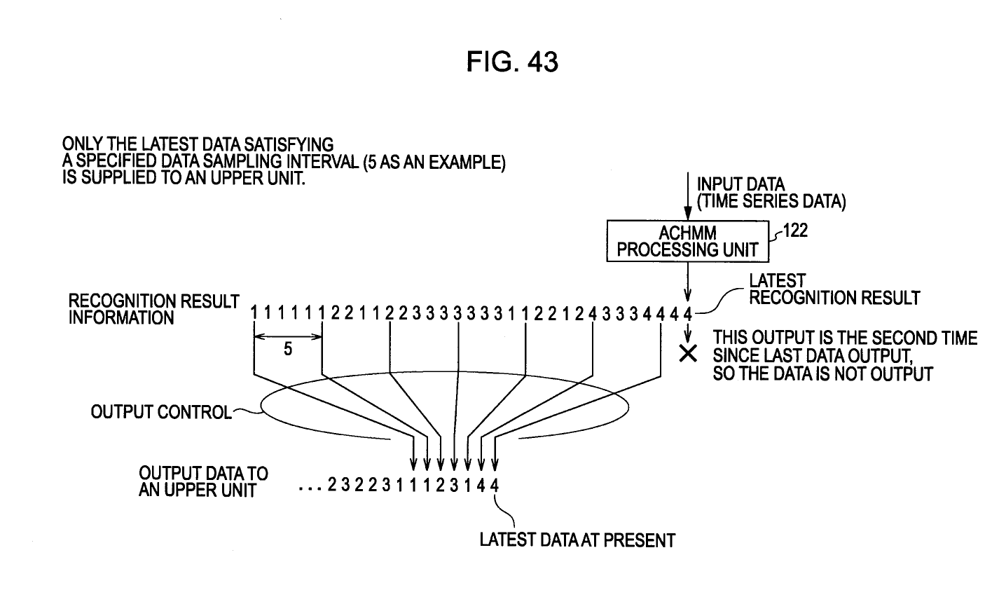

FIG. 43 is a diagram for describing a first method (first output control method) of output control of output data by the output control unit 123 in FIG. 42.

With the first output control method, the output control unit 123 temporarily stores the recognition result information to be supplied from (the recognizing unit 132 of) the ACHMM processing unit 122 in the output buffer 123A, and outputs the recognition result information of a predetermined timing as output data.

That is to say, with the first output control method, the recognition result information at predetermined timing is taken as an output condition of output data, and the recognition result information at timing for each predetermined sampling interval serving as predetermined timing, for example, is output as output data.

FIG. 43 illustrates the first output control method in the case of T=5 is employed as a sampling interval T.

In this case, the output control unit 123 repeats processing for temporarily storing the recognition result information to be supplied from the ACHMM processing unit 122 in the output buffer 123A, and outputting recognition result information later than the recognition result information output immediately before as output data, by five pieces.

According to the first output control method, the output data that is recognition result information in every five pieces such as described above is supplied to an upper unit.

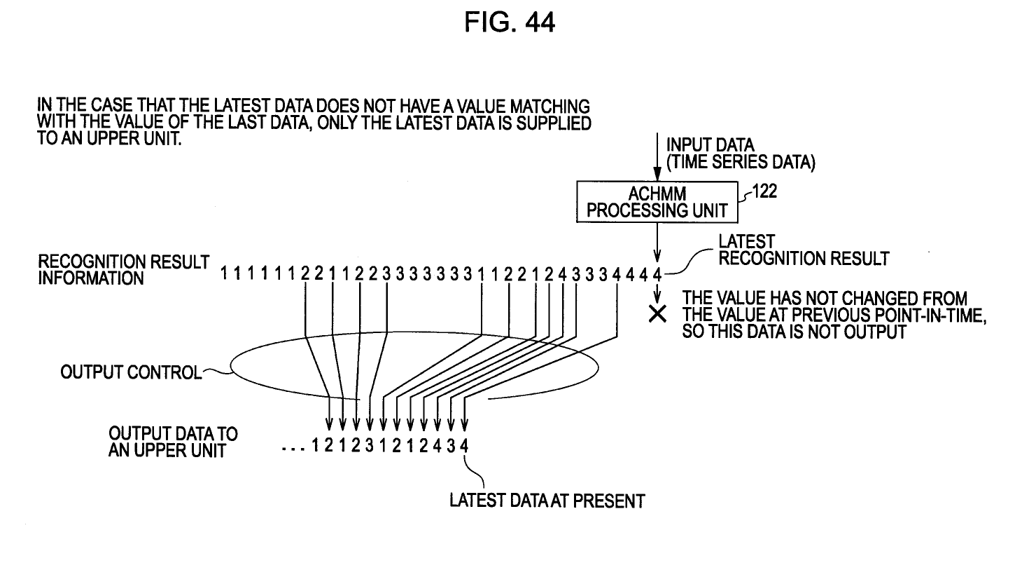

Note that in FIG. 43 (true for later-described FIGS. 44, 46, and 47), in order to prevent the drawing from becoming complicated, one-dimensional symbols are employed as recognition result information.

FIG. 44 is a diagram for describing a second method (second output control method) of output control of output data by the output control unit 123 in FIG. 42.

With the second output control method, the output control unit 123 temporarily stores the recognition result information to be supplied from (the recognizing unit 132 of) the ACHMM processing unit 122 in the output buffer 123A, and with it being as an output condition of output data that the latest recognition result information does not match the last recognition result information, outputs the latest recognition result information as the output data.

Accordingly, with the second output control method, in the event that the same recognition result information as the recognition result information output as output data at a certain point-in-time continues, as long as the same recognition result information thereof continues, the output data is not output.

Also, with the second output control method, in the event that the recognition result information at each point-in-time differs from the recognition result information at immediately previous point-in-time, the recognition result information at each point-in-time is output as output data.

According to the second output control method, in the way described above, the output data of which the same recognition result information does not continue is supplied to the upper unit.

Note that in the event that the output control unit 123 outputs output data by the second output control method, ACHMM learning to be performed by the upper unit receiving supply of the output data thereof is equivalent to learning of a time series configuration to be performed with switching of an event as unit time by the agent to which the learning device in FIG. 40 has been applied taking a state transition of the ACHMM caused due to change in an observed value that is the sensor signal output from the sensor 11 by performing an action, as an event, and is suitable for effectively structuralizing an event of the real world.

According to any of the first and second output control methods, the recognition result information obtained at the ACHMM processing unit 122 of which the several pieces are thinned out (temporal particle size is roughened) is supplied to the upper unit as output data.

Subsequently, the upper unit uses the recognition result information supplied as output data, as input data to perform the ACHMM processing.

Incidentally, the above type 1 recognition result information is different information when the last state s^{m}*_{L} of the maximum likelihood state series at the maximum likelihood module #m* differs, but the type 2 recognition result information is not different information unlike the type 1 recognition result information even when the last state s^{m}*_{L} of the maximum likelihood state series at the maximum likelihood module #m* differs, and is information blind to the difference of the states of the maximum likelihood module #m*.

Therefore, in the event that the lower unit 111ₕ outputs the type 2 recognition result information as output data, the state particle size that the upper unit 111ₕ₊₁ obtains in a self-organized manner by ACHMM learning (the particle size of a cluster for clustering an observed value at observation space, corresponding to the state of the HMM that is a module) is rougher as compared with a case of outputting type 1 recognition result information as output data.

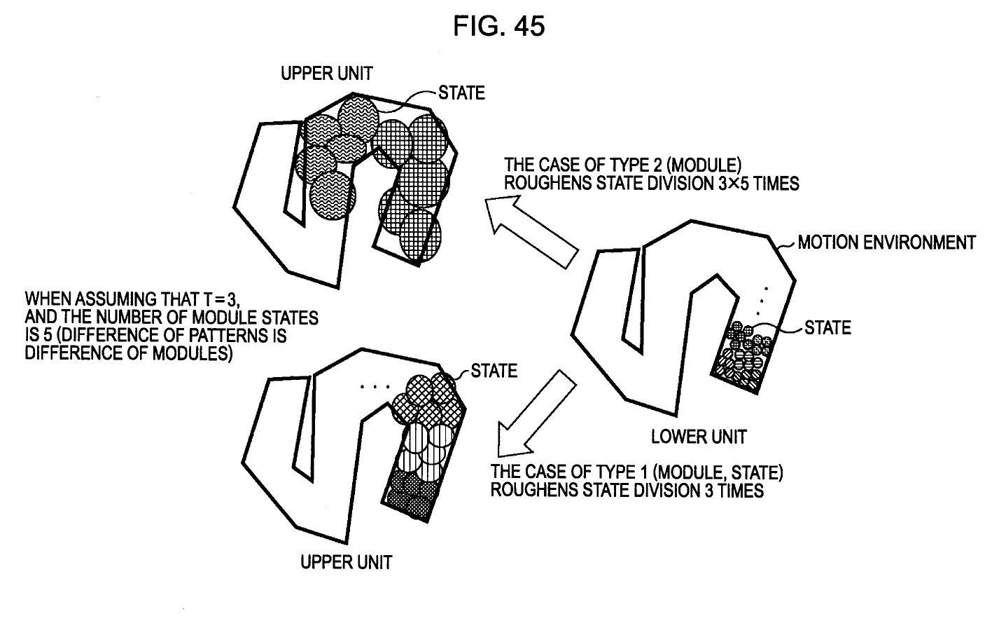

FIG. 45 is a diagram for describing the particle size of the state of an HMM serving as a module that the upper unit 111ₕ₊₁ obtains by ACHMM learning in the event that the lower unit 111ₕ outputs the recognition result information of each of the types 1 and 2 as output data.

Now, in order to simplify description, let us say that the lower unit 111ₕ supplies recognition result information at every certain sampling interval T to the upper unit 111ₕ₊₁ as output data by the first output control method of the first and second output control methods.

In the event that the output control unit 123 of the lower unit 111ₕ outputs the type 1 recognition result information as output data, the particle size of the state of an HMM serving as a module that the upper unit 111ₕ₊₁ obtains by ACHMM learning is rougher than the particle size of the state of the HMM serving as a module that the lower unit 111ₕ obtains by ACHMM learning, by sampling interval T times.

FIG. 45 schematically illustrates the particle size of the state of the HMM at the lower unit 111ₕ, and the particle size of the state of the HMM at the upper unit 111ₕ₊₁, in the event that the sampling interval T is 3 for example.

In the event of employing the type 1 recognition result information, for example, when the ACHMM unit 111₁ of the lowermost level uses the time series of an observed value to be observed from the motion environment where the agent to which the learning device in FIG. 40 has been applied to perform the ACHMM processing, the state of the HMM at the upper unit 111₂ of the ACHMM unit 111₁ corresponds to the region having width triple of the local region that the HMM at the ACHMM unit 111₁ that is the lower unit thereof handles.

On the other hand, in the event that the output control unit 123 of the lower unit 111ₕ outputs the type 2 recognition result information as output data, the particle size of the state of the HMM at the upper unit 111ₕ₊₁ is times the number of states N of the HMM that is a module, in the case of employing the above type 1 recognition result information.

That is to say, in the event of employing the type 2 recognition result information, the particle size of the state of the HMM at the upper unit 111ₕ₊₁ is a particle size rougher than the particle size of the state of the HMM at the lower unit 111ₕ by T×N times.

Accordingly, in the event of employing the type 2 recognition result information, if we say that the sampling interval T is, for example, 3 such as described above, and the number of states N of the HMM that is a module is, for example, 5, the particle size of the state of the HMM at the upper unit 111ₕ₊₁ is a particle size rougher than the particle size of the state of the HMM at the lower unit 111ₕ by 15 times.

### Input Control of Input Data

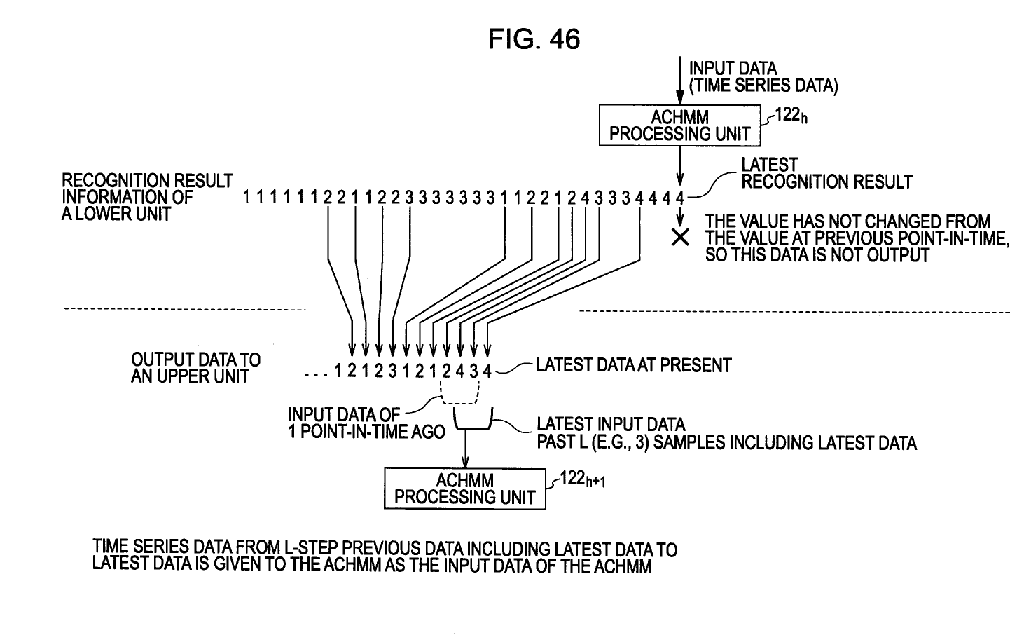

FIG. 46 is a diagram for describing a first method (first input control method) of input control of input data by the input control unit 121 in FIG. 42.

With the first input control method, the input control unit 121 temporarily stores the recognition result information (or the observed value to be supplied via the observation time series buffer 12 from the sensor 11) serving as an observed value to be externally supplied that is the output data to be supplied by the above first or second output control method from (the output control unit 123) a lower unit in the input buffer 121A, and when storing the latest output data from the lower unit, outputs the time series of the latest output data of the fixed length L as input data.

FIG. 46 illustrates the first input control method in the case that the fixed length L is 3 for example.

The input control unit 121 temporarily stores the output data from the lower unit in the input buffer 121A as an observed value to be externally supplied.

With the first input control method, when storing the latest output data from the lower unit in the input buffer 121A, the input control unit 121 reads out the time series data O={o₁, . . . , o_{L}} that is the time series of L=3 pieces of output data of the past L samples (points-in-time) including the latest output data thereof from the input buffer 121A as input data, and supplies this to the module learning unit 131 and recognizing unit 132 of the ACHMM processing unit 122.

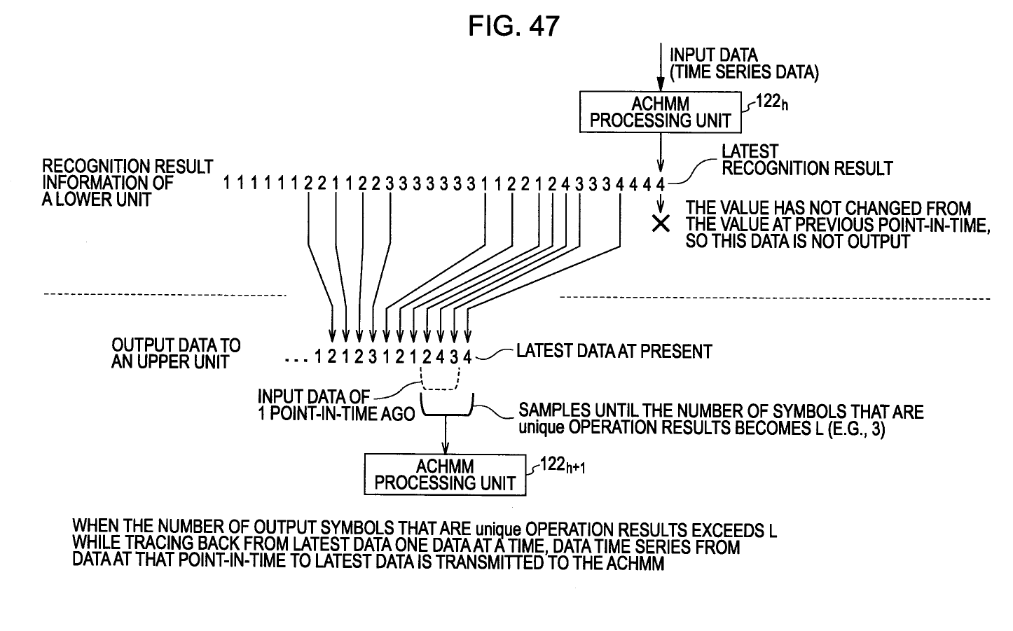

Note that in FIG. 46 (true for later-described FIG. 47), the output data from a lower unit will be supplied to the input control unit 121 of an upper unit by the second output control method.

Also, in FIG. 46 (true for later-described FIG. 47), the ACHMM processing unit 122 (FIG. 42) of the ACHMM unit 111ₕ of the h'th hierarchical level is described as ACHMM processing unit 122ₕ by appending a subscript h thereto.

FIG. 47 is a diagram for describing a second method (second input control method) of input control of input data by the input control unit 121 in FIG. 42.

With the second input control method, when storing the latest output data from the lower unit in the input buffer 121A, the input control unit 121 reads out from the output data at a point of having gone back in the past until output data having a different value appears a predetermined number L of times (until the number of sample of output data as a result of a unique operation reaches L), to the latest output data from the input buffer 121A as input data, and supplies this to the module learning unit 131 and recognizing unit 132 of the ACHMM processing unit 122.

Accordingly, the number of samples of input data to be supplied from the input control unit 121 to the ACHMM processing unit 122 is L samples according to the first input control method, but according to the second input control method, is a variable value equal to or greater than the L samples.

Note that with the ACHMM unit 111₁ of the lowermost level, in the event of the first input control method being employed, the window length W is employed as the fixed length L.

Also, in the event that the recognition result information serving as output data is the type 1 recognition result information that is the set [m*, s^{m}*_{L}] of the indexes of the maximum likelihood module #m* and the state s^{m}*_{L}, for example, as described in FIG. 20, the input control unit 121 of the upper unit 111ₕ₊₁ converts the recognition result information [m*, s^{m}*_{L}] that is a two-dimensional symbol into a one-dimensional symbol value not duplicated regarding all the modules making up the ACHMM of the lower unit 111ₕ, such as value N×(m*−1)+s^{m}*ₜ, and handles the one-dimensional symbol value as input data.

Here, in the event of applying the learning device in FIG. 40 to the agent to obtain the map of the motion environment in a self-organized manner using an observed value to be observed from the motion environment where the agent is located, it is desirable to employ the second input control method of the first and second input control methods at the input control unit 121.

That is to say, the motion environment is a reversible system wherein a state transition of the state of an HMM that is a module occurs due to movement m1′ of only predetermined movement amount with a certain direction Dir as a movement direction, and a state transition occurs wherein the state returns to the original state due to movement (movement returning to the original state) m1′ of only predetermined movement amount with the direction opposite to the direction Dir as a movement direction.

Now, let us say that the agent has performed movement m2 different from the movement m1 and m1′, and then has alternately repeated the movement m1 and m1′ several times, and after the last movement m1′ of the repetition, has performed movement m2′ for returning as to the movement m2.

Further, let us say that according to such movement, with the HMM that is a module of the ACHMM of the lower unit 111ₕ, as a state transition between three states #1, #2, and #3, state transitions occur such as “3→2→1→2→1→2→1→2→1→2→1→2→1→2→1→2→3” vibrating between the states #1 and #2 from the state #3.

With state transitions “3→2→1→2→1→2→1→2→1→2→1→2→1→2→1→2→3”, the state transitions between the states #1 and #2 overwhelmingly numerously appear as compared to the state transitions between the states #2 and #3.

Now, let us say that the type 1 recognition result information that is the set [m*, s^{m}*_{L}] of the indexes of the maximum likelihood module #m* and the state s^{m}*_{L} is employed, but in order to simplify description, of the recognition result information [m*, s^{m}*_{L}], (the index of) the maximum likelihood module #m* is ignored.

Further, here, in order to simplify description, the indexes of the states in the state transitions “3→2→1→2→1→2→1→2→1→2→1→2→1→2→1→2→3” are all supplied as output data from the lower unit 111ₕ to the upper unit 111ₕ₊₁ without change.

Now, with the upper unit 111ₕ₊₁, if we employ the first input control method with the fixed length L as 3 for example, the input control unit 121 of the upper unit 111ₕ₊₁ first takes “3→2→1” as input data, and then sequentially takes “2→1→2”, “1→2→1”, . . . , “1→2→1”, “2→1→2”, and “1→2→3” as input data.

Now, in order to simplify description, with the HMM that is a module of the ACHMM of the upper unit 111ₕ₊₁, for example, let us say that as to input data “3→2→1” state transitions “3→2→1” occur in the same way as the input data.

In this case, with additional learning of the HMM that is the object module at the upper unit 111ₕ₊₁, updating of the state transition probability of the state transition from the state #3 to the state #2 at the time of employing the first input data “3→2→1” is diluted (or forgotten) with updating of the state transition probability of a state transition between the states #1 and #2 using subsequently appearing a numerous input data “2→1→2” and “1→2→1” by an amount proportional to the emergence frequency of the input data “2→1→2” and “1→2→1”.

That is to say, of the states #1 through #3, for example, when paying attention on the state #2, with regard to the state #2, the state transition probability of a state transition as to the state #1 is increased by numerous input data “2→1→2” and “1→2→1”, but on the other hand, the state transition probability as to states other than the state #1, i.e., the other states including the state #3 is decreased.

On the other hand, with the upper unit 111ₕ₊₁, if the second input control method is employed with the fixed number L as 3 for example, the input control unit 121 of the upper unit 111ₕ₊₁ first takes “3→2→1” as input data, and subsequently takes “3→2→1→2”, “3→2→1→2→1”, . . . , “3→2→1→2→1→2→1→2→1→2→1→2→1→2→1→2”, and “1→2→3” as input data in order.

In this case, with additional learning of the HMM that is the object module at the upper unit 111ₕ₊₁, updating of the state transition probability of the state transition from the state #3 to the state #2 is performed also using subsequent input data in addition to the first input data “3→2→1”, and accordingly, with regard to the state #2, the state transition probability of the state transition as to the state #1 is increased, and also the state transition probability of the state transition as to the state #3 is somewhat increased, and the state transition probability as to a state other than the states #1 and #3 is relatively decreased.

In the way described above, according to the second input control method, updating of the state transition probability of the state transition from the state #3 to the state #2 of which the degree to be diluted (forgotten) can be reduced.

### Expansion of Observation Probability of HMM

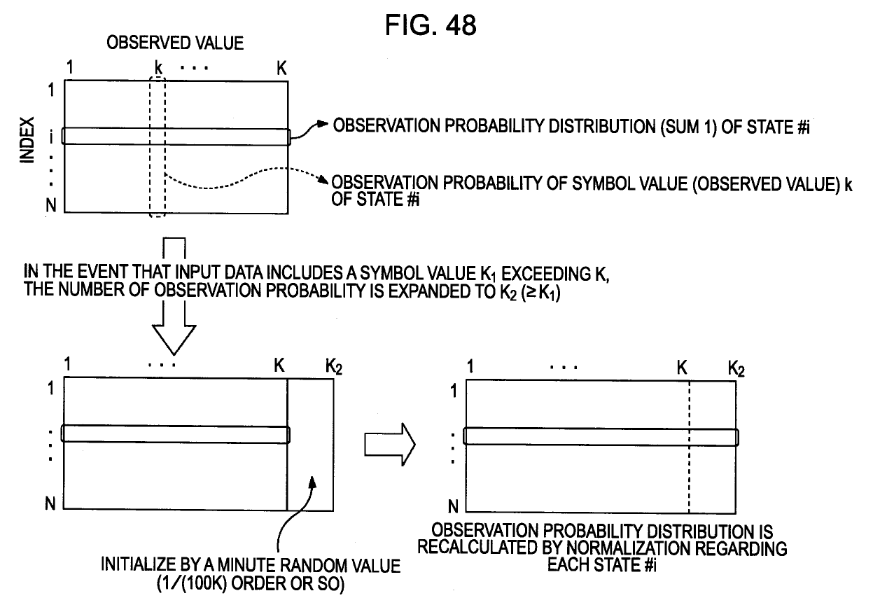

FIG. 48 is a diagram for describing expansion of the observation probability of the HMM that is a module of the ACHMM.

With the hierarchical ACHMM, in the event that the HMM that is a module of the ACHMM is a discrete HMM, input data may include an unobserved value that is an observed value that has not ever been observed.

That is to say, in particular, a new module may be added to the ACHMM, and accordingly, in the event that with the ACHMM unit 111ₕ of a hierarchical level other than the lowermost level, the maximum likelihood module m* representing the index serving as the recognition result information to be supplied from the lower unit 111ₕ₋₁ is a new module that has not been provided, in this case, the input data to be output by the input control unit 121 of the ACHMM unit 111ₕ includes an unobserved value equivalent to the index of the new module.

Here, as described above, as for the index m of the new module #m, a sequential integer is employed with 1 as an initial value, and accordingly, in the event that the maximum likelihood module #m* representing index serving as the recognition result information to be supplied from the lower unit 111ₕ₋₁ is a new module that has not been provided, with the ACHMM unit 111ₕ, an unobserved value equivalent to the index of the new module thereof is a value exceeding the maximum value of observed values that have been observed so far.

The module learning unit 131 of the ACHMM processing unit 122 (FIG. 42) of the ACHMM unit 111ₕ, in the even that the HMM that is a module of the ACHMM is a discrete HMM, when the input data to be supplied from the input control unit 121 includes an unobserved value that is an observed value that has not ever been observed, performs expansion processing for expanding the observation probability matrix of an observation probability that an observed value may be observed, of the HMM parameters of the HMM that is a module of the ACHMM, so as to include the observation probability of the unobserved value.

That is to say, in the event that the input data to be supplied from the input control unit 121 includes an unobserved value K₁ exceeding the maximum value K of observed values that have been observed so far, with the expansion processing, such as illustrated in FIG. 48, the module learning unit 131 takes the row direction (vertical direction) as the index i of the state #i, and also takes the column direction (horizontal direction) as an observed value k, and with the state #i, changes (expands), of the observation probability matrix with an observation probability that the observed value k may be observed as a component, the maximum value of the observed values in the column direction from the observed value K to a value K₂ other than the unobserved value K₁.

Further, with the expansion processing, observation probabilities of the values K₁ through K₂ that are unobserved values regarding each state of the HMM of the observation probability matrix is initialized to, for example, a random minute value, of the order of 1/(100×K).

Subsequently, randomization to a probability for normalizing the observation probability of each row of the observation probability matrix is performed so that the summation of the observation probabilities of one row of the observation probability matrix (the summation of observation probabilities that each observed value may be observed) becomes 1.0, and the expansion processing ends.

Note that the expansion processing is performed with the observation probability matrix of all the modules (HMMs) making up the ACHMM as an object.

### Unit Generating Processing

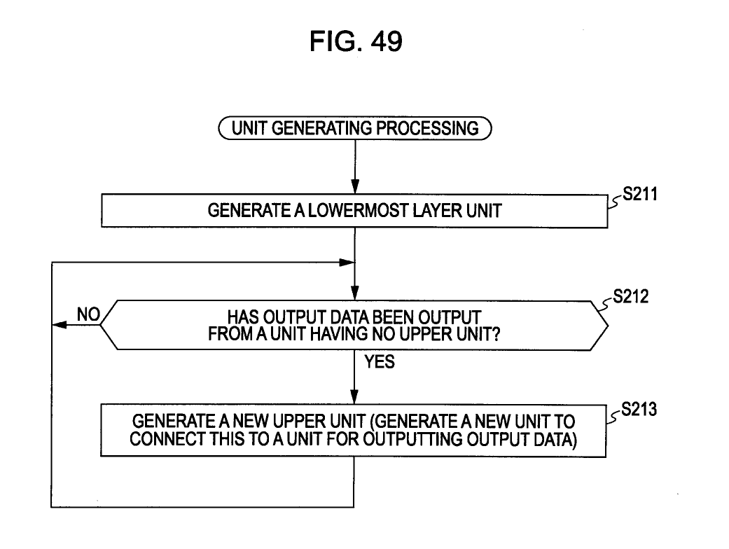

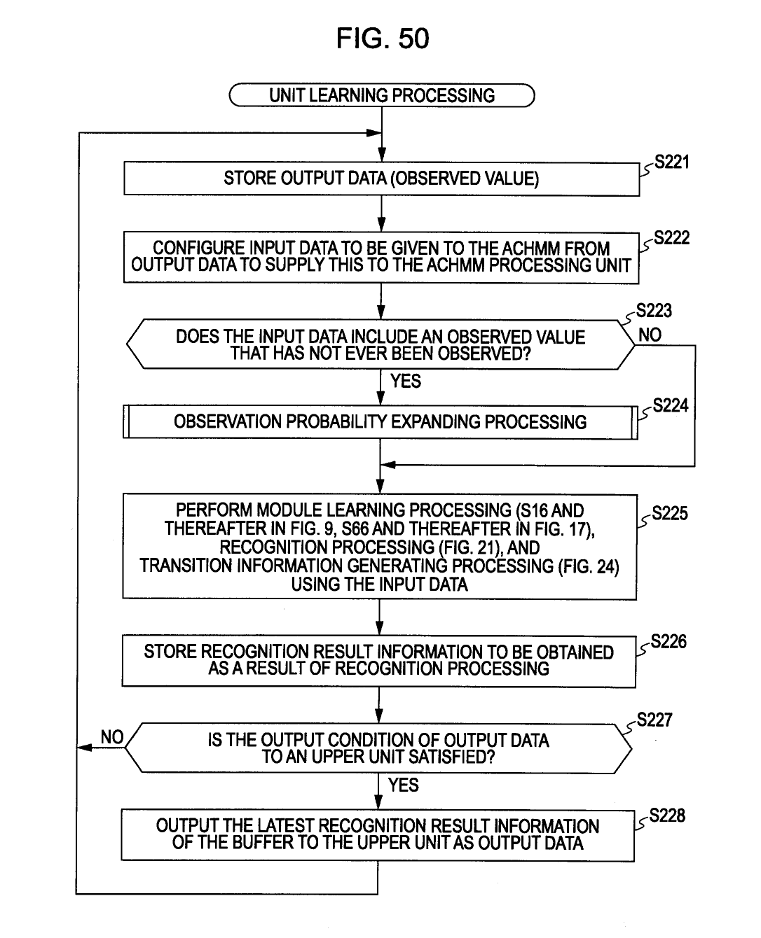

FIG. 49 is a flowchart for describing unit generating processing to be performed by the ACHMM hierarchy processing unit 101 in FIG. 40.

The ACHMM hierarchy processing unit 101 (FIG. 40) generates the ACHMM units 111 as appropriate, and further performs the unit generating processing for connecting the ACHMM units 111 in a hierarchical structure to configure a hierarchical ACHMM.

That is to say, with the unit generating processing, in step S211 the ACHMM hierarchy processing unit 101 generates the ACHMM unit 111₁ of the lowermost level, and configures the hierarchical ACHMM of one level with only the ACHMM unit 111₁ of the lowermost level as a component, and the processing proceeds to step S212.

Here, generation of an ACHMM unit is equivalent to, for example, with object oriented programming, that a class of an ACHMM unit is prepared, and an instance of the class of the ACHMM unit thereof is generated.

In step S212, the ACHMM hierarchical processing unit 101 determines whether or not the output data has been output from an ACHMM unit having no upper unit, of the ACHMM units 111.

Specifically, now, let us say that the hierarchical ACHMM is configured of H (hierarchical levels) ACHMM units 111₁ through 111_{H}, in step S212 determination is made whether or not the output data has been output from (the output control unit 123 (FIG. 42)) the ACHMM unit 111_{H} of the uppermost level.

In the event that determination is made in step S212 that the output data has been output from the ACHMM unit 111_{H} of the uppermost level, the processing proceeds to step S213, where the ACHMM hierarchy processing unit 101 generates a new ACHMM unit 111_{H+1} of the uppermost level serving as the upper unit of the ACHMM unit 111_{H}.

Specifically, in step S213 the ACHMM hierarchy processing unit 101 generates a new ACHMM unit (new unit) 111_{H+1}, and connects the new unit 111_{H+1} thereof to the ACHMM unit 111_{H} as the upper unit of the ACHMM unit 111_{H} which has be the uppermost level so far. Thus, a hierarchical HMM made up of H+1 ACHMM units 111₁ through 111_{H+1} is configured.

Subsequently, the processing returns from step S213 to step S212, and hereafter, the same processing is repeated.

Also, in the event that determination is made in step S212 that the output data has not been output from the ACHMM unit 111_{H} of the uppermost level, the processing returns to step S212.

As described above, with the unit generating processing, of the hierarchical ACHMM made up of the H ACHMM units 111₁ through 111_{H}, when an ACHMM unit not connected to an upper unit (hereafter, also referred to as “unconnected unit”), i.e., the ACHMM unit 111_{H} of the uppermost level outputs the output data, a new unit is generated. Subsequently, the new unit is taken as an upper unit, the unconnected unit is taken as a lower unit, the new unit and the unconnected unit are connected, and a hierarchical HMM made up of H+1 ACHMM units 111₁ through 111_{H+1} is configured.

As a result thereof, according to the unit generating processing, the number of hierarchical levels of a hierarchical ACHMM increases until it has reached a number suitable for the scale or configuration of a modeling object, and further, such as described in FIG. 45, the closer to the ACHMM unit 111ₕ of the upper level, the particle size (temporal space particle size) of the state of an HMM serving as a module is roughened, whereby a perceptual aliasing problem can be eliminated.

Note that the same initialization processing as with the processing in step S11 in FIG. 9 and step S61 in FIG. 17 is performed regarding the new unit, and an ACHMM is made up of a single module.

Also, with the output control unit 123, in the event of employing the first output control method (FIG. 43), the ACHMM of the ACHMM unit 111_{H} of the uppermost level that is an unconnected unit is configured of a single module (HMM), and also while the state s^{m}*_{L} of the recognition result information [m*, s^{m}*_{L}] to be obtained at the recognizing unit 132 of the ACHMM unit 111_{H} is in a specific single state, even when the output data is output from the ACHMM unit 111_{H} of the uppermost level, step S213 is skipped, and the ACHMM unit 111_{H+1} of the new uppermost level is not generated.

### Unit Learning Processing

FIG. 50 is a flowchart for describing processing (unit learning processing) to be performed by the ACHMM unit 111ₕ in FIG. 42.

In step S221, after awaiting that the output data serving as an observed value from the outside is supplied from the ACHMM unit 111ₕ₋₁ that is the lower unit of ACHMM unit 111ₕ (however, the observation time series buffer 12 (FIG. 40) in the event that the ACHMM unit 111ₕ is the ACHMM unit 111₁ of the lowermost level), the input control unit 121 of the ACHMM unit 111ₕ temporarily stores this in the input buffer 121A, and the processing proceeds to step S222.

In step S222, the input control unit 121 configures input data to be given to an ACHMM from the output data stored in the input buffer 121A by the first or second input control method, and supplies this to (the module learning unit 131 and recognizing unit 132 of) the ACHMM processing unit 122, and the processing proceeds to step S223.

In step S223, the module learning unit 131 of the ACHMM processing unit 122 determines whether or not an observed value (unobserved value) that has not been observed in an HMM that is a module of the ACHMM stored in the ACHMM storage unit 134 is included in the time series of an observed value serving as the input data from the input control unit 121.

In the event that determination is made in step S223 that an unobserved value is included in the input data, the processing proceeds to step S224, where the module learning unit 131 performs the expansion processing described in FIG. 48 to expand the observation probability matrix of the observation probability so as to include the observation probability of an unobserved value, and the processing proceeds to step S225.

Also, in the event that determination is made in step S223 that an unobserved value is not included in the input data, the processing skips step S224 to proceed to step S225, where the ACHMM processing unit 122 uses the input data from the input control unit 121 to perform the module learning processing, recognition processing, and transition information generating processing, and the processing proceeds to step S226.

Specifically, with the ACHMM processing unit 122, the module learning unit 131 uses the input data from the input control unit 121 to perform processing in step S16 and thereafter of the module learning processing in FIG. 9, or the processing in step S66 and thereafter in FIG. 17.

Subsequently, with the ACHMM processing unit 122, the recognizing unit 132 uses the input data from the input control unit 121 to perform the recognition processing in FIG. 21.

Subsequently, with the ACHMM processing unit 122, the transition information management unit 133 uses the recognition result information to be obtained as a result of the recognition processing performed using the input data at the recognizing unit 132 to perform the transition information generating processing in FIG. 24.

In step S226, the output control unit 123 temporarily stores the recognition result information to be obtained as a result of the recognition processing performed using the input data at the recognizing unit 132, in the output buffer 123A, and the processing proceeds to step S227.

In step S227, the output control unit 123 determines whether or not the output condition for the output data described in FIGS. 43 and 44 is satisfied.

In the event that determination is made in step S227 that the output condition for the output data is not satisfied, the processing skips step S228 to return to step S221.

Also, in the event that determination is made in step S227 that the output condition for the output data is satisfied, the processing proceeds to step S228, where the output control unit 123 takes the latest recognition result information stored in the output buffer 123A as output data, and outputs this to the ACHMM unit 111ₕ₊₁ that is the upper unit of the ACHMM unit 111ₕ, and the processing returns to step S221.

Configuration Example of the Agent to which the Learning Device has been Applied

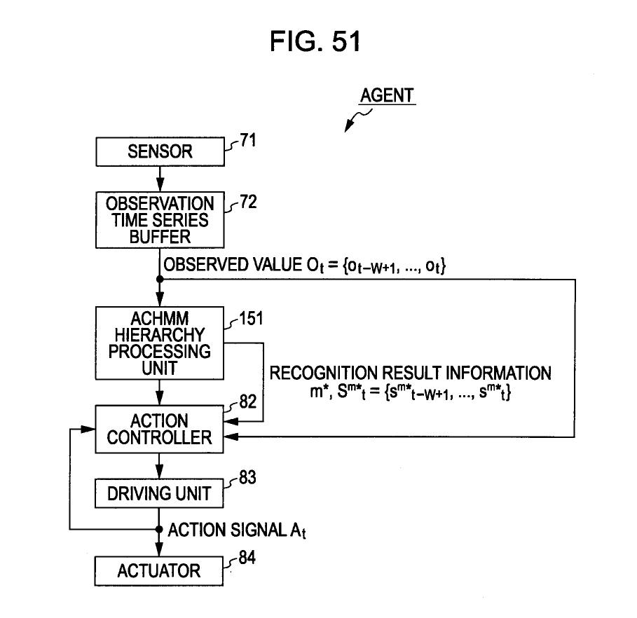

FIG. 51 is a block diagram illustrating a configuration example of an embodiment (second embodiment) of the agent to which the learning device in FIG. 40 has been applied.

Note that in the drawing, a portion corresponding to the case of FIG. 28 is appended with the same reference symbol, and hereafter, description thereof will be omitted as appropriate.

The agent in FIG. 51 is common to the case of FIG. 28 in that it includes a sensor 71, an observation time series buffer 72, an action controller 82, a driving unit 83, and an actuator 84.

However, the agent in FIG. 51 differs from the case of FIG. 28 in that it includes an ACHMM hierarchy processing unit 151 instead of the module learning unit 73 through the HMM configuration unit 77, and planning unit 81 in FIG. 28.

In FIG. 51, the ACHMM hierarchy processing unit 151 generates, in the same way as the ACHMM hierarchy processing unit 101 in FIG. 40, an ACHMM unit, connects this in a hierarchical structure, thereby configuring a hierarchical ACHMM.

However, the ACHMM unit generated by the ACHMM hierarchy processing unit 151 has a function for performing planning in addition to the functions of the ACHMM unit generated by the ACHMM hierarchy processing unit 101 in FIG. 40.

Note that in FIG. 51, the action controller 82 is provided separately from the ACHMM hierarchy processing unit 151, but the action controller 82 may be included in the ACHMM unit generated by the ACHMM hierarchy processing unit 151.

However, the action controller 82 performs learning of an action function for inputting an observed value to be observed at the sensor 71 to output an action signal regarding each state transition of the ACHMM unit of the lowermost level, and accordingly does not have to be provided to all the ACHMM units making up the hierarchical ACHMM, and may be provided to the ACHMM of the lowermost level alone.

Here, the agent in FIG. 28 performs an action for moving in accordance with a predetermined rule, performs ACHMM learning using the time series of an observed value to be observed at the sensor 71 at the movement destination of the motion environment that is a modeling object, and performs learning of the action function for inputting an observed value to output an action signal regarding each state transition.

Subsequently, the agent in FIG. 28 uses the combined HMM configured of the ACHMM after learning to obtain the maximum likelihood state series form the current state to the target state as a plan to get to the target state from the current state, and performs an action causing the state transition of the maximum likelihood state series serving as the plan thereof in accordance with the action function obtained at the time of ACHMM learning, thereby moving from the position corresponding to the current state to the position corresponding to the target state.

On the other hand, the agent in FIG. 51 also performs an action for moving in accordance with a predetermined rule, and with the ACHMM unit of the lowermost level, in the same way as with the agent in FIG. 28, the unit learning processing (FIG. 50) for performing ACHMM learning using the time series of an observed value to be observed at the sensor 71 is performed at the movement destination, and also learning of the action function for inputting an observed value to output an action signal is performed regarding each state transition of the ACHMM.

Further, with the agent in FIG. 51, with the ACHMM unit of a hierarchical level other than the lowermost level, input data that is time series data is configured from the recognition result information obtained at the lower unit, supplied as the output data from the lower unit thereof, and the unit learning processing (FIG. 50) for performing ACHMM learning is performed using the input data thereof as the time series of an observed value to be externally supplied.

Note that, with the agent in FIG. 51, while the unit learning processing is performed, a new unit is generated by the unit generating processing (FIG. 49) as appropriate.

Such as described above, with the agent in FIG. 51, the unit learning processing (FIG. 50) is performed at the ACHMM unit of each hierarchical level, and accordingly, the configuration of a more global motion environment is obtained in a self-organized manner at the ACHMM of the ACHMM unit of an upper hierarchical level, and the configuration of a more local motion environment is obtained in a self-organized manner at the ACHMM of the ACHMM unit of a lower hierarchical level, respectively.

Subsequently, with the agent in FIG. 51, after ACHMM learning of the ACHMM unit of each hierarchical level advances to some extent, when of the ACHMM units making up the hierarchical ACHMM, one state of the states of the ACHMM of the ACHMM unit of interest that is the ACHMM unit of a hierarchical level of interest is provided as the target state, with the ACHMM unit of interest, the maximum likelihood state series from the current state to the target state are obtained as a plan using the combined HMM made up of the ACHMM.

In the event that the ACHMM unit of interest is the ACHMM unit of the lowermost level, the agent in FIG. 51 performs, in the same way as with the agent in FIG. 28, an action causing the state transition of the maximum likelihood state series serving as a plan in accordance with the action function obtained at the time of ACHMM learning, thereby moving from the position corresponding to the current state to the position corresponding to the target state.

Also, in the event that the ACHMM unit of interest is the ACHMM unit of a hierarchical level other than the lowermost level, the agent in FIG. 51 references the observation probability of an observed value to be observed in the next state of the first state (current state) of the maximum likelihood state series serving as a plan to be obtained at the ACHMM unit of interest, takes the state of the ACHMM of the lower unit represented by an observed value of which the observation probability is equal to or greater than a predetermined threshold as a candidate of the target state at the lower unit (target state candidate), and with the lower unit, the maximum likelihood state series from the current state to the target state candidate is obtained as a plan.

Note that in the event that the type 1 recognition result information is employed as recognition result information, an observed value to be observed at the HMM that is a module of the ACHMM of the ACHMM unit of interest is the recognition result information [m*, s^{m}*_{L}] that is a set of the indexes of the maximum likelihood module #m* of the ACHMM of the lower unit of the ACHMM unit of interest, and the state s^{m}*_{L}, and accordingly, the state of the lower unit represented with such recognition result information [m*, s^{m}*_{L}] is the state s^{m}*_{L} of the module #m* of the ACHMM of the lower unit determined by the recognition result information [m*, s^{m}*_{L}].

Also, in the event that the type 2 recognition result information is employed as recognition result information, an observed value to be observed at the HMM that is a module of the ACHMM of the ACHMM unit of interest is the recognition result information [m*] that is the index of the maximum likelihood module #m* of the ACHMM of the lower unit of the ACHMM unit of interest. The state of the lower unit represented with such recognition result information [m*] is an arbitrary one, multiple states, or all the states of the module #m* of the ACHMM of the lower unit determined by the recognition result information [m*].

With the agent in FIG. 51, the same processing as with the lower unit of the ACHMM unit of interest is recursively performed at the ACHMM of a lower hierarchical level.

Further, with the ACHMM unit of the lowermost level, in the same way as with the agent in FIG. 28, a plan is obtained. Subsequently, the agent performs an action causing the state transition of the maximum likelihood state series serving as a plan in accordance with the action function obtained at the time of ACHMM learning, thereby moving from the position corresponding to the current state to the position corresponding to the target state.

That is to say, with the hierarchical ACHMM, the state transition of a plan obtained at the ACHMM unit of an upper hierarchical level is a global state transition, and accordingly, the agent in FIG. 51 propagates the plan obtained at the ACHMM unit of the upper hierarchical level to the ACHMM unit of the lower hierarchical level, and finally, performs movement causing the state transition of the plan obtained at the ACHMM unit of the lowermost level as an action.

### Configuration Example of ACHMM Unit

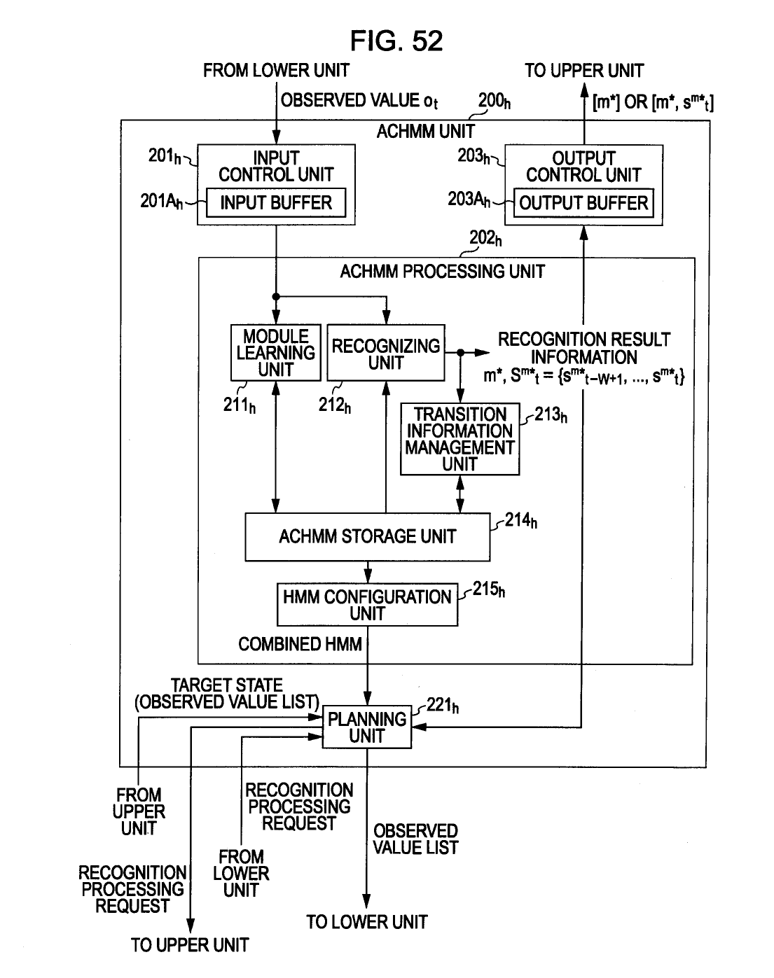

FIG. 52 is a block diagram illustrating a configuration example of an ACHMM unit 200ₕ of the h'th hierarchical level other than the lowermost level of ACHMM units 200 generated by the ACHMM hierarchy processing unit 151 in FIG. 51.

The ACHMM unit 200ₕ includes an input control unit 201ₕ, an ACHMM processing unit 202ₕ, an output control unit 203ₕ, and a planning unit 221ₕ.

The input control unit 201ₕ includes an input buffer 201Aₕ, and performs the same input control as with the input control unit 121 in FIG. 42.

The ACHMM processing unit 202ₕ includes a module learning unit 211ₕ, a recognizing unit 212ₕ, a transition information management unit 213ₕ, an ACHMM storage unit 214ₕ, and an HMM configuration unit 215ₕ.

The module learning unit 211ₕ through the HMM configuration unit 215ₕ are configured in the same way as the module learning unit 131 through the HMM configuration unit 135 in FIG. 42, and accordingly, the ACHMM processing unit 202ₕ performs the same processing as the ACHMM processing unit 122 in FIG. 42.

The output control unit 203ₕ includes an output buffer 203Aₕ, and performs the same output control as with the output control unit 123 in FIG. 42.

A recognition processing request for requesting recognition of the latest observed value is supplied from a lower unit 200ₕ₋₁ of the ACHMM unit 200ₕ to the planning unit 221ₕ.

Also, recognition result information [m*, s^{m}*ₜ] of the latest observed value is supplied from the recognizing unit 212ₕ to the planning unit 221ₕ, and a combined HMM is supplied from the HMM configuration unit 215ₕ to the planning unit 221ₕ.

Further, a list of observed values (observed value list) of which the observation probabilities are equal to or greater than a predetermined threshold of observed values to be observed in the upper unit 200ₕ₊₁, of the ACHMM unit 200ₕ through (the HMM that is a module of) the ACHMM of the upper unit 200ₕ₊₁ thereof, is supplied to the planning unit 221ₕ.

Here, the observed values of the observed value list to be supplied from the upper unit 200ₕ₊₁ are the recognition result information obtained at the ACHMM unit 200ₕ, and accordingly represent the state or module of the ACHMM of the ACHMM unit 200ₕ.

In the event that a recognition result request has been supplied from the lower unit 200ₕ₋₁, the planning unit 221ₕ demands recognition processing employing the input data O={o₁, o₂, . . . , o_{L}} including the latest observed value as the latest sample o_{L} from the recognizing unit 212ₕ.

Subsequently, the planning unit 221ₕ awaits the recognition result information [m*, s^{m}*_{L}] of the latest observed value being output by the recognizing unit 212ₕ performing the recognition processing, and receives the recognition result information [m*, s^{m}*_{L}] thereof.

Subsequently, the planning unit 221ₕ takes the states represented by the observed values, or all the states of modules represented by the observed values, of the observed value list from the upper unit 200ₕ₊₁ as target state candidates (the candidates of the target state in the hierarchical level (the h'th hierarchical level) of the ACHMM unit 200ₕ), and determines whether or not one of the one or more target state candidates matches the current state s^{m}*_{L} determined by the recognition result information [m*, s^{m}*_{L}] from the recognizing unit 212ₕ.

In the event that the current state s^{m}*_{L} and the target state candidates do not match, the planning unit 221ₕ obtains the maximum likelihood state series from the current state s^{m}*_{L} determined by the recognition result information [m*, s^{m}*_{L}] from the recognizing unit 212ₕ to the target state candidate regarding each of the one or more target state candidates.

Subsequently, the planning unit 221ₕ selects, of the maximum likelihood state series regarding each of the one or more target state candidates, for example, the maximum likelihood state series of which the number of states is the minimum as a plan.

Further, the planning unit 221ₕ generates an observed value list of one or more observed values of which the observation probabilities are equal to or greater than a threshold, of the observed values to be observed in the next state of the current state, and supplies this to the lower unit 200ₕ₋₁ of the ACHMM unit 200ₕ.

Also, in the event that the current state s^{m}*_{L}, and the target state candidates match, the planning unit 221ₕ supplies a recognition processing request to the upper unit 200ₕ₊₁ of the ACHMM unit 200ₕ.

Note that the target state (candidate) may not be provided from the upper unit 200ₕ₊₁ of the ACHMM unit 200ₕ to the planning unit 221ₕ in a form of the observed list, but in the same way as the target state being provided to the planning unit 81 of the agent in FIG. 28, an arbitrary single state of the ACHMM of the ACHMM unit 200ₕ may be provided to the planning unit 221ₕ as the target state by specification of the target state from the outside, or by setting of the target state by a motivation system.

Now, if we say that the target state to be provided to the planning unit 221ₕ in this way will be referred to as an external target state, in the event of the external target state being provided, the planning unit 221ₕ performs the same processing with the external target state as the target state candidate.

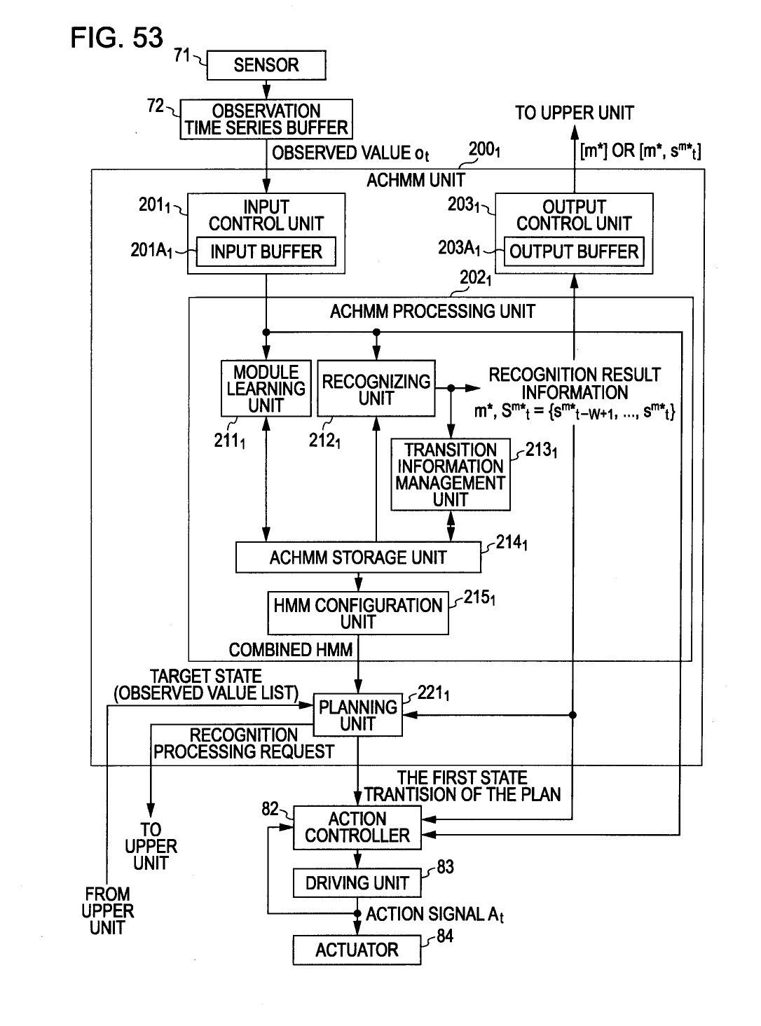

FIG. 53 is a block diagram illustrating a configuration example of the ACHMM unit 200₁ of the lowermost level, of the ACHMM units 200 to be generated by the ACHMM hierarchy processing unit 151 in FIG. 51.

The ACHMM unit 200₁ includes, in the same way as the ACHMM unit 200ₕ of a hierarchical level other than the lowermost level, an input control unit 201₁, an ACHMM processing unit 202₁, an output control unit 203₁, and a planning unit 221₁.

However, there is no lower unit of the ACHMM unit 200₁, and accordingly, with the planning unit 221₁, no recognition processing request is supplied from a lower unit, and no observed value list is generated to be supplied to the lower unit.

Instead, the planning unit 221₁ supplies a state transition from the first state (current state) of the plan to the next state to the action controller 82.

Also, with the ACHMM unit 200₁ of the lowermost level, the recognition result information to be output from the recognizing unit 212₁, and the latest observed value of the time series of the observed value of the sensor 71, serving as the input data that the input control unit 201₁ supplies to the ACHMM processing unit 202₁, are supplied to the action controller 82.

### Action Control Processing

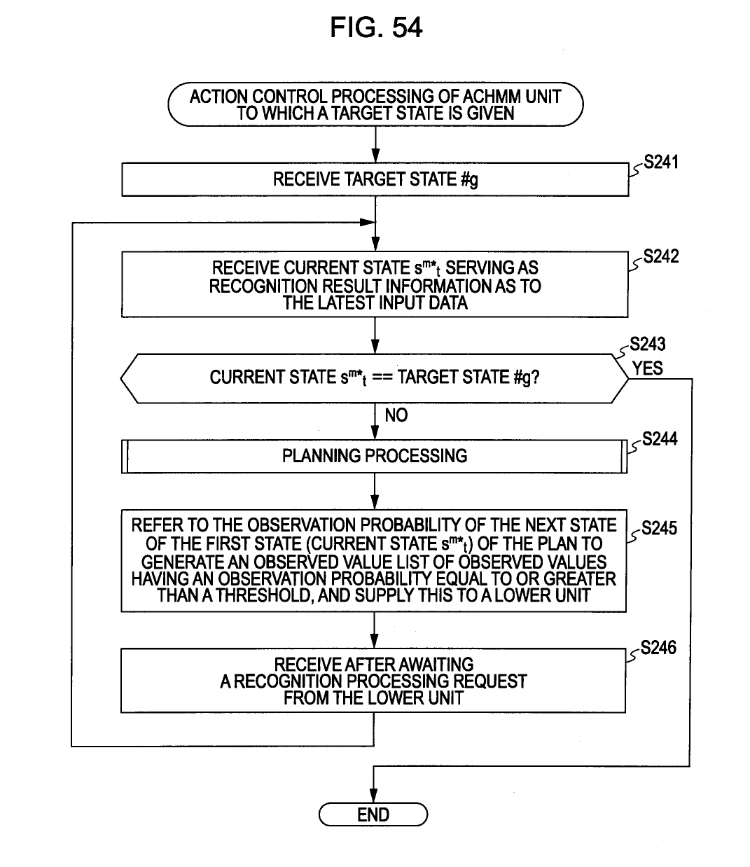

FIG. 54 is a flowchart for describing, in the event that the external target state has been provided to the ACHMM unit 200ₕ of the h'th hierarchical level in FIG. 52, action control processing for controlling the agent's action, to be performed by the planning unit 221ₕ of the ACHMM unit (hereafter, also referred to as “target state specifying unit”) 200ₕ thereof.

Note that in the event that the external target state has been provided to the ACHMM unit 200₁ of the lowermost level, the same processing as with the agent in FIG. 28 is performed, and accordingly, now, let us say that the target state specifying unit 200ₕ is the ACHMM unit of a hierarchical level other than the lowermost level.

Also, let us say that, with the agent in FIG. 51, the unit learning processing (FIG. 50) by the ACHMM unit 200ₕ of each hierarchical level advances to some extent, and learning of the action function by the action controller 82 has already been finished.

In step S241, the planning unit 221ₕ awaits one of the states of the ACHMM of the target state specifying unit 200ₕ being provided as an external target state #g, receives the external target state #g thereof, demands the recognition processing from the recognizing unit 212ₕ, and the processing proceeds to step S242.

In step S242, after awaiting that the recognizing unit 212ₕ outputs recognition result information to be obtained by performing the recognition processing employing the latest input data to be supplied from the input control unit 201ₕ, the planning unit 221ₕ receives the recognition result information thereof, and the processing proceeds to step S243.

In step S243, the planning unit 221ₕ determines whether or not the current state (the last state of the maximum likelihood state series where the input data is observed with the HMM that is the maximum likelihood module) to be determined from the recognition result information from the recognizing unit 212ₕ, and the external target state #g match.

In the event that determination is made in step S243 that the current state and the external target state #g do not match, the processing proceeds to step S244, where the planning unit 221ₕ performs the planning processing.

Specifically, in step S244, the planning unit 221ₕ obtains state series (the maximum likelihood state series) of which the likelihood of a state transition from the current state to the target state #g is the maximum with the combined HMM to be supplied from the HMM configuration unit 215ₕ in the same way as with the case in FIG. 31, as a plan to get to the target state #g from the current state.

Note that in FIG. 31, in the event that the length of the maximum likelihood state series from the current state to the target state #g is equal to or greater than a threshold, the maximum likelihood state series serving as a plan is determined to have not been obtained, but with the planning processing to be performed by the agent in FIG. 51, in order to simplify description, let us say that the maximum likelihood state series have to be obtained by employing a sufficient great value as the threshold.

Subsequently, the processing proceeds from step S244 to step S245, where the planning unit 221ₕ generates an observed value list of one or more observed values of which the observation probabilities are equal to or greater than the threshold, of the observed values to be observed in the next state by referencing the observation probability of the first state in the plan, i.e., the next state of the current state, and supplies this to (the planning unit 221ₕ₋₁ of) the lower unit 200ₕ₋₁ of the target state specifying unit 200ₕ.

Here, the observed value to be observed in the state of (the HMM that is a module of) the ACHMM of the target state specifying unit 200ₕ is recognition results information obtained at the lower unit 200ₕ₋₁ of the target state specifying unit 200ₕ thereof, and accordingly is an index representing the state or module of the ACHMM of the lower unit 200ₕ₋₁.

Also, as for the threshold of observed values to be used for generation of an observed value list, for example, a fixed threshold may be employed. Further, the threshold of observed values may adaptively be set so that the observation probabilities of a predetermined number of observed values are equal to greater than the threshold.

After the planning unit 221ₕ supplies the observed value list to the lower unit 200ₕ₋₁ in step S245, the processing proceeds to step S246, where the planning unit 221ₕ awaits a recognition processing request being supplied from (the planning unit 221ₕ₋₁ of) the lower unit 200ₕ₋₁, and receives this.

Subsequently, the planning unit 221ₕ demands the recognition processing employing the input data O={o₁, o₂, . . . , o_{L}} including the latest observed value as the latest sample o_{L} from the recognizing unit 212ₕ in accordance with the recognition processing request from the lower unit 200ₕ₋₁.

Subsequently, the processing returns from step S246 to step S242, where after awaiting that the recognizing unit 212ₕ outputs the recognition result information of the latest observed value by performing the recognition processing employing the latest input data to be supplied from the input control unit 201ₕ, and the planning unit 221ₕ receives the recognition result information thereof, and hereafter, the same processing is repeated.

Subsequently, in the event that determination is made in step S243 that the current state and the external target state #g match, i.e., in the event that the agent has moved within the motion environment, and has got to the position corresponding to the external target state #g, the processing ends.

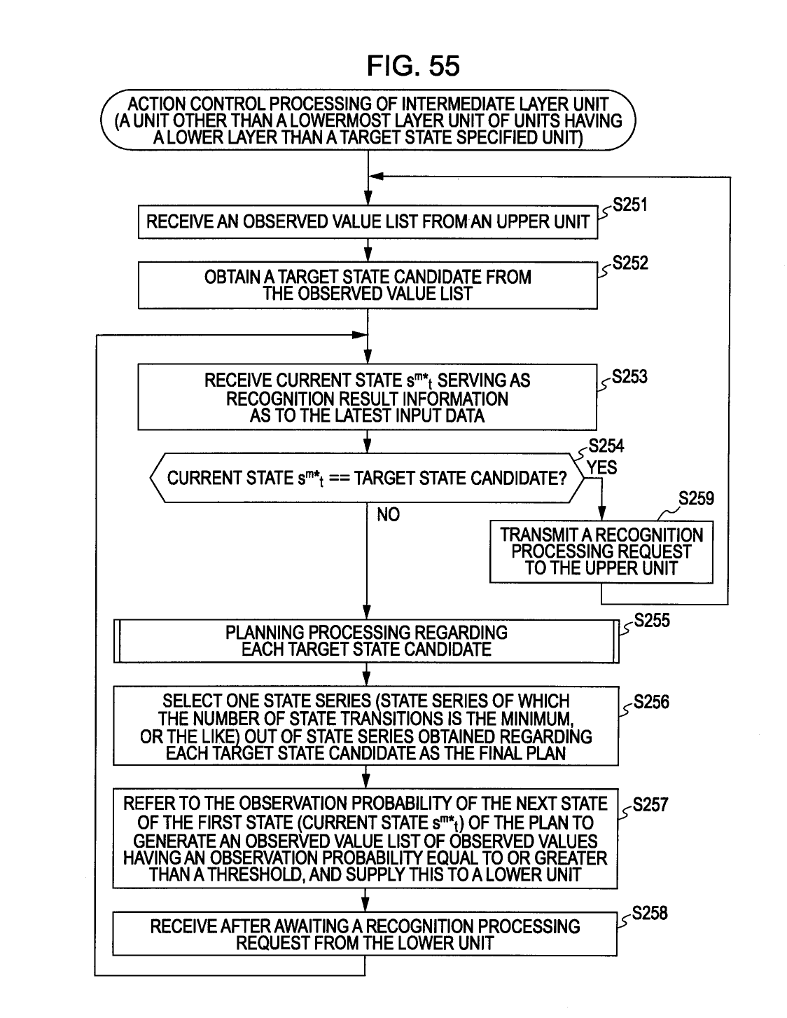

FIG. 55 is a flowchart for describing action control processing for controlling the agent's action, to be performed by the planning unit 221ₕ of the ACHMM unit (hereafter, also referred to as “intermediate layer unit”) 200ₕ (FIG. 52) other than the ACHMM unit 200₁ of the lowermost layer, of the ACHMM units of a lower hierarchical level than the target state specifying unit.

In step S251, the planning unit 221ₕ awaits and receives the observed value list being supplied from (the planning unit 221ₕ₊₁ of) the upper unit 200ₕ₊₁ of the intermediate unit 200ₕ, and the processing proceeds to step S252.

In step S252, the planning unit 221ₕ obtains a target state candidate from the observed value list from the upper unit 200ₕ₊₁.

Specifically, the observed values of the observed value list to be supplied from the upper unit 200ₕ₊₁ are indexes representing the state or module of the ACHMM of the intermediate layer unit 200ₕ, and the planning unit 221ₕ takes all the states of the HMM that is the state or module of the ACHMM of the intermediate layer unit 200ₕ represented with each of the indexes that are one or more observed values of the observed value list, as target state candidates.

After the one or more target state candidates are obtained in step S252, the planning unit 221ₕ demands the recognition processing from the recognizing unit 212ₕ, and the processing proceeds to step S253. In step S253, after awaiting that the recognizing unit 212ₕ outputs the recognition result information to be obtained by performing the recognition processing employing the latest input data to be supplied from the input control unit 201ₕ, the planning unit 221ₕ receives the recognition result information thereof, and the processing proceeds to step S254.

In step S254, the planning unit 221ₕ determines whether or not the current state (the last state of the maximum likelihood state series where the input data may be observed with the HMM that is the maximum likelihood module) to be determined from the recognition result information from the recognizing unit 212ₕ, and one of the one or more target state candidates match.

In the event that determination is made in step S254 that the current state does not match any of the one or more target state candidates, the processing proceeds to step S255, where the planning unit 221ₕ performs the planning processing regarding each of the one or more target state candidates.

Specifically, in step S255, the planning unit 221ₕ obtains state series (the maximum likelihood state series) of which the likelihood of a state transition from the current state to the target state candidate is the maximum with the combined HMM to be supplied from the HMM configuration unit 215ₕ in the same way as with the case in FIG. 31 regarding each of the one or more target state candidates.

Subsequently, the processing proceeds from step S255 to step S256, where the planning unit 221ₕ selects, of the maximum likelihood state series obtained regarding the one or more target state candidates, for example, single maximum likelihood state series of the which the number of states is the minimum as a final plan, and the processing proceeds to step S257.

In step S257, the planning unit 221ₕ generates an observed value list of one or more observed values of which the observation probabilities are equal to or greater than a threshold, of observed values to be observed in the next state by referencing the observation probability of the next state of the first state (current state) in the plan, and supplies this to (the planning unit 221ₕ₋₁ of) the lower unit 200ₕ₋₁ of the intermediate layer unit 200ₕ.

Here, the observed value to be observed in the state of (the HMM that is a module of) the ACHMM of the intermediate layer unit 200ₕ is recognition results information obtained at the lower unit 200ₕ₋₁ of the intermediate layer unit 200ₕ thereof, and accordingly is an index representing the state or module of the ACHMM of the lower unit 200ₕ₋₁.

After the planning unit 221ₕ supplies the observed value list to the lower unit 200ₕ₋₁, the processing proceeds to step S258, where the planning unit 221ₕ awaits and receives a recognition processing request being supplied from (the planning unit 221ₕ₋₁ of) the lower unit 200ₕ₋₁.

Subsequently, the planning unit 221ₕ demands the recognition processing employing the input data including the latest observed value as the latest sample from the recognizing unit 212ₕ in accordance with the recognition processing request from the lower unit 200ₕ₋₁.

Subsequently, the processing returns from step S258 to step S253, where after awaiting that the recognizing unit 212ₕ outputs the recognition result information of the latest observed value by performing the recognition processing employing the latest input data to be supplied from the input control unit 201ₕ, and the planning unit 221ₕ receives the recognition result information thereof, and hereafter, the same processing is repeated.

Subsequently, in the event that determination is made in step S254 that the current state matches one of the one or more target state candidates, i.e., in the event that the agent has moved within the motion environment, and has got to the position corresponding to one of the one or more target state candidates, the processing proceeds to step S259, where the planning unit 221ₕ supplies (transmits) a recognition processing request to (the planning unit 221ₕ₊₁ of) the upper unit 200ₕ₊₁ of the intermediate layer unit 200ₕ.

Subsequently, the processing returns from step S259 to step S251, where, as described above, the planning unit 221ₕ awaits and receives the observed value list being supplied from the upper unit 200ₕ₊₁ of the intermediate layer unit 200ₕ, and hereafter, the same processing is repeated.

Note that the action control processing of the intermediate layer unit 200ₕ ends in the event that the action control processing (FIG. 54) of the target state specifying unit ends (in the event that determination is made in step S243 in FIG. 54 that the current state and the external target state #g match).

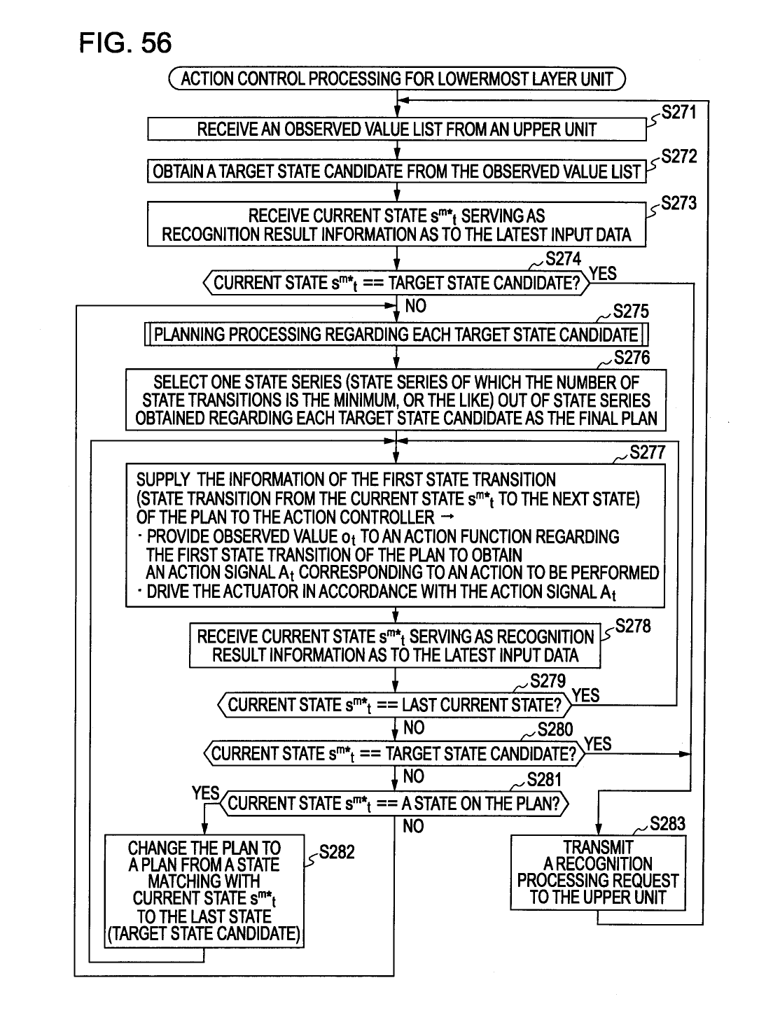

FIG. 56 is a flowchart for describing action control processing for controlling the agent's action, to be performed by the planning unit 221₁ of the lowermost layer ACHMM unit (hereafter, also referred to as “lowermost layer unit”) 200₁ (FIG. 53).

With the lowermost layer unit 200₁, in steps S271 through S276, the same processing as steps S251 through S256 in FIG. 55 is performed, respectively.

Specifically, in step S271, the planning unit 221₁ awaits and receives the observed value list being supplied from (the planning unit 221₂ of) the upper unit 200₂ of the lowermost layer unit 200₁, and the processing proceeds to step S272.

In step S272, the planning unit 221₁ obtains a target state candidate from the observed value list from the upper unit 200₂.

Specifically, the observed values of the observed value list to be supplied from the upper unit 200₂ are indexes representing the state or module of the ACHMM of the lowermost layer unit 200₁, and the planning unit 221₁ takes all the states of the HMM that is the state or module of the ACHMM of the lowermost layer unit 200₁ represented with each of the indexes that are one or more observed values of the observed value list, as target state candidates.

After the one or more target state candidates are obtained in step S272, the planning unit 221₁ demands the recognition processing from the recognizing unit 212₁, and the processing proceeds to step S273. In step S273, after awaiting that the recognizing unit 212₁ outputs the recognition result information to be obtained by performing the recognition processing employing the latest input data (the time series of an observed value to be observed at the sensor 71) to be supplied from the input control unit 201₁, the planning unit 221₁ receives the recognition result information thereof, and the processing proceeds to step S274.

In step S274, the planning unit 221₁ determines whether or not the current state to be determined from the recognition result information from the recognizing unit 212₁, and one of the one or more target state candidates match.

In the event that determination is made in step S274 that the current state does not match any of the one or more target state candidates, the processing proceeds to step S275, where the planning unit 221₁ performs the planning processing regarding each of the one or more target state candidates.

Specifically, in step S275, the planning unit 221₁ obtains the maximum likelihood state series from the current state to the target state candidate with the combined HMM to be supplied from the HMM configuration unit 215₁ in the same way as with the case in FIG. 31 regarding each of the one or more target state candidates.

Subsequently, the processing proceeds from step S275 to step S276, where the planning unit 221₁ selects, of the maximum likelihood state series obtained regarding the one or more target state candidates, for example, single maximum likelihood state series of the which the number of states is the minimum as a final plan, and the processing proceeds to step S277.

In step S277, the planning unit 221₁ supplies information (state transition information) representing the first state transition of the plan, i.e., a state transition from the current state to the next state thereof in the plan to the action controller 82 (FIGS. 51 and 53), and the processing proceeds to step S278.

Here, the planning unit 221₁ supplies the state transition information to the action controller 82, whereby the action controller 82 providing the latest observed value (the observed value at the current point-in-time) to be supplied from the input control unit 201 to the action function regarding the state transition represented by the state transition information from the planning unit 221₁ as input, thereby obtaining the action signal to be output from the action function as the action signal of an action to be performed by the agent.

Subsequently, the action controller 82 supplies the action signal thereof to the driving unit 83. The driving unit 83 supplies the action signal from the action controller 82 to the actuator 84, thereby driving the actuator 84, and thus, the agent performs, for example, an action for moving within the motion environment.

As described above, after the agent moves within the motion environment, in step S278, at the position after movement, the recognizing unit 212₁ performs the recognition processing employing the input data including the observed value (the latest observed value) to be observed at the sensor 71 as the latest sample. After awaiting that recognition result information to be obtained by the recognition processing is output, the planning unit 221₁ receives the recognition result information to be output from the recognizing unit 212₁, and the processing proceeds to step S279.

In step S279, the planning unit 221₁ determines whether or not the current state to be determined from the recognition result information (the recognition result information received in immediately previous step S278) from the recognizing unit 212₁ matches the last current state that was the current state one point-in-time ago.

In the event that determination is made in step S279 that the current state matches the last current state, i.e., in the event that the current state corresponding to the position after the agent has moved, and the last current state corresponding to the position before the agent has moved are the same state, and a state transition has not occurred at the ACHMM of the ACHMM unit of the lowermost level due to the movement of the agent, the processing returns to step S277, and hereafter, the same processing is repeated.

Also, in the event that determination is made in step S279 that the current state does not match the last current state, i.e., in the event that a state transition has occurred at the ACHMM of the ACHMM unit of the lowermost level due to the movement of the agent, the processing proceeds to step S280, where the planning unit 221₁ determines whether or not the current state to be determined from the recognition result information from the recognizing unit 212₁ matches one of the one or more target state candidates.

In the event that determination is made in step S280 that the current state does not match any of the one or more target state candidates, the processing proceeds to step S281, where the planning unit 221₁ determines whether or not the current state matches one of the states on (the state series serving as) the plan.

In the event that determination is made in step S281 that the current state matches one of the states on the plan, i.e., in the event that the agent is located in the position corresponding to one state of the state series serving as the plan, the processing proceeds to step S282, where the planning unit 221₁ changes the plan to state series from the state matching the current state (the state matching the current state, first appears from the first state toward the final state of the plan) to the final state of the plan, of the states on the plan, and the processing returns to step S277.

In this case, the processing in step S277 and thereafter is performed using the changed plan.

Also, in the event that determination is made in step S281 that the current state does not match any of the states on the plan, i.e., in the event that the agent is not located in the position corresponding to any state of the state series serving as the plan, the processing returns to step S275, and hereafter, the same processing is repeated.

In this case, regarding each of the one or more target state candidates, the maximum likelihood state series from the new current state (the current state to be determined from the recognition result information received in immediately previous step S278) to the target state are obtained (step S275), one of the maximum likelihood state series is selected from the maximum likelihood state series regarding each of the one or more target state candidates as a plan (step S276), thereby performing recreation of the plan, and hereafter, the same processing is performed using the plan thereof.

On the other hand, in the event that determination is made in step S274 or step S280 that the current state matches one of the one or more target state candidates, i.e., in the event that the agent has moved within the motion environment, and has got to the position corresponding to one of the one or more target state candidates, the processing proceeds to step S283, where the planning unit 221₁ supplies (transmits) a recognition processing request to (the planning unit 221₂ of) the upper unit 200₂ of the lowermost layer unit 200₁.

Subsequently, the processing returns from step S283 to step S271, where, as described above, the planning unit 221₁ awaits and receives the observed value list being supplied from the upper unit 200₂ of the lowermost layer unit 200₁, and hereafter, the same processing is repeated.

Note that the action control processing of the lowermost layer unit 200₁ ends, in the same way as with the action control processing of the intermediate layer unit, in the event that the action control processing (FIG. 54) of the target state specifying unit ends (in the event that determination is made in step S243 in FIG. 54 that the current state and the external target state #g match).

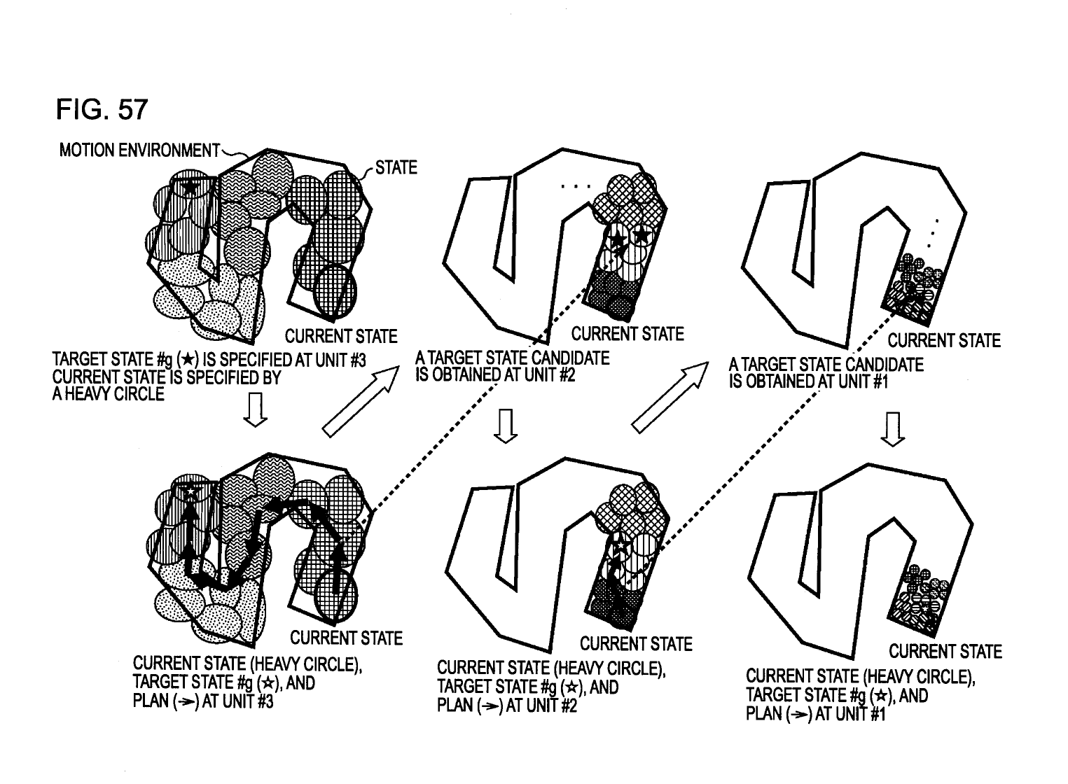

FIG. 57 is a diagram schematically illustrating the ACHMM of each hierarchical level in the case that the hierarchical ACHMM is configured of the ACHMM units #1, #2, and #3 of three hierarchical levels.

In FIG. 57, ellipses represent a state of an ACHMM. Also, great ellipses represent a state of the ACHMM of the ACHMM unit #3 of the third hierarchical level (uppermost level), medium ellipses represent a state of the ACHMM of the ACHMM unit #2 of the second hierarchical level, and small ellipses represent a state of the ACHMM of the ACHMM unit #1 of the first hierarchical level (lowermost level), respectively.

FIG. 57 illustrates a state of the ACHMM of each hierarchical level in the corresponding position of the motion environment where the agent moves.

For example, in the event that a certain state of the ACHMM of the third hierarchical level (illustrated with a star mark in the drawing) is provided to the ACHMM unit #3 as the external target state #g, with the ACHMM unit #3, the current state is obtained by the recognition processing, and with (the combined HMM configured of) the ACHMM of the third hierarchical level, the maximum likelihood state series from the current state to the external target state #g are obtained as a plan (illustrated with an arrow in the drawing).

Subsequently, the ACHMM unit #3 generates an observed value list of observed values of which the observation probabilities are equal to or greater than a predetermined threshold, of the observed values to be observed in the next state of the first state of the plan, and supplies this to the ACHMM unit #2 that is the lower unit.

With the ACHMM unit #2, the current state is obtained by the recognition processing, and on the other hand, from an index representing the state (or module) of the ACHMM of the second hierarchical level, that is an observed value of the observed value list from the ACHMM unit #3 which is the upper unit, the state represented by the index thereof (illustrated with a star mark in the drawing) is obtained as a target state candidate, and regarding each of the one or more target state candidates, the maximum likelihood state series from the current state to the target state candidate are obtained at (the combined HMM configured of) the ACHMM of the second hierarchical level.

Further, with the ACHMM unit #2, of the maximum likelihood state series regarding each of the one or more target state candidates, the maximum likelihood state series of which the number of states is the minimum (illustrated with an arrow in the drawing) is selected as a plan.

Subsequently, with the ACHMM unit #2, of the observed values to be observed in the next state of the first state of the plan, an observed value list of observed values of which the observation probabilities are equal to or greater than a predetermined threshold is generated, and is supplied to the ACHMM unit #1 which is the lower unit.

With the ACHMM unit #1 as well, in the same way as with the ACHMM unit #2, the current state is obtained by the recognition processing, and on the other hand, one or more target state candidates (illustrated with a star mark in the drawing) are obtained from the observed values of the observed value list from the ACHMM unit #2 which is the upper unit, and regarding each of the one or more target state candidates, the maximum likelihood state series from the current state to the target state candidate are obtained at (the combined HMM configured of) the ACHMM of the first hierarchical level.

Further, with the ACHMM unit #1, of the maximum likelihood state series regarding each of the one or more target state candidates, the maximum likelihood state series of which the number of states is the minimum (illustrated with an arrow in the drawing) are selected as a plan.

Subsequently, with the ACHMM unit #1, state transition information representing the first state transition of the plan is supplied to the action controller 82 (FIG. 51), and thus, the agent moves so that the first state transition of the plan obtained at the ACHMM unit #1 occurs at the ACHMM of the first hierarchical level.

Subsequently, the agent moves to the position corresponding to one of the one or more target state candidates of the ACHMM of the first hierarchical level, and in the event that the state of one of the one or more target state candidates has become the current state, the ACHMM unit #1 supplies a recognition processing request to the ACHMM unit #2 which is the upper unit.

With the ACHMM unit #2, in response to the recognition processing request from the ACHMM unit #1 which is the lower unit, the recognition processing is performed, and the current state is newly demanded.

Further, with the ACHMM unit #2, regarding each of the one or more target state candidates obtained from the observed values of the observed value list from the ACHMM unit #3 which is the upper unit, the maximum likelihood state series from the current state to the target state candidate are obtained at the ACHMM of the second hierarchical level.

Subsequently, with the ACHMM unit #2, of the maximum likelihood state series regarding each of the one or more target state candidates, the maximum likelihood state series of which the number of states is the minimum are selected as a plan, and hereafter, the same processing is repeated.

Subsequently, with the ACHMM unit #2, in the event that the current state to be obtained by the recognition processing to be performed according to the recognition processing request from the ACHMM unit #1 which is the lower unit matches one of the one or more target state candidates to be obtained from the observed values of the observed value list from the ACHMM unit #3 which is the upper unit, the ACHMM unit #2 supplies a recognition processing request to the ACHMM unit #3 which is the upper unit.

With the ACHMM unit #3, the recognition processing is performed to newly obtain the current state in response to the recognition processing request from the ACHMM unit #2 which is the lower unit.

Further, with the ACHMM unit #3, the maximum likelihood state series from the current state to the external target state #g are obtained as a plan at the ACHMM of the third hierarchical level, and hereafter, the same processing is repeated.

Subsequently, with the ACHMM unit #3, in the event that the current state to be obtained by the recognition processing to be performed according to the recognition processing request from the ACHMM unit #2 which is the lower unit matches the external target state #g, the ACHMM unit #1 through #3 end the processing.

In this way, the agent can move to the position corresponding to the external target state #g within the motion environment.

As described above, with the agent in FIG. 51, state transition control is performed after a state transition plan for realizing the target state at an arbitrary hierarchical level is spread out to the lowermost level in order, whereby the agent can obtain an autonomous environment model and an arbitrary state realizing capability.

### Third Embodiment

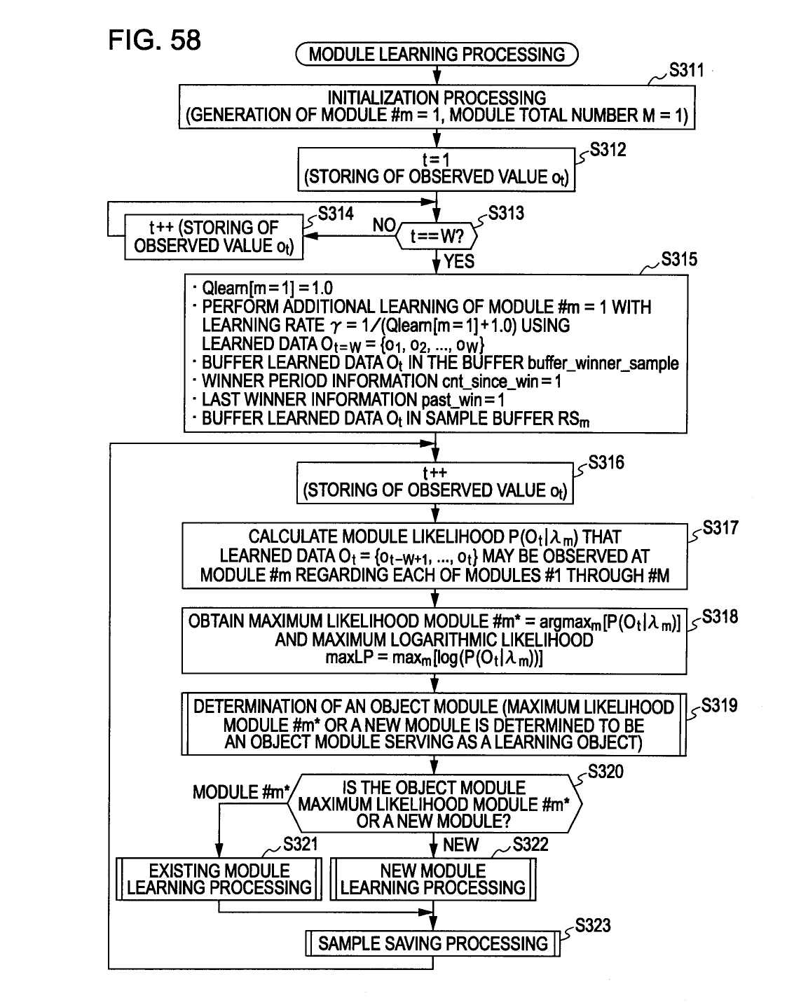

FIG. 58 is a flowchart for describing another example of the module learning processing to be performed by the module learning unit 13 in FIG. 8.

Note that, with the module learning processing in FIG. 58, the variable window learning described in FIG. 17 is performed, but the fixed window learning described in FIG. 9 may also be performed.

With the module learning processing in FIGS. 9 and 17, such as described in FIG. 10, according to magnitude correlation between the most logarithmic likelihood maxLP that is the logarithmic likelihood of the maximum likelihood module #m*, and the predetermined threshold likelihood TH, the maximum likelihood module #m* or a new module is determined to be the object module.

Specifically, in the event that the most logarithmic likelihood maxLP is equal to or greater than the threshold likelihood TH, the maximum likelihood module #m* becomes the object module, and in the event that the most logarithmic likelihood maxLP is smaller than the threshold likelihood TH, a new module is determined to be the object module.

However, in the event that the object module is determined according to the magnitude correlation between the most logarithmic likelihood maxLP and the threshold likelihood TH, in reality, even when it is better for obtaining an excellent ACHMM (e.g., ACHMM having a higher possibility that correct recognition result information may be obtained at the recognizing unit 14 (FIG. 1)) as the entire ACHMM to perform the additional learning of the maximum likelihood module #m* with the maximum likelihood module #m* as the object module, in the event that the most logarithmic likelihood maxLP is less than the threshold likelihood TH even if only slightly, the additional learning of the new module is performed with the new module as the object module.

Similarly, in reality, even when it is better for obtaining an excellent ACHMM as the entire ACHMM to perform the additional learning of the new module with the new module as the object module, in the event that the most logarithmic likelihood maxLP matches the threshold likelihood TH, or greater than the threshold likelihood TH even if only slightly, the additional learning of the maximum likelihood module #m* is performed with the maximum likelihood module #m* as the object module.

Therefore, with the third embodiment, the object module determining unit 22 (FIG. 8) determines the object module based on a posterior probability to be obtained by Bayes estimation, of the ACHMM in each case of a case where the additional learning of the maximum likelihood module #m* has been performed, and a case where the additional learning of the new module has been performed.

Specifically, the object module determining unit 22 calculates, for example, the improvement amount of the posterior probability of the ACHMM after the new module learning processing which is an ACHMM to be obtained in the case that the additional learning of the new module has been performed, as to the posterior probability of the ACHMM after the existing module learning processing which is an ACHMM to be obtained in the case that the additional learning of the maximum likelihood module #m* has been performed, and based on the improvement amount thereof, determines the maximum likelihood module or new module to be the object module.

In this way, according to the object module being determined based on the improvement amount of the posterior probability of the ACHMM, the new module is added to the ACHMM in a logical and flexible (adaptive) manner, whereby the ACHMM made up of a suitable number of modules as to a modeling object can be obtained, as compared to the case of determining the object module according to the magnitude correlation between the most logarithmic likelihood maxLP and the threshold likelihood TH. As a result thereof, the excellent ACHMM can be obtained.

Here, with the HMM learning, as described above, with an HMM defined by the HMM parameters λ, the HMM parameters λ are estimated so as to maximize the likelihood P(O|λ) that the time series data O that is learned data may be observed. As for estimation of the HMM parameters λ, in general, the Baum-Welch reestimation method employing the EM algorithm is employed.

Also, with regard to estimation of the HMM parameters λ, for example, a method for improving the precision of an HMM by estimating the HMM parameters λ so as to maximize the posterior likelihood P(O|λ) that the HMM where the learned data O has been observed may be the HMM defined by the HMM parameters λ is described in Brand, M. E., “Pattern Discovery via Entropy Minimization”, Uncertainty 99: International Workshop on Artificial Intelligence and Statistics, January 1999.

With the method for estimating the HMM parameters λ so as to maximize the posterior likelihood P(λ|O) of the HMM, the HMM parameters λ are estimated so as to maximize the posterior likelihood P(λ|O)=P(O|λ)×P(λ)/P(O) of the HMM by paying attention on that an entropy H(λ) defined from the HMM parameters λ, is introduced, and a priori probability P(λ) that is the HMM defined by the HMM parameters λ, has a relation proportional to exp(−H(λ)) (exp( ) represents an exponential function of which the base is a Napier's constant).

Note that the entropy H(λ) defined from the HMM parameters λ, is a scale for measuring compactness of the configuration of an HMM, i.e., a scale for measuring a more structural degree wherein there is little expressional ambiguity, the nature is closer to deterministic distinction, i.e., with the recognition result as to input of any observation time series as well, the likelihood of the maximum likelihood state dominantly increases as compared to the likelihood of the other states.

With the third embodiment, along the lines of the method for estimating the HMM parameters λ so as to maximize the posterior likelihood P(λ|O) of the HMM, an ACHMM entropy H(θ) defined by the model parameter θ is introduced, and an ACHMM logarithmic a priori probability log(P(θ)) is defined by Expression log(P(θ))=−prior_balance×H(θ) using a proportional constant prior_balance.

Further, with the third embodiment, with the ACHMM to be defined by the model parameter θ, as for a likelihood P(O|θ) that the time series data O may be observed, for example, the likelihood P(O|λ_{m*})=maxₘ [P(O|λₘ)] of the maximum likelihood module #m* that is a single module of the ACHMM is employed.

As described above, the ACHMM logarithmic a priori probability log(P(θ)), and the likelihood P(O|θ) are defined, whereby the posterior probability P(θ|O) of the ACHMM can be represented with P(θ|O)=P(O|θ)×P(θ)/P(O) based on Bayes estimation using the probability P(O) that the time series data O may occur.

With the third embodiment, the object module determining unit 22 (FIG. 8) determines the maximum likelihood module or the new module to be the object module based on the posterior probability of the ACHMM in a case where the additional learning of the maximum likelihood module #m* has been performed, and the posterior probability of the ACHMM in a case where the additional learning of the new module has been performed.

Specifically, with the object module determining unit 22, for example, in the event that the posterior probability of the ACHMM after the new module learning processing to be obtained in the case of having performed the additional learning of the new module is improved as to the posterior probability of the ACHMM after the existing module learning processing to be obtained in the case of having performed the additional learning of the maximum likelihood module #m*, the new module is determined to be the object module, and the additional learning of the new module serving as the object module thereof is performed.

Also, in the event that the posterior probability of the ACHMM after the new module learning processing is not improved, the maximum likelihood module #m* is determined to be the object module, and the additional learning of the maximum likelihood module #m* serving as the object module thereof is performed.

As described above, according to the object module being determined based on the posterior probability of the ACHMM, the new module is added to the ACHMM in a logical and flexible (adaptive) manner, as a result thereof, generation of a new module can be prevented from being performed too much or too little as compared to the case of determining the object module based on the magnitude correlation between the most logarithmic likelihood maxLP and the threshold likelihood TH.

### Module Learning Processing

FIG. 58 is a flowchart for describing the module learning processing for performing ACHMM learning while determining the object module based on the ACHMM posterior probability such as described above.

With the module learning processing in FIG. 58, in steps S311 through 5322, generally the same processing is performed as steps S61 through S72 of the module learning processing in FIG. 17, respectively.

However, with the module learning processing in FIG. 58, in step S315, the same processing as with step S65 in FIG. 17 is performed, and also the learned data Oₜ is buffered in a later-described sample buffer RSₘ.

Further, in step S319, while the ACHMM is configured of the single module #1, in the same way as step S69 in FIG. 17, the object module is determined according to the magnitude correlation between the most logarithmic likelihood maxLP and the threshold likelihood TH, but in the event that the ACHMM is configured of two or more (multiple) modules #1 through #M, the object module is determined based on the posterior probability of the ACHMM.

Also, after the same existing module learning processing as step S71 in FIG. 17 is performed in step S321, and after the same new module learning processing as step S72 in FIG. 17 is performed in step S322, in step S323 later-described sample saving processing is performed.

Specifically, with the module learning processing in FIG. 58, in step S311 the updating unit 23 of the module learning unit 13 (FIG. 8) performs, as initializing processing, generation of an ergodic HMM serving as the first module #1 making up the ACHMM, and setting the module total number M to 1 serving as an initial value.

Subsequently, after awaiting that the observed value oₜ is output from the sensor 11 and is stored in the observation time series buffer 12, the processing proceeds from step S311 to step S312, and the module learning unit 13 (FIG. 8) sets the point-in-time t to 1, and the processing proceeds to step S313.

In step S313, the module learning unit 13 determines whether or not the point-in-time t is equal to the window length W.

In the event that determination is made in step S313 that the point-in-time t is not equal to the window length W, after awaiting that the next observed value oₜ is output from the sensor 11, and is stored in the observation time series buffer 12, the processing proceeds to step S314.

In step S314, the module learning unit 13 increments the point-in-time t by one, and the processing returns to step S313, and hereafter, the same processing is repeated.

Also, in the event that determination is made in step S313 that the point-in-time t is equal to the window length W, i.e., in the event that the time series data O_{t=W}={o₁, . . . , o_{W}} that is the time series of the observed value for the window length W is stored in the observation time series buffer 12, the object module determining unit 22 (FIG. 8) determines, of the ACHMM made up of the single module #1 alone, the object module #1 thereof to be the object module.

Subsequently, the object module determining unit 22 supplies the module index m=1 representing the module #1 that is the object module to the updating unit 23, and the processing proceeds from step S313 to step S315.

In step S315, the updating unit 23 sets the effective learning frequency Qlearn[m=1] of the module #1 that is the object module represented with the module index m=1 from the object module determining unit 22 to 1.0 serving as an initial value.

Further, in step S315, the updating unit 23 obtains the learning rate γ of the module #1 that is the object module in accordance with Expression γ=1/(Qlearn[m=1]+1.0).

Subsequently, the updating unit 23 takes the time series data O_{t=W}={o₁, . . . , o_{W}} of the window length W stored in the observation time series buffer 12 as learned data, and uses the learned data O_{t=W} thereof to perform the additional learning of the module #1 that is the object module with the learning rate γ=1/(Qlearn[m=1]+1.0).

Specifically, the updating unit 23 updates the HMM parameters λₘ₌₁ of the module #1 that is the object module, stored in the ACHMM storage unit 16 in accordance with the above Expressions (3) through (16).

Further, the updating unit 23 buffers the learned data O_{t=W} in the buffer buffer_winner_sample that is a variable for buffering an observed value, secured in the built-in memory (not illustrated).

Also, the updating unit 23 sets winner period information cnt_since_win that is a variable representing a period for a module that has been the maximum likelihood module at one point-in-time ago being the maximum likelihood module, secured in the built-in memory, to 1 serving as an initial value.

Further, the updating unit 23 sets the last winner information past_win that is a variable representing (the module that was) the maximum likelihood module at one point-in-time ago, secured in the built-in memory, to 1 that is the module index of the module #1 serving as an initial value.

Also, the object module determining unit 22 buffers the learned data O_{t=W} employed for the additional learning of the module #1 that is the object module a sample buffer RS₁ of sample buffers RSₘ that are variables for buffering the learned data employed for the additional learning of each module as sample in a manner correlated with each module #m, secured in the memory housed in the updating unit 23.

Subsequently, after awaiting that the next observed value oₜ is output from the sensor 11, and is stored in the observation time series buffer 12, and the processing proceeds from step S315 to step S316, where the module learning unit 13 increments the point-in-time t by one, and the processing proceeds to step S317.

In step S317, the likelihood calculating unit 21 (FIG. 8) takes the latest time series data Oₜ={o_{t-W+1}, . . . , oₜ} of the window length W stored in the observation time series buffer 12 as learned data, obtains the module likelihood P(Oₜ|λₘ) regarding each of all of the modules #1 through #M of making up the ACHMM stored in the ACHMM storage unit 16, and supplied this to the object module determining unit 22.

Subsequently, the processing proceeds from step S317 to step S318, where the object module determining unit 22 obtains, of the modules #1 through #M making up the ACHMM, the maximum likelihood module #m*=argmaxₘ[P(Oₜ|λₘ)] of which the module likelihood P(Oₜ|λₘ) from the likelihood calculating unit 21 is the maximum.

Further, the object module determining unit 22 obtains the most logarithmic likelihood maxLP=maxₘ[log(P(Oₜ|λₘ))] from the module likelihood P(Oₜ|λₘ) from the likelihood calculating unit 21, and the processing proceeds from step S318 to step S319.

In step S319, the object module determining unit 22 performs object module determining processing for determining the maximum likelihood module #m* or new module to be the object module based on the most logarithmic likelihood maxLP or the ACHMM posterior probability.

Subsequently, the object module determining unit 22 supplies the module index of the object module to the updating unit 23, and the processing proceeds from step S319 to step S320.

In step S320, the updating unit 23 determines whether or not the object module represented with the module index from the object module determining unit 22 is either the maximum likelihood module #m* or new module.

In the event that determination is made in step S320 that the object module is the maximum likelihood module #m*, the processing proceeds to step S321, where the updating unit 23 performs the existing module learning processing (FIG. 18) for updating the HMM parameters λ_{m*} of the maximum likelihood module #m*.

In the event that determination is made in step S320 that the object module is the new module, the processing proceeds to step S322, where the updating unit 23 performs the new module learning processing (FIG. 19) for updating the HMM parameters of the new module.

After the existing module learning processing in step S321, and after the new module learning processing in step S322, in either case, the processing proceeds to step S323, where the object module determining unit 22 performs sample saving processing for buffering the learned data Oₜ employed for updating (additional learning of the object module #m) of the HMM parameters of the object module #m in the sample buffer RSₘ corresponding to the object module #m thereof as a learned data sample.

Subsequently, after awaiting that the next observed value oₜ is output from the sensor 11, and is stored in the observation time series buffer 12, and the processing returns from step S323 to step S316, and hereafter, the same processing is repeated.

### Sample Saving Processing

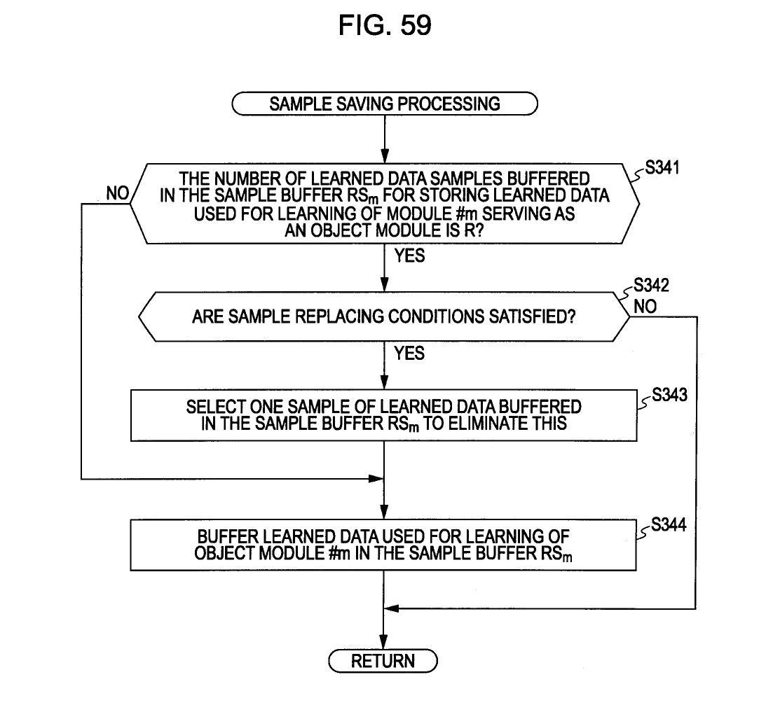

FIG. 59 is a flowchart for describing sample saving processing to be performed in step S323 in FIG. 58 by the object module determining unit 22 (FIG. 8).

In step S341, the object module determining unit 22 (FIG. 8) determines whether or not the number of learned data (number of samples) buffered in the sample buffer RSₘ of the module #m that is the object module is equal to or greater than a predetermined number R.

In the event that determination is made in step S341 that the number of the learned data samples buffered in the sample buffer RSₘ of the module #m that is the object module is neither equal to nor greater than the predetermined number R, i.e., in the event that the number of the learned data samples buffered in the sample buffer RSₘ of the module #m is less than the predetermined number R, the processing skips steps S342 and S343 to proceed to step S344, where the object module determining unit 22 (FIG. 8) buffers the learned data Oₜ employed for learning of the module #m that is the object module in the sample buffer RSₘ of the module #m in an additional manner, and the processing returns.

Also, in the event that determination is made in step S341 that the number of the learned data samples buffered in the sample buffer RSₘ of the module #m that is the object module is equal to or greater than the predetermined number R, the processing proceeds to step S342, where the object module determining unit 22 (FIG. 8) determines whether or not a sample replacing condition is satisfied whereby one sample of the R samples of the learned data buffered in the sample buffer RSₘ of the module #m is replaced with the learned data Oₜ employed for learning of the module #m which has become the object module.

Here, as for the sample replacing condition, for example, a first condition may be employed wherein after the last buffering of the learned data to the sample buffer RSₘ, learning of the module #m is the SAMP_STEP'th (a predetermined frequency) learning.

In the event that the first condition is employed as the sample replacing condition, after the number of the learned data samples buffered in the sample buffer RSₘ reaches the R, each time learning of the module #m is performed SAMP_STEP times, replacing of the learned data buffered in the sample buffer RSₘ is performed.

Also, as for the sample replacing condition, a second condition may be employed wherein a replacing probability p for performing replacing of the learned data buffered in the sample buffer RSₘ is set beforehand, when one of two numerals is generated at random with the probability p, and the other numeral is generated at random with the probability 1-p, the generated numeral is one of the numerals.

In the event that the second condition is employed as the sample replacing condition, the replacing probability p is taken as 1/SAMP_STEP, and thus, after the number of the learned data samples buffered in the sample buffer RSₘ reaches the R, from the standpoint of the expected-value, in the same way as with the first condition, each time learning of the module #m is performed SAMP_STEP times, replacing of the learned data buffered in the sample buffer RSₘ is performed.

In the event that determination is made in step S342 that the sample replacing condition is not satisfied, the processing skips steps S343 and S344 to return.

In the event that determination is made in step S342 that the sample replacing condition is satisfied, the processing proceeds to step S343, where the object module determining unit 22 (FIG. 8) randomly selects one sample of the R samples of the learned data buffered in the sample buffer RSₘ of the module #m that is the object module, and eliminates this from the sample buffer RSₘ.

Subsequently, the processing proceeds from step S343 to step S344, where the object module determining unit 22 (FIG. 8) buffers the learned data Oₜ employed for learning of the module #m that is the object module in the sample buffer RSₘ in an additional manner, and thus, the number of the learned data samples buffered in the sample buffer RSₘ is set to the R, and the processing returns.

As described above, with the sample saving processing, until the R'th learning of the module #m (additional learning) is performed, all of the learned data employed for learning of the module #m so far is buffered in the sample buffer RSₘ, and when the frequency of learning of the module #m exceeds the R times a part of the learned data employed for learning of the module #m so far is buffered in the sample buffer RSₘ.

### Determination of Object Module

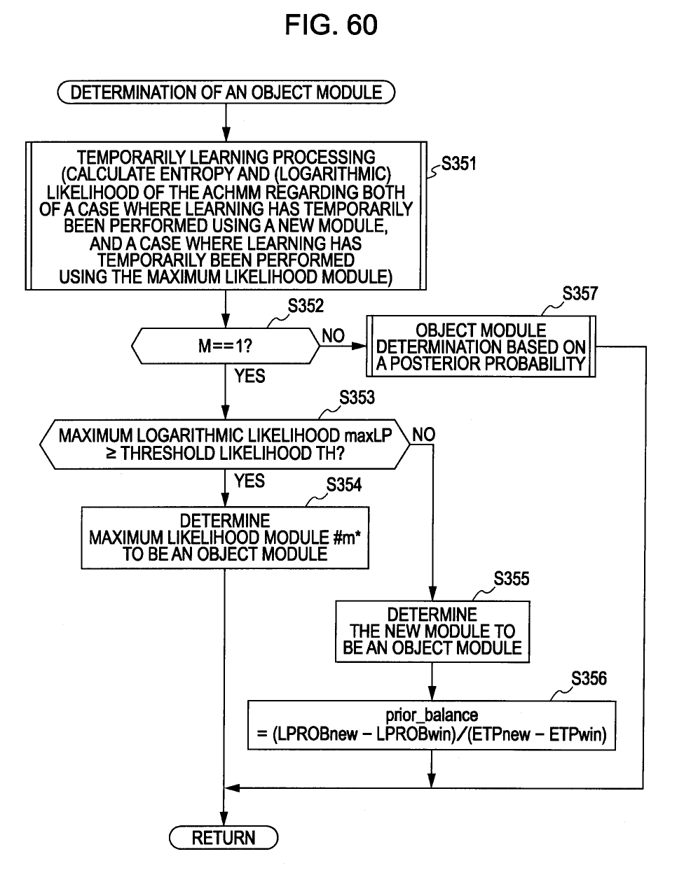

FIG. 60 is a flowchart for describing object module determining processing to be performed in step S319 in FIG. 58.

In step S351, the object module determining unit 22 performs tentative learning processing wherein the entropy H(θ) and logarithmic likelihood log(P(Oₜ|θ)) of the ACHMM are obtained regarding each of a case where the new module learning processing (FIG. 19) is tentatively performed with the new module as the object module, and a case where the existing module learning processing (FIG. 18) is tentatively performed with the maximum likelihood module as the object module.

Note that the details of the tentative learning processing will be described later, but the tentative learning processing is performed using the copies of the model parameters of the ACHMM currently stored in the ACHMM storage unit 16 (FIG. 8). Accordingly, the model parameters of the ACHMM stored in the ACHMM storage unit 16 are not changed (updated) by the tentative learning processing.

After the tentative learning processing in step S351, the processing proceeds to step S352, where the object module determining unit 22 (FIG. 8) determines whether or not the module total number M of the ACHMM is 1.

Here, the ACHMM serving as an object for determination of the module total number M in step S352 is not the ACHMM after the tentative learning processing but the ACHMM currently stored in the ACHMM storage unit 16.

In the event that determination is made in step S352 that the module total number M of the ACHMM is 1, i.e., in the event that the ACHMM is configured of the single module #1 alone, the processing proceeds to step S353, and hereafter, in steps S353 through S355, in the same way as steps S31 through S33 in FIG. 10, the object module is determined based on the magnitude correlation between the most logarithmic likelihood maxLP and the threshold likelihood TH.

Specifically, in step S353, the object module determining unit 22 (FIG. 8) determined whether or not the most logarithmic likelihood maxLP that is the logarithmic likelihood of the maximum likelihood module #m* is equal to or greater than the threshold likelihood TH set such as described in FIGS. 13 through 16.

In the event that determination is made that the most logarithmic likelihood maxLP is equal to or greater than the threshold likelihood TH, the processing proceeds to step S354, where the object module determining unit 22 determines the maximum likelihood module #m* to be the object module, and the processing returns.

Also, in the event that determination is made that the most logarithmic likelihood maxLP is less than the threshold likelihood TH, the processing proceeds to step S355, where the object module determining unit 22 determines the new module to be the object module, and the processing proceeds to step S356.

In step S356, the object module determining unit 22 uses the entropy H(θ) of the ACHMM to obtain a proportional constant prior_balance for obtaining the logarithmic a priori probability log(P(θ)) of the ACHMM in accordance with Expression log(P(θ))=−prior_balance×H(θ), and the processing returns.

Now, let us say that the entropy H(θ) and logarithmic likelihood log(P(Oₜ|θ)) of the ACHMM, which are obtained in the tentative learning processing to be performed in the above step S351, in the case that the new module learning processing (FIG. 19) has tentatively been performed, will be represented with ETPnew and LPROBnew, respectively.

Further, let us say that the entropy H(θ) and logarithmic likelihood log(P(Oₜ|θ)) of the ACHMM, in the case that the existing module learning processing (FIG. 18) has tentatively been performed with the maximum likelihood module obtained in the tentative learning processing as the object module, will be represented with ETPwin and LPROBwin, respectively.

In step S356, the object module determining unit 22 uses the entropy ETPnew and logarithmic likelihood LPROBnew of the ACHMM after the new module learning processing (FIG. 19) has tentatively been performed, and the entropy ETPwin and logarithmic likelihood LPROBwin of the ACHMM after the existing module learning processing (FIG. 18) has tentatively been performed to obtain the proportional constant prior_balance in accordance with Expression prior_balance=(LPROBnew−LPROBwin)/(ETPnew−ETPwin).

On the other hand, in the event that determination is made that the module total number M of the ACHMM is not 1, i.e., in the event that the ACHMM is configured of the two or modules #1 through M, the processing proceeds to step S357, where the object module determining unit 22 performs object module determining processing based on (the improvement amount of) the a priori probability of the ACHMM to be obtained by using the proportional constant prior_balance obtained in step S356, and the processing returns.

Here, the posterior probability P(θ|O) of the ACHMM defined by the model parameter θ may be obtained based on Bayes estimation, by Expression P(θ|O)=P(O|θ)×P(θ)/P(O) using a probability (a priori probability) P(O) that the a priori probability P(θ), likelihood P(O|θ), and time series data O of the ACHMM may occur.

With Expression P(θ|O)=P(O|θ)×P(θ)/P(O), if the logarithm is applied to both sides, this expression becomes Expression log(P(θ|O))=log(P(O|θ))+log(P(θ))−log(P(O)).

Now, let us say that in the event that the new module learning processing (FIG. 19) has tentatively been performed, the model parameter θ of the ACHMM after the new module learning processing thereof will be represented with θ_{new}, and also in the event that the existing module learning processing (FIG. 18) has tentatively been performed, the model parameter θ of the ACHMM after the existing module learning processing thereof will be represented with θ_{win}.

In this case, the (logarithmic) posterior probability log(P(θ_{new}|O)) of the ACHMM after the new module learning processing is represented with Expression log(P(θ_{new}|O))=log(P(O|θ_{new})+log(P(θ_{new}))−log(P(O)).

Also, the (logarithmic) posterior probability log(P(θ_{win}|O)) of the ACHMM after the existing module learning processing is represented with Expression log(P(θ_{win}|O))=log(P(O|θ_{win}))+log(P(θ_{win}))−log(P(O)).

Accordingly, the improvement amount ΔAP of the posterior probability log(P(θ_{new}|O)) of the ACHMM after the new module learning processing as to the posterior probability log(P(θ_{win}|O)) of the ACHMM after the existing module learning processing is represented with

$$\begin{matrix}Expression Δ AP = log ( P ( {θ}_{new} \vert O ) ) - log ( P ( {θ}_{win} \vert O ) ) \\ = log ( P ( O \vert {θ}_{new} ) ) + log ( P ( {θ}_{new} ) ) - log ( P ( O ) ) - \\ \{ ( log ( P ( O \vert {θ}_{win} ) ) + log ( P ( {θ}_{win} ) ) - log ( P ( O ) ) ) \} \\ = log ( P ( O \vert {θ}_{new} ) ) - log ( P ( O \vert {θ}_{win} ) ) + \\ log ( P ( {θ}_{new} ) ) - log ( P ( {θ}_{win} ) ) .\end{matrix}$$

Also, the logarithmic a priori probability log(P(θ)) is represented with Expression log(P(θ))=−prior_balance×H(θ). Accordingly, the improvement amount ΔAP of the above posterior probability is represented with

$$\begin{matrix}Expression Δ AP = log ( P ( O \vert {θ}_{new} ) ) - log ( P ( O \vert {θ}_{win} ) ) - \\ prior\_balance \times ( H ( {θ}_{new} ) - H ( {θ}_{win} ) ) \\ = ( LPROBnew - LPROBwin ) - prior\_balance \times \\ ( ETPnew - ETPwin ) .\end{matrix}$$

On the other hand, in FIG. 60, calculation of the proportional constant prior_balance in step S356 is performed in the event that the module total number M of the ACHMM is determined to be 1 (step S352), and the most logarithmic likelihood maxLP is determined to be less than the threshold likelihood TH (step S353), and thus, the new module first generated is determined to be the object module (step S355).

Accordingly, in the event that the ACHMM is configured of a single module, when the logarithmic likelihood (i.e., the most logarithmic likelihood maxLP) of the module thereof is less than the threshold likelihood TH, the entropy ETPnew and logarithmic likelihood LPROBnew of the ACHMM after the new module learning processing, which are obtained in the tentative learning processing in step S351 performed immediately before, are the entropy and logarithmic likelihood of the ACHMM to be obtained by adding the new module in the ACHMM for the first time, and performing additional learning of learned data.

Also, in the event that the ACHMM is configured of a single module, when the logarithmic likelihood (i.e., the most logarithmic likelihood maxLP) of the module thereof is less than the threshold likelihood TH, the entropy ETPwin and logarithmic likelihood LPROBwin of the ACHMM after the existing module learning processing, which are obtained in the tentative learning processing in step S351 performed immediately before, are the entropy and logarithmic likelihood of the ACHMM to be obtained by performing additional learning of learned data using the single module making up the ACHMM.

In step S356, with calculation of the proportional constant prior_balance to be obtained in accordance with Expression prior_balance=(LPROBnew−LPROBwin)/(ETPnew−ETPwin), as described above, the entropy ETPnew and logarithmic likelihood LPROBnew of the ACHMM after the new module learning processing, and the entropy ETPwin and logarithmic likelihood LPROBwin of the ACHMM after the existing module learning processing are employed.

In step S356, the proportional constant prior_balance to be obtained in accordance with Expression prior_balance=(LPROBnew−LPROBwin)/(ETPnew−ETPwin) is the prior_balance in the event that the improvement amount ΔAP of the posterior probability represented with Expression ΔAP=(LPROBnew−LPROBwin)−prior_balance×(ETPnew−ETPwin) is 0.

Specifically, in step S356, the proportional constant prior_balance to be obtained in accordance with Expression prior_balance=(LPROBnew−LPROBwin)/(ETPnew−ETPwin) is the prior_balance with the improvement amount ΔAP of the posterior probability in the event that as to the ACHMM made up of a single module, the logarithmic likelihood of the module thereof is less than the threshold likelihood TH, and the new module is added for the first time, as 0.

Accordingly, in the event that such a proportional constant prior_balance is used, and the improvement amount ΔAP of the posterior probability to be obtained in accordance with Expression ΔAP=(LPROBnew−LPROBwin)−prior_balance×(ETPnew−ETPwin) exceeds 0, the new module is determined to be the object module, and in the event that the improvement amount ΔAP does not exceed 0, the maximum likelihood module is determined to be the object module, whereby the posterior probability of the ACHMM can be improved as compared to a case where with observation space, the object module is determined using the threshold likelihood TH suitable for obtaining a desired clustering particle size for clustering an observed value.

Here, the proportional constant prior_balance is a transform coefficient for transforming the entropy H(θ) of the ACHMM into the logarithmic a priori probability log(P(θ))=−prior_balance×H(θ), but the logarithmic a priori probability log(P(θ)) influences the (logarithmic) posterior probability log(P(θ|O)), and accordingly, the proportional constant prior_balance is a parameter for controlling a degree for the entropy H(θ) influencing the posterior probability log(P(θ|O)) of the ACHMM.

Further, the maximum likelihood module or new module is determined to be the object module depending on whether or not the posterior probability of the ACHMM to be obtained using the proportional constant prior_balance is improved, and accordingly, the proportional constant prior_balance influences how to add the new module to the ACHMM.

In FIG. 60, determination of the object module, i.e., determination regarding whether or not the new module is added to the ACHMM is performed using the threshold likelihood TH until the new module is added to the ACHMM for the first time, the proportional constant prior_balance is obtained using the threshold likelihood TH thereof with the improvement amount ΔAP of the posterior probability of the ACHMM when the new module is added to the new module for the first time as 0 (reference).

The proportional constant prior_balance thus obtained can be conceived a coefficient for converting the clustering particle size for clustering an observed value into a degree (degree of incidence) where the entropy H(θ) influencing the posterior probability P(θ|O) to be obtained by Bayes estimation.

Determination of the subsequent object modules are performed based on the improvement amount ΔAP of the posterior probability to be obtained using the proportional constant prior_balance, and accordingly, the new module is added to the ACHMM in a logical and flexible (adaptive) manner so as to realize a desired clustering particle size, and the ACHMM made up of a sufficient number of modules as to the modeling object can be obtained.

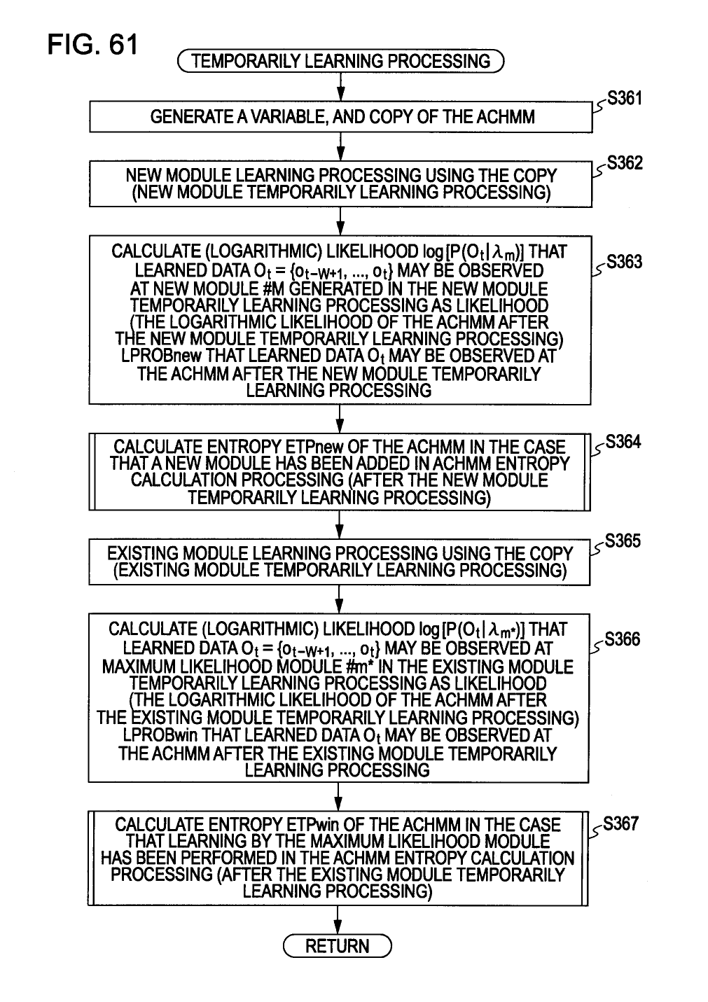

FIG. 61 is a flowchart for describing the tentative learning processing to be performed in step S351 in FIG. 60.

With the tentative learning processing, in step S361 the object module determining unit 22 (FIG. 8) controls the updating unit 23 to generate a copy of a variable, for example, the buffer_winner_sample, to be used for copying of (the model parameters of) the ACHMM stored in the ACHMM storage unit 16, and ACHMM learning.

Here, with the tentative learning processing, the following processing is performed using the ACHMM and the copy of a variable generated in step S361.

After step S361, the processing proceeds to step S362, where the object module determining unit 22 controls the updating unit 23 to perform the new module learning processing (FIG. 19) using the ACHMM and the copy of a variable, and the processing proceeds to step S363.

Here, the new module learning processing to be performed using the ACHMM and the copy of a variable will also be referred to as new module tentative learning processing.

In step S363, the object module determining unit 22 obtains the logarithmic likelihood log(P(Oₜ|λ_{M})) that the latest (current point-in-time t) learned data Oₜ may be observed at the new module #M generated in the new module tentative learning processing as the logarithmic likelihood LPROBnew=log(P(Oₜ|θ_{new})) of the ACHMM after the new module tentative learning processing, and the processing proceeds to step S364.

Here, with the new module tentative learning processing (FIG. 19) in step S362, additional learning (updating of the parameters in accordance with Expressions (3) through (16)) of the new module #m in step S115 in FIG. 19 is repeatedly performed until the new module #m becomes the maximum likelihood module.

Accordingly, when the logarithmic likelihood LPROBnew=log(P(Oₜ|θ_{new})) after the new module tentative learning processing is obtained in step S363, the new module #m has become the maximum likelihood module, and the logarithmic likelihood (most logarithmic likelihood) of the new module #m that is the maximum likelihood module thereof is obtained as the logarithmic likelihood LPROBnew=log(P(Oₜ|θ_{new})) of the ACHMM after the new module tentative learning processing.

Note that the frequency of repetition of additional learning of the new module #m in the new module tentative learning processing in step S362 is restricted to predetermined frequency (e.g., 20 times or the like), and additional learning of the new module #m is repeated while updating the learning rate γ in accordance with Expression γ=1/(Qlearn[m]+1.0) until the new module #m becomes the maximum likelihood module.

Subsequently, in the event that the new module #m does not become the maximum likelihood module even when repeating additional learning of the new module #m a predetermined number of times, in step S363 the logarithmic likelihood (most logarithmic likelihood) of the maximum likelihood module is obtained as the logarithmic likelihood LPROBnew=log(P(Oₜ|θ_{new})) of the ACHMM after the new module tentative learning processing instead of the new module #m.

With the new module learning processing in step S322 in FIG. 58 as well, in the same way as the new module tentative learning processing in step S362, additional learning of the new module #m is repeated by restricting the frequency of repetition to predetermined frequency until the new module #m becomes the maximum likelihood module.

In step S364, the object module determining unit 22 controls the updating unit 23 to perform calculation processing of the entropy H(θ) of the ACHMM with the ACHMM after the new module tentative learning processing as an object, thereby obtaining the entropy ETPnew=H(θ_{new}) of the ACHMM after the new module tentative learning processing, and the processing proceeds to step S365.

Here, the calculation processing of the entropy H(θ) of the ACHMM will be described later.

In step S365, the object module determining unit 22 controls the updating unit 23 to perform the existing module learning processing (FIG. 18) using the ACHMM and the copy of a variable, and the processing proceeds to step S366.

Here, the existing module learning processing to be performed using the ACHMM and the copy of a variable will also be referred to as existing module tentative learning processing.

In step S366, the object module determining unit 22 obtains the logarithmic likelihood log(P(Oₜ|λ_{m*})) that the latest (current point-in-time t) learned data Oₜ may be observed a the module #m* that has become the maximum likelihood module in the existing module learning processing as the logarithmic likelihood LPROBwin=log(P(Oₜ|θ_{win})) of the ACHMM after the existing module tentative learning processing, and the processing proceeds to step S367.

In step S367, the object module determining unit 22 controls the Updating unit 23 to perform calculation processing of the entropy H(θ) of the ACHMM with the ACHMM after the existing module tentative learning processing as an object, thereby obtaining the entropy ETPwin=H(θ_{win}) of the ACHMM after the existing module tentative learning processing, and the processing returns.

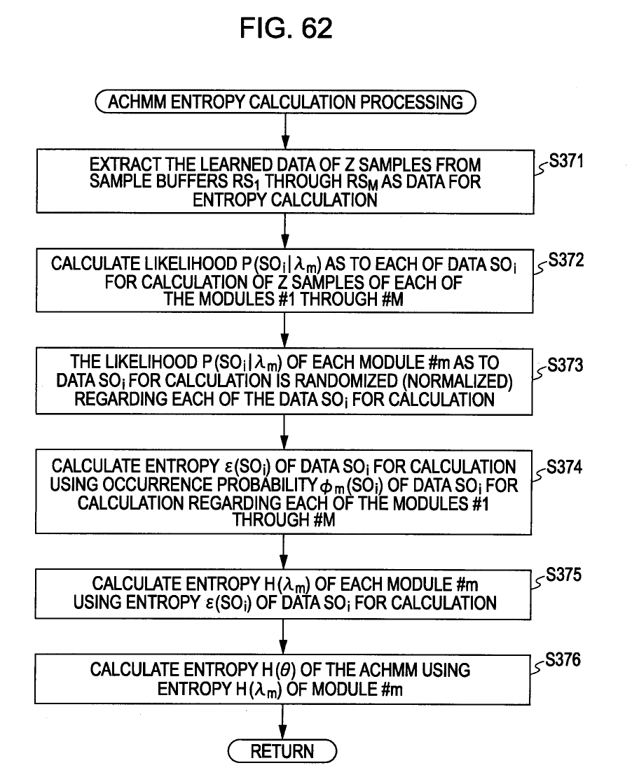

FIG. 62 is a flowchart for describing the calculation processing of the entropy H(θ) of the ACHMM to be performed in steps S364 and S367 in FIG. 61.

In step S371, the object module determining unit 22 (FIG. 8) controls the updating unit 23 to extract the learned data of a predetermined Z samples from the sample buffers RS₁ through RS_{M} correlated with the M modules #1 through #M making up the ACHMM as data for calculation of the entropy H(θ), and the processing proceeds to step S372.

Here, as for the number Z of data for calculation for extracting from the sample buffers RS₁ through RS_{M}, an arbitrary value may be taken, but it is desirable to employ a sufficient large value as compared to the number of modules making up the ACHMM. For example, in the event that the number of modules making up the ACHMM is 200 or so, 1000 or so may be employed as the value Z.

Also, as for the method for extracting the learned data of Z samples serving as data for calculation from the sample buffers RS₁ through RS_{M}, for example, a method may be employed wherein one sample buffer RSₘ is randomly selected out of the sample buffers RS₁ through RS_{M}, the learned data of one sample of the learned data stored in the sample buffer RSₘ thereof is repeatedly extracted Z times at random.

Note that an arrangement may be made wherein a value obtained by dividing the frequency wherein additional learning of the module #m has been performed (the frequency wherein the module #m has become the object module) by the summation of the frequency of additional learning of all of the modules #1 through #M is taken as a probability ωₘ, and selection of the sample buffer RSₘ out of the sample buffers RS₁ through RS_{M} is performed with the probability ωₘ.

Here, of the data for calculation of Z samples extracted from the sample buffers RS₁ through RS_{M}, the i'th data for calculation is represented with SOᵢ.

In step S372, the object module determining unit 22 obtains the likelihood P(SOᵢ|λₘ) as to each of the data for calculation SOᵢ of Z samples, each of the modules #1 through #M, and the processing proceeds to step S373.

In step S373, the object module determining unit 22 randomizes the likelihood P(SOᵢ|λₘ) of each module #m as to the data for calculation SOᵢ to a probability that the summation regarding all of the modules #1 through #M making up the ACHMM may be 1.0 (randomization to a probability distribution), regarding each of the data SOᵢ for calculation of Z samples.

Specifically, now, if we say that a Z-row×M-column matrix is taken as a likelihood matrix with the likelihood P(SOᵢ|λₘ) as an i'th-row m'th-column component, in step S373 each of the likelihood P(SOᵢ|λ₁), P(SOᵢ|λ₂), . . . , P(SOᵢ|λ_{M}) is normalized for each row of the likelihood matrix so that the summation of the likelihood P(SOᵢ|λ₁), P(SOᵢ|λ₂), . . . , P(SOᵢ|λ_{M}), that are the components of the row thereof, is 1.0.

More specifically, if we say that the probability to be obtained by randomizing the likelihood P(SOᵢ|λₘ) is represented with φₘ(SOᵢ), in step S373 the likelihood P(SOᵢ|λₘ) is randomized to a probability φm(SOᵢ) in accordance with

$$\begin{matrix}Expression ( 17 ) & \\ {ψ}_{m} ( {SO}_{i} ) = P ( {SO}_{i} \vert {λ}_{m} ) / {\sum }_{m} P ( {SO}_{i} \vert {λ}_{m} ) . & ( 17 )\end{matrix}$$

Here, summation (Σ) regarding the variable m in Expression (17) is a summation obtained by changing the variable m to an integer from 1 through M.

After step S373, the processing proceeds to step S374, where the object module determining unit 22 obtains the entropy ε(SOᵢ) of the data for calculation SOᵢ with the probability φₘ(SOᵢ) as an occurrence probability that the data for calculation SOᵢ may occur in accordance with Expression (18), and the processing proceeds to step S375.

$$ɛ ( {SO}_{i} ) = - {\sum }_{m} {ψ}_{m} ( {SO}_{i} ) log ( {ψ}_{m} ( {SO}_{i} ) ) \qquad ( 18 )$$

Here, a summation regarding the variable m in Expression (18) is a summation obtained by changing the variable m to an integer from 1 through M.

In step S375, the object module determining unit 22 uses the entropy ε(SOᵢ) of the data for calculation SOᵢ to calculate the entropy H(λₘ) of the module #m in accordance with Expression (19), and the processing proceeds to step S376.

$$H ( {λ}_{m} ) = {\sum }_{i} {ω}_{m} ( {SO}_{i} ) ɛ ( {SO}_{i} ) \qquad ( 19 )$$

Here, a summation regarding the variable i in Expression (19) is a summation obtained by changing the variable i to an integer from 1 through Z.

Also, in Expression (19), ωₘ(SOᵢ) is weight serving as a degree causing the entropy ε(SOᵢ) of the data for calculation SOᵢ to influence the entropy H(λₘ) of the module #m, this weight ωₘ(SOᵢ) is obtained using the likelihood P(SOᵢ|λₘ) in accordance with Expression (20).

$${ω}_{m} ( {SO}_{i} ) = P ( {SO}_{i} \vert {λ}_{m} ) / {\sum }_{i} P ( {SO}_{i} \vert {λ}_{m} ) \qquad ( 20 )$$

Here, a summation regarding the variable i in Expression (20) is a summation obtained by changing the variable i to an integer from 1 through Z.

In step S376, the object module determining unit 22 obtains the summation regarding the modules #1 through #M of the entropy H(λₘ) of the module #m in accordance with Expression (21) as the entropy H(θ) of the ACHMM, and the processing returns.

$$H ( θ ) = {\sum }_{m} H ( {λ}_{m} ) \qquad ( 21 )$$

Here, a summation regarding the variable m in Expression (21) is a summation obtained by changing the variable m to an integer from 1 through M.

Note that the weight ωₘ(SOᵢ) obtained in Expression (20) is a coefficient for causing the entropy ε(SOᵢ) of the data for calculation SOᵢ for improving the likelihood P(SOᵢ|λₘ) of the module #m to influence the entropy H(λₘ) of the module #m.

Specifically, the entropy H(λₘ) of the module #m is conceptually a scale representing a degree wherein the likelihood of a module other than the module #m is low when the likelihood P(SOᵢ|λₘ) of the module #m thereof is high.

On the other hand, it represents a situation representing lack of compactness of the ACHMM, i.e., a degree close to more random property with great expressional ambiguity that the entropy ε(SOᵢ) of the data for calculation SOᵢ is high.

Accordingly, in the event that there is a module #m where the likelihood P(SOᵢ|λₘ) that the data for calculation SOᵢ of which the entropy ε(SOᵢ) is high as compared to other data for calculation, there is no calculation data where only the module #m thereof dominantly has high likelihood regarding the module #m thereof, and existence of the module #m thereof generates redundancy of the entire ACHMM.

Specifically, existence of the module #m where the likelihood P(SOᵢ|λₘ) that the data for calculation SOᵢ of which the entropy ε(SOᵢ) is high may be observed is high as compared to other data for calculation greatly contributes to causing the ACHMM to have a situation of lack of compactness.

Therefore, with Expression (19) for obtaining the entropy H(λₘ) of the module #m, in order to cause the entropy ε(SOᵢ) of the data for calculation SOᵢ of which the likelihood P(SOᵢ|λₘ) of the module #m is high to influence the entropy H(λₘ), the entropy ε(SOᵢ) is added with the great weight ωₘ(SOᵢ) proportional to the high likelihood P(SOᵢ|λₘ).

On the other hand, the module #m where the likelihood P(SOᵢ|λₘ) that the data for calculation SOᵢ of which the entropy ε(SOᵢ) is low has a little contribution to causing the ACHMM to have a situation of lack of compactness.

Therefore, with Expression (19) for obtaining the entropy H(λₘ) of the module #m, the entropy ε(SOᵢ) of the data for calculation SOᵢ of which the likelihood P(SOᵢ|λₘ) of the module #m is low is added with the little weight ωₘ(SOᵢ) proportional to the low likelihood P(SOᵢ|λₘ).

Note that, according to Expression (20), the weight ωₘ(SOᵢ) increases regarding the module #m where the likelihood P(SOᵢ|λₘ) that the data for calculation SOᵢ of which the entropy ε(SOᵢ) is small may be observed increases, and in Expression (19), the small entropy ε(SOᵢ) is added with such great weight ωₘ(SOᵢ), but as to the scale of the entropy ε(SOᵢ) the likelihood P(SOᵢ|λₘ), i.e., the scale of the weight ωₘ(SOᵢ) is small, and accordingly, the entropy H(λₘ) of the module #m in Expression (19) is not influenced by such a small entropy ε(SOᵢ) so much.

That is to say, the entropy H(λₘ) of the module #m in Expression (19) is strongly influenced in the case that the likelihood P(SOᵢ|λₘ) that the data for calculation SOᵢ of which the entropy ε(SOᵢ) is high may be observed at the module #m is high, and the value thereof increases.

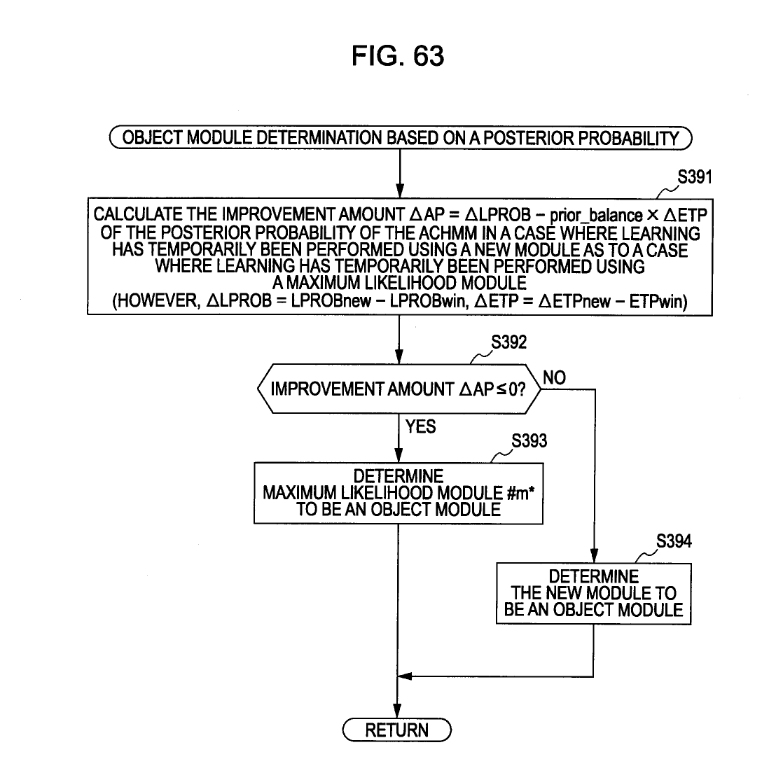

FIG. 63 is a flowchart for describing the object module determining processing based on a posterior probability, to be performed in step S357 in FIG. 60.

The object module determining processing based on a posterior probability is performed, such as described in FIG. 60, after the ACHMM is made up of a single module, and when the most logarithmic likelihood maxLP (the logarithmic likelihood of the single module making up the ACHMM) becomes less than the threshold likelihood TH, the new module becomes the object module, and the proportional constant prior_balance is obtained, and accordingly, when the ACHMM is configured of two or more (multiple) modules, and thereafter.

With the object module determining processing based on a posterior probability, in step S391 the object module determining unit 22 (FIG. 8) obtains the improvement amount ΔAP of the posterior probability of the ACHMM after the new module tentative learning processing as to the posterior probability of the ACHMM after the existing module tentative learning processing, using the entropy ETPwin and logarithmic likelihood LPROBwin of the ACHMM after the existing module tentative learning processing obtained in the tentative learning processing performed immediately before (step S351 in FIG. 60), and the entropy ETPnew and logarithmic likelihood LPROBnew of the ACHMM after the new module tentative learning processing.

Specifically, the object module determining unit 22 obtains the improvement amount ΔETP of the entropy ETPnew of the ACHMM after the new module tentative learning as to the entropy ETPwin of the ACHMM after the existing module tentative learning processing in accordance with Expression (22).

ΔETP=ETPnew−ETPwin (22)

Further, the object module determining unit 22 obtains the improvement amount ΔLPROB of the logarithmic likelihood LPROBnew of the ACHMM after the new module tentative learning as to the logarithmic likelihood LPROBwin of the ACHMM after the existing module tentative learning processing in accordance with Expression (23).

ΔLPROB=LPROBnew−LPROBwin (23)

Subsequently, the object module determining unit 22 uses the entropy improvement amount ΔETP, the logarithmic likelihood improvement amount ΔLPROB, and the proportional constant prior_balance to obtain the improvement amount ΔAP of the posterior probability of the ACHMM after the new module tentative learning processing as to the posterior probability of the ACHMM after the existing module tentative learning processing in accordance with Expression (24) matching the above Expression ΔAP=(LPROBnew−LPROBwin)−prior_balance×(ETPnew−ETPwin).

ΔAP=ΔLPROB−prior_balance×ΔETP (24)

After the improvement amount ΔAP of the posterior probability of the ACHMM is obtained in step S391, the processing proceeds to step S392, where the object module determining unit 22 determines whether or not the improvement amount ΔAP of the posterior probability of the ACHMM is equal to or less than 0.

In the event that determination is made in step S392 that the improvement amount ΔAP of the posterior probability of the ACHMM is equal to or less than 0, i.e., in the event that the posterior probability of the ACHMM after additional learning has been performed with the new module as the object module is not higher than the posterior probability of the ACHMM after additional learning has been performed with the maximum likelihood module as the object module, the processing proceeds to step S393, where the object module determining unit 22 determines the maximum likelihood module #m* to be the object module, and the processing returns.

Also, in the event that determination is made in step S392 that the improvement amount ΔAP of the posterior probability of the ACHMM is greater than 0, i.e., in the event that the posterior probability of the ACHMM after additional learning has been performed with the new module as the object module is higher than the posterior probability of the ACHMM after additional learning has been performed with the maximum likelihood module as the object module, the processing proceeds to step S394, where the object module determining unit 22 determines the new module to be the object module, and the processing returns.

As described above, the object module determining method based on a posterior probability is applied to the agent in FIG. 28 or 51 wherein the maximum likelihood module or new module is determined to be the object module based on the improvement amount of a posterior probability, whereby the agent can construct an ACHMM serving as a state transition model of a motion environment, which is configured of the number of modules suitable for the scale of the motion environment, without preliminary knowledge regarding the scale and configuration of the motion environment, by the agent repeating learning of an existing module already included in the ACHMM, addition of a new module to be used, as process wherein the agent moves within the motion environment where the agent is located to gather experience as appropriate.

Note that the object module determining method based on a posterior probability may applied to, in addition to an ACHMM, a learning model employing a module-addition-type learning architecture (hereafter, also referred to as “module-additional-architecture-type learning model”).

As for a module-additional-architecture-type learning model, in addition to a learning model like an ACHMM employing an HMM as a module to learn time series data in a competitive additional manner, for example, there is a learning model employing a time series pattern storage model as a module such as a recurrent neural network (RNN) for learning time series data to store time series patterns, or the like to learn time series data in a competitive additional manner.

That is to say, the object module determining method based on a posterior probability may be applied to a module-additional-architecture-type learning model employing a time series pattern storage model such as an HMM or RNN or the like, or another arbitrary model as a module.

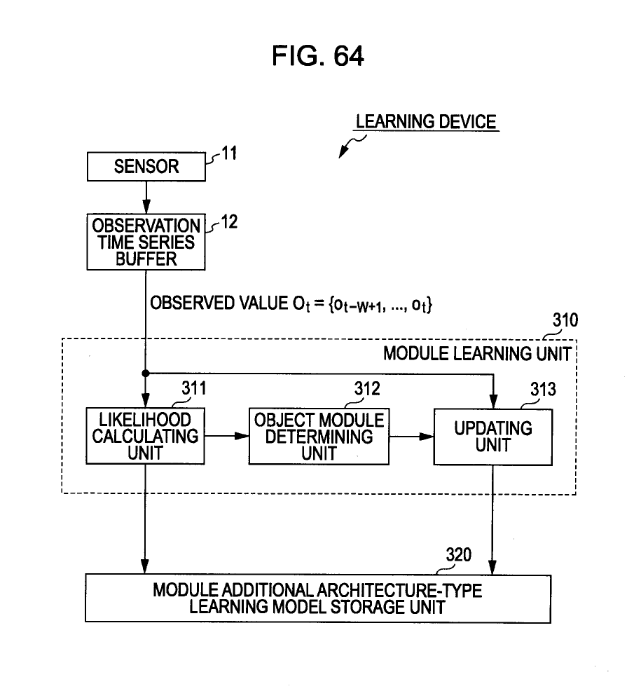

FIG. 64 is a block diagram illustrating a configuration example of the third embodiment of the learning device to which the information processing device according to the present invention has been applied.

Note that in the drawing, a portion corresponding to the case of FIG. 1 is appended with the same reference symbol, and hereafter, description thereof will be omitted as appropriate.

In FIG. 64, the learning device includes the sensor 11, the observation time series buffer 12, a module learning unit 310, and a module-additional-architecture-type learning model storage unit 320.

With the learning device in FIG. 64, an observed value stored in the observation time series buffer 12 is sequentially supplied to a likelihood calculating unit 311 and an updating unit 313 of the module learning unit 310 in increments of time series data of the above window length W.

The module learning unit 310 includes the likelihood calculating unit 311, an object module determining unit 312, and the updating unit 313.

With the time series data of the window length W that is the time series of an observed value to be successively supplied from the observation time series buffer 12 as learned data to be used for learning, with regard to each module making up a module-additional-architecture-type learning model stored in the module-additional-architecture-type learning model storage unit 320, the likelihood calculating unit 311 obtains likelihood that the learned data may be observed at the module, and supplies this to the object module determining unit 312.

The object module determining unit 312 determines, of the module-additional-architecture-type learning models stored in the module-additional-architecture-type learning model storage unit 320, the maximum likelihood module of which the likelihood from the likelihood calculating unit 311 is the maximum, or a new module to be the object module that is an object for updating the model parameters of a time series pattern storage model that is a module making up a module-additional-architecture-type learning model, and supplies a module index representing the object module thereof to the updating unit 313.

Specifically, the object module determining unit 312 determines the maximum likelihood module or new module to be the object module based on the posterior probability of the module-additional-architecture-type learning model of each case of a case where learning of the maximum likelihood module is performed using the learned data, and a case where learning of the new module using the learned data, and supplies the module index representing the object module thereof to the updating unit 313.

The updating unit 313 performs additional learning for updating the model parameters of a time series pattern storage model that is a module represented with the module index supplied from the object module determining unit 312 using the learned data from the observation time series buffer 12, and updates the storage content of the module-additional-architecture-type learning model storage unit 320 using the updated model parameters.

The module-additional-architecture-type learning model storage unit 320 stores a module-additional-architecture-type learning model having a time series pattern storage model for storing time series patterns as a module that is the minimum component.

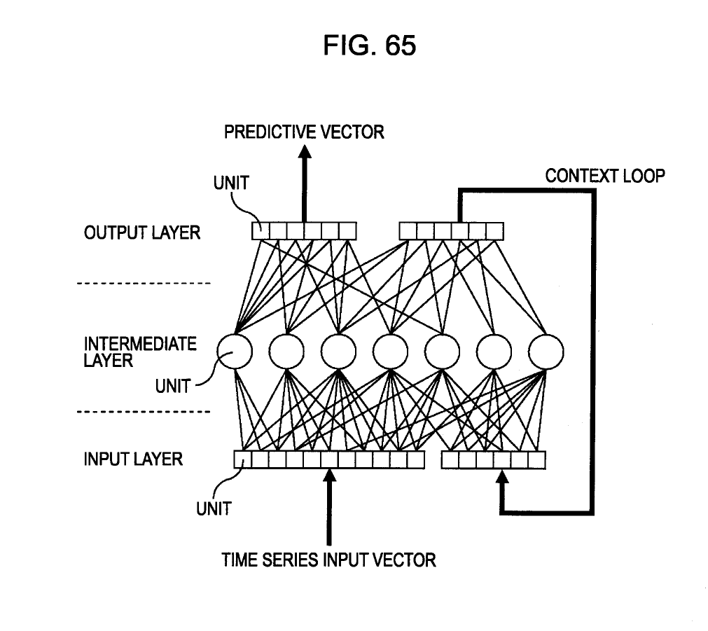

FIG. 65 is a diagram illustrating an example of a time series pattern storage model serving as a module of a module-additional-architecture-type learning model.

In FIG. 65, an RNN is employed as a time series pattern storage model.

In FIG. 65, the RNN is configured of three levels of an input level, an intermediate level (hidden level), and an output level. The input level, intermediate level, and output level are each configured of an arbitrary number of a unit equivalent to a neuron.

With the RNN, an input vector xₜ is externally input (supplied) to an input unit which is a part of units of the input level. Here, the input vector xₜ represents a sample (vector) at the point-in-time t. Note that, with the present Specification, “vector” may be a vector having one component, i.e., a scalar value.

The remaining unit other than the input unit to which the input vector xₜ is input of the input level is a context unit, and the output (vector) of a part of units of the output level is fed back to the context unit via a context loop as context representing an internal state.

Here, the context at the point-in-time t to be input to the context unit of the input level when the input vector xₜ at the point-in-time t is input to the input unit of the input level will be described as cₜ.

The units of the intermediate level perform weighting addition using predetermined weight with the input vector xₜ and the context cₜ to be input to the input level as objects, perform calculation of a nonlinear function with the result of the weighting addition as an argument, and output the calculation result thereof to the units of the output level.

With the units of the output level, the same processing as with the units of the intermediate level is performed with the data to be output from the units of the intermediate level as an object. Subsequently, context cₜ₊₁ at the next point-in-time t+1 is, such as described above, output from a part of the units of the output level, and is fed back to the input level. Also, the output vector corresponding to the input vector xₜ, i.e., when assuming that the input vector xₜ is equivalent to an argument of the function, the output vector equivalent to the function value as to the argument thereof is output from the remaining units of the output level.

Here, with learning of the RNN, for example, the sample at the point-in-time t of certain time series data is provided to the RNN as the input vector, and also the sample at the next point-in-time t+1 of the time series data thereof is provided to the RNN as the true value of the output vector, and the weight is updated so as to reduce error as to the true value, of the output vector.

With the RNN wherein such learning has been performed, as the output vector as to the input vector xₜ, the predicted value x*ₜ₊₁ of the input vector xₜ₊₁ at the next point-in-time t+1 of the input vector xₜ thereof is output.

Note that, as described above, with the RNN, the input to a unit is subjected to weighting addition, and the weight to be used for this weighting addition is a model parameter of the RNN(RNN parameter). The weight serving as a RNN parameter includes weight from the input unit to a unit of the intermediate level, weight from a unit of the intermediate level to a unit of the output level, and the like.

In the event that such a RNN is employed as a module, at the time of learning of the RNN thereof, as the true values of the input vector and the output vector, for example, the learned data Oₜ={o_{t-W+1}, . . . , oₜ} that is time series data of the window length W is provided.

Subsequently, with learning of the RNN, weight for reducing (the summation of) the predicted error of the predicted value of the sample at the point-in-time t+1 serving as the output vector to be output from the RNN when the sample of each point-in-time of the learned data Oₜ={o_{t-W+1}, . . . , oₜ} is provided to the RNN as the input vector is obtained, for example, by the BPTT (Back-Propagation Through Time) method.

Here, the predicted error Eₘ(t) of the RNN serving as the module #m as to the learned data Oₜ={o_{t-W+1}, . . . , oₜ} is obtained in accordance with Expression (25), for example.

$${E}_{m} ( t ) = \frac{1}{2} {\sum }_{τ = t - W - 2}^{t - 1} {\sum }_{d = 1}^{D} {( {ο}_{d}^{\hat{}} ( τ ) - {ο}_{d} ( τ ) )}^{2} \qquad ( 25 )$$

Here, in Expression (25), O_{d}(τ) represents a d-dimensional component of an input vector o_{τ} that is a sample at a point-in-time τ of the time series data Oₜ, and ô_{d}(τ) represents a d-dimensional component of a predicted value (vector) ô_{τ} of the input vector o_{τ} at the point-in-time τ that is the output vector to be output from the RNN as to the input vector o_{τ-1}.

With learning of a module-additional-architecture-type learning model employing such a RNN as a module, the object module may be determined at the module learning unit 310 (FIG. 64) using the threshold (threshold likelihood TH) in the same way as with the case of an ACHMM.

Specifically, in the event of determining the object module using the threshold, the module learning unit 310 obtains the predicted error Eₘ(t) of each module #m of the module-additional-architecture-type learning model regarding the learned data Oₜ in accordance with Expression (25).

Further, the module learning unit 310 obtains the minimum predicted error E_{win} of the predicted error Eₘ(t) of each module #m of the module-additional-architecture-type learning model in accordance with Expression E_{w1n}=minₘ[Eₘ(t)].

Here, minₘ[ ] represents the minimum value of the value within the parentheses that varies as to the index m.

In the event that the minimum predicted error E_{win} is equal to or less than a predetermined threshold E_{add}, the module learning unit 310 determines the module from which the minimum predicted error E_{win} thereof has been obtained to be the object module, and in the event that the minimum predicted error E_{win} is greater than the predetermined threshold E_{add}, determines a new module to be the object module.

With the module learning unit 310, in addition to determining the object module using the threshold such as described above, the object module may be determined based on a posterior probability.

In the event that the object module is determined based on a posterior probability, the likelihood of the RNN that is the module #m as to the time series data Oₜ has to be provided.

Therefore, with the module learning unit 310, the likelihood calculating unit 311 obtains the predicted error Eₘ(t) of each module #m of the module-additional-architecture-type learning model in accordance with Expression (25). Further, the likelihood calculating unit 311 obtains the likelihood (the likelihood of the RNN defined by the RNN parameters (weight) λₘ) P(Oₜ|λₘ) of each module #m that is a real value of 0.0 through 1.0 and the summation thereof is 1.0 by randomizing the predicted error Eₘ(t) to a probability in accordance with Expression (26), and supplies this to the object module determining unit 312.

$$P ( {O}_{t} \vert {λ}_{m} ) = {e}^{- \frac{{E}_{n} ( t )}{2 {σ}^{2}}} / {\sum }_{j = 1}^{M} {e}^{- \frac{{E}_{j} ( t )}{2 {σ}^{2}}} \qquad ( 26 )$$

Here, if we say that as the likelihood P(Oₜ|θ) of a module-additional-architecture-type learning model θ (a module-additional-architecture-type learning model defined by the model parameter θ) as to the time series data Oₜ, the maximum value of the likelihood P(Oₜ|λₘ) of each module of the module-additional-architecture-type learning model is employed in accordance with Expression P(Oₜ|θ)=maxₘ[P(Oₜ|λₘ)], and also as the entropy H(θ) of the module-additional-architecture-type learning model θ, in the same way as with the case of an ACHMM, an entropy to be obtained from the likelihood P(Oₜ|λₘ) is employed, the logarithmic a priori probability log(P(θ)) of the module-additional-architecture-type learning model θ may be obtained in accordance with Expression log(P(θ))=−prior_balance×H(θ) employing the proportional constant prior_balance.

Further, the posterior probability P(θ|Oₜ) of the module-additional-architecture-type learning model θ may be obtained in accordance with Expression P(θ|Oₜ)=P(Oₜ|θ)×P(θ)/P(Oₜ) based on Bayes estimation using the a priori probabilities P(θ) and P(Oₜ) and the likelihood P(Oₜ|θ) in the same way as with the case of an ACHMM.

Accordingly, the improvement amount ΔAP of the posterior probability of the module-additional-architecture-type learning model θ may also be obtained in the same way as with the case of an ACHMM.

With the module learning unit 310, the object module determining unit 312 uses the likelihood P(Oₜ|λₘ) to be supplied from the likelihood calculating unit 311 to obtain, such as described above, the improvement amount ΔAP of the posterior probability based on Bayes estimation, of the module-additional-architecture-type learning model θ, and determines the object module based on the improvement amount ΔAP thereof.

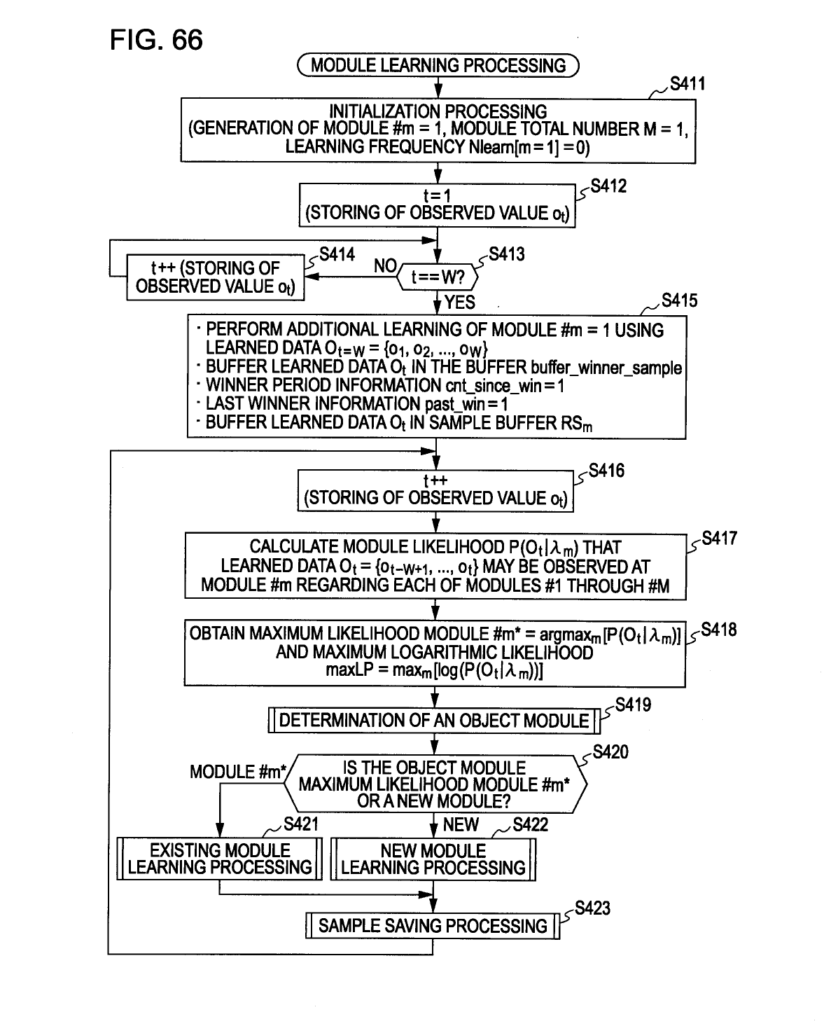

FIG. 66 is a flowchart for describing learning processing (module learning processing) of the module-additional-architecture-type learning model θ to be performed by the module learning unit 310 in FIG. 64.

Note that with the module learning processing in FIG. 66, the variable window learning described in FIG. 17 is performed, but the fixed window learning described in FIG. 9 may be performed.

In steps S411 through S423 of the module learning processing in FIG. 66, the same processing as steps S311 through S323 of the module learning processing in FIG. 58 is performed, respectively.

However, the module learning processing in FIG. 66 differs in that a module-additional-architecture-type learning model employing the RNN serving as a module is taken as an object, from the module learning processing in FIG. 58 in which an ACHMM employing an HMM serving as a module is taken as an object, and with the module learning processing in FIG. 66, partially different processing from the module learning processing in FIG. 58 will be performed due to such a point.

Specifically, in step S411, as initialization processing, the updating unit 313 (FIG. 64) performs generation of RNNs serving as the first module #1 making up a module-additional-architecture-type learning model to be stored in the module-additional-architecture-type learning model storage unit 320, and setting the module total number M to 1 serving as an initial value.

Here, with generation of RNNs, the RNNs of a predetermined number of units of the input level, intermediate level, and output level, and the context unit are generated, and weight thereof is initialized using a random number, for example.

Subsequently, after awaiting that the observed value oₜ is output from the sensor 11, and is stored in the observation times series buffer 12, the processing proceeds from step S411 to step S412, where the module learning unit 310 (FIG. 64) sets the point-in-time t to 1, and the processing proceeds to step S413.

In step S413, the module learning unit 310 determines whether or not the point-in-time t is equal to the window length W.

In the event that determination is made in step S413 that the point-in-time t is not equal to the window length W, after awaiting that the next observed value oₜ is output from the sensor 11, and is stored in the observation time series buffer 12, the processing proceeds to step S414.

In step S414, the module learning unit 310 increments the point-in-time t by one, and the processing returns to step S413, and hereafter, the same processing is repeated.

Also, in the event that determination is made in step S413 that the point-in-time t is equal to the window length W, i.e., in the event that the time series data O_{t=W}={o₁, . . . , o_{W}} that is the time series of an observed value of the window length W is stored in the observation time series buffer 12, the object module determining unit 312 determines, of the module-additional-architecture-type learning model made up of the single module #1, the module #1 thereof to be the object module.

Subsequently, the object module determining unit 312 supplies a module index m=1 representing the module #1 that is the object module to the updating unit 313, and the processing proceeds from step S413 to step S415.

In step S415, the updating unit 313 performs additional learning of the module #1 that is the object module represented by the module index m=1 from the object module determining unit 312 using the time series data O_{t=W}={o₁, . . . , o_{W}} of the window length W stored in the observation time series buffer 12 as learned data.

Here, in the event that the module of the module-additional-architecture-type learning model is a RNN, for example, the method described in Japanese Unexamined Patent Application Publication No. 2008-287626 may be employed as an additional learning method of a RNN.

In step S415, the updating unit 313 further buffers the learned data O_{t=W} in the buffer buffer_winner_sample.

Also, the updating unit 313 sets the winner period information cnt_since_win to 1 serving as an initial value.

Further, the updating unit 313 sets the last winner information past_win to 1 that is the module index of the module #1, serving as an initial value.

Subsequently, the updating unit 313 buffers the learned data Oₜ in the sample buffer RS₁.

Subsequently, after awaiting that the next observed value oₜ is output from the sensor 11, and is stored in the observation time series buffer 12, the processing proceeds from step S415 to step S416, where the module learning unit 310 increments the point-in-time t by one, and the processing proceeds to step S417.

In step S417, the likelihood calculating unit 311 takes the latest time series data Oₜ={o_{t-W+1}, . . . , oₜ} of the window length W stored in the observation time series buffer 12 as learned data, and obtains the module likelihood P(Oₜ|λₘ) regarding each of all of the modules #1 through #M making up the module-additional-architecture-type learning model stored in the module-additional-architecture-type learning model storage unit 320, and supplies this to the object module determining unit 312.

Specifically, with regard to each module #m, the likelihood calculating unit 311 provides (the sample o_{τ} at each point-in-time of) the learned data Oₜ to the RNN that is the module #m (hereinafter, also written as “RNN#m”) as the input vector, and obtains the predicted error Eₘ(t) of the output vector as to the input vector in accordance with Expression (25).

Further, the likelihood calculating unit 311 uses the predicted error Eₘ(t) to obtain the module likelihood P(Oₜ|λₘ) that is the likelihood of a RNN#m defined with the RNN parameters λₘ in accordance with Expression (26), and supplies this to the object module determining unit 312.

Subsequently, the processing proceeds from step S417 to step S418, where the object module determining unit 312 obtains the maximum likelihood module #m*=argmaxₘ[P(Oₜ|λₘ)] where the module likelihood P(Oₜ|λₘ) from the likelihood calculating unit 311 is the maximum of the modules #1 through #M making up the module-additional-architecture-type learning model.

Further, the object module determining unit 312 obtains the most logarithmic likelihood maxLP=maxₘ[log(P(Oₜ|λₘ))] (the logarithm of the module likelihood P(Oₜ|λ_{m*}) of the maximum likelihood module #m*) from the module likelihood P(Oₜ|λₘ) from the likelihood calculating unit 311, and the processing proceeds from step S418 to step S419.

In step S419, the object module determining unit 312 performs object module determining processing for determining the maximum likelihood module #m* or a new module that is a RNN to be newly generated to be the object module for updating the RNN parameters based on the most logarithmic likelihood maxLP, or the posterior probability of the module-additional-architecture-type learning model.

Subsequently, the object module determining unit 312 supplies the module index of the object module to the updating unit 313, and the processing proceeds from step S419 to step S420.

Here, the object module determining processing in step S419 is performed in the same way as with the case described in FIG. 60.

Specifically, in the event that the module-additional-architecture-type learning model is made up of the single module #1 alone, based on the magnitude correlation between the most logarithmic likelihood maxLP and a predetermined threshold, when the most logarithmic likelihood maxLP is equal to or greater than the threshold, the maximum likelihood module #m* is determined to be the object module, and when the most logarithmic likelihood maxLP is less than the threshold, the new module is determined to be the object module.

Further, in the event that the module-additional-architecture-type learning model is made up of the single module #1 alone, when the new module was determined to be the object module, the proportional constant prior_balance is obtained such as described in FIG. 60.

Also, in the event that the module-additional-architecture-type learning model is made up of two or more, M modules #1 through #M, such as described in FIGS. 60 and 63, the improvement amount ΔAP of the posterior probability of the module-additional-architecture-type learning model after the new module tentative learning processing as to the posterior probability of the module-additional-architecture-type learning model after the existing module tentative learning processing is obtained using the proportional constant prior_balance.

Subsequently, in the event that the improvement amount ΔAP of the posterior probability is equal to or less than 0, the maximum likelihood module #m* is determined to be the object module.

On the other hand, in the event that the improvement amount ΔAP of the posterior probability is greater than 0, the new module is determined to be the object module.

Here, “the existing module tentative learning processing of the module-additional-architecture-type learning model” is existing module learning processing to be performed using the module additional architecture type learning model stored in the module-additional-architecture-type learning model storage unit 320, and the copy of a variable.

With the existing module learning processing of the module-additional-architecture-type learning model, the same processing as described in FIG. 18 is performed except that neither the effective learning frequency Qlearn[m] nor the learning rate γ are employed, and additional learning is performed with a RNN as an object instead of an HMM.

Similarly, “the new module tentative learning processing of the module-additional-architecture-type learning model” is new module learning processing to be performed using the module additional architecture type learning model stored in the module-additional-architecture-type learning model storage unit 320, and the copy of a variable.

With the new module learning processing of the module-additional-architecture-type learning model, the same processing as described in FIG. 19 is performed except that neither the effective learning frequency Qlearn[m] nor the learning rate γ are employed, and additional learning is performed with a RNN as an object instead of an HMM.

In step S420, the updating unit 313 determines whether the object module represented with the module index from the object module determining unit 312 is either the maximum likelihood module #m* or the new module.

In the event that determination is made in step S420 that the object module is the maximum likelihood module #m*, the processing proceeds to step S421, where the updating unit 313 performs the existing module learning processing for updating the RNN parameters λ_{m*} of the maximum likelihood module #m*.

Also, in the event that determination is made in step S420 that the object module is the new module, the processing proceeds to step S422, where the updating unit 313 performs the new module learning processing for updating the RNN parameters of the new module.

After the existing module learning processing in step S421, and after the new module learning processing in step S422, in either case, the processing proceeds to step S423, where the object module determining unit 312 performs the sample saving processing described in FIG. 59 wherein the learned data Oₜ used for updating of the RNN parameters of the object module #m (additional learning of the object module #m) is buffered in the sample buffer RSₘ corresponding to the object module #m thereof as a learned data sample.

Subsequently, after awaiting that the next observed value oₜ is output from the sensor 11, and is stored in the observation time series buffer 12, the processing returns from step S423 to step S416, and hereafter, the same processing is repeated.

As described above, even when the module of the module-additional-architecture-type learning model is an RNN, the predicted error is randomized to a probability in accordance with Expression (26) or the like, thereby converting into likelihood, and based on the improvement amount of the posterior probability of the module-additional-architecture-type learning model, which is obtained using the likelihood thereof, the object module is determined, thereby the new module is added to the module-additional-architecture-type learning model in a logical and flexible (adaptive) manner as compared to a case where the object module is determined according to the magnitude correlation between the most logarithmic likelihood maxLP and the threshold, and accordingly, the module-additional-architecture-type learning model made up of a sufficient number of modules can be obtained as to a modeling object.

Description of a Computer to which an Embodiment of the Present Invention has been Applied

Next, the above-described series of processing can be executed by hardware or by software. In the event that the series of processing is performed by software, a program making up the software is installed in a general-purpose computer or the like.

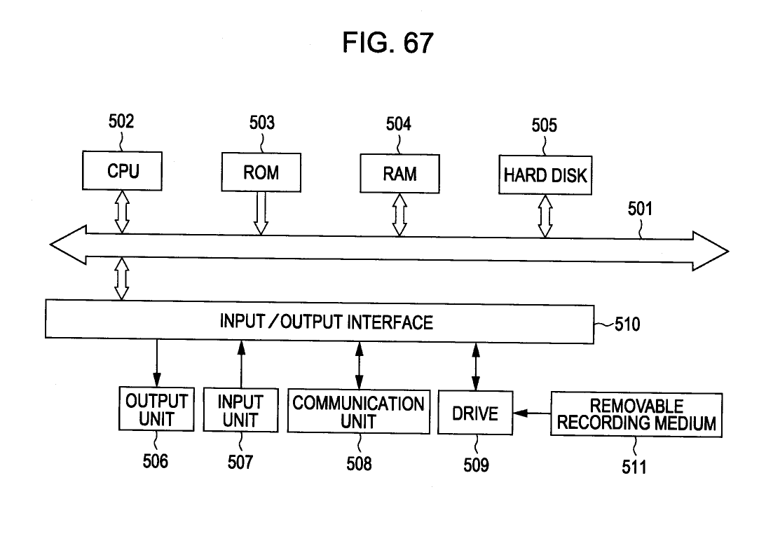

Therefore, FIG. 67 illustrates the configuration example of an embodiment of a computer to which a program for executing the above-described series of processing is installed.

The program can be recorded beforehand in a hard disk 505 or ROM 503, serving as recording media built into the computer.

Alternatively, the program can be stored (recorded) in a removable recording medium 511. Such a removable recording medium 511 can be provided as so-called packaged software. Examples of the removable recording medium 511 include flexible disks, CD-ROM (Compact Disc Read Only Memory) discs, MO (Magneto Optical) discs, DVD (Digital Versatile Disc), magnetic disks, semiconductor memory.

Besides being installed to a computer from the removable recording medium 511 such as described above, the program may be downloaded to the computer via a communication network or broadcasting network, and installed to the built-in hard disk 505. That is to say, the program can be, for example, wirelessly transferred to the computer from a download site via a digital broadcasting satellite, or transferred to the computer by cable via a network such as a LAN (Local Area Network) or the Internet.

The computer has built therein a CPU (Central Processing Unit) 502 with an input/output interface 510 being connected to the CPU 502 via a bus 501.

Upon a command being input by an input unit 507 being operated by the user or the like via the input/output interface 510, in accordance therewith the CPU 502 executes a program stored in ROM (Read Only Memory) 503, or loads a program stored in the hard disk 505 to RAM (Random Access Memory) 504 and executes the program.

Thus, the CPU 502 performs processing following the above-described flowcharts, or processing performed by the configurations of the block diagrams described above. Subsequently, the CPU 502, for example, outputs the processing results thereof from an output unit 506 via the input/output interface 510, or transmits the processing results from a communication unit 508, or further records in the hard disk 505, as appropriate.

Note that the input unit 507 is configured of a keyboard, mouse, microphone, or the like. Also, the output unit 506 is configured of an LCD (Liquid Crystal Display), speaker, or the like.

It should be noted that with the Present Specification, the processing which the computer performs following the program does not have to be performed in the time-sequence following the order described in the flowcharts. That is to say, the processing which the computer performs following the program includes processing executed in parallel or individually (e.g., parallel processing or object-oriented processing) as well.

Also, the program may be processed by a single computer (processor), or may be processed by decentralized processing by multiple computers. Moreover, the program may be transferred to a remote computer and executed.

It should be noted that embodiments of the Present Invention are not restricted to the above-described embodiments, and that various modifications may be made without departing from the spirit and scope of the Present Invention.

The present application contains subject matter related to that disclosed in Japanese Priority Patent Application JP 2009-206435 filed in the Japan Patent Office on Sep. 7, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing device comprising:
hierarchy processing means configured to generate a unit to connect said unit in a hierarchical structure, said unit including
input control means configured to perform input control for storing an observed value to be externally supplied, and outputting the time series of said observed value as input data to be given to a learning model having an HMM (Hidden Markov Model) as a module that is the minimum component,
model processing means configured to perform processing using said learning model, which includes
module learning means configured to obtain, regarding each module making up said learning model, likelihood of said input data being observed with said module, to determine one module of said learning model, or a new module to be an object module that is an object module having HMM parameters to be updated, based on said likelihood, and to perform module learning processing for updating the HMM parameters of said object module using said input data, and
recognizing means configured to recognize said input data using said learning model to output recognition result information that represents the recognition result of said input data, and
output control means configured to perform output control for storing said recognition result information to output said recognition result information as output data to be externally output;
wherein said output control means of a lower unit which is a lower layer unit output said output data to an upper unit which is an upper layer unit connected to said lower unit;
and wherein said input control means of said upper unit store said output data from said lower unit, and output the time series of said output data as said input data.

2. The information processing device according to claim 1, wherein said output control means output said recognition result information as said output data when a predetermined output condition is satisfied;
and wherein said hierarchy processing means generate a new unit when said output control means of an unconnected unit which is a unit not connected to said upper unit output said output data, and connect said new unit to said unconnected unit as an upper unit of said unconnected unit.

3. The information processing device according to claim 1, wherein said input control means of a lowermost layer unit which is a unit of the lowermost layer store an observed value observed from a modeling object which is an object for modeling as said externally supplied observed value, and output the time series of said observed value as said input data;
and wherein an HMM serving as said module making up said learning model of said lowermost layer unit is a continuous HMM in the case that an observed value to be observed from said modeling object is a continuous value, and is a discrete HMM in the case of an observed value to be observed from said modeling object is a discrete value;
and wherein said recognizing means output a symbol representing a maximum likelihood module that is a module having the maximum likelihood of said input data being observed of modules making up said learning model, or two symbols of a symbol representing said maximum likelihood module, and a symbol representing the last state of maximum likelihood state series that is a series of said HMM states in which a state transition having the maximum likelihood of said input data being observed occurs with said maximum likelihood module as recognition result information representing the recognition result of said input data;
and wherein said output control means store said symbol that is said recognition result information, and output this as said output data;
and wherein said input control means of a unit other than said lowermost layer unit store said symbol that is said output data from said lower unit as said externally supplied observed value, and output the time series of said observed value as said input data;
and wherein an HMM serving as said module making up said learning model of a unit other than said lowermost layer unit is a discrete HMM.

4. The information processing device according to claim 3, wherein in the case that an HMM serving as said module making up said learning model is a discrete HMM, when an unobserved value that is an observed value that has not been observed so far is included in said input data, as expansion processing for expanding an observation probability matrix of an observation probability that an observed value of the HMM parameters of said HMM may be observed so as to include the observation probability of said unobserved value, said model processing means perform processing for initializing the observation probability of said unobserved value to a random minute value, and randomizing an observation probability that each observed value may be observed in each state of said HMM so that summation of the observation probability becomes 1.

5. The information processing device according to claim 3, said unit further comprising:
transition information management means configured to generate transition information that is the frequency information of each state transition of said learning model based on said recognition result information;
HMM configuration means configured to configure a combined HMM that is a single HMM obtained by combining a plurality of modules of said learning model using the HMM parameters of the plurality of modules thereof, and said transition information; and
planning means configured to obtain, with an arbitrary state of said combined HMM as a target state candidate that is a candidate of a target state, the maximum likelihood state series that are a series of said combined HMM states in which the likelihood of a state transition from the current state that is a state of the maximum state probability to said target state candidate is the maximum as a plan to get to said target state candidate from said current state;
wherein said planning means of said unit obtain said maximum likelihood state series regarding each of said one or more target state candidates with a state corresponding to each of said symbols that are one or more observed values having an observation probability equal to or greater than a threshold of observed values to be observed in the next state of said current state of said plan supplied from an upper layer unit, and obtained at the unit thereof, as said target state candidate, select said maximum likelihood state series of which the number of states is the minimum of said maximum likelihood state series regarding each of said one or more target state candidates as said plan, and in the case that there is a lower layer unit, supply one or more observed values having an observation probability equal to or greater than a threshold of observed values to be observed in the next state of said current state in said plan to the lower layer unit.

6. The information processing device according to claim 1, wherein said output control means output said recognition result information at predetermined timing as said output data.

7. The information processing device according to claim 1, wherein said output control means output said recognition result information at every predetermined interval as said output data.

8. The information processing device according to claim 1, wherein said output control means output said latest recognition result information as said output data in the case that said latest recognition result information does not match said last recognition result information.

9. The information processing device according to claim 1, wherein said input control means of said upper unit output the time series of said latest fixed-length output data as said input data when storing said latest output data from said lower unit.

10. The information processing device according to claim 1, wherein said input control means of said upper unit output from said output data at the time of having gone back in the past to said latest output data as said input data until a predetermined number of said output data having a different value appear from said latest output data, when storing said latest output data from said lower unit.

11. The information processing device according to claim 1, wherein said recognizing means output a symbol representing a maximum likelihood module that is a module having the maximum likelihood of said input data being observed of modules making up said learning model with the recognition result of said input data as recognition result information.

12. The information processing device according to claim 1, wherein said recognizing means output two symbols of a symbol representing a maximum likelihood module that is a module having the maximum likelihood of said input data being observed of modules making up said learning model, and a symbol representing the last state of maximum likelihood state series that is a series of said HMM states in which a state transition having the maximum likelihood of said input data being observed occurs with said maximum likelihood module as recognition result information representing the recognition result of said input data.

13. An information processing method comprising a step of:
generating a unit to connect said unit in a hierarchical structure, said unit including
input control means configured to perform input control for storing an observed value to be externally supplied, and outputting the time series of said observed value as input data to be given to a learning model having an HMM (Hidden Markov Model) as a module that is the minimum component,
model processing means configured to perform processing using said learning model, which includes
module learning means configured to obtain, regarding each module making up said learning model, likelihood of said input data being observed with said module, to determine one module of said learning model, or a new module to be an object module that is an object module having HMM parameters to be updated, based on said likelihood, and to perform module learning processing for updating the HMM parameters of said object module using said input data, and
recognizing means configured to recognize said input data using said learning model to output recognition result information that represents the recognition result of said input data, and
output control means configured to perform output control for storing said recognition result information to output said recognition result information as output data to be externally output;
wherein said output control means of a lower unit which is a lower layer unit output said output data to an upper unit which is an upper layer unit connected to said lower unit;
and wherein said input control means of said upper unit store said output data from said lower unit, and output the time series of said output data as said input data.

14. A program causing a computer to serve as:
hierarchy processing means configured to generate a unit to connect said unit in a hierarchical structure, said unit including
input control means configured to perform input control for storing an observed value to be externally supplied, and outputting the time series of said observed value as input data to be given to a learning model having an HMM (Hidden Markov Model) as a module that is the minimum component,
model processing means configured to perform processing using said learning model, which includes
module learning means configured to obtain, regarding each module making up said learning model, likelihood of said input data being observed with said module, to determine one module of said learning model, or a new module to be an object module that is an object module having HMM parameters to be updated, based on said likelihood, and to perform module learning processing for updating the HMM parameters of said object module using said input data, and
recognizing means configured to recognize said input data using said learning model to output recognition result information that represents the recognition result of said input data, and
output control means configured to perform output control for storing said recognition result information to output said recognition result information as output data to be externally output;
wherein said output control means of a lower unit which is a lower layer unit output said output data to an upper unit which is an upper layer unit connected to said lower unit;
and wherein said input control means of said upper unit store said output data from said lower unit, and output the time series of said output data as said input data.

15. An information processing device comprising:
a hierarchy processing unit configured to generate a unit to connect said unit in a hierarchical structure, said unit including
an input control unit configured to perform input control for storing an observed value to be externally supplied, and outputting the time series of said observed value as input data to be given to a learning model having an HMM (Hidden Markov Model) as a module that is the minimum component,
a model processing unit configured to perform processing using said learning model, which includes
a module learning unit configured to obtain, regarding each module making up said learning model, likelihood of said input data being observed with said module, to determine one module of said learning model, or a new module to be an object module that is an object module having HMM parameters to be updated, based on said likelihood, and to perform module learning processing for updating the HMM parameters of said object module using said input data, and
a recognizing unit configured to recognize said input data using said learning model to output recognition result information that represents the recognition result of said input data, and
an output control unit configured to perform output control for storing said recognition result information to output said recognition result information as output data to be externally output;
wherein said output control unit of a lower unit which is a lower layer unit outputs said output data to an upper unit which is an upper layer unit connected to said lower unit;
and wherein said input control unit of said upper unit stores said output data from said lower unit, and outputs the time series of said output data as said input data.
